(19) United States
(12) Patent Application Publication
(10) Pub. No.: US 2023/0039668 A1
(43) Pub. Date: Feb. 9, 2023

(54) DYE INK COMPOSITION, CYAN DYE INK, DYE INK FOR INK JET RECORDING, INK JET RECORDING METHOD, AND AQUEOUS DYE SOLUTION

(71) Applicant: FUJIFILM Corporation, Tokyo (JP)

(72) Inventor: Keiichi TATEISHI, Ashigarakami-gun (JP)

(73) Assignee: FUJIFILM Corporation, Tokyo (JP)

(21) Appl. No.: 17/943,213

(22) Filed: Sep. 13, 2022

Related U.S. Application Data
(63) Continuation of application No. PCT/JP2021/013706, filed on Mar. 30, 2021.

(30) Foreign Application Priority Data
Mar. 30, 2020 (JP) 2020-061658

(51) Int. Cl. C09D 11/328; C09B 67/22; C09D 11/037; C09D 11/033; C09D 11/38

(52) U.S. Cl. CPC C09D 11/328; C09B 67/0035; C09D 11/037; C09D 11/033; C09D 11/38

(57) ABSTRACT

A dye ink composition includes: a compound A represented by the general formula (I-1-1) or (I-1-2) as defined herein; a compound B represented by the general formula (1-2-1) or (I-2-2) as defined herein; at least one of a compound C-I represented by the general formula (I-3-1-1) or (I-3-1-2) as defined herein or a compound C-II represented by the general formula (I-3-2-1) or (I-3-2-2) as defined herein; a compound D represented by the general formula (I-4-1) or (I-4-2) as defined herein; and water, in which, as defined herein, a ratio of W₁ to W_{A1} is 6.0% to 35.0% by mass, a ratio of W₂ to W_{A1} is 20.0% to 45.0% by mass, a ratio of W₃ to W_{A1} is 15.0% to 45.0% by mass, and a ratio of W₄ to W_{A1} is 1.0% to 30.0% by mass.

### CROSS REFERENCE TO RELATED APPLICATION

This is a continuation of International Application No. PCT/JP2021/013706 filed on Mar. 30, 2021, and claims priority from Japanese Patent Application No. 2020-061658 filed on Mar. 30, 2020, the entire disclosures of which are incorporated herein by reference.

### BACKGROUND OF THE INVENTION

1. Field of the Invention

The present invention relates to a dye ink composition, a cyan dye ink, a dye ink for ink jet recording, an ink jet recording method, and an aqueous dye solution.

### 2. Description of the Related Art

Dye ink compositions including phthalocyanine dyes are known in the related art.

For example, JP2006-503149A describes an ink composition including a phthalocyanine dye having Ni as a central metal atom.

### SUMMARY OF THE INVENTION

Ink jet paper (also referred to as “ink jet glossy paper”, “photo paper”, or the like) that has an ink-receiving layer having a function of absorbing an ink and fixing a colorant is generally used as a recording material to which an ink jet recording method is applied.

Recently, from the viewpoint of the operating cost (low material cost and being free of maintenance) and the like, more and more users are switching from an electrophotographic recording process using color toners to an ink jet process, also for application to documents in, for example, homes and offices.

In view of such situations, there has been a demand for dye ink compositions that exhibit high print density to both ink jet paper and plain paper serving as recording materials.

Furthermore, in recent years, ink jet printers mounting large-volume ink-tanks having a volume of 50 mL or more have been developed, and such ink jet printers mounting large-volume ink-tanks are said to be excellent in terms of, for example, printing cost because the frequency at which an ink cartridge is replaced can be reduced.

On the other hand, however, dye ink compositions used in such ink jet printers mounting large-volume ink-tanks are required to have continuous ejection stability at a level that has not been achieved in the related art. In addition, storage stability at a level that has not been achieved in the related art is also required because inks remain in the large-volume ink-tanks for a long period.

In JP2006-503149A, no investigations from these points of view are performed, and the above-described new problems that do not arise in the related art cannot be addressed.

That is, an object of the present invention is to provide a dye ink composition that enables the formation of an image having high print density on both ink jet paper and plain paper, that enables stable ejection of an ink even during long time use (that has good continuous ejection stability), and that enables the formation of an image having high print density and has good continuous ejection stability even after a long period of time has passed after preparation; a cyan dye ink including the dye ink composition; a dye ink for ink jet recording, the dye ink including the dye ink composition; an ink jet recording method using the dye ink for ink jet recording; and an aqueous dye solution that can be used to produce the dye ink composition.

The inventors of the present invention have found that the above object can be achieved by the configurations described below.

<1>

A dye ink composition including:

a compound A represented by the following general formula (I-1-1) or (I-1-2);

a compound B represented by the following general formula (I-2-1) or (I-2-2);

at least one of a compound C-I represented by the following general formula (I-3-1-1) or (I-3-1-2) or a compound C-II represented by the following general formula (I-3-2-1) or (I-3-2-2);

a compound D represented by the following general formula (I-4-1) or (I-4-2); and

water.

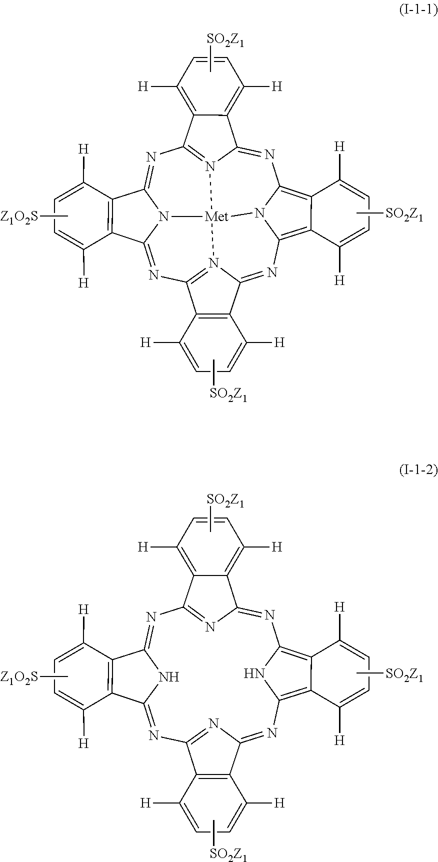

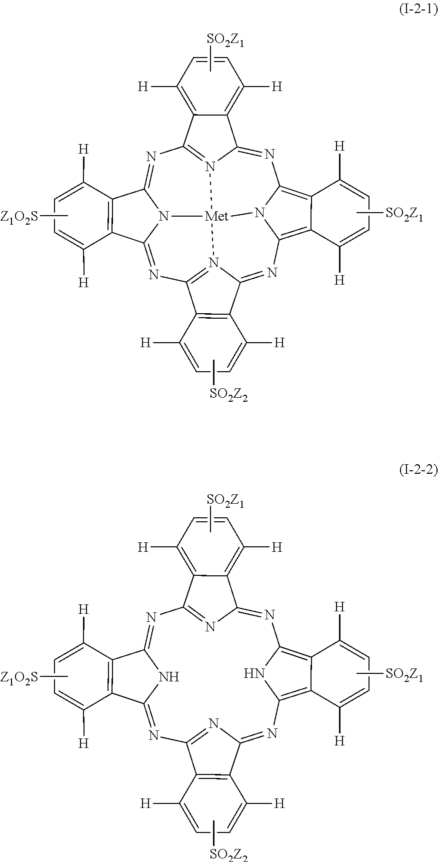

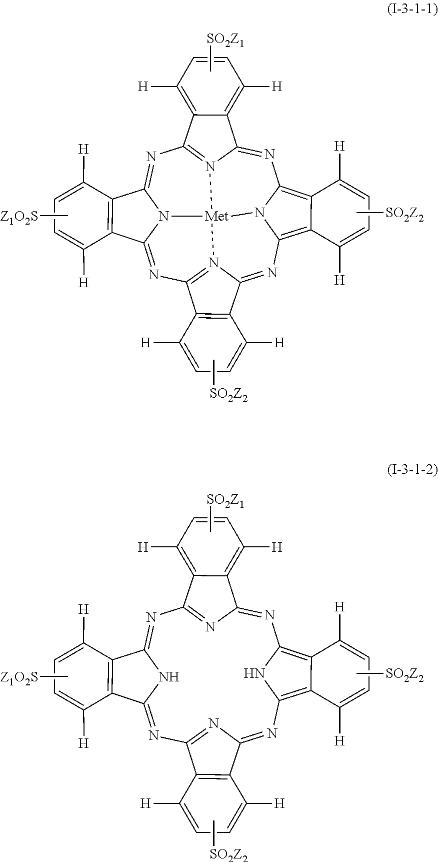

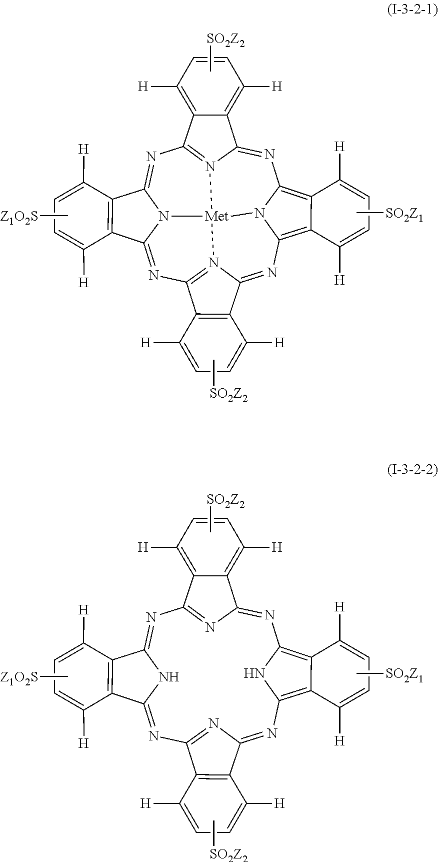

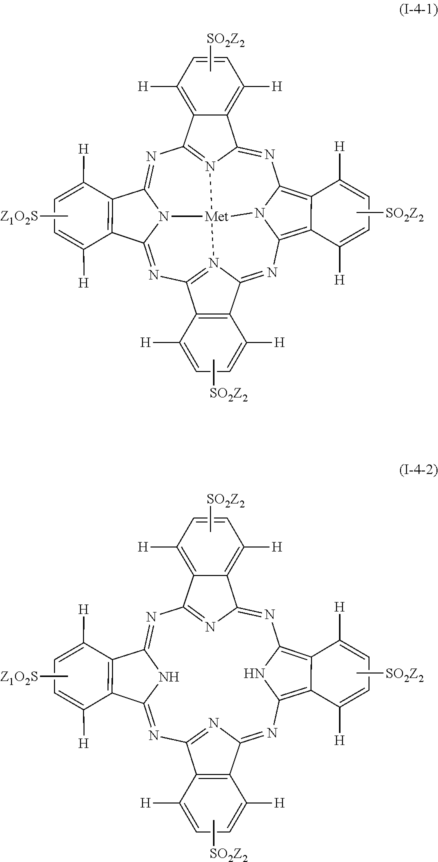

In the general formulae (I-1-1), (I-2-1), (I-3-1-1), (I-3-2-1), and (I-4-1), Met represents Al, Fe, Co, Ni, Zn, Mg, or Mn.

In the general formulae (I-1-1), (I-1-2), (I-2-1), (I-2-2), (I-3-1-1), (I-3-1-2), (I-3-2-1), (I-3-2-2), (I-4-1), and (I-4-2), Z₁ represents an alkyl group, an aryl group, or a heterocyclic group, the alkyl group, the aryl group, and the heterocyclic group having a substituent that has at least one ionic hydrophilic group. A plurality of Z₁ in the general formulae (I-1-1), (I-1-2), (I-2-1), (I-2-2), (I-3-1-1), (I-3-1-2), (I-3-2-1), and (I-3-2-2) may be the same or different.

In the general formulae (I-2-1), (I-2-2), (I-3-1-1), (I-3-1-2), (I-3-2-1), (I-3-2-2), (I-4-1), and (I-4-2), Z₂ represents a substituted or unsubstituted alkyl group, a substituted or unsubstituted aryl group, or a substituted or unsubstituted heterocyclic group. However, Z₂ does not have an ionic hydrophilic group. A plurality of Z₂ in the general formulae (I-3-1-1), (I-3-1-2), (I-3-2-1), (I-3-2-2), (I-4-1), and (I-4-2) may be the same or different,

In the dye ink composition, in a case where a mass of the compound A is represented by W₁, a mass of the compound B is represented by W₂, a sum of a mass of the compound C-I and a mass of the compound C-II is represented by W₃, a mass of the compound D is represented by W₄, and a sum total of W₁, W₂, W₃, and W₄ is represented by W_{A1},

a ratio of W₁ to W_{A1} is 6.0% to 35.0% by mass,

a ratio of W₂ to W_{A1} is 20.0% to 45.0% by mass,

a ratio of W₃ to W_{A1} is 15.0% to 45.0% by mass, and

a ratio of W₄ to W_{A1} is 1.0% to 30.0% by mass.

<2>

The dye ink composition according to <1>, further including a compound E represented by the following general formula (I-5-1) or (I-5-2).

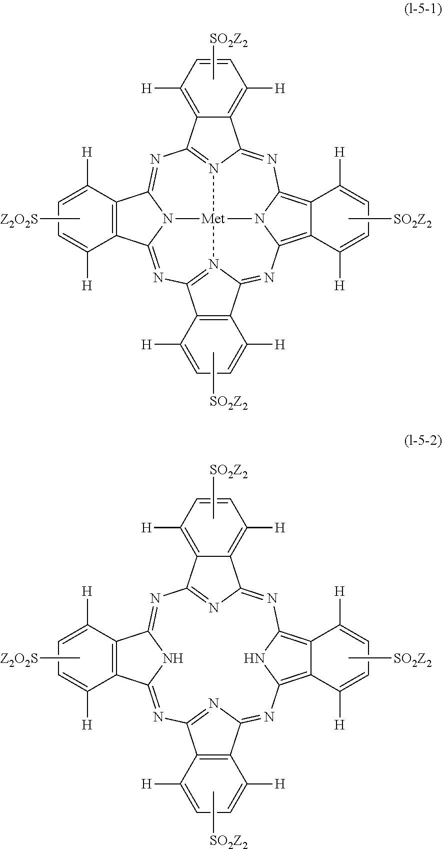

In the general formula (I-5-1), Met represents Al, Fe, Co, Ni, Zn, Mg, or Mn. Z₂ represents a substituted or unsubstituted alkyl group, a substituted or unsubstituted aryl group, or a substituted or unsubstituted heterocyclic group. However, Z₂ does not have an ionic hydrophilic group. The plurality of Z₂ may be the same or different.

<3>

The dye ink composition according to <2>, in which, in the dye ink composition, in a case where a mass of the compound A is represented by W₁, a mass of the compound B is represented by W₂, a sum of a mass of the compound C-I and a mass of the compound C-II is represented by W₃, a mass of the compound D is represented by W₄, a mass of the compound E is represented by W₅, and a sum total of W₁, W₂, W₃, W₄, and W₅ is represented by W_{A2},

a ratio of W₁ to W_{A2} is 5.0% to 35.0% by mass,

a ratio of W₂ to W_{A2} is 20.0% to 45.0% by mass,

a ratio of W₃ to W_{A2} is 15.0% to 45.0% by mass,

a ratio of W₄ to W_{A2} is 1.0% to 30.0% by mass, and

a ratio of W₅ to W_{A2} is 0.1% to 10.0% by mass.

<4>

The dye ink composition according to any one of <1> to <3>, in which Z₂ has at least one of a hydroxy group or a tertiary nitrogen atom.

<5>

The dye ink composition according to any one of <1> to <4>, in which the ionic hydrophilic group is at least one of —SO₃M, —CO₂M, or —PO(OM)₂, and M represents a hydrogen atom or a counter cation.

<6>

The dye ink composition according to <1> or <3>, in which a ratio of W_{A1} or W_{A2} to a total mass of the dye ink composition is 3.0% by mass or more and 5.5% by mass or less.

<7>

The dye ink composition according to any one of <1> to <6>, further including a compound represented by the following general formula (II).

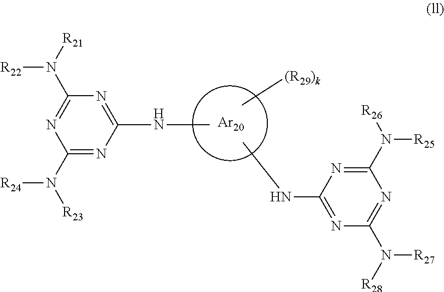

In the general formula (II), Ar₂₀ represents a benzene ring or a naphthalene ring. R₂₁ to R₂₈ each independently represent a hydrogen atom or a substituent. R₂₁ and R₂₂ may be linked to each other to form a ring. R₂₃ and R₂₄ may be linked to each other to form a ring. R₂₅ and R₂₆ may be linked to each other to form a ring. R₂₇ and R₂₈ may be linked to each other to form a ring. R₂₉ represents a substituent. In a case where Ar₂₀ represents a benzene ring, k represents an integer of 0 to 4. In a case where Ar₂₀ represents a naphthalene ring, k represents an integer of 0 to 6. In a case where a plurality of R₂₉ are present, the plurality of R₂₉ may be the same or different. In a case where a plurality of R₂₉ are present, the plurality of R₂₉ may be linked together to form a ring. However, at least any one of R₂₁ to R₂₉ has a hydrophilic group.

<8>

The dye ink composition according to <7>, in which a content of the compound represented by the general formula (II) is 0.5% to 3.0% by mass with respect to a total mass of the dye ink composition.

<9>

The dye ink composition according to any one of <1> to <8>, further including a compound represented by the following general formula (Cy-1).

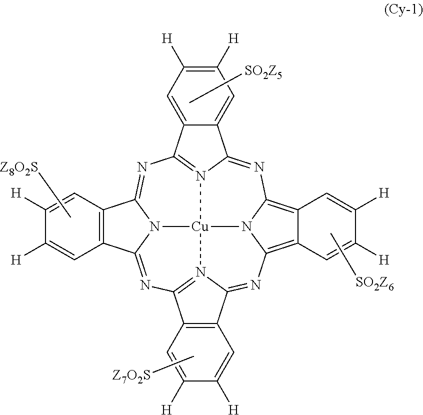

In the general formula (Cy-1), Z₅, Z₆, Z₇, and Z₈ each independently represent a substituted or unsubstituted alkyl group, a substituted or unsubstituted aryl group, or a substituted or unsubstituted heterocyclic group. However, at least one of Z₅, Z₆, Z₇, or Z₈ has a substituent that has an ionic hydrophilic group.

<10>

The dye ink composition according to any one of <1> to <9>, further including a compound represented by any of the following general formulae (Cy-2) to (Cy-5).

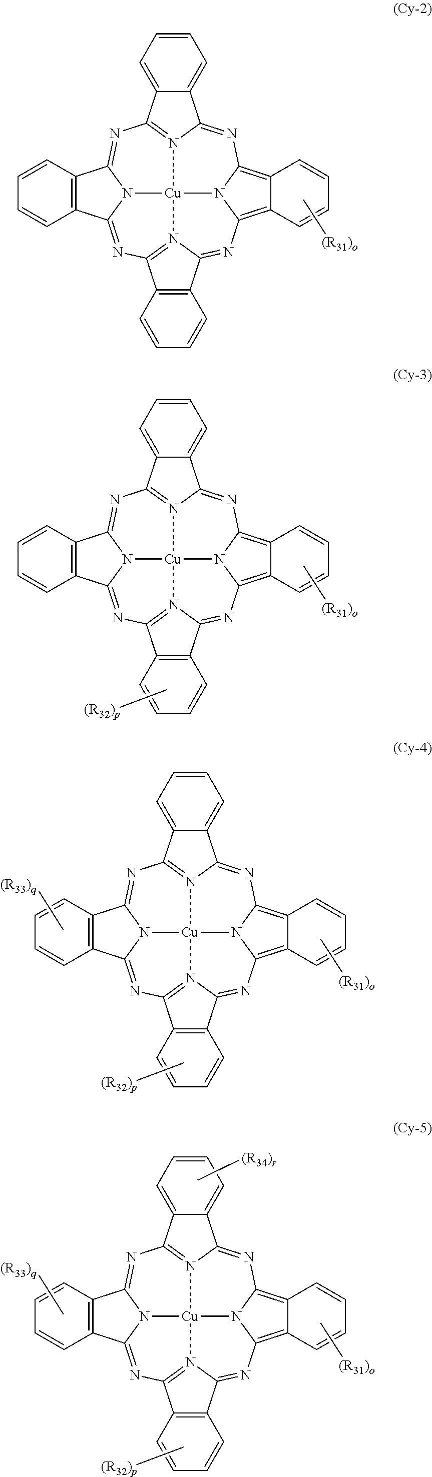

In the general formulae (Cy-2) to (Cy-5), R₃₁, R₃₂, R₃₃, and R₃₄ each independently represent a substituted or unsubstituted sulfamoyl group, a substituted or unsubstituted carbamoyl group, a sulfo group, or a carboxy group. In a case where a plurality of R₃₁ are present, the plurality of R₃₁ may be the same or different. In a case where a plurality of R₃₂ are present, the plurality of R₃₂ may be the same or different. In a case where a plurality of R₃₃ are present, the plurality of R₃₃ may be the same or different. In a case where a plurality of R₃₄ are present, the plurality of R₃₄ may be the same or different. o, p, q, and r each independently represent an integer of 1 to 4.

<11>

The dye ink composition according to any one of <1> to <10>, further including a chelating agent.

<12>

The dye ink composition according to any one of <1> to <11>, further including a preservative.

<13>

A cyan dye ink including the dye ink composition according to any one of <1> to <12>.

<14>

A dye ink for ink jet recording, the dye ink including the dye ink composition according to any one of <1> to <12>.

<15>

An ink jet recording method having ejecting the dye ink for ink jet recording according to <14> with a recording head for an ink jet process.

<16>

An aqueous dye solution including:

a preservative,

a compound A represented by the following general formula (I-1-1) or (I-1-2),

a compound B represented by the following general formula (I-2-1) or (I-2-2),

at least one of a compound C-I represented by the following general formula (I-3-1-1) or (I-3-1-2) or a compound C-II represented by the following general formula (I-3-2-1) or (I-3-2-2), and

a compound D represented by the following general formula (I-4-1) or (I-4-2),

in which in a case where a mass of the compound A is represented by W₁, a mass of the compound B is represented by W₂, a sum of a mass of the compound C-I and a mass of the compound C-11 is represented by W₃, a mass of the compound D is represented by W₄, and a sum total of W₁, W₂, W₃, and W₄ is represented by W_{A1,}

a ratio of W_{A1} to a total mass of the aqueous dye solution is 8% to 15% by mass.

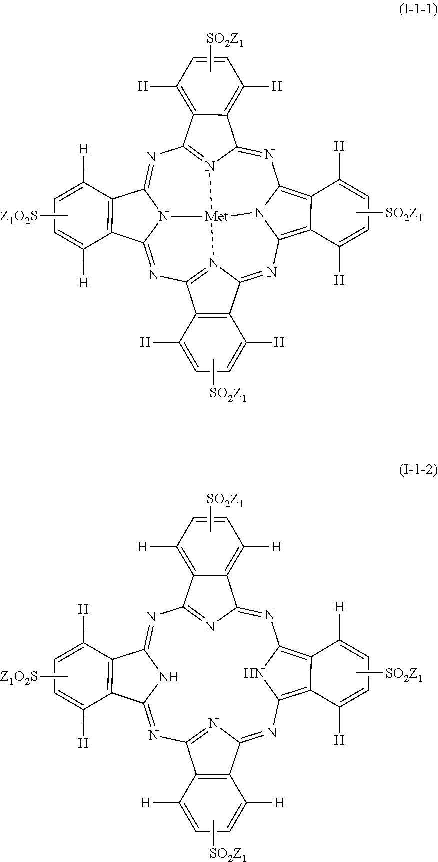

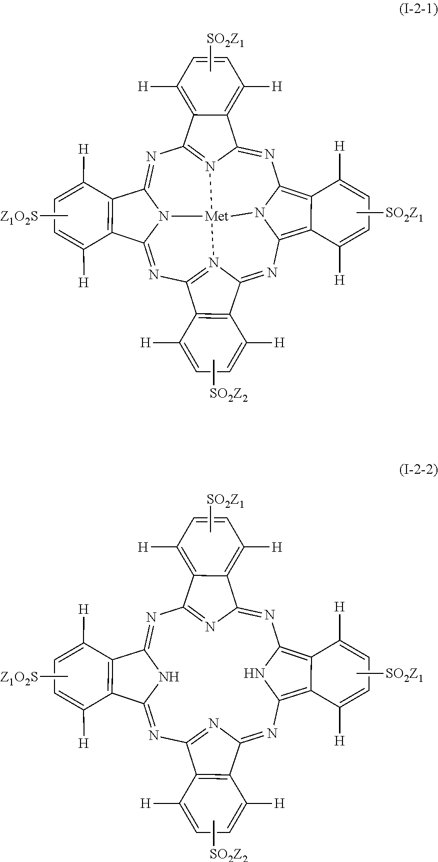

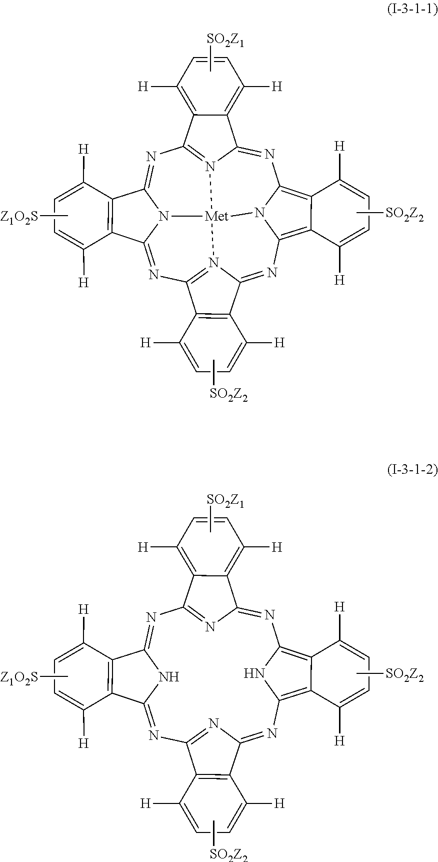

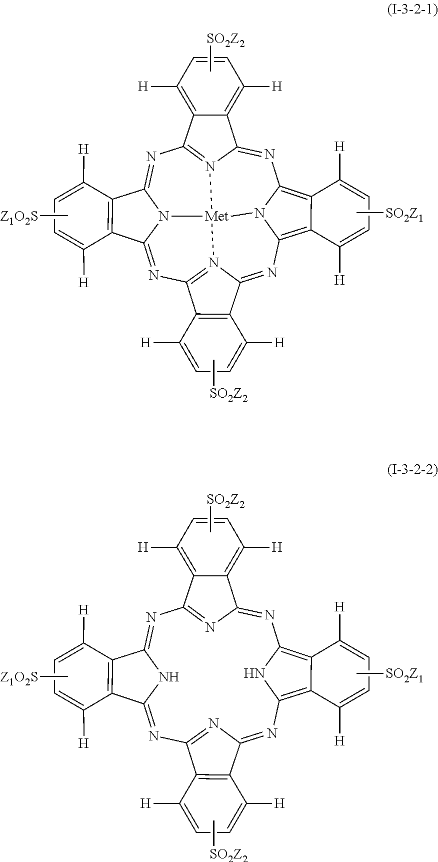

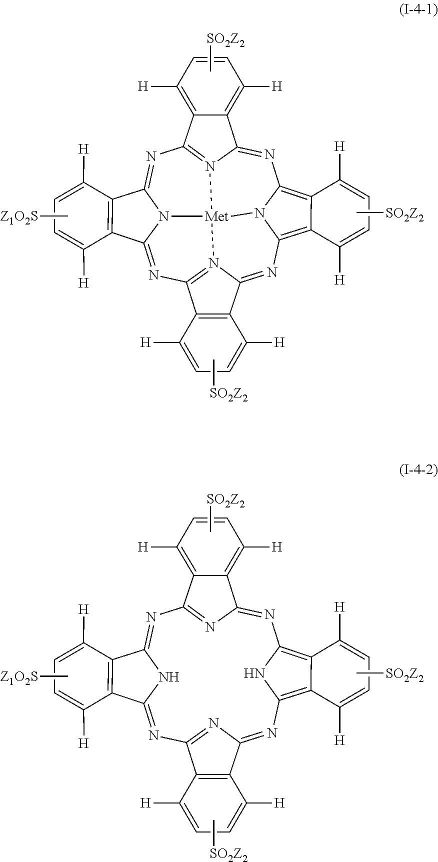

In the general formulae (I-1-1), (I-2-1), (I-3-1-1), (I-3-2-1), and (I-4-1), Met represents Al, Fe, Co, Ni, Zn, Mg, or Mn.

In the general formulae (I-1-1), (I-1-2), (I-2-1), (I-2-2), (I-3-1-1), (I-3-1-2), (I-3-2-1), (I-3-2-2), (I-4-1), and (I-4-2), Zi represents an alkyl group, an aryl group, or a heterocyclic group, the alkyl group, the aryl group, and the heterocyclic group having a substituent that has at least one ionic hydrophilic group. A plurality of Zᵢ in the general formulae (I-1-1), (I-1-2), (I-2-1), (I-2-2), (I-3-1-1), (I-3-1-2), (I-3-2-1), and (I-3-2-2) may be the same or different.

In the general formulae (I-2-1), (I-2-2), (I-3-1-1), (I-3-1-2), (I-3-2-1), (I-3-2-2), (I-4-1), and (I-4-2), Z₂ represents a substituted or unsubstituted alkyl group, a substituted or unsubstituted aryl group, or a substituted or unsubstituted heterocyclic group. However, Z₂ does not have an ionic hydrophilic group. A plurality of Z₂ in the general formulae (I-3-1-1), (I-3-1-2), (I-3-2-1), (I-3-2-2), (I-4-1), and (I-4-2) may be the same or different.

<17>

The aqueous dye solution according to <16>, further comprising:

a compound E represented by the following general formula (I-5-1) or (I-5-2),

in which in a case where a mass of the compound E is represented by W₅ and a sum total of W₁, W₂, W₃, W₄, and W₅ is represented by W_{A2},

a ratio of W_{A2} to the total mass of the aqueous dye solution is 8% to 15% by mass.

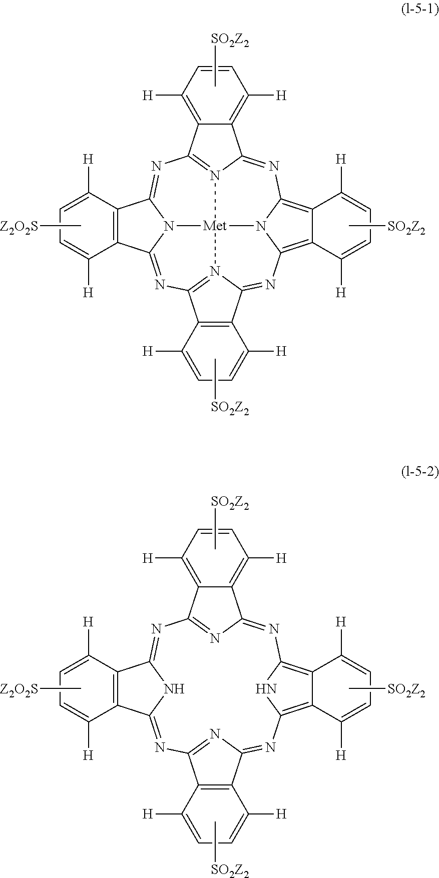

In the general formula (I-5-1), Met represents Al, Fe, Co, Ni, Zn, Mg, or Mn. Z₂ represents a substituted or unsubstituted alkyl group, a substituted or unsubstituted aryl group, or a substituted or unsubstituted heterocyclic group. However, Z₂ does not have an ionic hydrophilic group. The plurality of Z₂ may be the same or different.

<18>

The aqueous dye solution according to <16> or <17>, further including a compound represented by the following general formula (II).

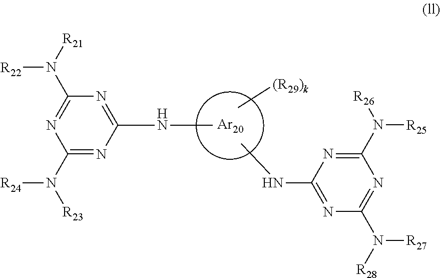

In the general formula (II), Ara) represents a benzene ring or a naphthalene ring. R₂₁ to R₂₈ each independently represent a hydrogen atom or a substituent. R₂₁ and R₂₂ may be linked to each other to form a ring. R₂₃ and R₂₄ may be linked to each other to form a ring. R25 and R₂₆ may be linked to each other to form a ring. R₂₇ and R₂₈ may be linked to each other to form a ring. R₂₉ represents a substituent. In a case where Ar₂₀ represents a benzene ring, k represents an integer of 0 to 4. In a case where Ar₂₀ represents a naphthalene ring, k represents an integer of 0 to 6. In a case where a plurality of R₂₉ are present, the plurality of R₂₉ may be the same or different. In a case where a plurality of R₂₉ are present, the plurality of R₂₉ may be linked together to form a ring. However, at least any one of R₂₁ to R₂₉ has a hydrophilic group.

<19>

The aqueous dye solution according to any one of <16> to <18>, further including a chelating agent.

<20>

The aqueous dye solution according to any one of <16> to <19>, further including a compound represented by the following general formula (S).

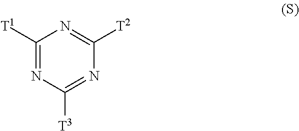

In the general formula (S), T¹, T², and T³ each independently represent *—NH—(CH₂)ₙ-Rt, *—NH—(CH₂)ₙ—OH, *—N—((CH₂)ₙ—OH)₂, *—OM, a halogen atom, or a substituted or unsubstituted arylamino group. However, at least one of T¹, T², or T³ represents *—NH—(CH₂)ₙ-Rt, *—NH—(CH₂)ₙ—OH, or *—N—((CH₂)ₙ—OH)₂. * represents a binding site to a triazine ring, n represents an integer of 1 to 5, and Rt represents COOM, SO₃M, or PO(OM)₂. M represents a hydrogen atom or a counter cation. In a case where a plurality of n are present, the plurality of n may be the same or different. In a case where a plurality of M are present, the plurality of M may be the same or different.

<21>

The aqueous dye solution according to <20>, in which the compound represented by the general formula (S) is at least one compound selected from the following compound group (s).

Compound Group (s):

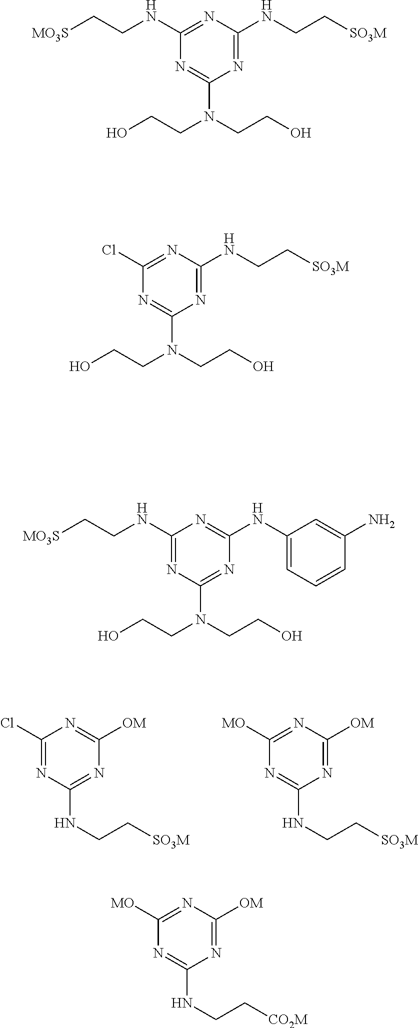

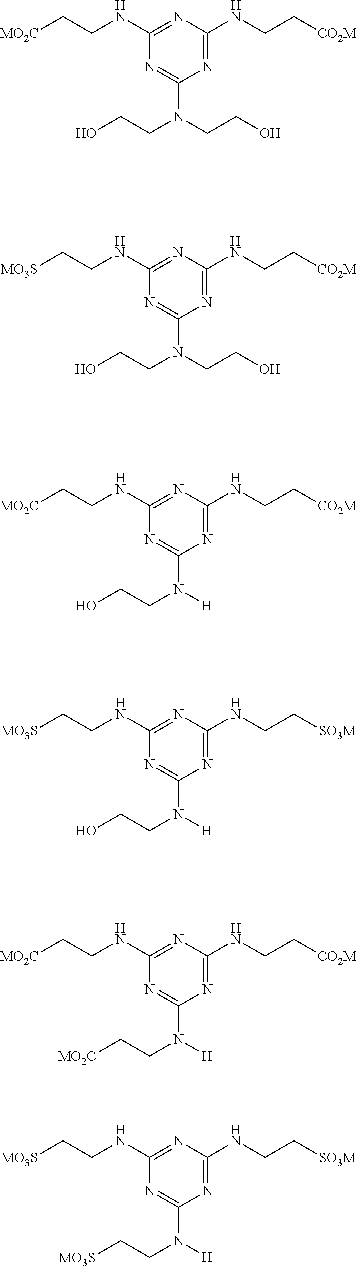

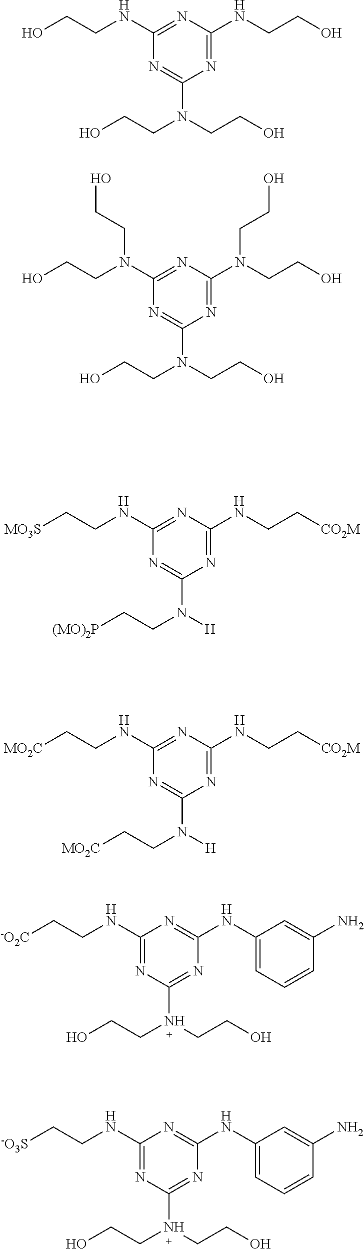

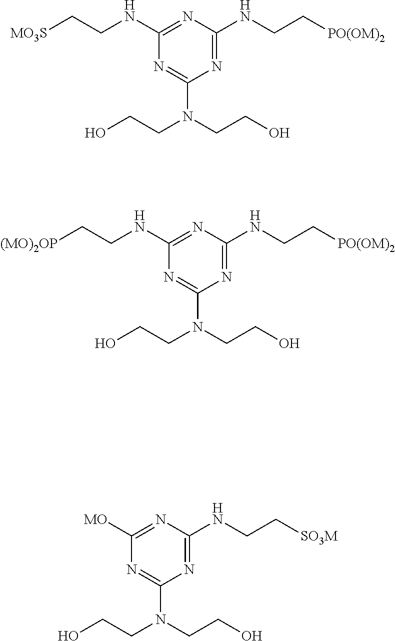

M in a compound of the compound group (s) represents a hydrogen atom or a counter cation. In a case where a plurality of M are present in the compound, the plurality of M may be the same or different.

According to the present invention, it is possible to provide a dye ink composition that enables the formation of an image having high print density on both ink jet paper and plain paper, that enables stable ejection of an ink even during long time use (that has good continuous ejection stability), and that enables the formation of an image having high print density and has good continuous ejection stability even after a long period of time has passed after preparation; a cyan dye ink including the dye ink composition; a dye ink for ink jet recording, the dye ink including the dye ink composition; an ink jet recording method using the dye ink for ink jet recording; and an aqueous dye solution that can be used to produce the dye ink composition.

### DESCRIPTION OF THE PREFERRED EMBODIMENTS

Hereafter, the present invention will be described in detail with reference to preferred embodiments.

### Dye Ink Composition

A dye ink composition according to the present invention is a dye ink composition including

a compound A represented by general formula (I-1-1) or (I-1-2) below,

a compound B represented by general formula (I-2-1) or (I-2-2) below,

at least one of a compound C-I represented by general formula (I-3-1-1) or (I-3-1-2) below or a compound C-II represented by general formula (I-3-2-1) or (I-3-2-2) below,

a compound D represented by general formula (I-4-1) or (I-4-2) below, and

water.

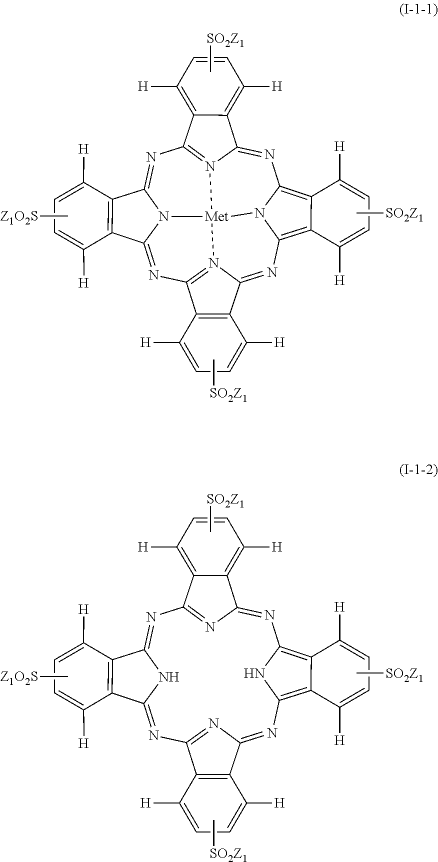

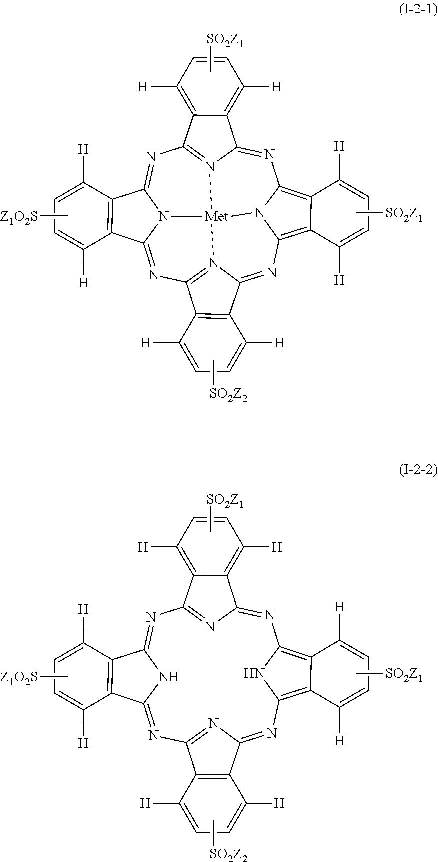

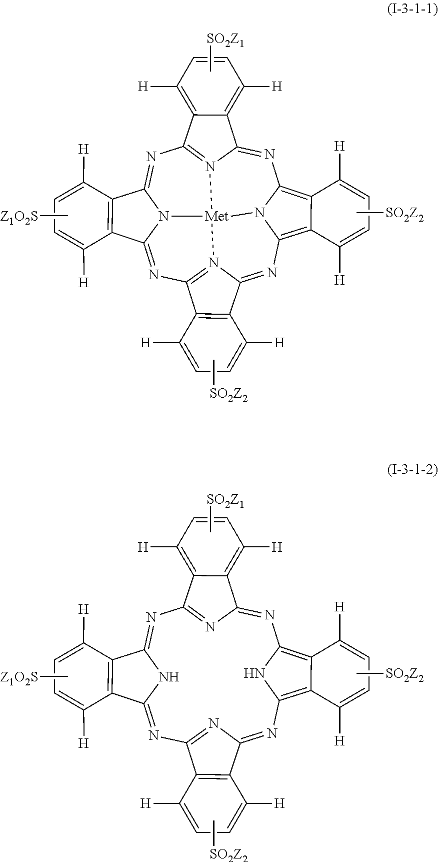

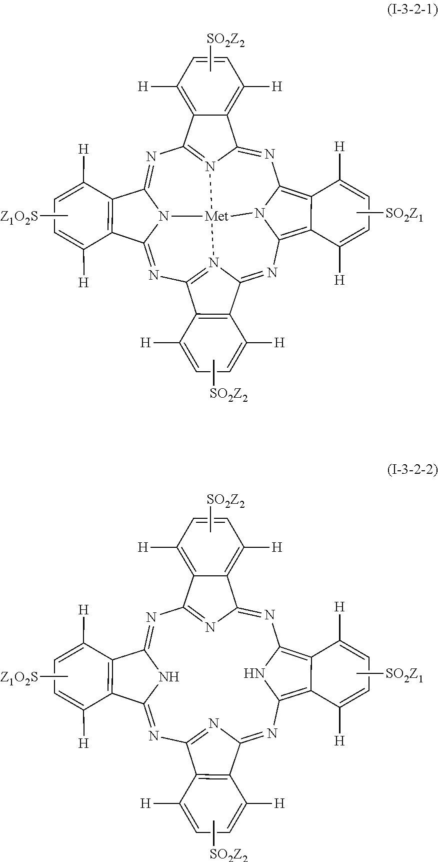

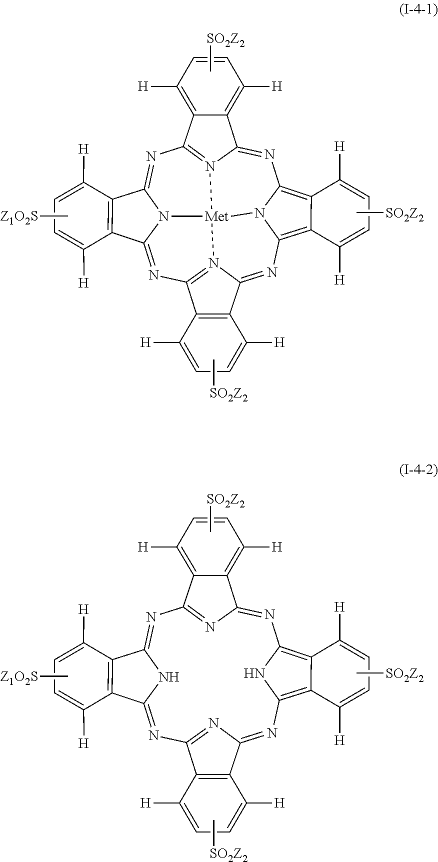

In general formulae (I-1-1), (I-2-1), (I-3-1-1), (I-3-2-1), and (I-4-1), Met represents Al, Fe, Co, Ni, Zn, Mg, or Mn.

In general formulae (I-1-1), (I-1-2), (I-2-1), (I-2-2), (I-3-1-1), (I-3-1-2), (I-3-2-1), (I-3-2-2), (I-4-1), and (I-4-2), Z₁ represents an alkyl group, aryl group, or heterocyclic group having a substituent that includes at least one ionic hydrophilic group. A plurality of Z₁ in general formulae (I-1-1), (I-1-2), (I-2-I), (I-2-2), (I-3-1-1), (I-3-1-2), (I-3-2-1), and (I-3-2-2) may be the same or different.

In general formulae (I-2-1), (I-2-2), (I-3-1-1), (I-3-1-2), (I-3-2-1), (I-3-2-2), (I-4-1), and (I-4-2), Z₂ represents a substituted or unsubstituted alkyl group, a substituted or unsubstituted aryl group, or a substituted or unsubstituted heterocyclic group. However, Z₂ does not have an ionic hydrophilic group. A plurality of Z₂ in general formulae (I-3-1-1), (I-3-1-2), (I-3-2-1), (I-3-2-2), (I-4-1), and (I-4-2) may be the same or different.

The reason why the dye ink composition according to the present invention enables the formation of an image having high print density on both ink jet paper and plain paper, has good continuous ejection stability, and enables the formation of an image having high print density and has good continuous ejection stability even after a long period of time has passed after preparation has not been completely clarified; however, the inventors of the present invention infer that the reason is as follows.

The use of a dye ink composition that includes an existing water-soluble phthalocyanine dye enables the formation of an image with a cyan hue by an ink jet recording method. In the image immediately after the formation, the phthalocyanine dye is considered to form a relatively stable association state of the dye in an aqueous medium. Next, during drying of the dye ink composition, together with a change in the temperature and humidity of the surrounding environment, the water-soluble phthalocyanine dye is considered to proceed to a more stable association state of the dye with the temperature and moisture serving as driving force. It is inferred that a decrease in wavelength of the hue and a simultaneous decrease in the color value occur, and consequently, the print density decreases.

Furthermore, in the case of the dye ink composition that includes an existing water-soluble phthalocyanine dye, when an image is formed not on ink jet paper, which has an ink-receiving layer supported on porous silica or alumina, but on plain paper, the dye ink composition penetrates as it is in the thickness direction of base paper. Therefore, when droplets of the dye ink composition are ejected onto plain paper, the resulting image is considered to have a reflection density lower than that in the case where droplets of the dye ink composition are ejected onto ink jet paper, as long as the amount of dye ink composition ejected in the form of droplets is the same.

In contrast, in the present invention, since the compound A, the compound B, at least one of the compound C-I or the compound C-II, and the compound D are used as a coloring agent, in an image immediately after being formed by the ink jet recording method, the compound A, the compound B, at least one of the compound C-I or the compound C-II, and the compound D can be stabilized by the effect of the intermolecular interaction. It is assumed that, as a result, a high-order associate is formed between dye molecules to increase the apparent molecular weight of the phthalocyanine-based dyes, and the dye ink composition is less likely to penetrate in the depth direction of plain paper (the coloring agent is easily localized in a surface portion of the paper); therefore, high print density could be achieved.

In addition, when an image is formed on plain paper, the dye ink composition having a strong interaction between molecules of the phthalocyanine dyes of the compound A, the compound B, at least one of the compound C-I or the compound C-II, and the compound D also interacts with, for example, cellulose fibers constituting base paper and is thereby less likely to penetrate as it is in the thickness direction of the base paper, and as a result, the reflection density is less likely to decrease. This is considered to be another mechanism by which high print density could be realized.

Furthermore, it is considered that since the compound A having high water solubility and the compound D that induces a strong intermolecular interaction coexist in the dye ink composition according to the present invention, it was possible to achieve continuous ejection stability and storage stability at higher levels than those in the related art. More specifically, the presence of the compound A having the highest water solubility enhances compatibility of the mixture of the compound A to the compound D in the water medium.

In the present invention, when a compound is a salt, the salt is present in the water-soluble ink in the form of being dissolved in a state where the salt is completely dissociated into ions. When a compound has an ionic hydrophilic group having a high acid dissociation constant (pKa), the compound may be present in the form of being dissolved in a state where most of the compound is dissociated and a part thereof is in a salt state.

### Compound A

The compound A in the present invention will be described.

The compound A is a compound represented by general formula (I-1-1) or (I-1-2) below.

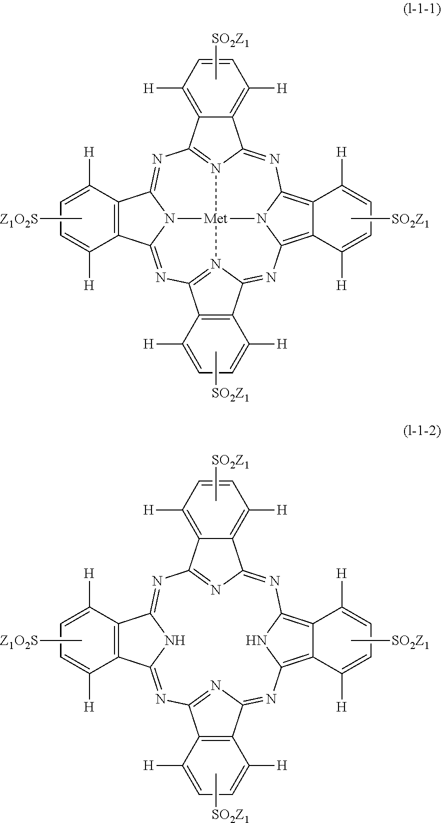

In general formula (I-1-1), Met represents Al, Fe, Co, Ni, Zn, Mg, or Mn. In general formulae (I-1-1) and (I-1-2), each Z₁ represents an alkyl group, aryl group, or heterocyclic group having a substituent that includes at least one ionic hydrophilic group. The plurality of Z₁ may be the same or different.

The compound A is a phthalocyanine dye in which substituted sulfonyl groups (—SO₂—Z₁) are introduced to β positions of the phthalocyanine skeleton. That is, in general formulae (I-1-1) and (I-1-2), —SO₂—Z₁ replace hydrogen atoms at β positions of the phthalocyanine skeleton but do not replace hydrogen atoms at a positions of the phthalocyanine skeleton. All the four —SO₂—Z₁ in general formulae (I-1-1) and (I-1-2) are preferably the same group.

The α positions and the β positions of the phthalocyanine skeleton are as illustrated in formulae (a-1) and (a-2) below.

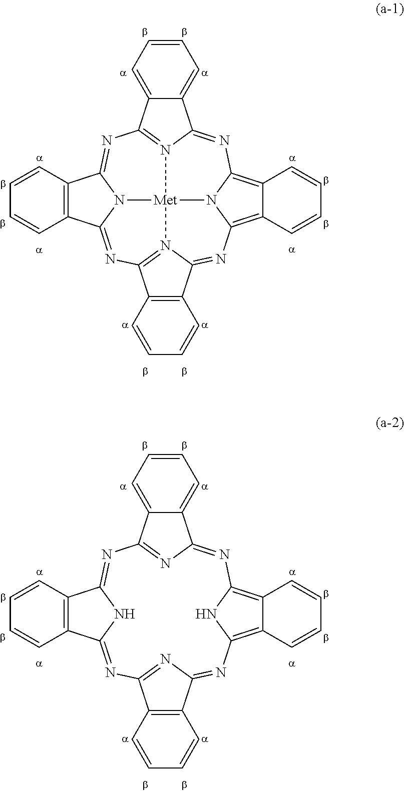

In formula (a-1), Met represents Al, Fe, Co, Ni, Zn, Mg, or Mn.

In general formulae (I-1-1) and (I-1-2), each Z₁ represents an alkyl group, aryl group, or heterocyclic group having a substituent that includes at least one ionic hydrophilic group.

The “alkyl group, aryl group, or heterocyclic group having a substituent that includes at least one ionic hydrophilic group” may be an “an alkyl group, aryl group, or heterocyclic group having, as a substituent, at least one ionic hydrophilic group” or may be an “alkyl group, aryl group, or heterocyclic group having, as a substituent, a group other than an ionic hydrophilic group, the group being substituted with at least one ionic hydrophilic group”.

Z₁ preferably represents an alkyl group or aryl group having a substituent that includes at least one ionic hydrophilic group and more preferably represents an alkyl group having a substituent that includes at least one ionic hydrophilic group.

When Z₁ represents an alkyl group having a substituent that includes at least one ionic hydrophilic group, the alkyl group is not particularly limited but is preferably an alkyl group having 1 to 8 carbon atoms, more preferably an alkyl group having 1 to 6 carbon atoms, and still more preferably an alkyl group having 3 to 5 carbon atoms from the viewpoints of water solubility of the dye and stability of the substituent. The alkyl group may be linear, branched, or cyclic but is preferably a linear alkyl group having 3 to 5 carbon atoms from the viewpoints of availability of raw materials and water solubility of the dye. Specific examples of the alkyl group include a methyl group, an ethyl group, a n-propyl group, an i-propyl group, a n-butyl group, an isobutyl group, a sec-butyl group, a t-butyl group, and a n-pentyl group.

In the present specification, an “alkyl group” may be linear, branched, or cyclic. That is, the “alkyl group” also includes a cycloalkyl group, a bicycloalkyl group, and the like. This also applies to an alkyl group in other substituents (for example, an alkyl group in an alkyloxy group or an alkylthio group). This also applies to an “alkenyl group” and an “alkynyl group”.

When Z₁ represents an aryl group having a substituent that includes at least one ionic hydrophilic group, the aryl group is not particularly limited but is preferably an aryl group having 6 to 14 carbon atoms, more preferably an aryl group having 6 to 12 carbon atoms, and particularly preferably an aryl group having 6 to 10 carbon atoms from the viewpoints of availability of raw materials and water solubility of the dye. Specific examples of the aryl group include a phenyl group and a naphthyl group.

When Z₁ represents a heterocyclic group having a substituent that includes at least one ionic hydrophilic group, the heterocyclic group is not particularly limited but is preferably a heterocyclic group having 2 to 12 carbon atoms, more preferably a heterocyclic group having 2 to 8 carbon atoms, and particularly preferably a heterocyclic group having 2 to 6 carbon atoms from the viewpoints of availability of raw materials, water solubility of the dye, and stability of the substituent. Examples of heteroatoms included in the heterocyclic group include, but are not particularly limited to, a sulfur atom, a nitrogen atom, and an oxygen atom.

The ionic hydrophilic group is a group selected from the group consisting of a sulfo group (—SO₃M), a carboxy group (—CO₂M), a thiocarboxy group, a sulfino group (—SO₂M), a phosphono group (—PO(OT)(OM)), a dihydroxyphosphino group, a phosphate group (—PO(OM)₂), a quaternary ammonium group, an acylsulfamoyl group (—SO₂N⁻M⁺COT), a sulfonylcarbamoyl group (—CON⁻M⁺SO₂-T), and a sulfonylaminosulfonyl group (—SO₂N⁻M⁺SO₂-T). M represents a hydrogen atom or a counter cation. T is a monovalent substituent (such as an alkyl group or an aryl group).

From the viewpoints of providing the dye with water solubility and enhancing storage stability of the dye ink composition, the ionic hydrophilic group included in Z₁ is preferably an acidic group, more preferably a sulfo group (—SO₃M), a carboxy group (—CO₂M), or a phosphate group (—PO(OM)₂), still more preferably a sulfo group (—SO₃M) or a carboxy group (—CO₂M), and most preferably a sulfo group (—SO₃M).

M represents a hydrogen atom or a counter cation.

When M represents a counter cation, examples thereof include an ammonium ion (NH₄⁺), alkali metal ions (e.g., a lithium ion, a sodium ion, and a potassium ion), and organic cations (e.g., a tetramethylammonium ion, a tetramethylguanidinium ion, and a tetramethylphosphonium ion).

M is preferably a hydrogen atom, an alkali metal cation, or an ammonium ion and more preferably an alkali metal ion.

From the viewpoint of providing the dye with water solubility, M in —SO₃M is preferably a lithium ion, a sodium ion, a potassium ion, or an ammonium ion, more preferably a lithium ion, a sodium ion, or an ammonium ion, particularly preferably a lithium ion or a sodium ion, and most preferably a lithium ion.

From the viewpoint of providing the dye with water solubility, M in —CO₂M is preferably a lithium ion, a sodium ion, a potassium ion, or an ammonium ion, more preferably a sodium ion, a potassium ion, or an ammonium ion, particularly preferably a sodium ion or a potassium ion, and most preferably a potassium ion.

M may be a divalent counter cation. In a case where M is a divalent counter cation, the compound may have, for example, a form in which one M functions as a counter cation of two —SO₃⁻. From the viewpoint of water solubility, M is preferably a monovalent counter cation.

Z₁ may have only one ionic hydrophilic group or two or more ionic hydrophilic groups. In a case where Z₁ has two or more ionic hydrophilic groups, the ionic hydrophilic groups may be the same or different.

When M represents a particular cation (e.g., a lithium ion), all M need not necessarily be lithium ions, but substantially, the counter cation having the highest presence ratio is preferably a lithium ion. Under the conditions of such a presence ratio, the compound can include, as M, for example, a hydrogen atom, an alkali metal ion (e.g., a sodium ion or a potassium ion), an alkaline-earth metal ion (e.g., a magnesium ion, a calcium ion, or the like), a quaternary ammonium ion, a quaternary phosphonium ion, or a sulfonium ion. The amount of lithium ions is preferably 50% or more, more preferably 60% or more, still more preferably 80% or more, particularly preferably 90% or more, and most preferably 100% relative to the total number of M.

The case of a lithium ion also applies to a case where the particular cation represents a cation (e.g., a sodium ion) other than a lithium ion.

When Z₁ is an alkyl group, aryl group, or heterocyclic group having, as a substituent, a group other than an ionic hydrophilic group, the group being substituted with at least one ionic hydrophilic group, examples of the group other than the ionic hydrophilic group include substituted or unsubstituted alkyloxy groups, substituted or unsubstituted aryloxy groups, substituted or unsubstituted amino groups, substituted or unsubstituted sulfamoyl groups, substituted or unsubstituted carbamoyl groups, substituted or unsubstituted alkylsulfonyl groups, and substituted or unsubstituted arylsulfonyl groups. When these substituents can further have at least one substituent, groups having, as the additional substituent, a substituent selected from the group consisting of the aforementioned substituents are also included in the examples of the group other than the ionic hydrophilic group. The group other than the ionic hydrophilic group preferably has 1 to 20 carbon atoms and more preferably has 1 to 10 carbon atoms.

Z₁ may have, in addition to a substituent that includes an ionic hydrophilic group, a substituent other than the substituent that includes an ionic hydrophilic group. Examples of the substituent other than the substituent that includes an ionic hydrophilic group include halogen atoms, a hydroxy group, substituted or unsubstituted alkyl groups, substituted or unsubstituted aryl groups, substituted or unsubstituted heterocyclic groups, substituted or unsubstituted alkyloxy groups, substituted or unsubstituted aryloxy groups, substituted or unsubstituted amino groups, substituted or unsubstituted sulfamoyl groups, substituted or unsubstituted carbamoyl groups, substituted or unsubstituted alkylsulfonyl groups, and substituted or unsubstituted arylsulfonyl groups. When these substituents can further have at least one substituent, groups having, as the additional substituent, a substituent selected from the group consisting of the aforementioned substituents are also included in the examples of the substituent other than the substituent that includes an ionic hydrophilic group. When the substituent other than the substituent that includes an ionic hydrophilic group is an organic group (group that includes at least one carbon atom), the substituent is preferably an organic group having 1 to 10 carbon atoms, and more preferably an organic group having 1 to 6 carbon atoms.

Preferred examples of Z₁ include —(CH₂)₃—SO₃M, —(CH₂)₄—SO₃M, —(CH₂)₂CH(CH₃)—SO₃M, —(CH₂)₅—SO₃M, —(CH₂)₃—CO₂M, —(CH₂)₄—CO₂M, —(CH₂)₅—CO₂M, —C₂H₄OC₂H₄SO₃M, —C₂H₄OC₂H₄OC₂H₄SO₃M, —CH₂CH(OH)CH₂SO₃M, —CH₂CH(OH)CH₂CO₂M, —(CH₂)₃—SO₂NHCH₂CH(OH)CH₂SO₃M, —(CH₂)₃—SO₂NHCH₂CH(OH)CH₂CO₂M, —(CH₂)₃—CONHC₂H₄SO₃M, —(CH₂)₃—CONHCH₂CH(OH)CH₂CH₂SO₃M, —(CH₂)₃—CONHCH₂CH(OH)CH₂CO₂M, —(CH₂)₃—SO₂NHCH₂CH₂N{CH₂CH₂SO₃M}₂, —(CH₂)₃—SO₂NHCH₂CH₂N{CH₂CH₂CO₂M}₂, and

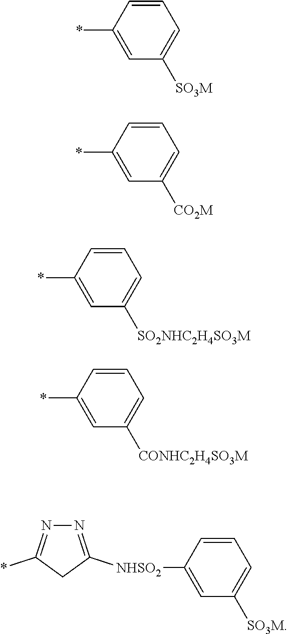

In the above structural formulae, * represents a binding site to a sulfonyl group.

In the structural formulae, M represents a hydrogen atom or a counter cation, and specific examples and preferred examples are the same as those described above.

The plurality of Z₁ in general formulae (I-1-1) and (I-1-2) may be the same or different; however, all Z₁ are preferably the same.

In general formula (I-1-1), Met represents Al, Fe, Co, Ni, Zn, Mg, or Mn, preferably represents Al, Fe, Ni, Zn, Mg, or Mn, more preferably represents Fe, Zn, Mg, or Mn, and still more preferably represents Mg.

The compound A included in the dye ink composition according to the present invention may be one compound or two or more compounds. A compound represented by general formula (I-1-1) and a compound represented by general formula (I-1-2) may be used in combination as the compound A.

### Compound B

The compound B in the present invention will be described.

The compound B is a compound represented by general formula (I-2-1) or (I-2-2) below.

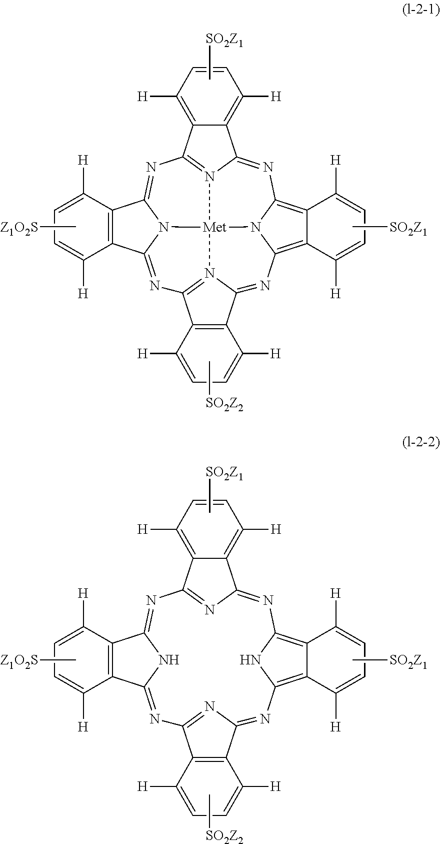

In general formula (I-2-1), Met represents Al, Fe, Co, Ni, Zn, Mg, or Mn. In general formulae (I-2-1) and (I-2-2), each Zi represents an alkyl group, aryl group, or heterocyclic group having a substituent that includes at least one ionic hydrophilic group. The plurality of Z₁ may be the same or different. In general formulae (I-2-1) and (I-2-2), Z₂ represents a substituted or unsubstituted alkyl group, a substituted or unsubstituted aryl group, or a substituted or unsubstituted heterocyclic group. However, Z₂ does not have an ionic hydrophilic group.

The compound B is a phthalocyanine dye in which substituted sulfonyl groups (—SO₂—Z₁ and —SO₂—Z₂) are introduced to β positions of the phthalocyanine skeleton. That is, in general formulae (I-2-1) and (I-2-2), —SO₂—Z₁ and —SO₂—Z₂ replace hydrogen atoms at β positions of the phthalocyanine skeleton but do not replace hydrogen atoms at a positions of the phthalocyanine skeleton. All the three —SO₂—Z₁ in general formulae (I-2-1) and (I-2-2) are preferably the same group.

Met in general formula (I-2-1) is the same as Met in general formula (I-1-1) described above.

Each Z₁ in general formulae (I-2-1) and (I-2-2) is the same as Z₁ in general formulae (I-1-1) and (I-1-2) described above.

The plurality of Z₁ in general formulae (I-2-1) and (I-2-2) may be the same or different; however, all Z₁ are preferably the same.

In general formulae (I-2-1) and (I-2-2), Z₂ represents a substituted or unsubstituted alkyl group, a substituted or unsubstituted aryl group, or a substituted or unsubstituted heterocyclic group. However, Z₂ does not have an ionic hydrophilic group.

Z₂ preferably represents a substituted or unsubstituted alkyl group or a substituted or unsubstituted aryl group and more preferably represents a substituted or unsubstituted alkyl group.

When Z₂ represents a substituted or unsubstituted alkyl group, the alkyl group is not particularly limited but is preferably an alkyl group having 1 to 8 carbon atoms, more preferably an alkyl group having 1 to 6 carbon atoms, and still more preferably an alkyl group having 3 to 5 carbon atoms from the viewpoints of water solubility of the dye and stability of the substituent. The alkyl group may be linear, branched, or cyclic but is preferably a linear alkyl group having 3 to 5 carbon atoms from the viewpoints of availability of raw materials and water solubility of the dye. Specific examples of the alkyl group include a methyl group, an ethyl group, a n-propyl group, an i-propyl group, a n-butyl group, an isobutyl group, a sec-butyl group, a t-butyl group, and a n-pentyl group.

When Z₂ represents a substituted or unsubstituted aryl group, the aryl group is not particularly limited but is preferably an aryl group having 6 to 14 carbon atoms, more preferably an aryl group having 6 to 12 carbon atoms, and particularly preferably an aryl group having 6 to 10 carbon atoms from the viewpoints of availability of raw materials and water solubility of the dye. Specific examples of the aryl group include a phenyl group and a naphthyl group.

When Z₂ represents a substituted or unsubstituted heterocyclic group, the heterocyclic group is not particularly limited but is preferably a heterocyclic group having 2 to 12 carbon atoms, more preferably a heterocyclic group having 2 to 8 carbon atoms, and particularly preferably a heterocyclic group having 2 to 6 carbon atoms from the viewpoints of availability of raw materials, water solubility of the dye, and stability of the substituent. Examples of heteroatoms included in the heterocyclic group include, but are not particularly limited to, a sulfur atom, a nitrogen atom, and an oxygen atom.

When Z₂ represents a substituted alkyl group, a substituted aryl group, or a substituted heterocyclic group, the substituent is not particularly limited as long as the substituent is a group other than the aforementioned ionic hydrophilic group. Examples of the substituent include halogen atoms, a hydroxy group, substituted or unsubstituted alkyl groups, substituted or unsubstituted aryl groups, substituted or unsubstituted heterocyclic groups, substituted or unsubstituted alkyloxy groups, substituted or unsubstituted aryloxy groups, substituted or unsubstituted amino groups, substituted or unsubstituted sulfamoyl groups, substituted or unsubstituted carbamoyl groups, substituted or unsubstituted alkylsulfonyl groups, and substituted or unsubstituted arylsulfonyl groups. When these substituents can further have at least one substituent, groups having, as the additional substituent, a substituent selected from the group consisting of the aforementioned substituents are also included in the examples of the substituent. The substituent is preferably a halogen atom, a hydroxy group, a substituted or unsubstituted aryl group, a substituted or unsubstituted alkyloxy group, a substituted or unsubstituted aryloxy group, a substituted or unsubstituted amino group, a substituted or unsubstituted sulfamoyl group, a substituted or unsubstituted carbamoyl group, a substituted or unsubstituted alkylsulfonyl group, or a substituted or unsubstituted arylsulfonyl group, more preferably a hydroxy group, a substituted or unsubstituted amino group, a substituted or unsubstituted sulfamoyl group, a substituted or unsubstituted carbamoyl group, a substituted or unsubstituted alkylsulfonyl group, or a substituted or unsubstituted arylsulfonyl group, still more preferably a substituted or unsubstituted sulfamoyl group or a substituted or unsubstituted carbamoyl group, and particularly preferably a substituted or unsubstituted sulfamoyl group.

When the substituent is an organic group, the substituent is preferably an organic group having 1 to 20 carbon atoms, more preferably an organic group having 1 to 10 carbon atoms, and still more preferably an organic group having 1 to 8 carbon atoms.

Z₂ preferably has at least one of a hydroxy group or a tertiary nitrogen atom, more preferably has a hydroxy group, and still more preferably has an alcoholic hydroxy group (a hydroxy group bound to an alkyl group) for the reason that a strong intermolecular interaction is exhibited.

When Z₂ has a tertiary nitrogen atom, Z₂ preferably has a substituent represented by general formula (N-1) below.

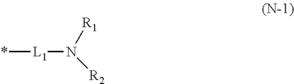

In general formula (N-1), R₁ and R₂ each independently represent a monovalent substituted or unsubstituted hydrocarbon group and L₁ represents a divalent substituted or unsubstituted hydrocarbon group. * represents a binding site to the Z₂ residue.

The monovalent hydrocarbon group represented by R₁ and R₂ is not particularly limited but is, for example, an alkyl group, preferably an alkyl group having 1 to 10 carbon atoms, and more preferably an alkyl group having 1 to 6 carbon atoms.

Preferably, R₁ and R₂ each independently represent an alkyl group, and the total number of carbon atoms of R₁ and R₂ is 6 or less from the viewpoint of water solubility of the dye.

The divalent hydrocarbon group represented by L₁ is not particularly limited but is, for example, an alkylene group, preferably an alkylene group having 1 to 10 carbon atoms, more preferably an alkylene group having 1 to 6 carbon atoms, and, from the viewpoint of water solubility of the dye, particularly preferably an alkylene group having 3 to 5 carbon atoms.

R₁, R₂, and L₁ may have a substituent, and the substituent is not particularly limited as long as the substituent is a group other than the aforementioned ionic hydrophilic group. Examples of the substituent include halogen atoms, a hydroxy group, substituted or unsubstituted alkyl groups, substituted or unsubstituted aryl groups, substituted or unsubstituted heterocyclic groups, substituted or unsubstituted alkyloxy groups, substituted or unsubstituted aryloxy groups, substituted or unsubstituted amino groups, substituted or unsubstituted sulfamoyl groups, substituted or unsubstituted carbamoyl groups, substituted or unsubstituted alkylsulfonyl groups, and substituted or unsubstituted arylsulfonyl groups. When these substituents can further have at least one substituent, groups having, as the additional substituent, a substituent selected from the group consisting of the aforementioned substituents are also included in the examples of the substituent. When the substituent is an organic group, the substituent is preferably an organic group having 1 to 10 carbon atoms, and more preferably an organic group having 1 to 6 carbon atoms.

Preferred examples of Z₂ include —CH₂CH₂CH₂OH, —CH₂CH(OH)CH₃, —CH₂CH(OH)CH₂OH, —CH₂CH₂CH₂N(CH₃)₂, —(CH₂)₃—SO₂NHCH₂CH₂OH, —(CH₂)₃—SO₂N(CH₂CH₂OH)₂, —(CH₂)₃—SO₂NHCH₂CH₂CH₂OH, —(CH₂)₃—SO₂NHCH₂CH(OH)CH₃, —(CH₂)₃—SO₂NHCH₂CH(OH)CH₂OH, —(CH₂)₃—CONHCH₂CH(OH)CH₃, —(CH₂)₃—CONHCH₂CH(OH)CH₂OH, —(CH₂)₃—SO₂NHCH₂CH₂N(CH₃)₂, —(CH₂)₃—SO₂NHCH₂CH₂CH₂N(CH₃)₂, and

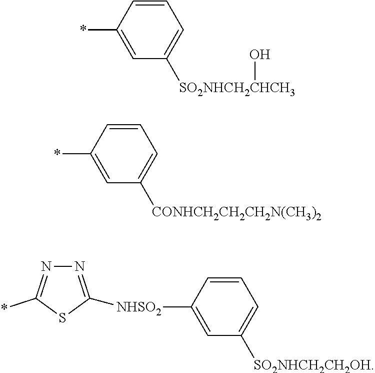

In the above structural formulae, * represents a binding site to a sulfonyl group.

The compound B included in the dye ink composition according to the present invention may be one compound or two or more compounds. A compound represented by general formula (I-2-1) and a compound represented by general formula (I-2-2) may be used in combination as the compound B.

### Compound C-I and Compound C-II

The compound C-I and the compound C-II in the present invention will be described.

The compound C-I is a compound represented by general formula (I-3-1-1) or (I-3-1-2), and the compound C-II is a compound represented by general formula (I-3-2-1) or (I-3-2-2).

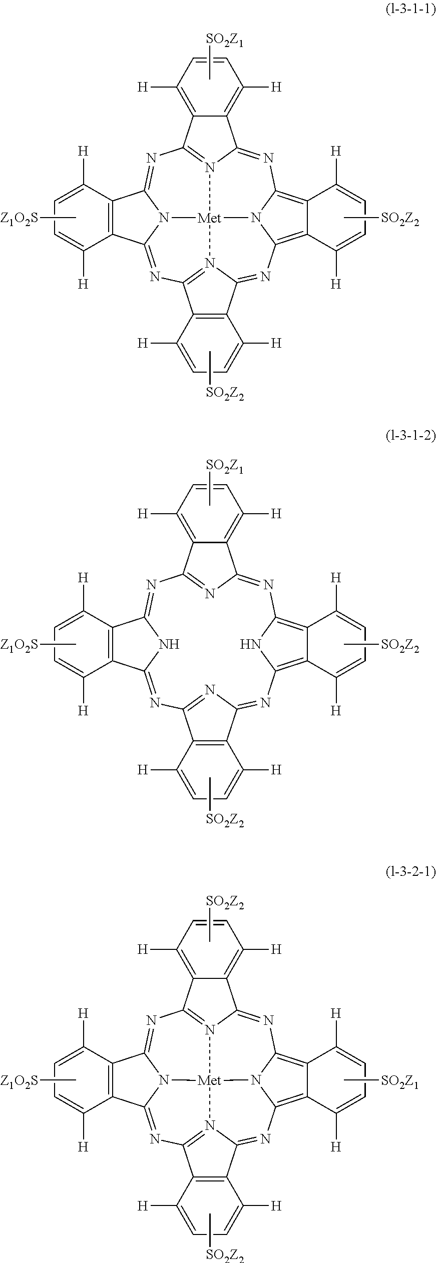

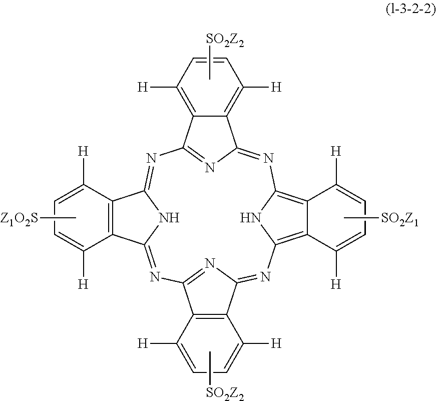

In general formulae (I-3-1-1) and (I-3-2-1), Met represents Al, Fe, Co, Ni, Zn, Mg, or Mn. In general formulae (I-3-1-1), (I-3-1-2), (I-3-2-1), and (I-3-2-2), each Z₁ represents an alkyl group, aryl group, or heterocyclic group having a substituent that includes at least one ionic hydrophilic group. The plurality of Z₁ may be the same or different. Each Z₂ represents a substituted or unsubstituted alkyl group, a substituted or unsubstituted aryl group, or a substituted or unsubstituted heterocyclic group. However, Z₂ does not have an ionic hydrophilic group. The plurality of Z₂ may be the same or different.

The compound represented by general formula (I-3-1-1) or (I-3-1-2) and the compound represented by general formula (I-3-2-1) or (I-3-2-2) are positional isomers in which the introduction positions of substituents are different.

The compound C-I and the compound C-II are each a phthalocyanine dye in which substituted sulfonyl groups (—SO₂—Z₁ and —SO₂—Z₂) are introduced to β positions of the phthalocyanine skeleton. That is, in general formulae (I-3-1-1), (I-3-1-2), (I-3-2-1), and (I-3-2-2), —SO₂—Z₁ and —SO₂—Z₂ replace hydrogen atoms at β positions of the phthalocyanine skeleton but do not replace hydrogen atoms at α positions of the phthalocyanine skeleton. All the two —SO₂—Z₁ in general formulae (I-3-1-1), (I-3-1-2), (I-3-2-1), and (I-3-2-2) are preferably the same group. All the two —SO₂-Z2 in general formulae (I-3-1-1), (I-3-1-2), (I-3-2-1), and (I-3-2-2) are preferably the same group.

Each Met in general formulae (I-3-1-1) and (I-3-2-1) is the same as Met in general formula (I-1-1) described above.

Each Z₁ in general formulae (I-3-1-1), (I-3-1-2), (I-3-2-1), and (I-3-2-2) is the same as Z₁ in general formulae (I-1-1) and (I-1-2) described above.

The plurality of Z₁ in general formulae (I-3-1-1), (I-3-1-2), (I-3-2-1), and (I-3-2-2) may be the same or different; however, all Z₁ are preferably the same.

Each Z₂ in general formulae (I-3-1-1), (I-3-1-2), (I-3-2-1), and (I-3-2-2) is the same as Z₂ in general formulae (I-2-1) and (I-2-2) described above.

The plurality of Z₂ in general formulae (I-3-1-1), (I-3-1-2), (I-3-2-1), and (I-3-2-2) may be the same or different; however, all Z₂ are preferably the same.

The dye ink composition according to the present invention includes at least one of the compound C-I or the compound C-II. The dye ink composition may include only the compound C-I, only the compound C-II, or both the compound C-I and the compound C-II.

When the dye ink composition according to the present invention includes the compound C-I, the compound C-I included in the dye ink composition according to the present invention may be one compound or two or more compounds. A compound represented by general formula (I-3-1-1) and a compound represented by general formula (I-3-1-2) may be used in combination as the compound C-I.

When the dye ink composition according to the present invention includes the compound C-II, the compound C-II included in the dye ink composition according to the present invention may be one compound or two or more compounds. A compound represented by general formula (I-3-2-1) and a compound represented by general formula (I-3-2-2) may be used in combination as the compound C-II.

### Compound D

The compound D in the present invention will be described.

The compound D is a compound represented by general formula (I-4-1) or (I-4-2).

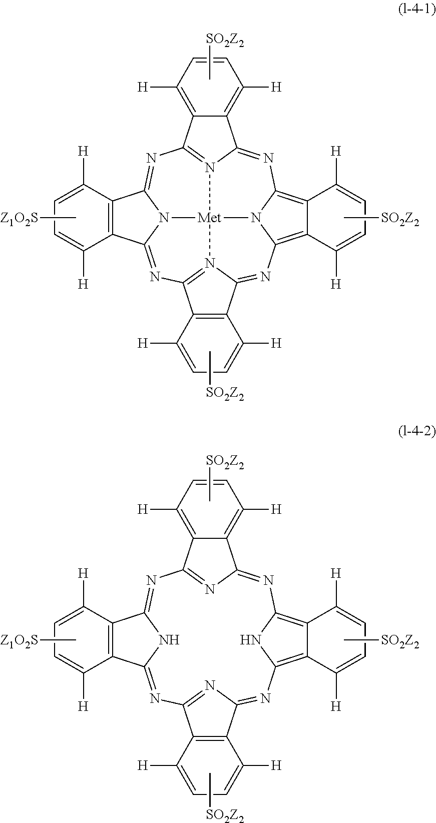

In general formula (I-4-1), Met represents Al, Fe, Co, Ni, Zn, Mg, or Mn. In general formulae (I-4-1) and (I-4-2), Zi represents an alkyl group, aryl group, or heterocyclic group having a substituent that includes at least one ionic hydrophilic group. Each Z₂ represents a substituted or unsubstituted alkyl group, a substituted or unsubstituted aryl group, or a substituted or unsubstituted heterocyclic group. However, Z₂ does not have an ionic hydrophilic group. The plurality of Z₂ may be the same or different.

The compound D is a phthalocyanine dye in which substituted sulfonyl groups (—SO₂—Z₁ and —SO₂—Z₂) are introduced to β positions of the phthalocyanine skeleton. That is, in general formulae (I-4-1) and (I-4-2), —SO₂—Z₁ and —SO₂—Z₂ replace hydrogen atoms at β positions of the phthalocyanine skeleton but do not replace hydrogen atoms at a positions of the phthalocyanine skeleton. All the three —SO₂—Z₂ in general formulae (I-4-1) and (I-4-2) are preferably the same group.

Met in general formula (I-4-1) is the same as Met in general formula (I-1-1) described above.

Each Z₁ in general formulae (I-4-1) and (I-4-2) is the same as Z₁ in general formulae (I-1-1) and (I-1-2) described above.

Each Z₂ in general formulae (I-4-1) and (I-4-2) is the same as Z₂ in general formulae (I-2-1) and (I-2-2) described above.

The plurality of Z₂ in general formulae (I-4-1) and (I-4-2) may be the same or different; however, all Z₂ are preferably the same.

The compound D included in the dye ink composition according to the present invention may be one compound or two or more compounds. A compound represented by general formula (I-4-1) and a compound represented by general formula (I-4-2) may be used in combination as the compound D.

### Compound E

The dye ink composition according to the present invention preferably further includes a compound E below in addition to the compound A to the compound D described above.

The compound E induces a stronger intermolecular interaction to the compound A than the compound B to the compound D described above.

When the dye ink composition according to the present invention includes the compound A to the compound E, the dye ink composition can exhibit better continuous ejection stability and storage stability.

The compound E will be described below.

The compound E is a compound represented by general formula (I-5-1) or (I-5-2).

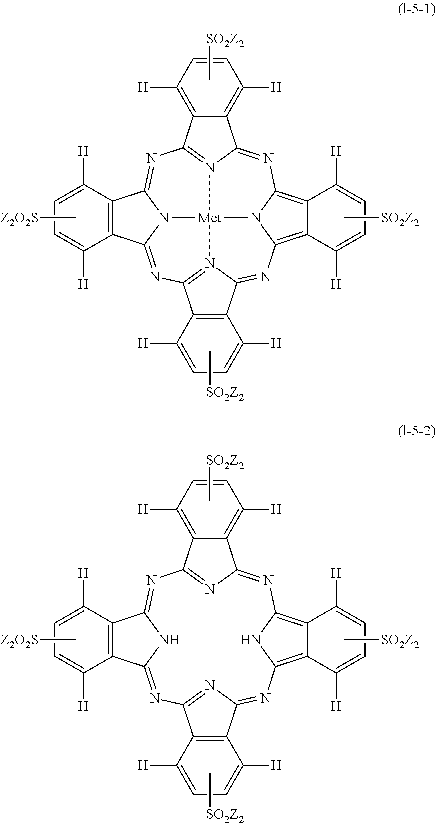

In general formula (I-5-1), Met represents the same as that in general formulae (I-1-1), (I-2-1), (I-3-1-1), (I-3-2-1), and (I-4-1). Each Z₂ represents the same as that in general formulae (I-2-1), (I-2-2), (I-3-1-1), (I-3-1-2), (I-3-2-1), (I-3-2-2), (I-4-1), and (I-4-2). The plurality of Z₂ may be the same or different.

The compound E is a phthalocyanine dye in which substituted sulfonyl groups (—SO₂—Z₂) are introduced to β positions of the phthalocyanine skeleton. That is, in general formulae (I-5-1) and (I-5-2), —SO₂—Z₂ replace hydrogen atoms at β positions of the phthalocyanine skeleton but do not replace hydrogen atoms at a positions of the phthalocyanine skeleton. All the four —SO₂—Z₂ in general formulae (I-5-1) and (I-5-2) are preferably the same group.

Met in general formula (I-5-1) is the same as Met in general formula (I-1-1) described above.

Each Z₂ in general formulae (I-5-1) and (I-5-2) is the same as Z₂ in general formulae (I-2-1) and (I-2-2) described above.

The plurality of Z₂ in general formulae (I-5-1) and (I-5-2) may be the same or different; however, all Z₂ are preferably the same.

When the dye ink composition according to the present invention includes the compound E, the compound E included in the dye ink composition according to the present invention may be one compound or two or more compounds. A compound represented by general formula (I-5-1) and a compound represented by general formula (I-5-2) may be used in combination as the compound E.

All Z₁ in the compound A to the compound D are preferably the same group.

All Z₂ in the compound B to the compound E are preferably the same group.

Specific examples of the compound A to the compound E are given below, but are not limited thereto. Note that the specific examples below are each a mixture including positional isomers (refer to formulae (2A-1) to (2D-1) and (2A-2) to (2D-2) below) of specific substituents R (each R represents —SO₂Z₁ or —SO₂Z₂), and therefore, the introduction positions of substituents are not specified, and the positional isomers are treated as the same compound. In the specific examples below, it is indicated that the substituted sulfonyl groups (—SO₂Z₁ or —SO₂Z₂) each replace any hydrogen atom at a β position but do not replace the portions having “H” in each structural formula. In formulae (2A-1) to (2D-1) below, Met represents Al, Fe, Co, Ni, Zn, Mg, or Mn.

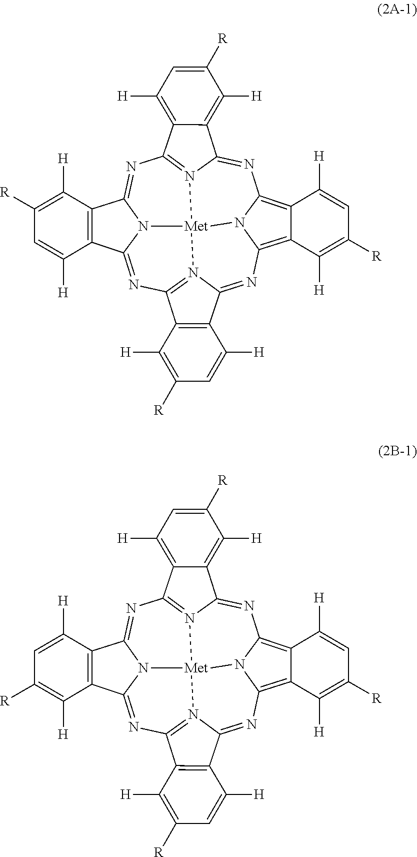

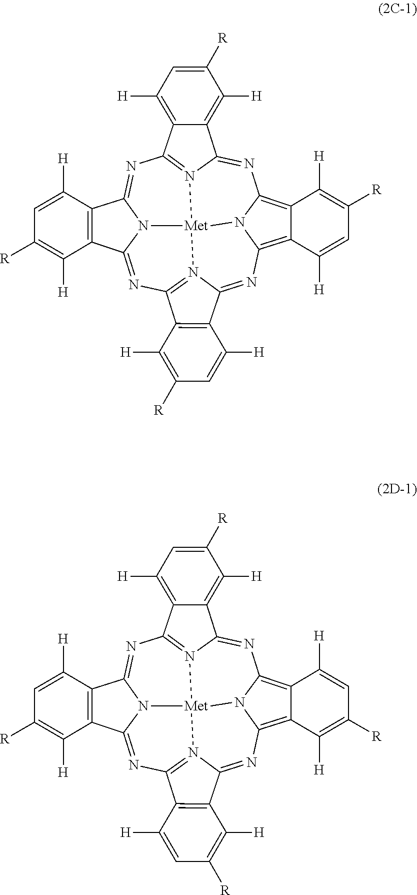

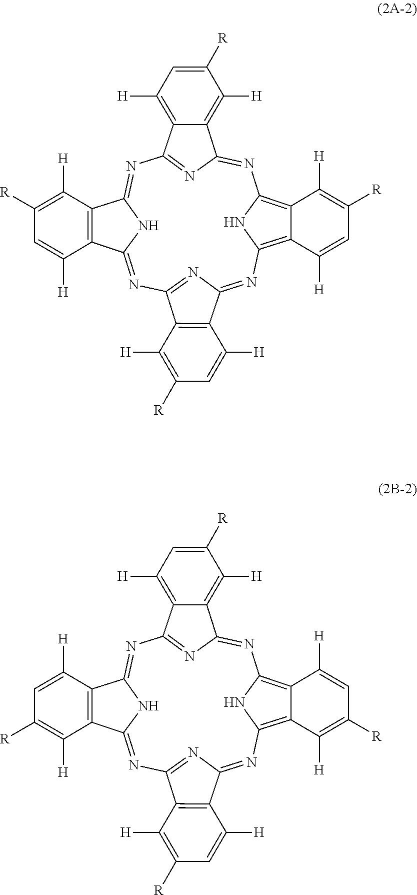

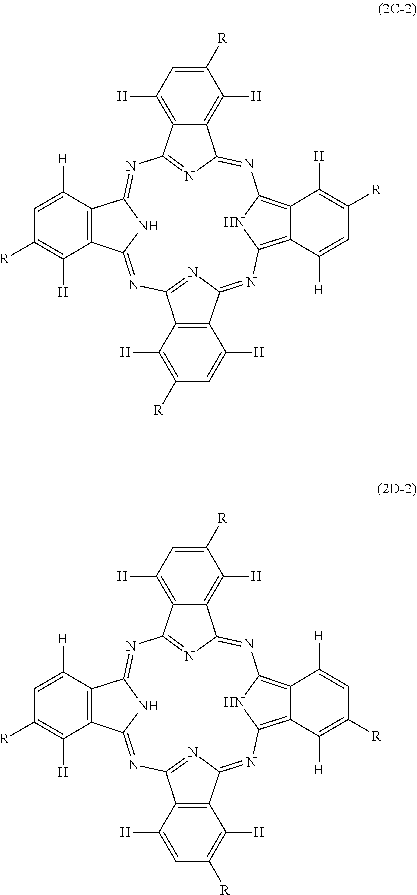

Specific examples of the compound A are given without distinguishing the substitution positions. That is, the specific examples below each encompass positional isomers having different substitution positions as in formulae (2A-1) to (2D-1) and (2A-2) to (2D-2) above. Each R in this case represents a substituent (—SO₂Z₁). In A-1-1 to A-1-24 below, Met represents Al, Fe, Co, Ni, Zn, Mg, or Mn.

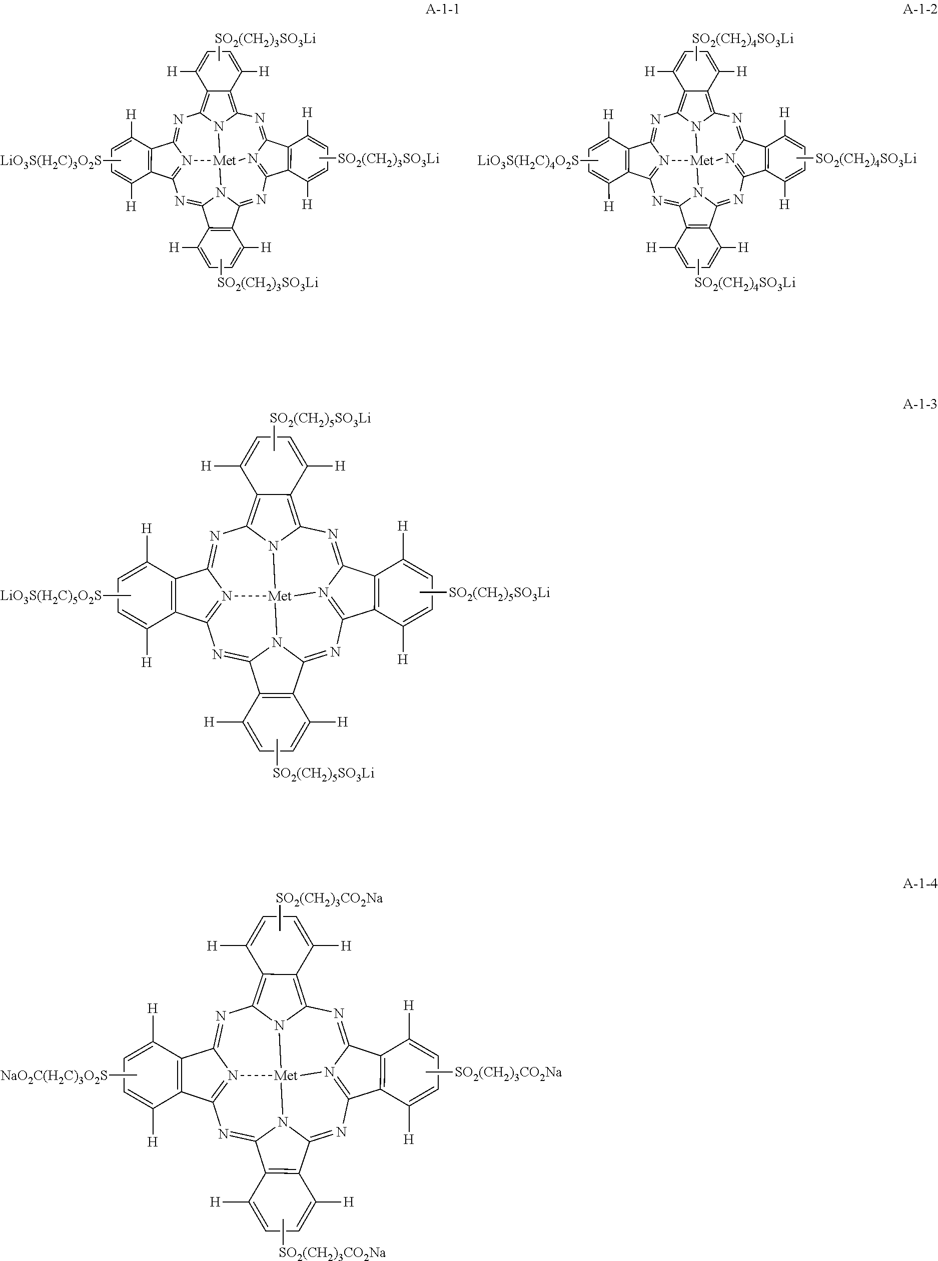

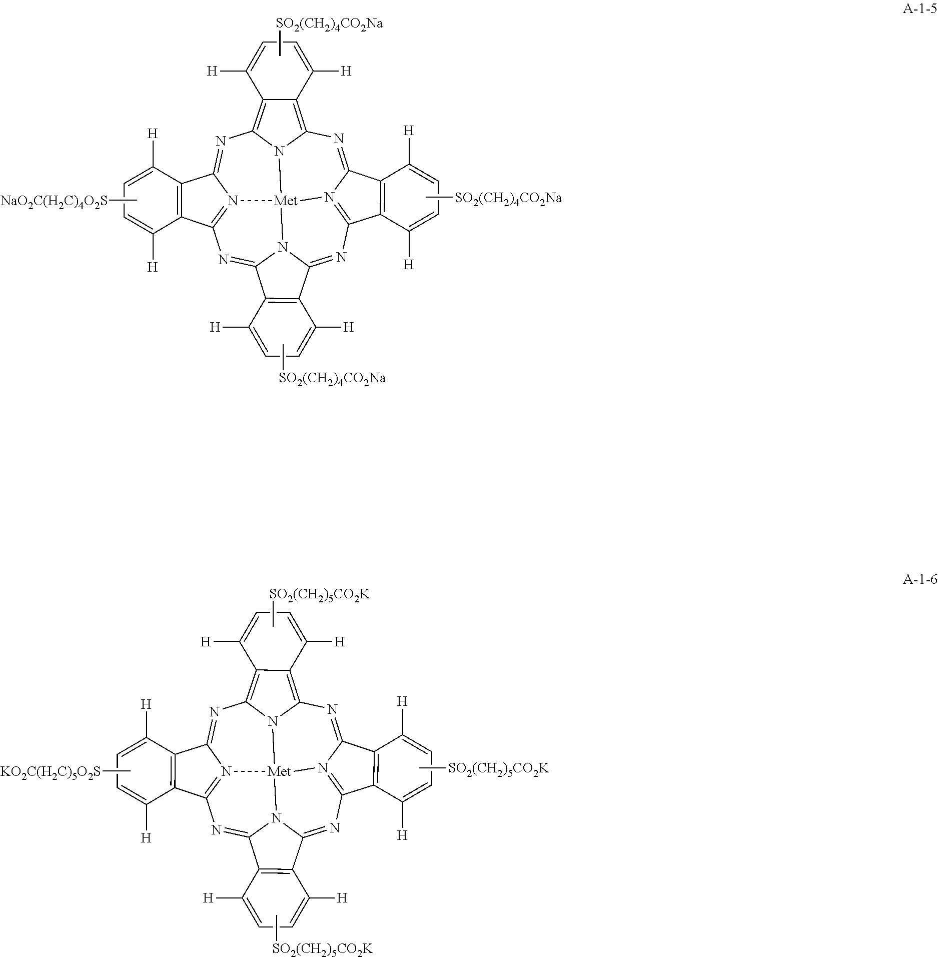

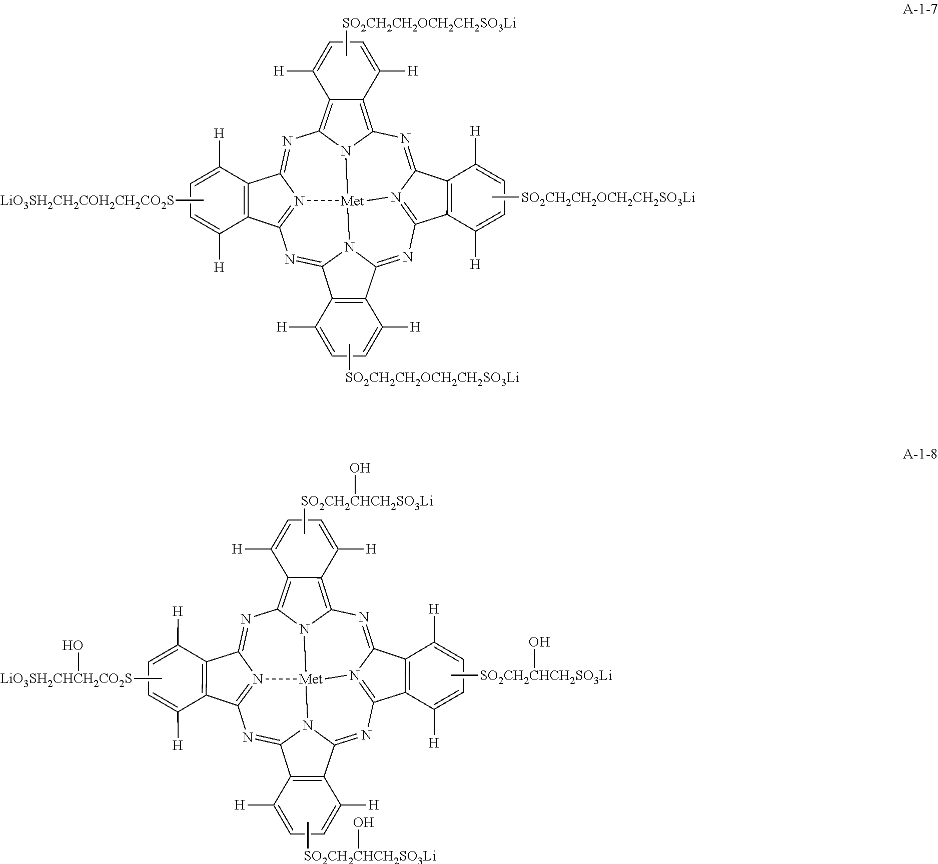

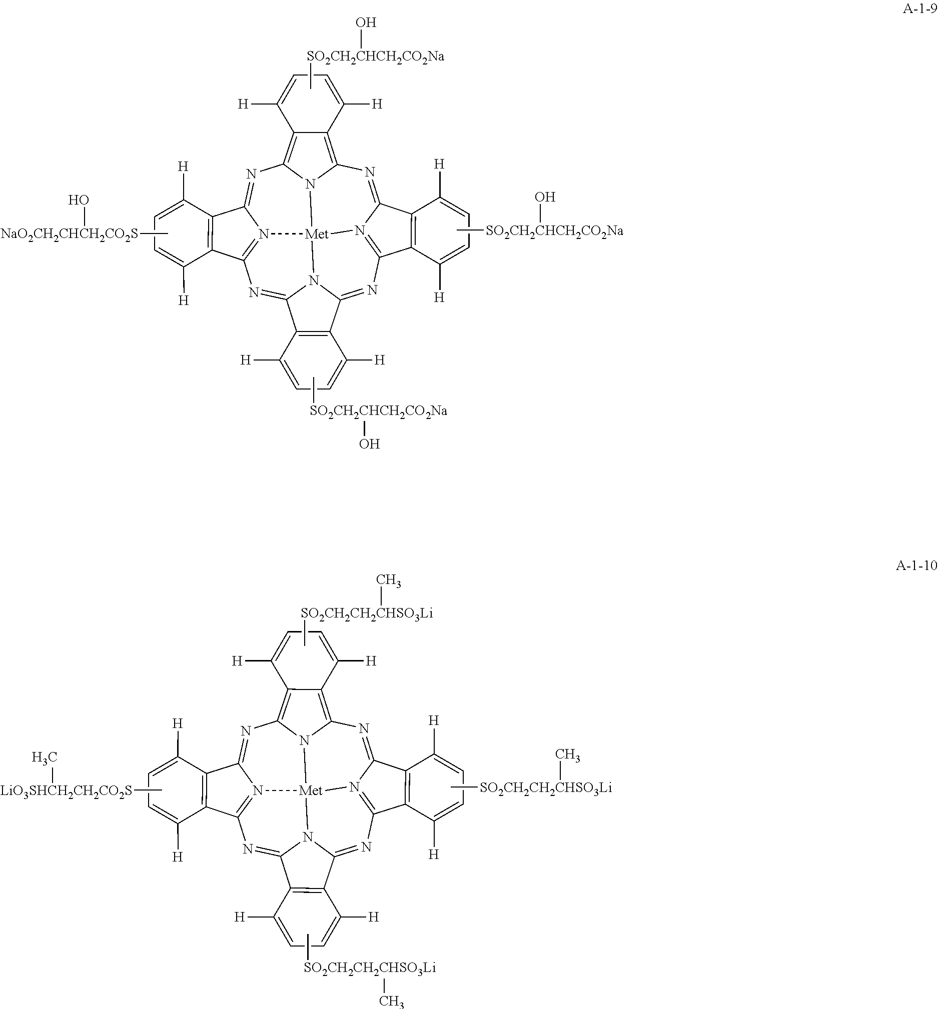

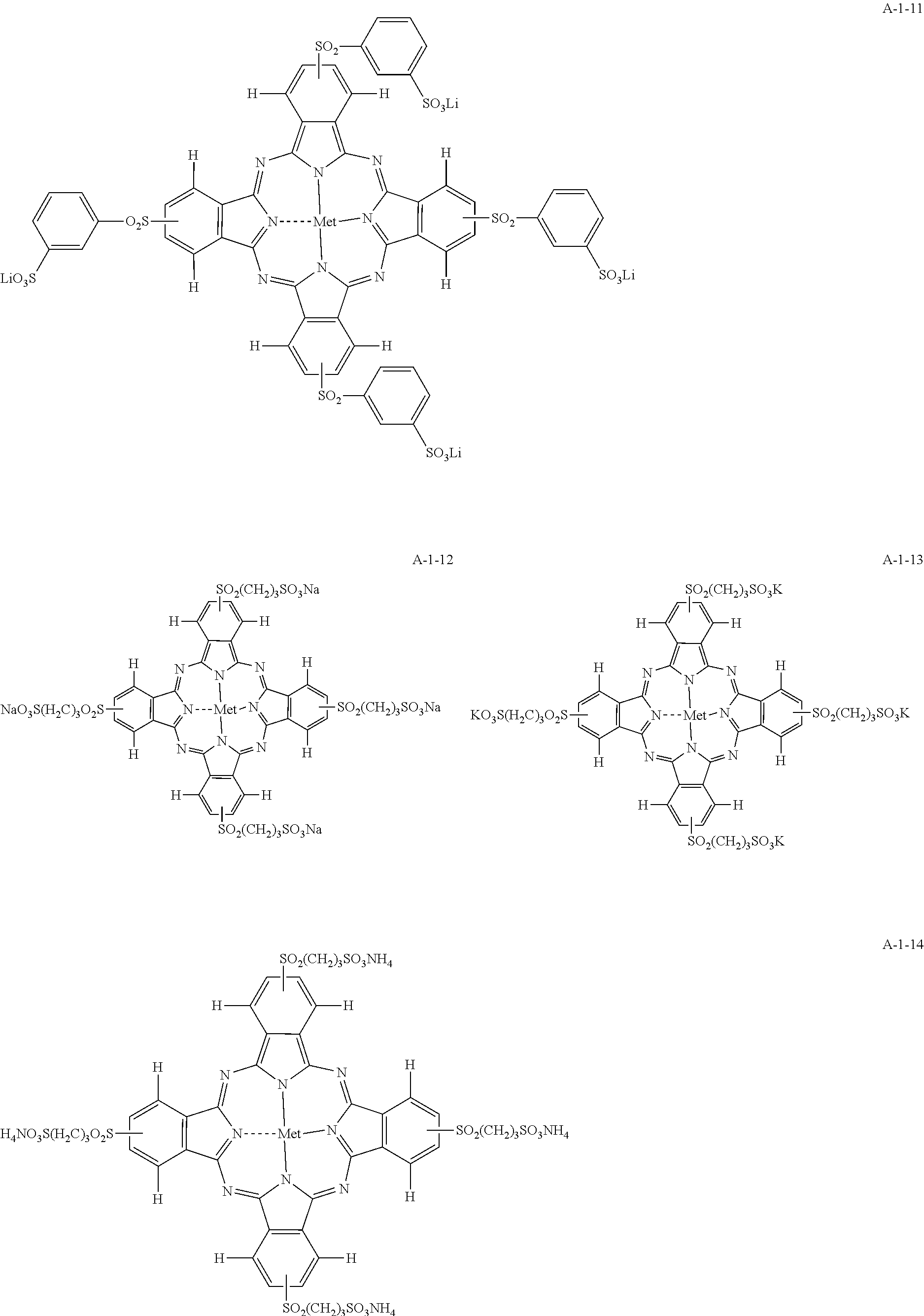

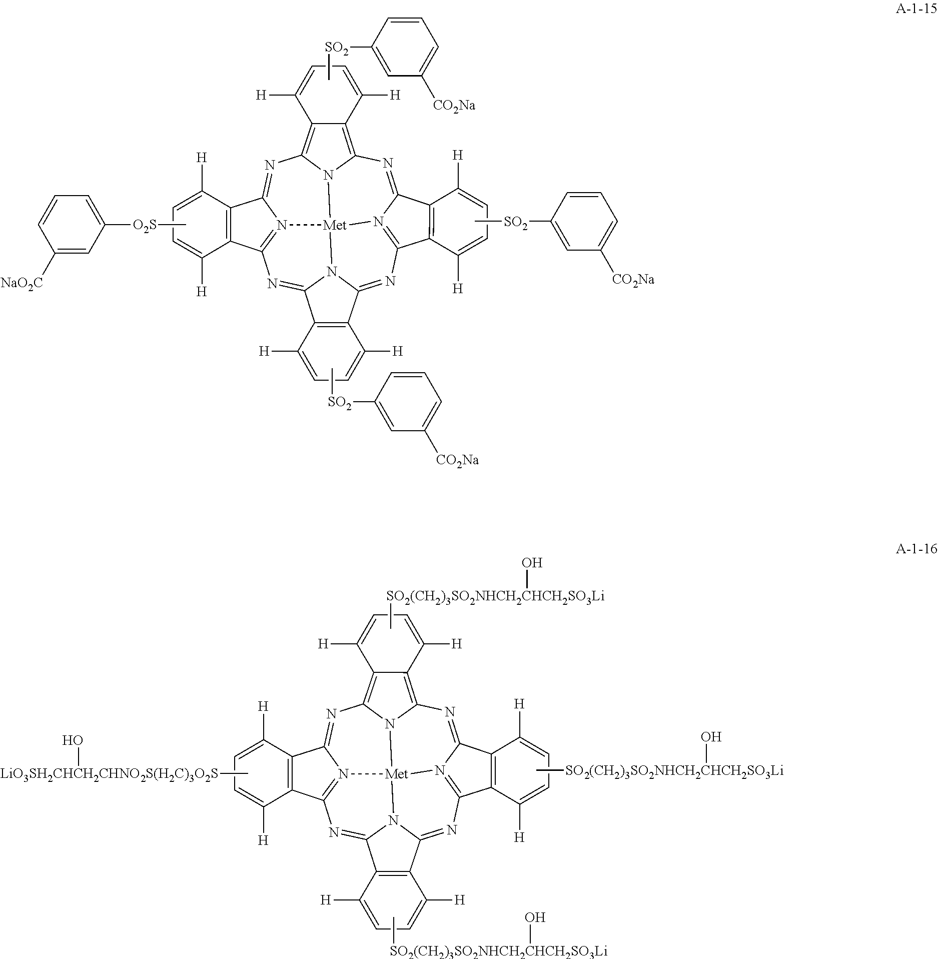

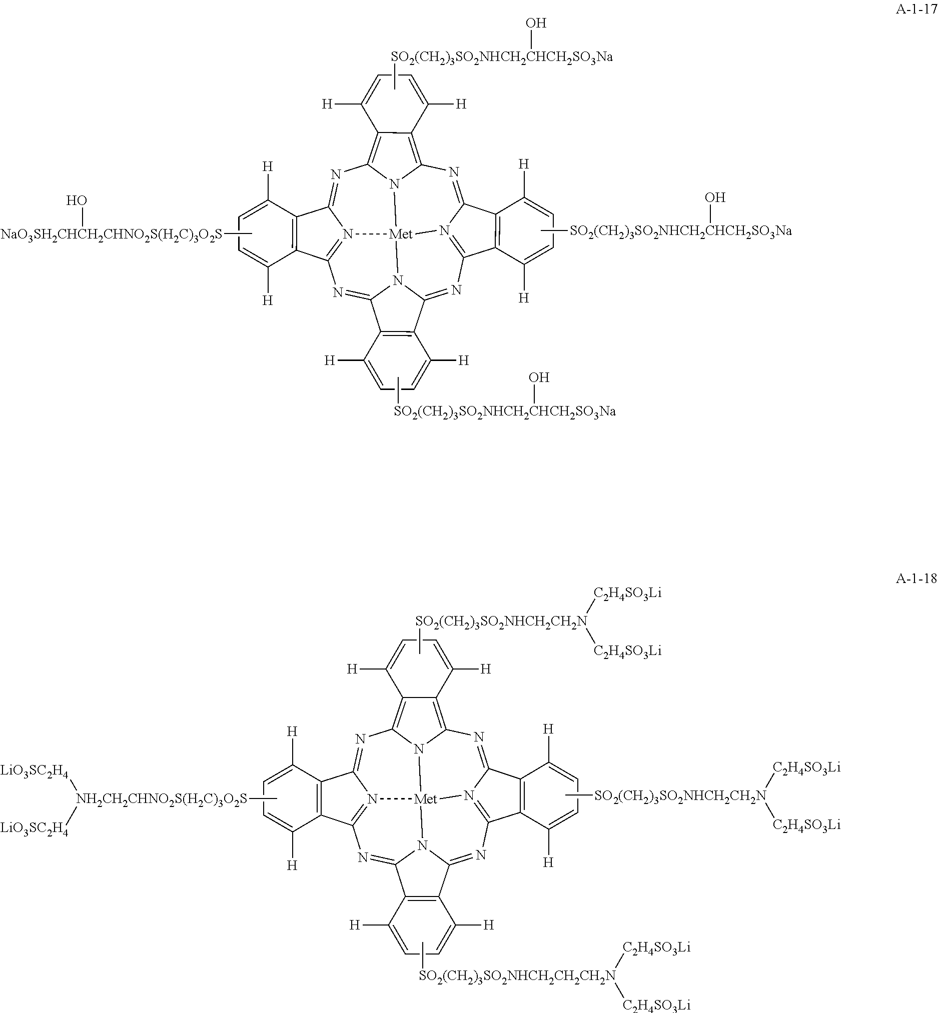

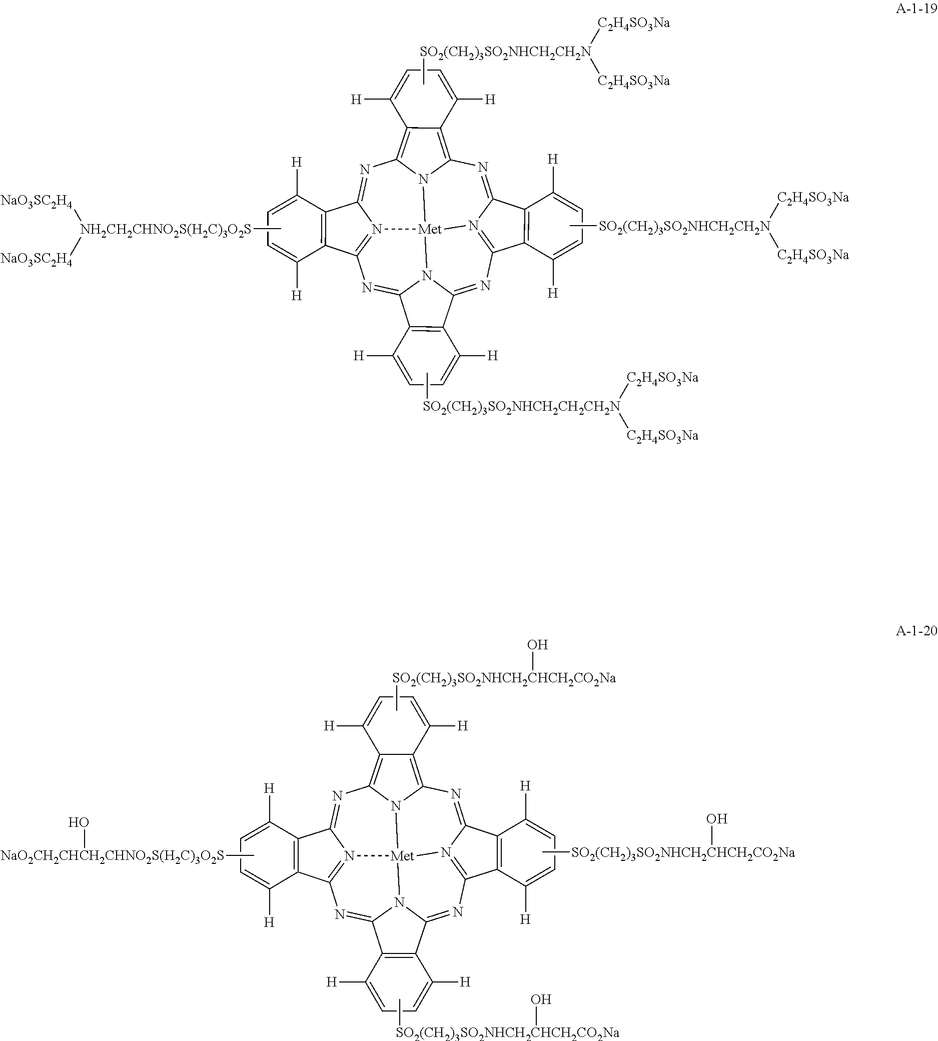

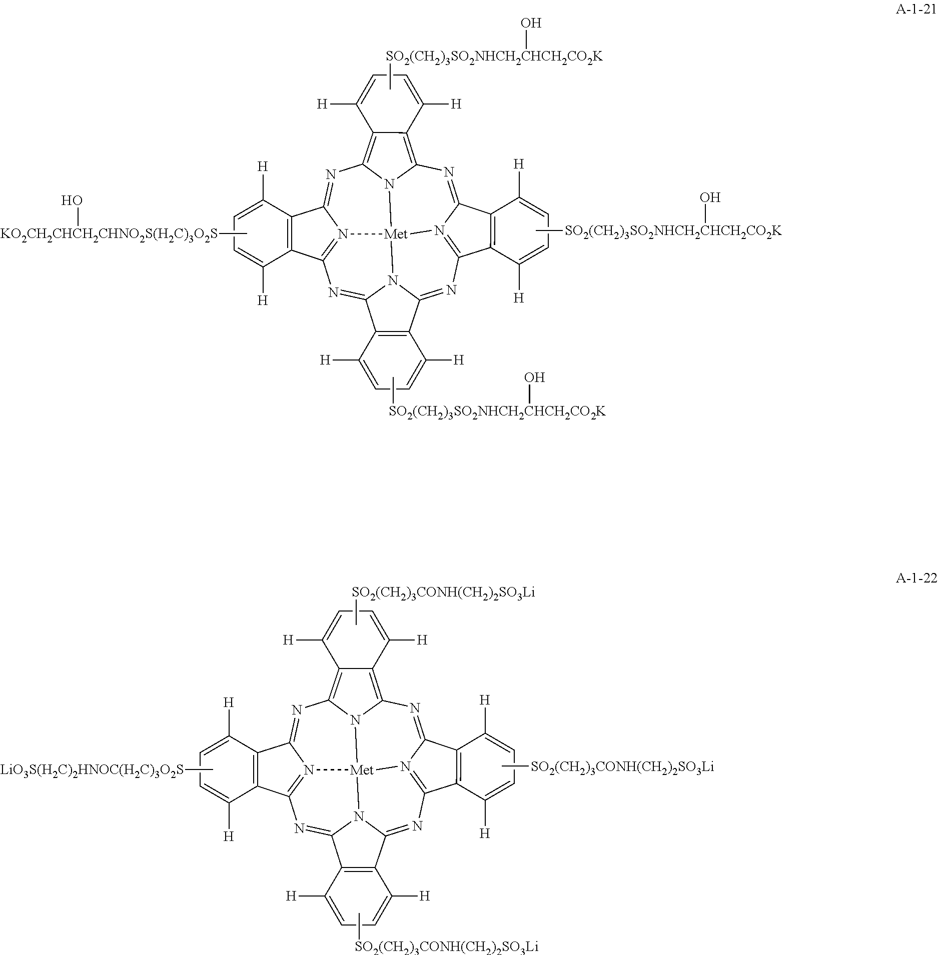

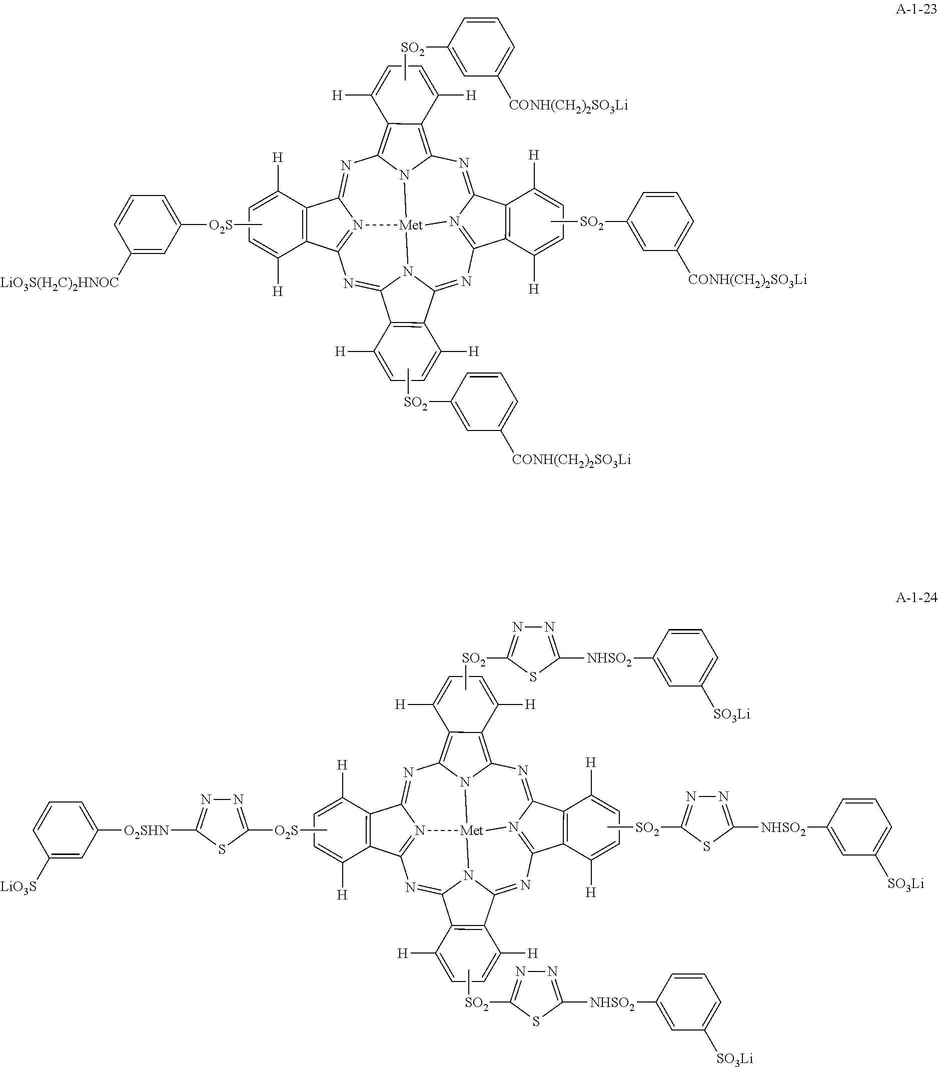

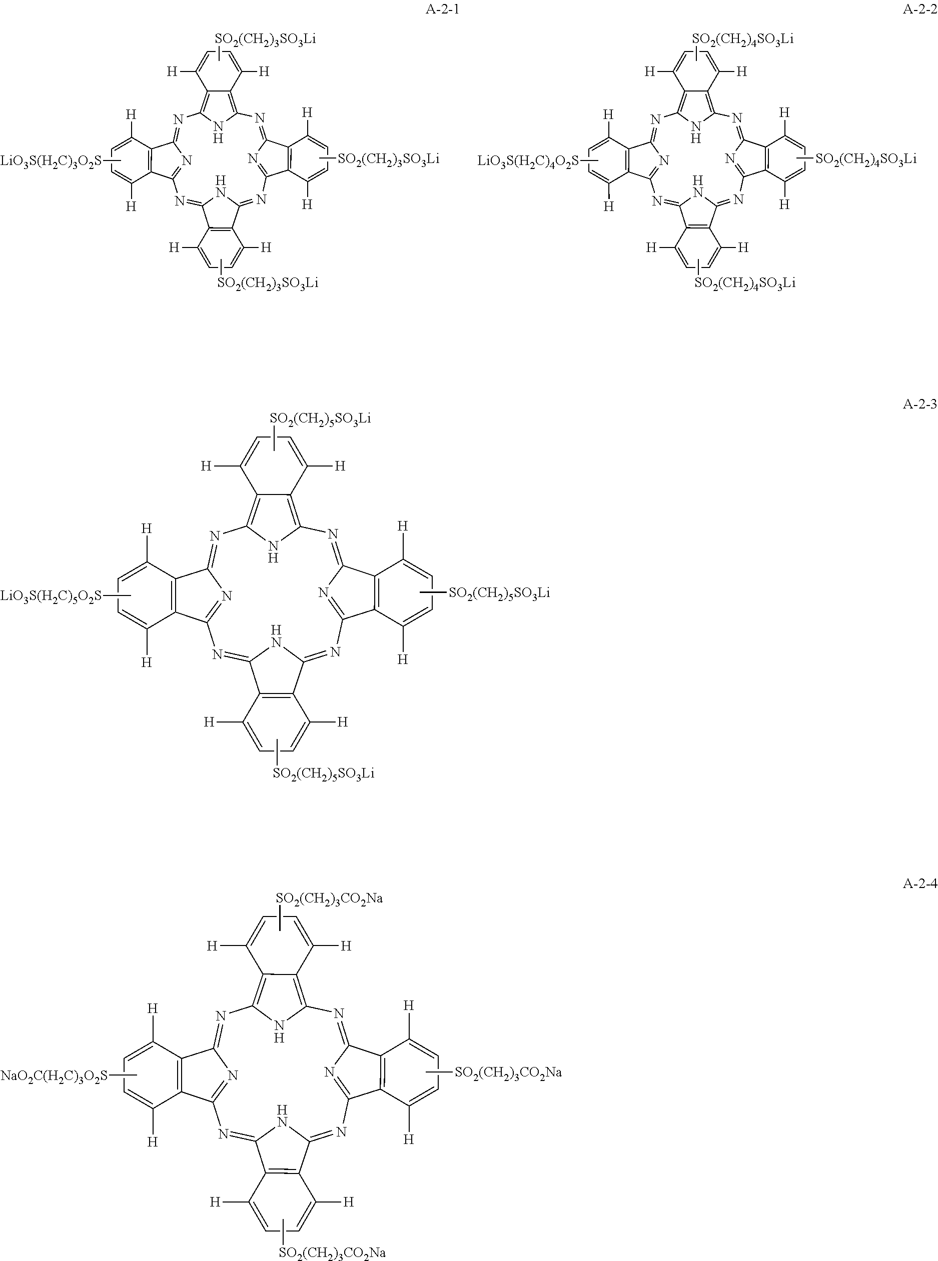

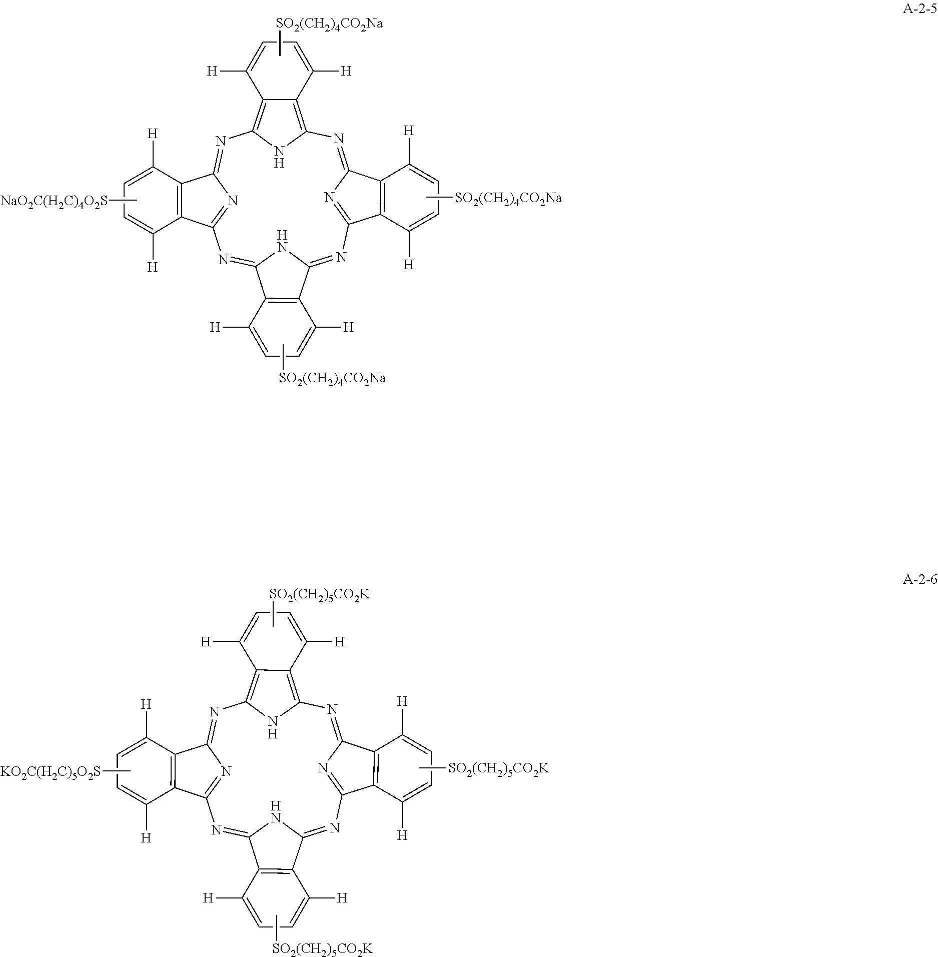

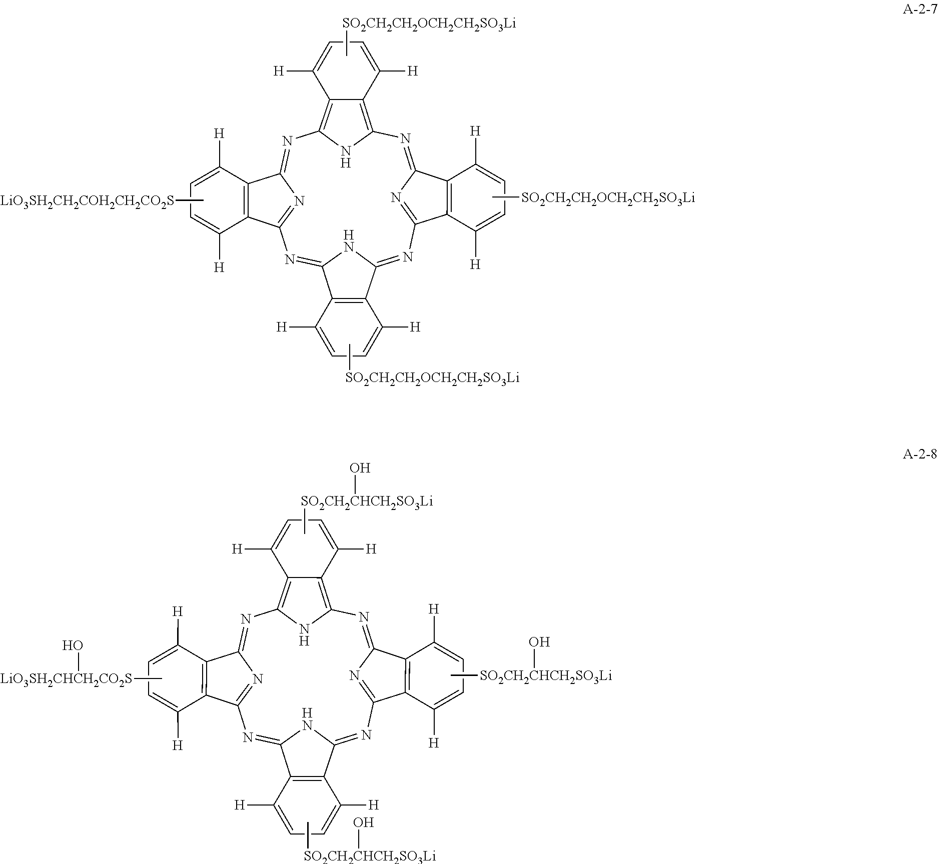

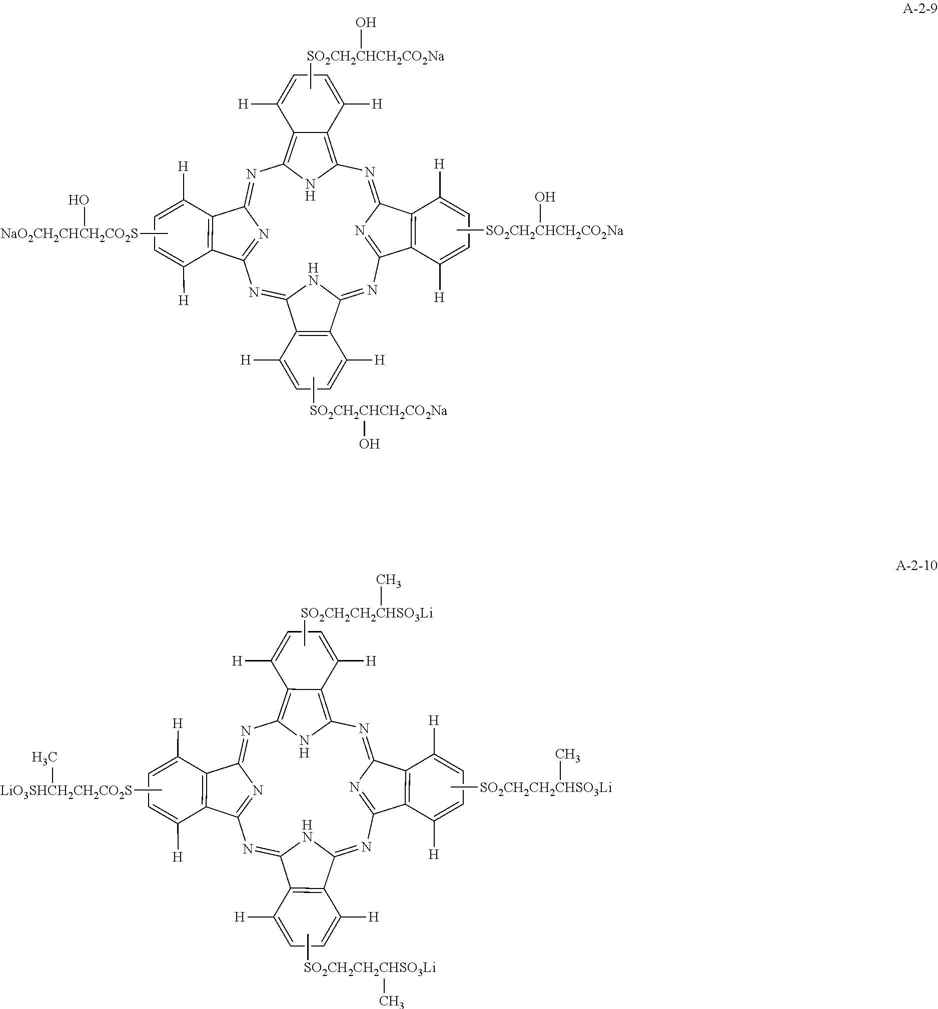

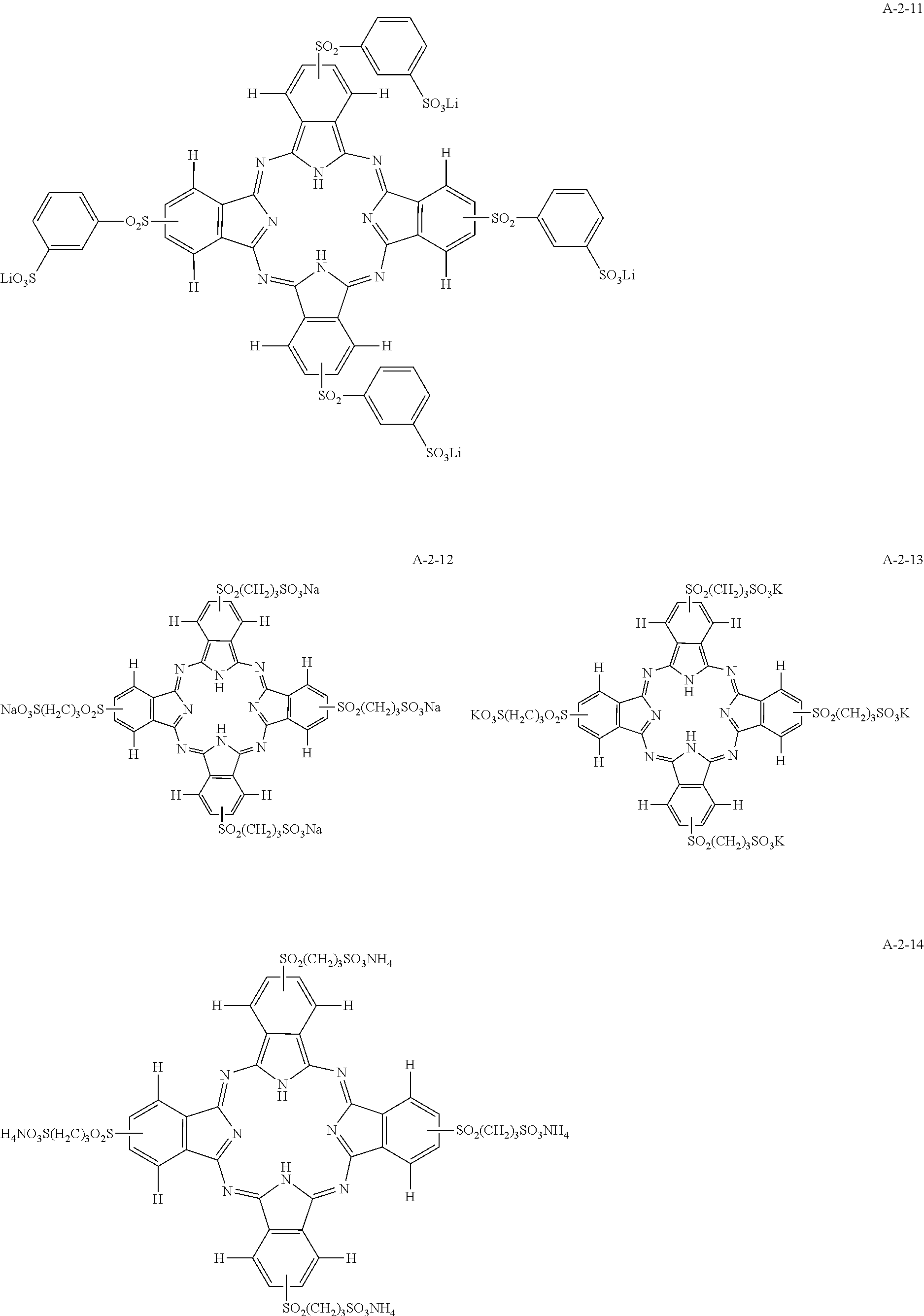

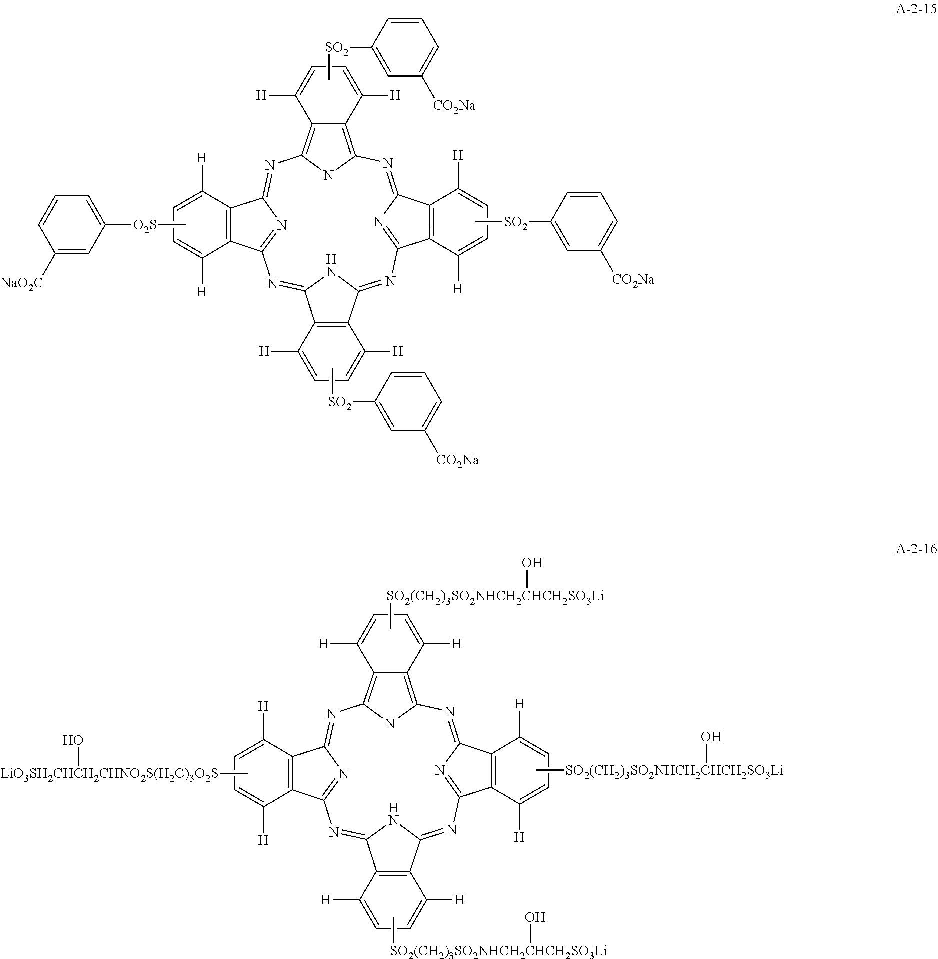

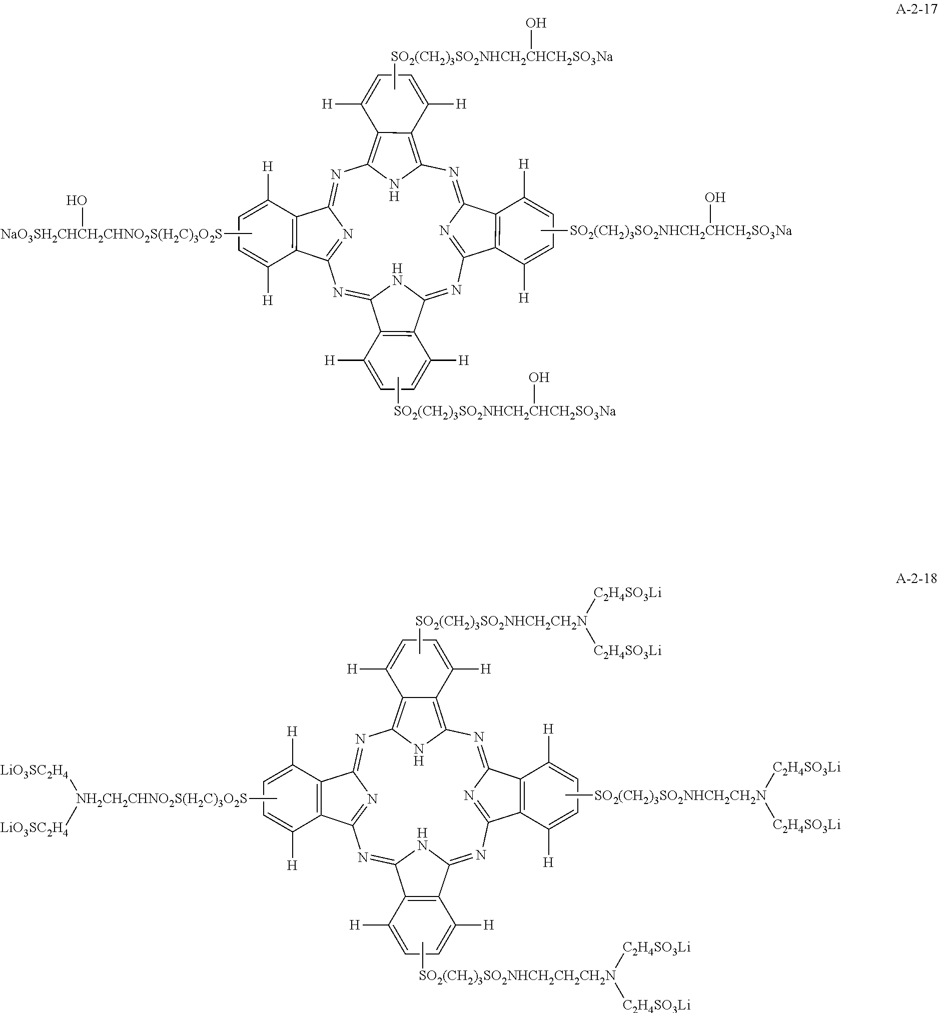

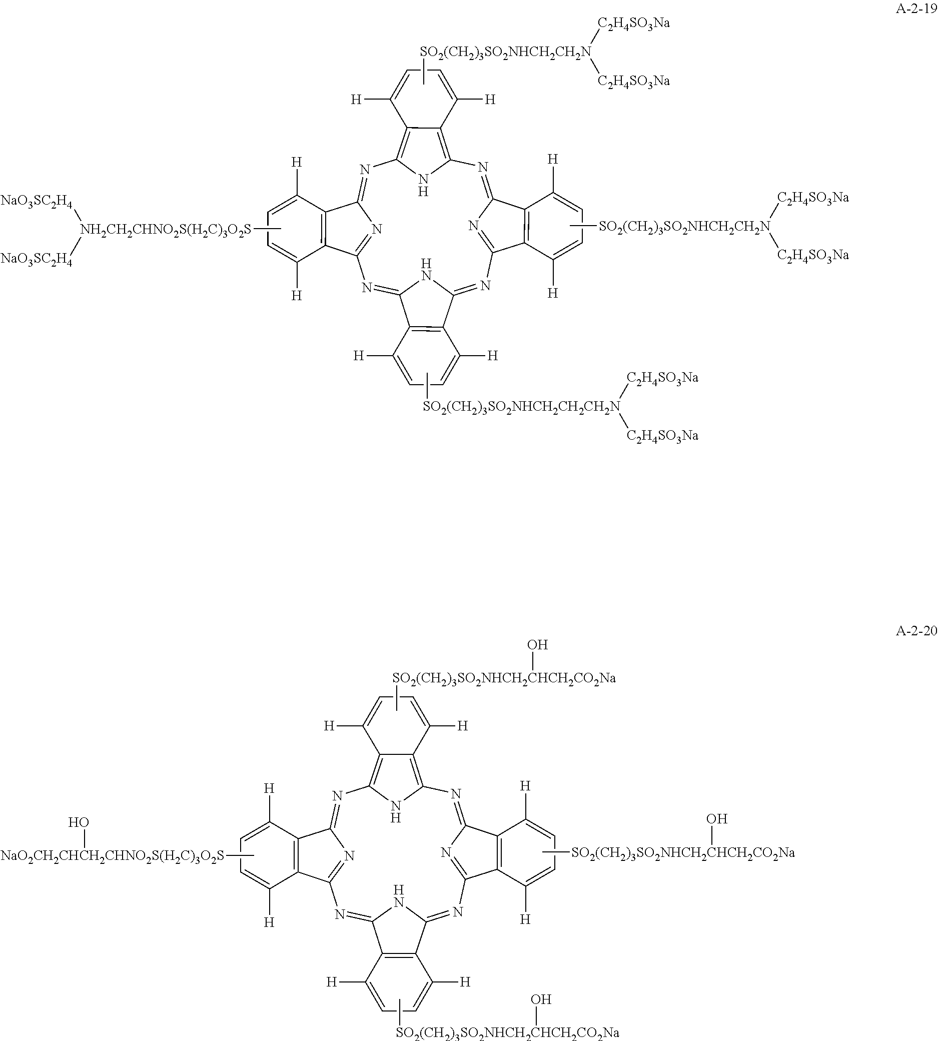

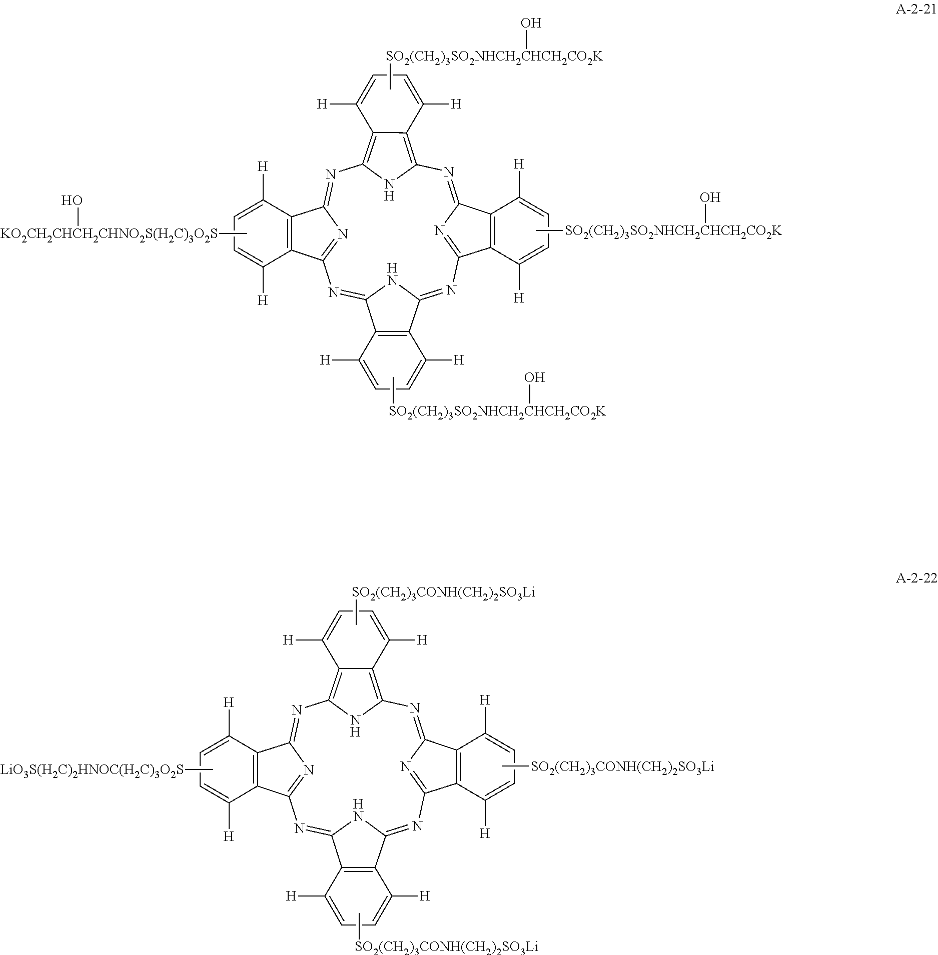

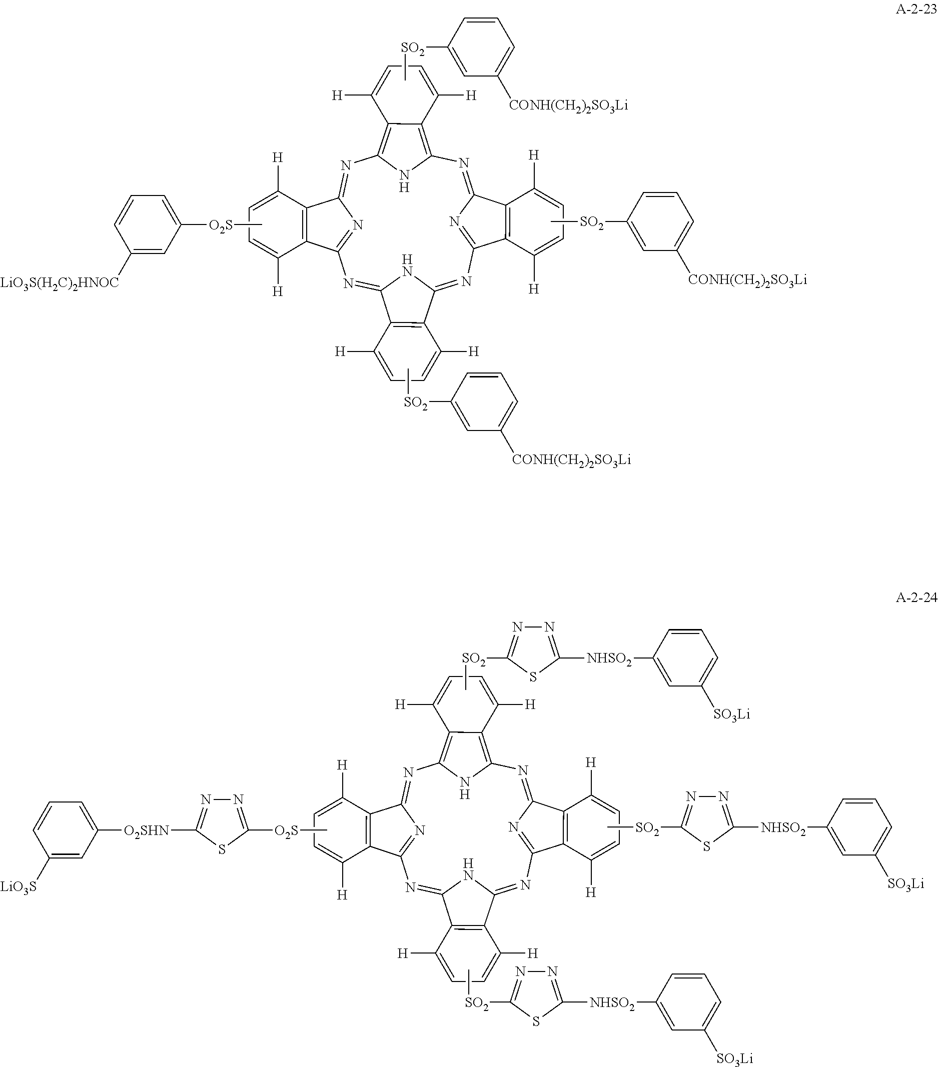

Specific examples of the compound B are given without distinguishing the substitution positions. That is, the specific examples below each encompass positional isomers having different substitution positions as in formulae (2A-1) to (2D-1) and (2A-2) to (2D-2) above. Each R in this case independently represents a substituent (—SO₂Z₁ or —SO₂Z₂). In B-1-1 to B-1-16 below, Met represents Al, Fe, Co, Ni, Zn, Mg, or Mn.

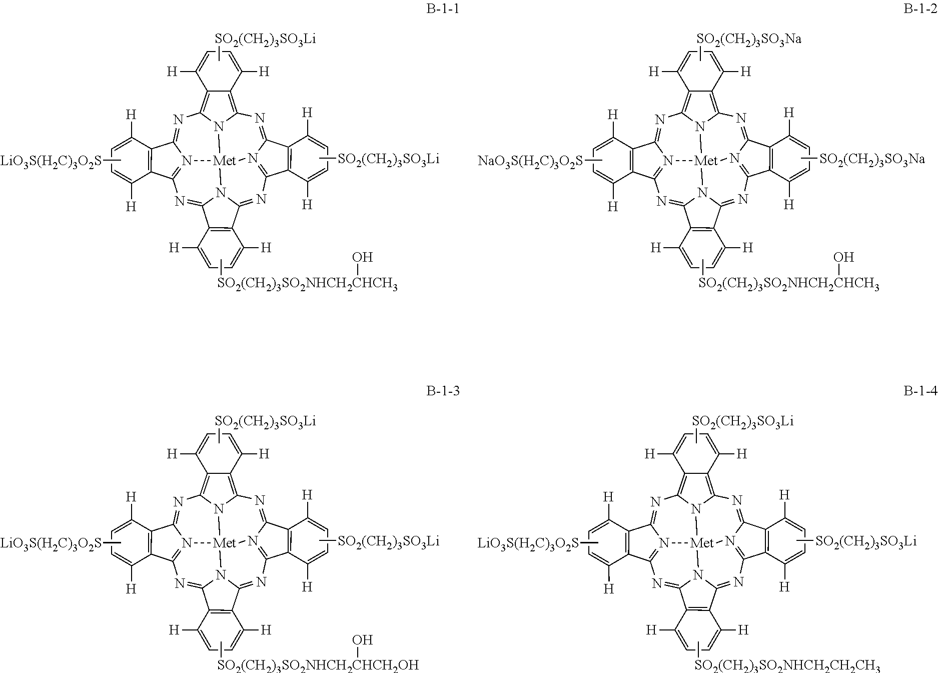

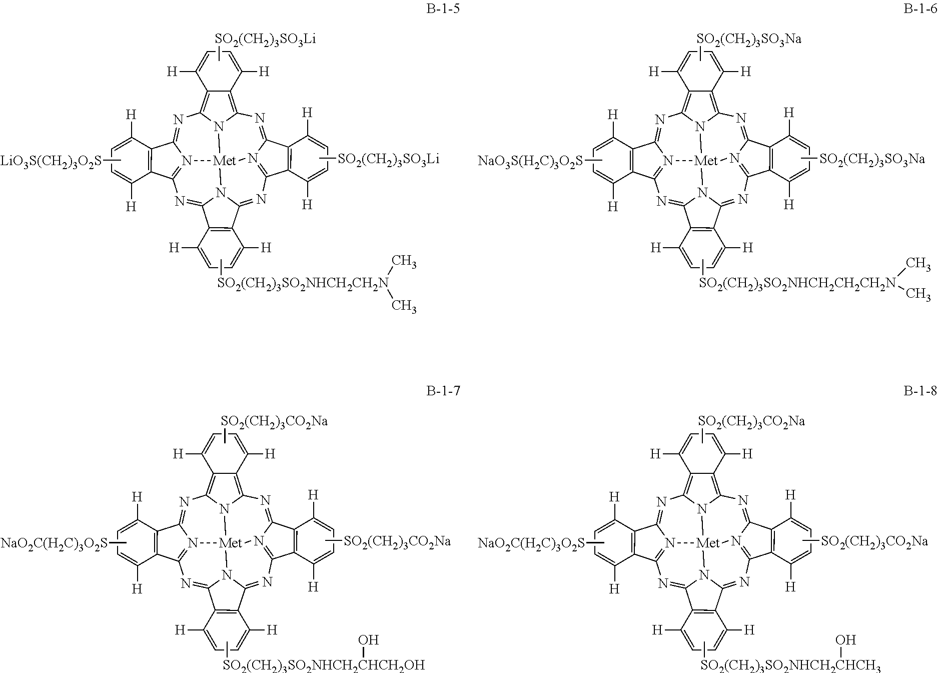

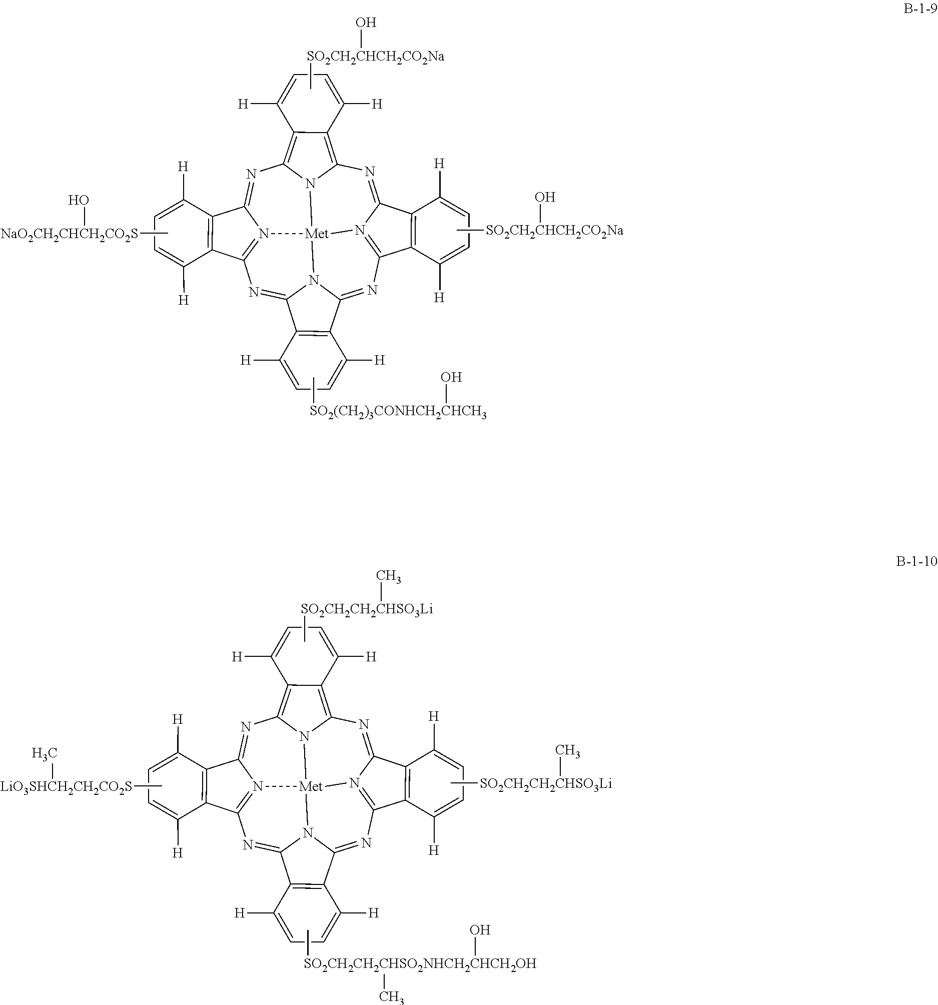

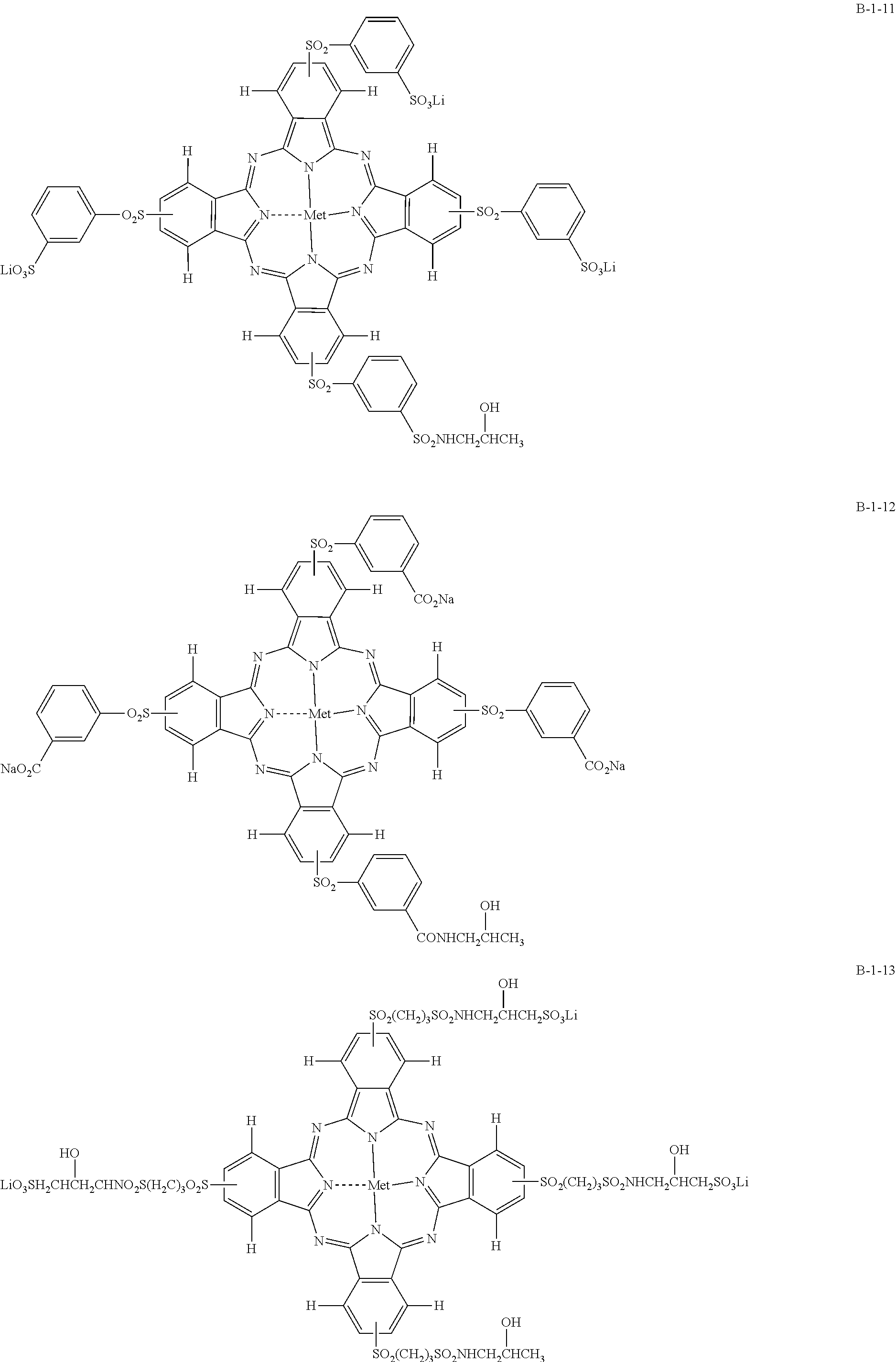

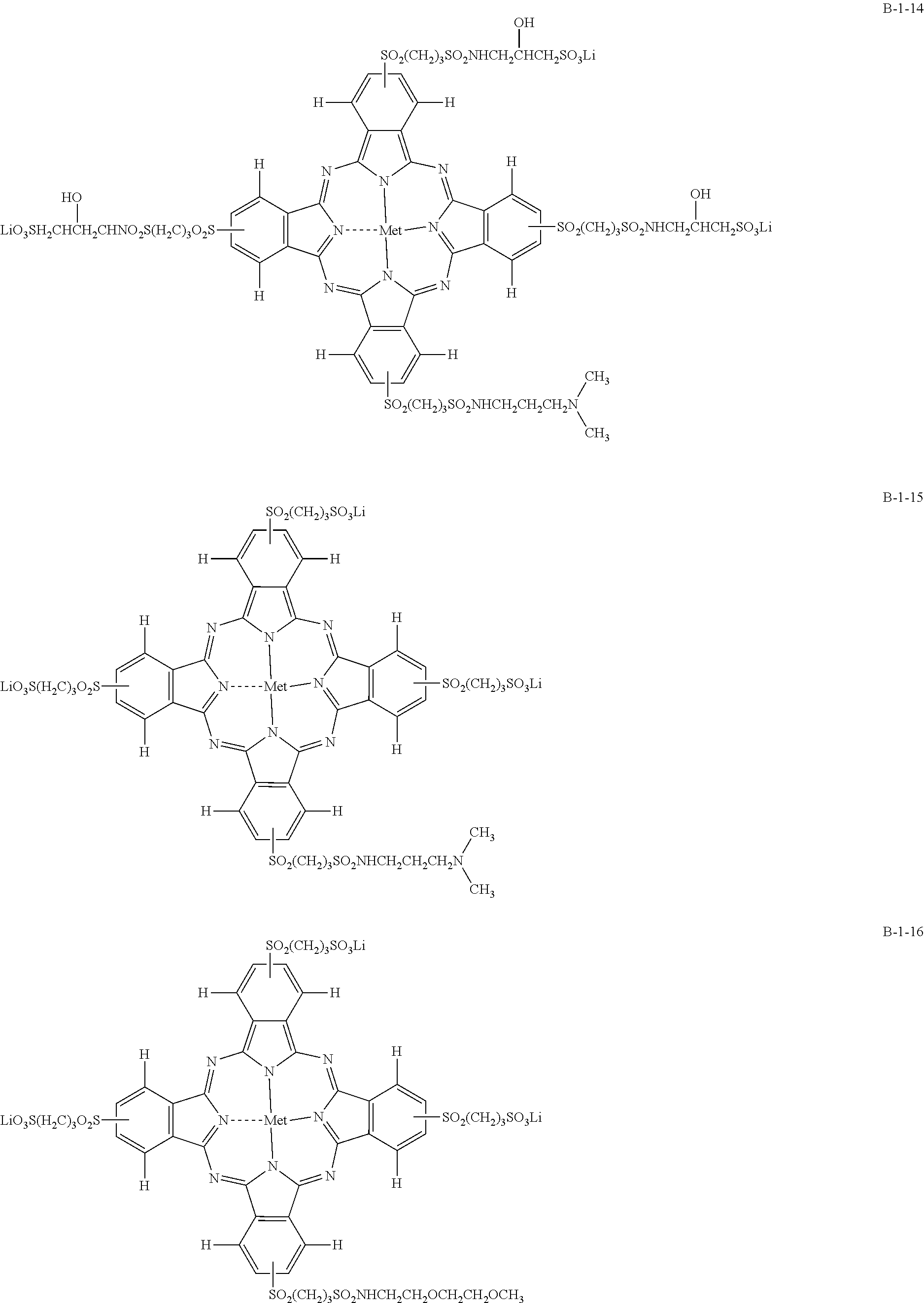

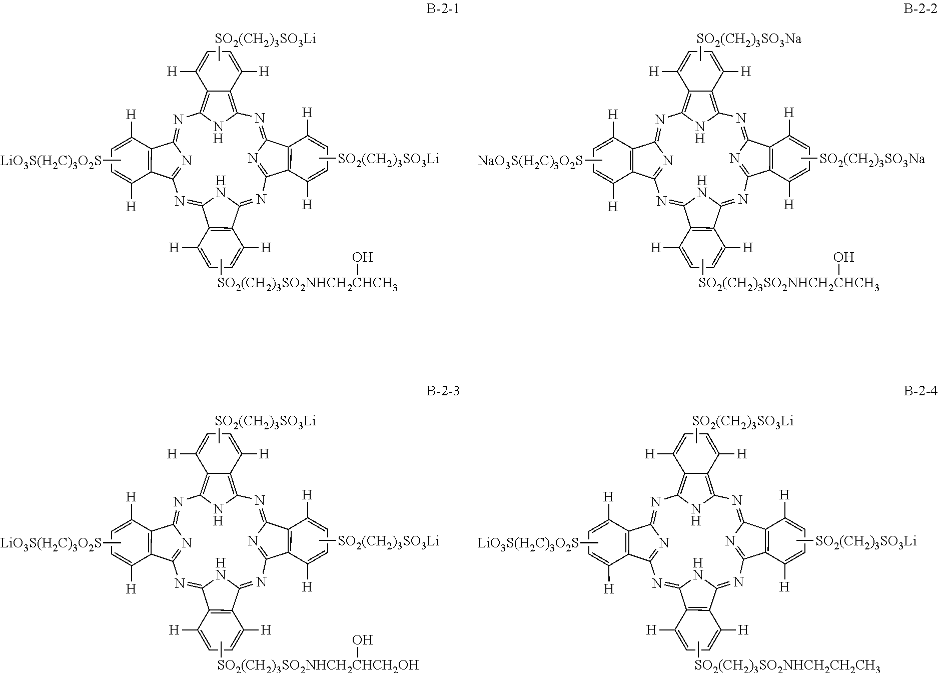

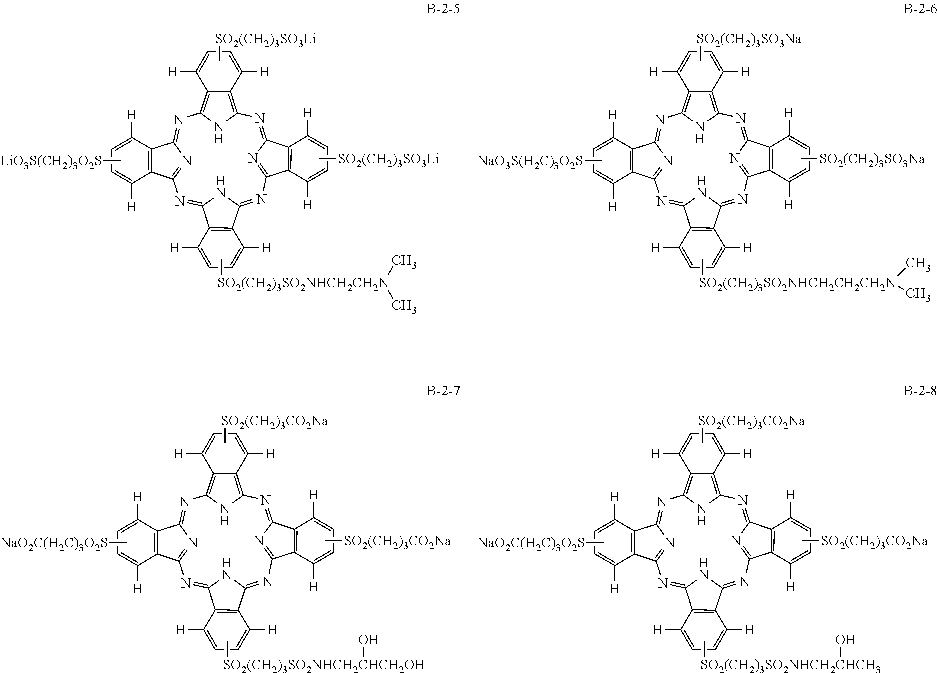

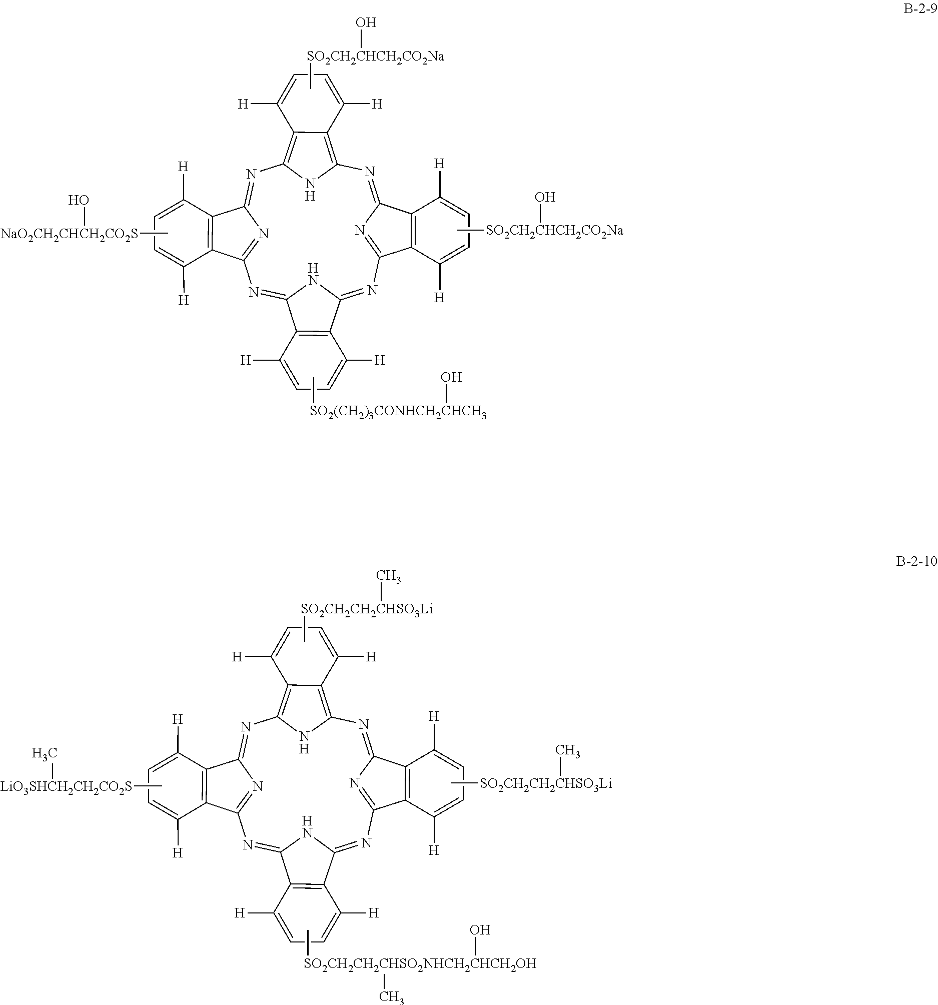

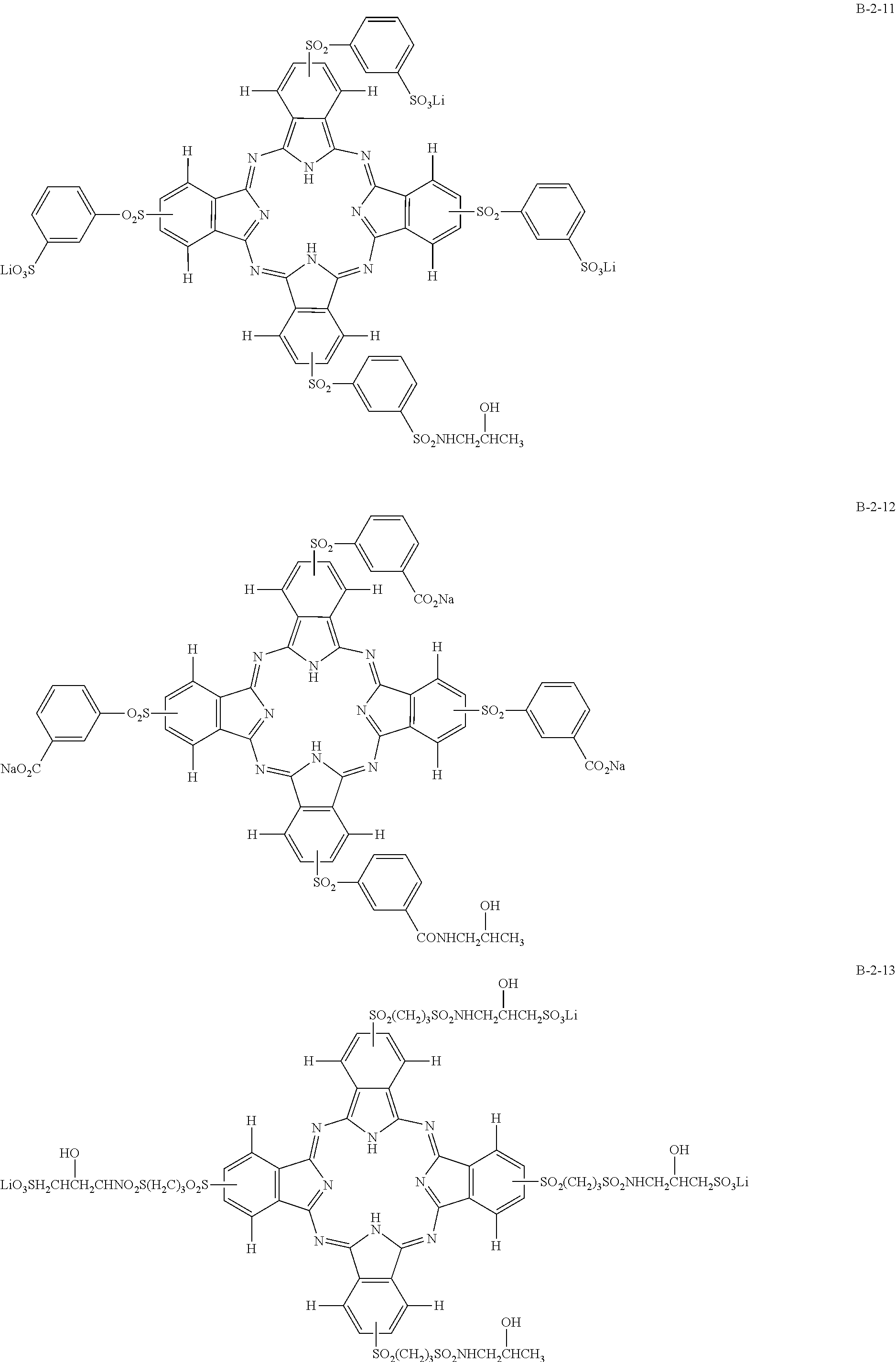

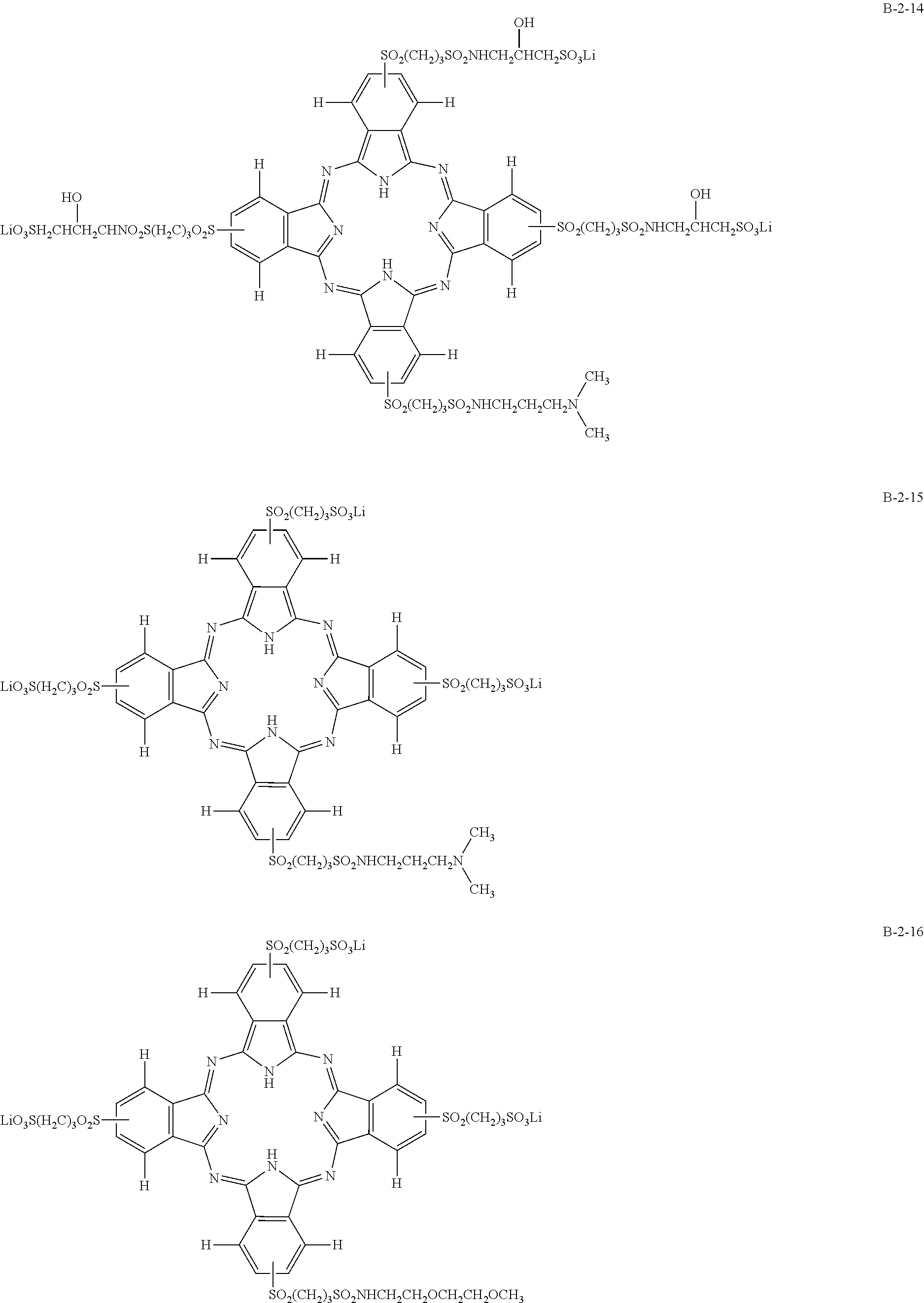

Specific examples of the compound C-I and the compound C-II are given without distinguishing the substitution positions. That is, the specific examples below each encompass positional isomers having different substitution positions as in formulae (2A-1) to (2D-1) and (2A-2) to (2D-2) above. Each R in this case independently represents a substituent (—SO₂Z₁ or —SO₂Z₂). In C-1-1-1 to C-1-8-2 below, Met represents Al, Fe, Co, Ni, Zn, Mg, or Mn.

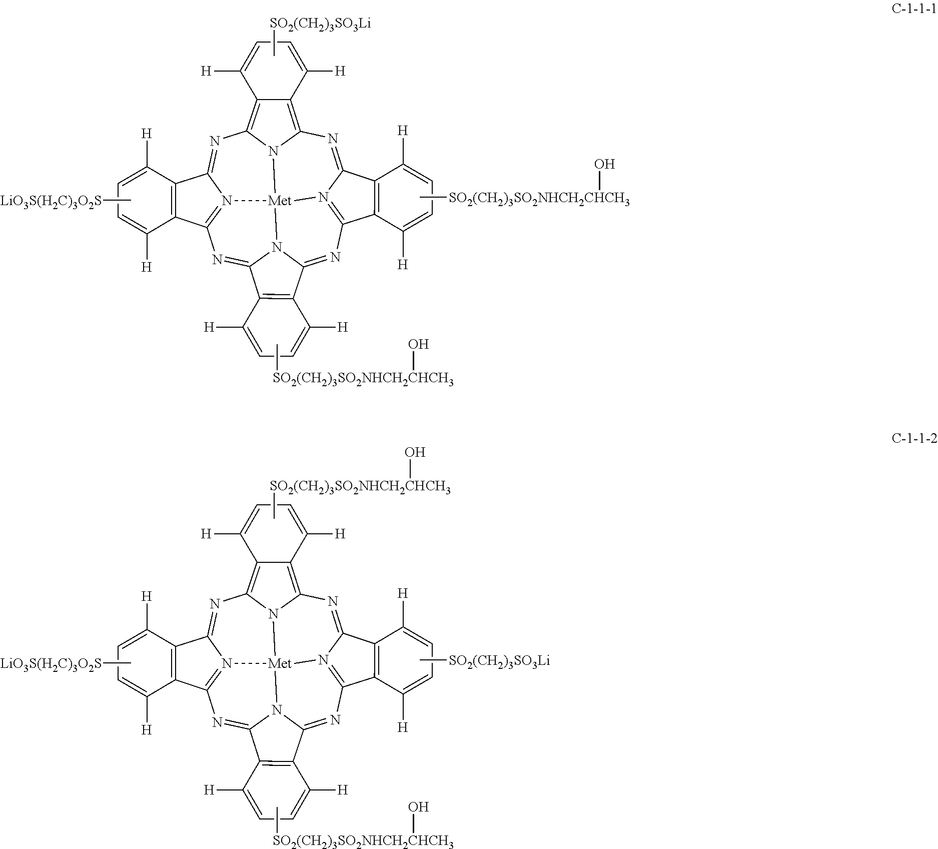

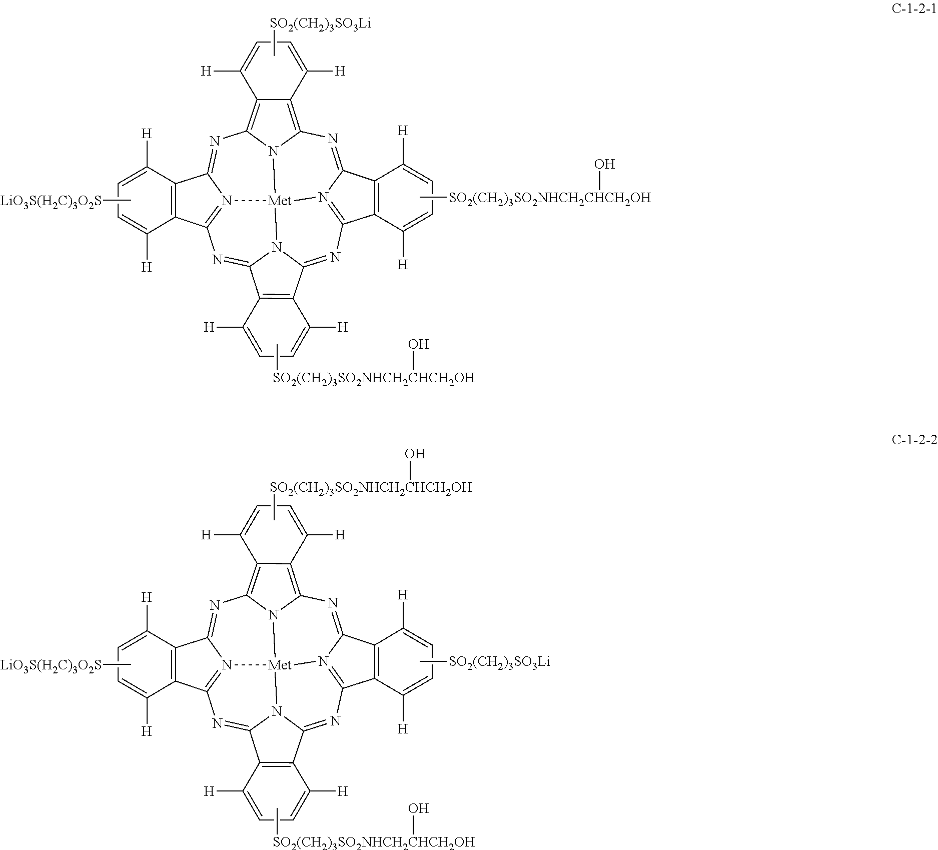

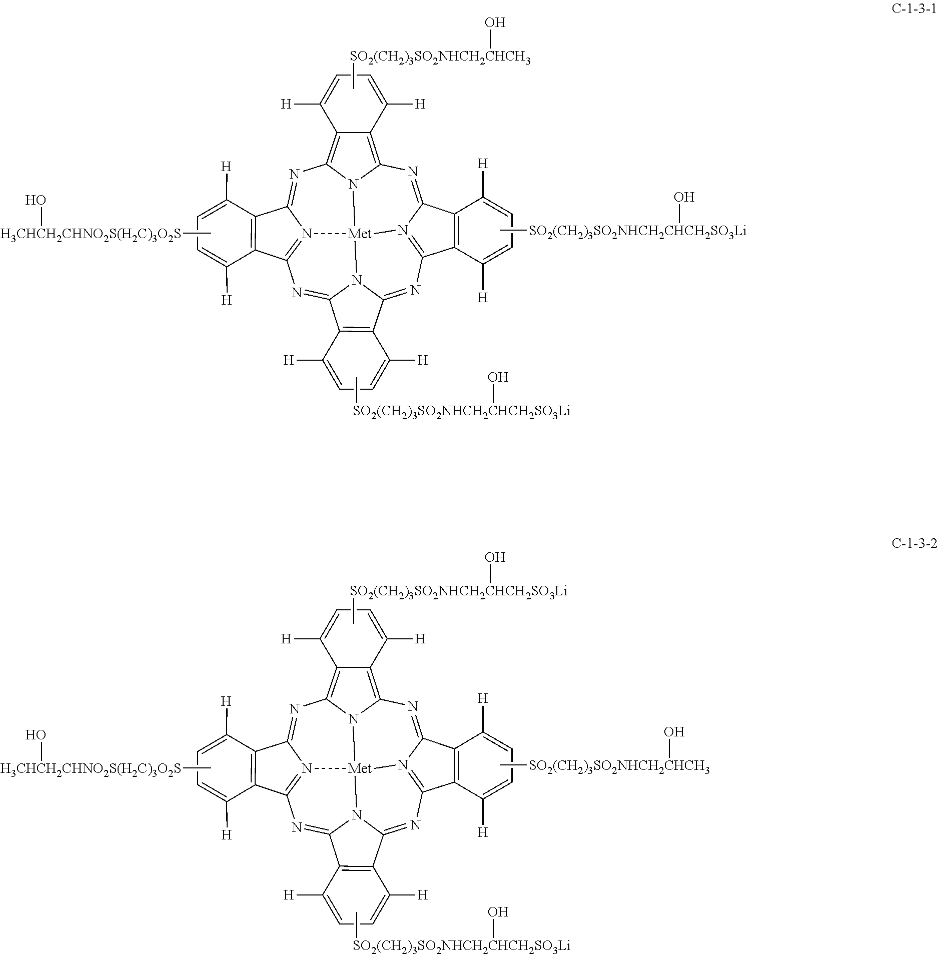

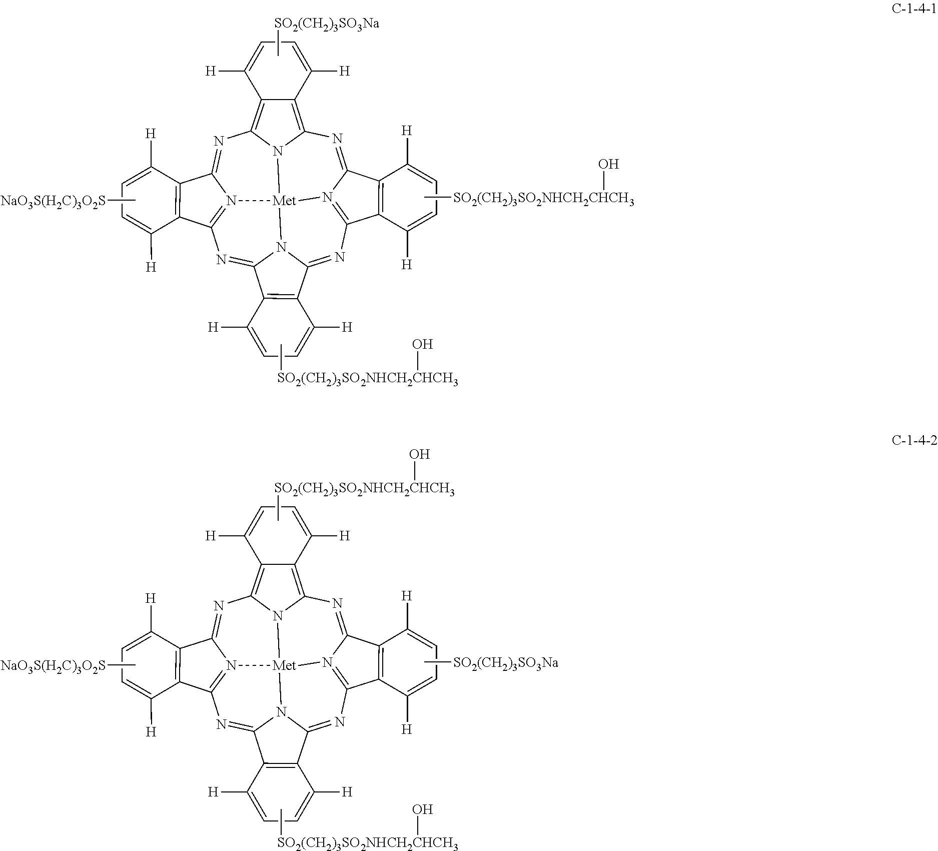

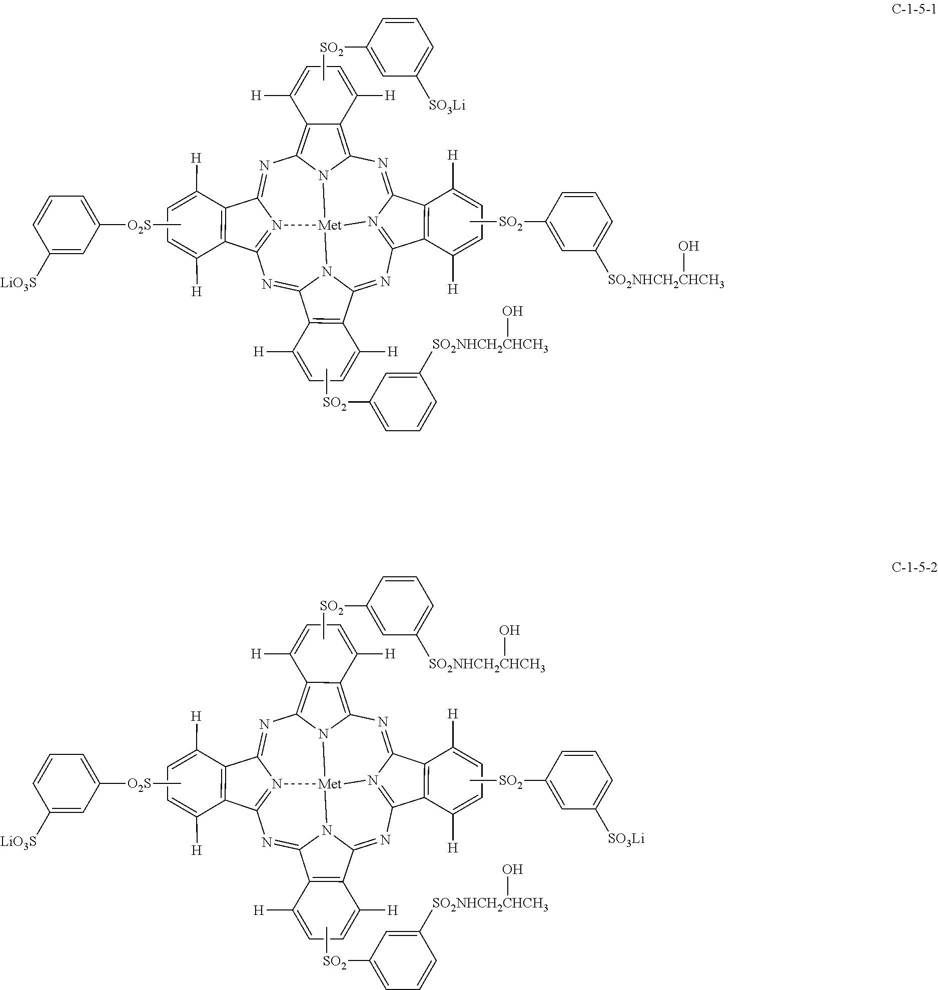

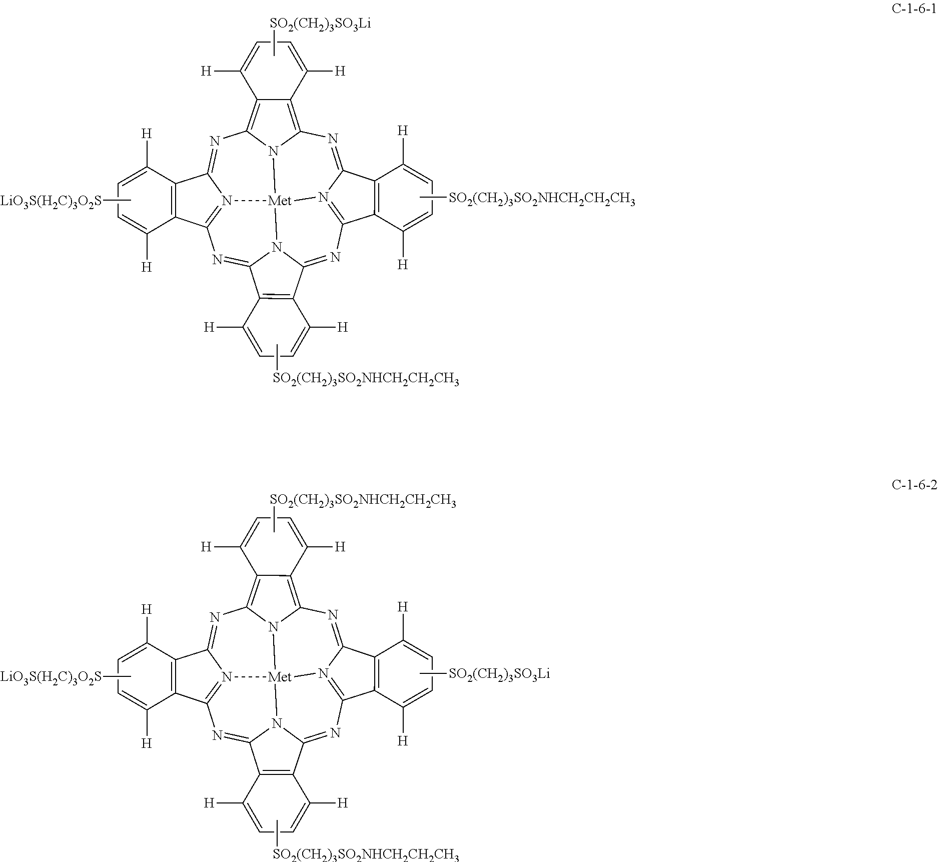

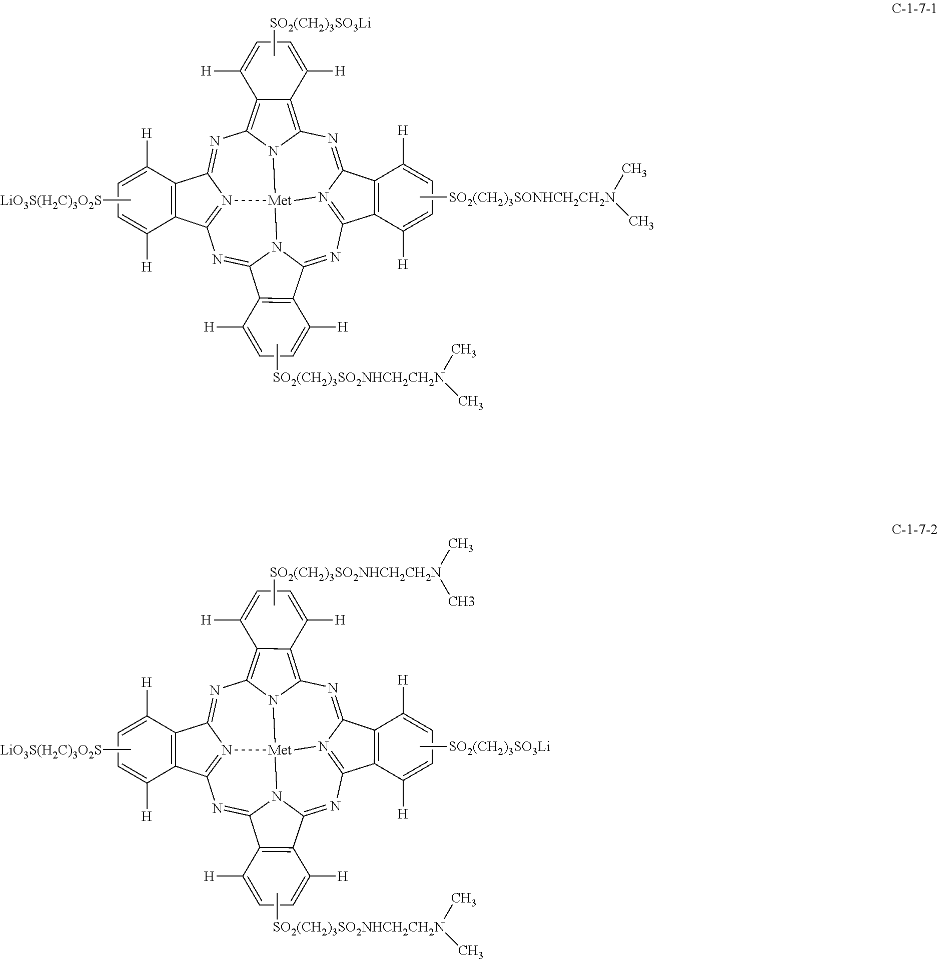

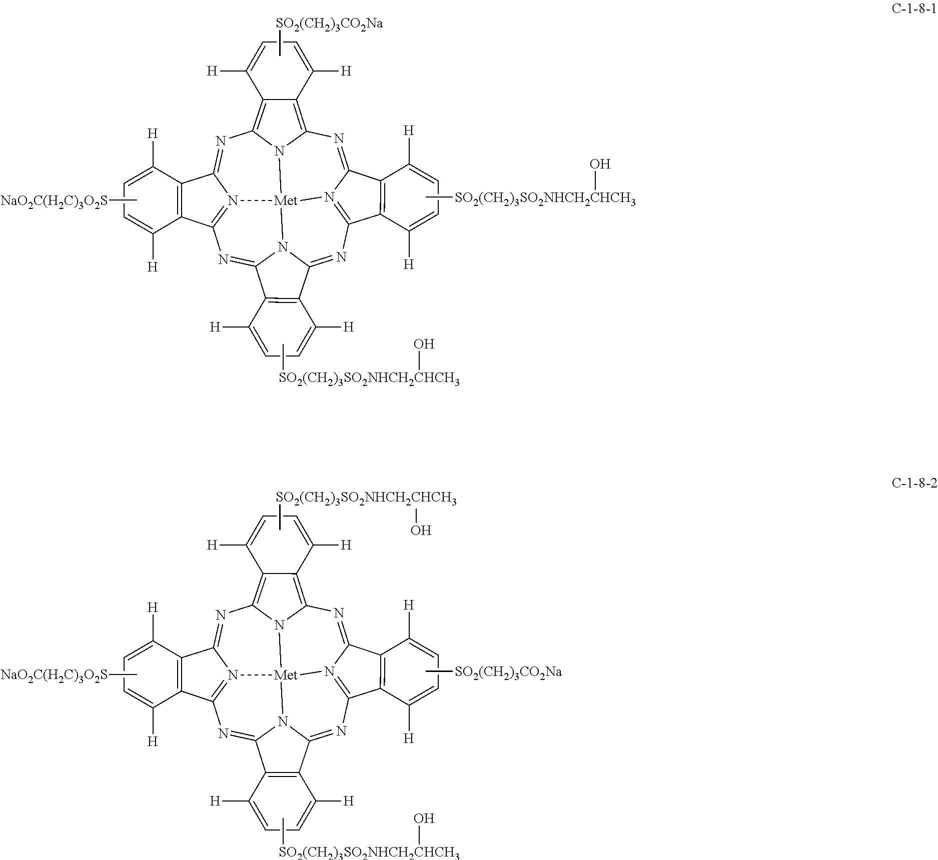

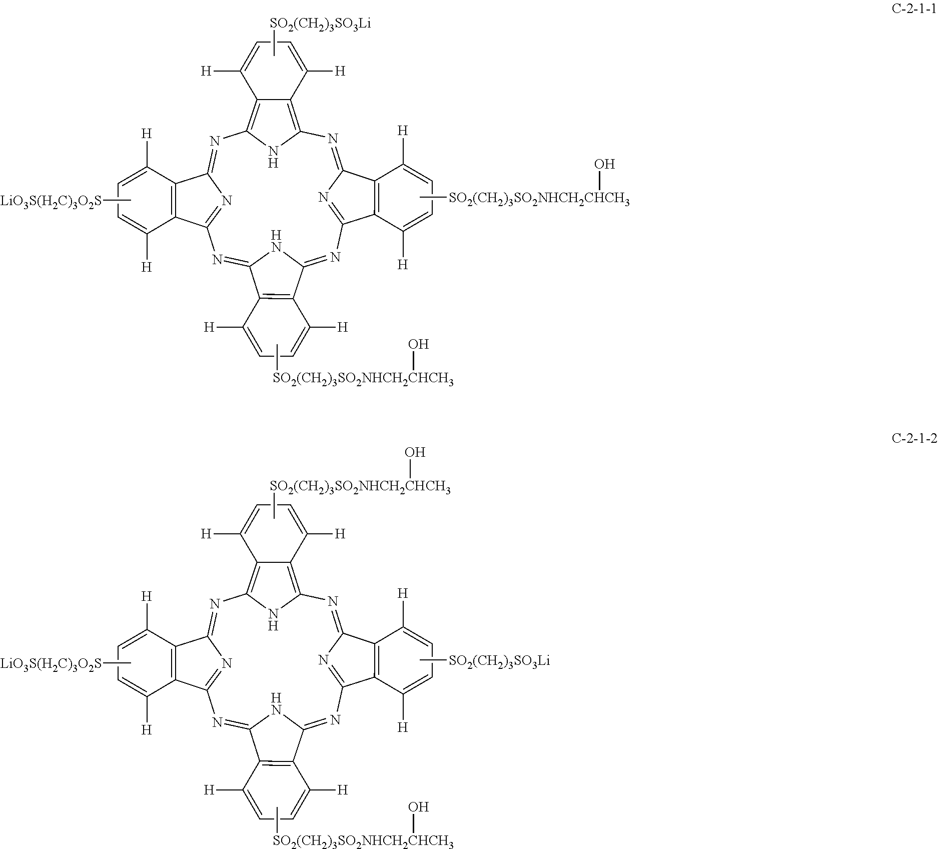

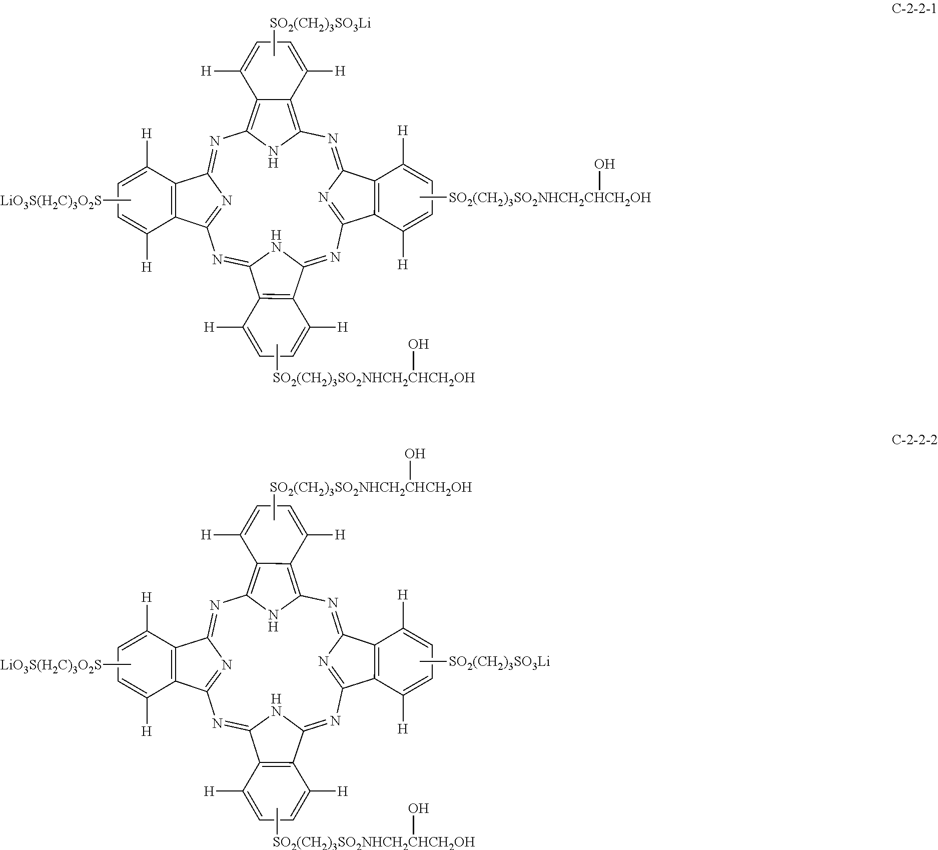

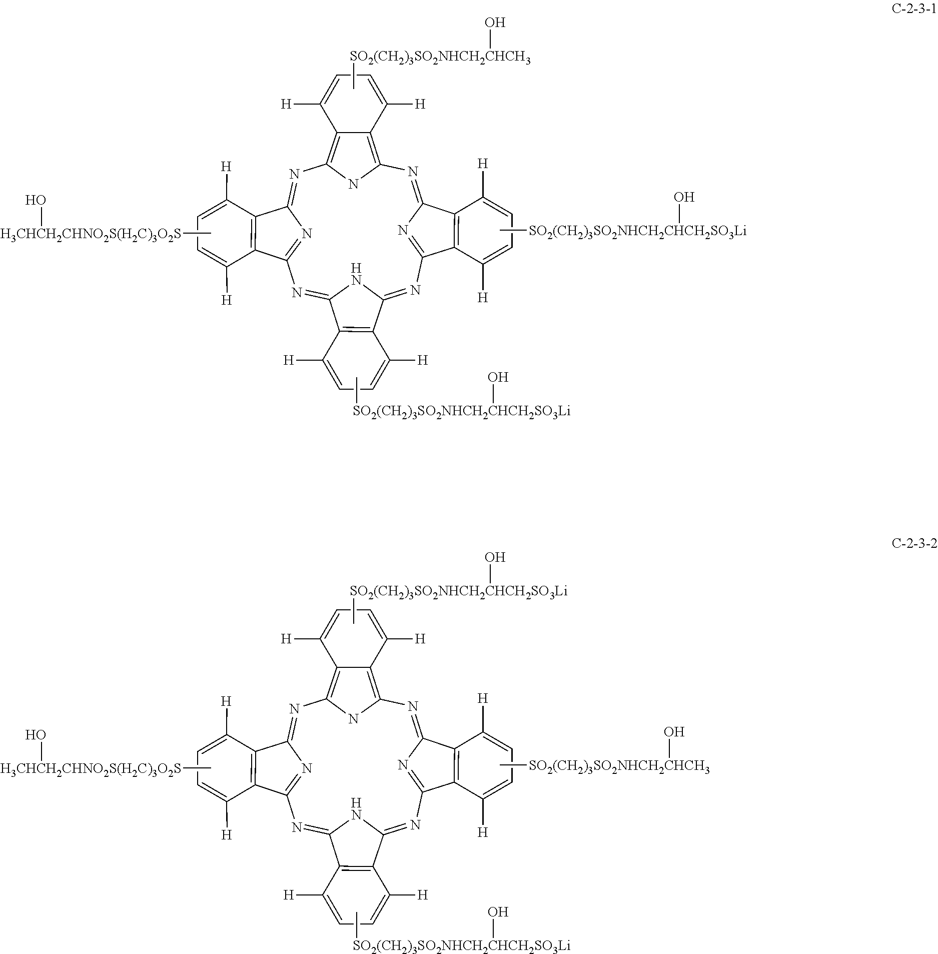

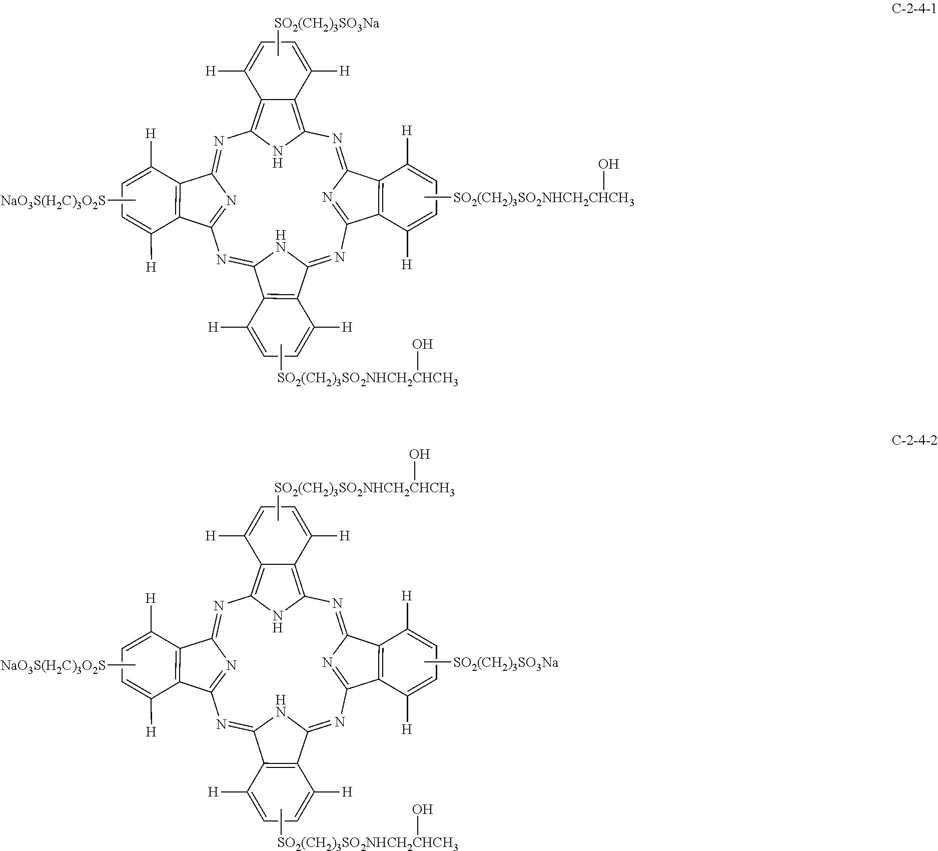

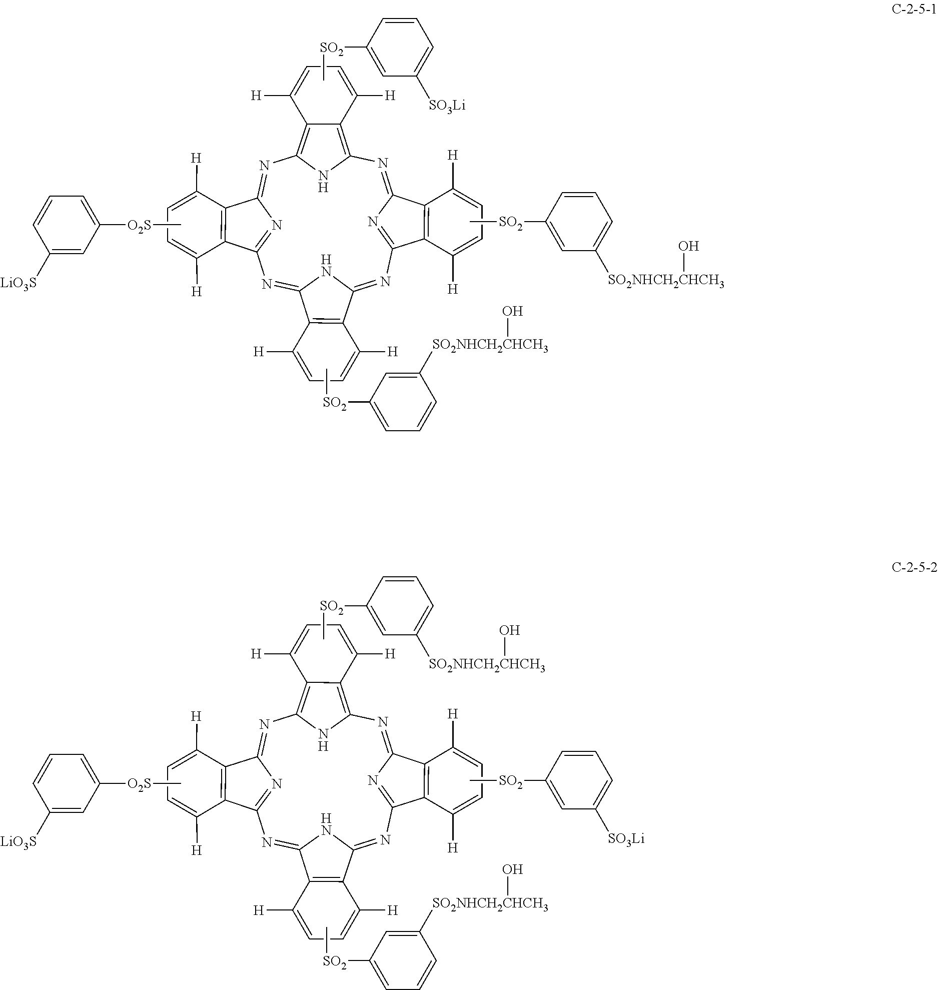

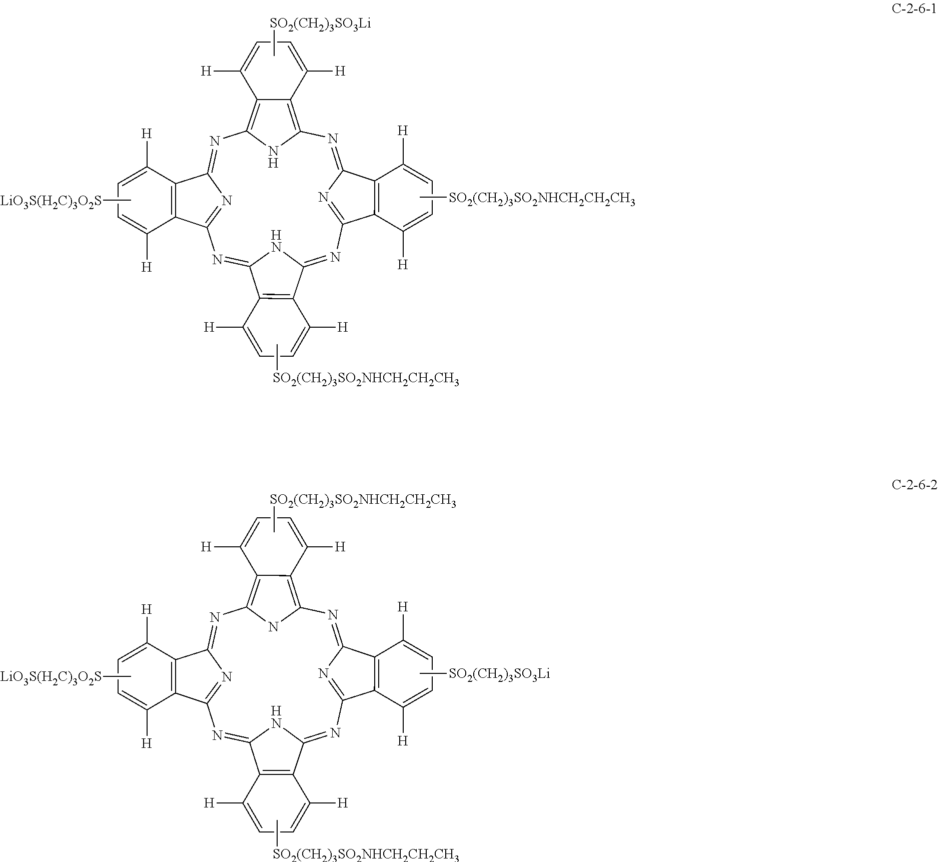

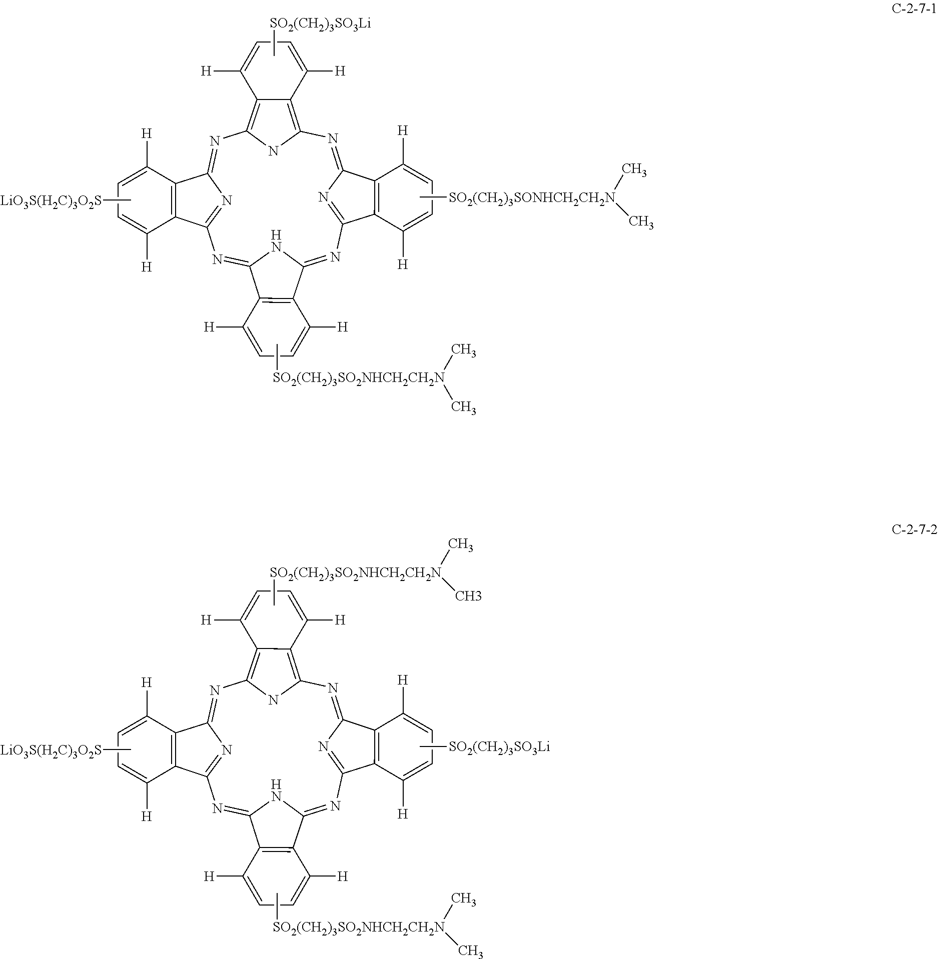

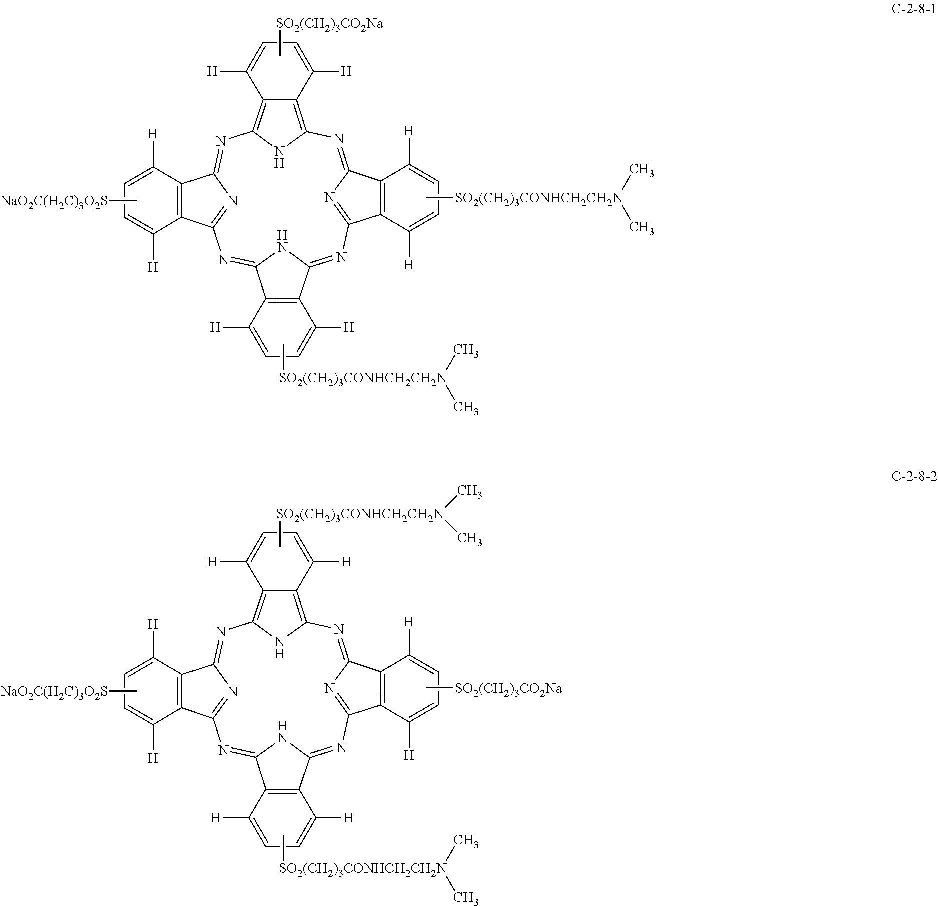

Specific examples of the compound D are given without distinguishing the substitution positions. That is, the specific examples below each encompass positional isomers having different substitution positions as in formulae (2A-1) to (2D-1) and (2A-2) to (2D-2) above. Each R in this case independently represents a substituent (—SO₂Z₁ or —SO₂Z₂). In D-1-1 to D-1-8 below, Met represents Al, Fe, Co, Ni, Zn, Mg, or Mn.

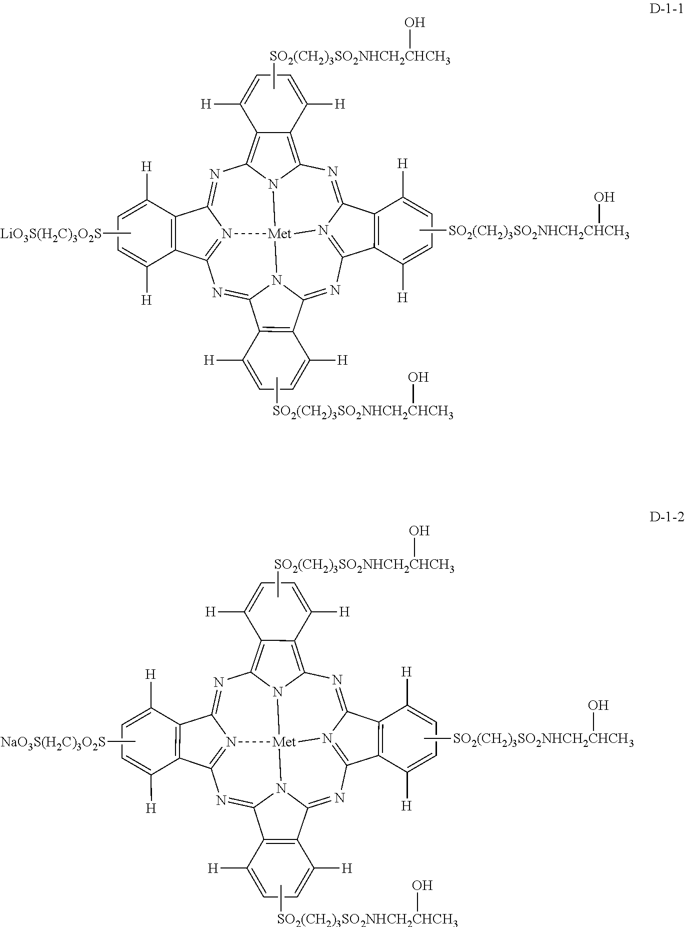

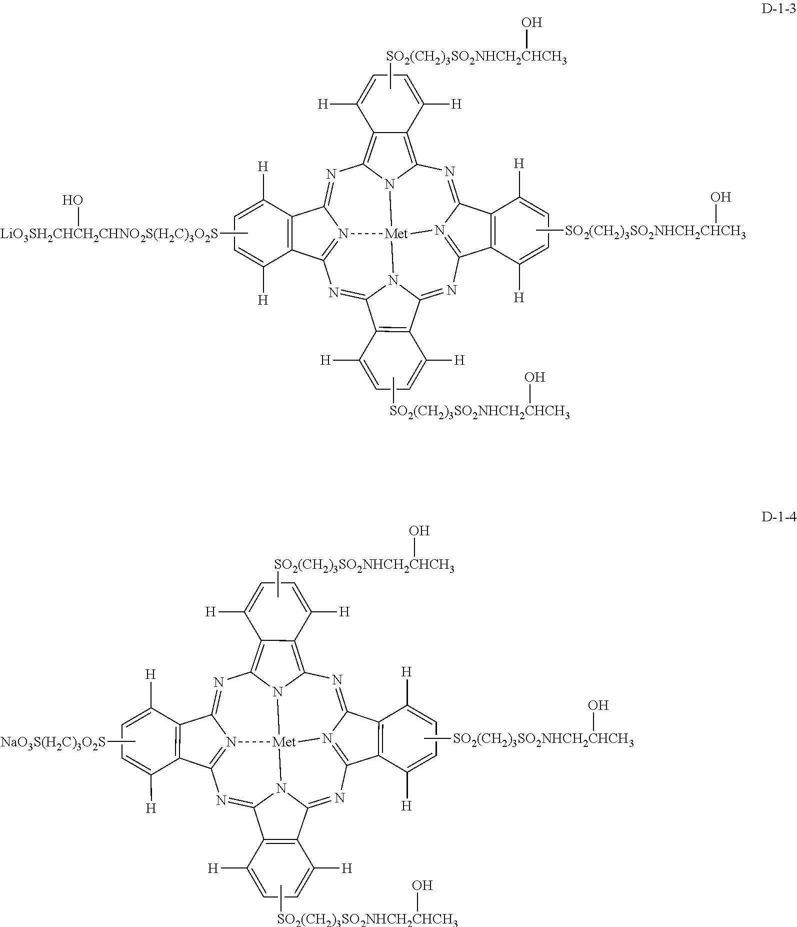

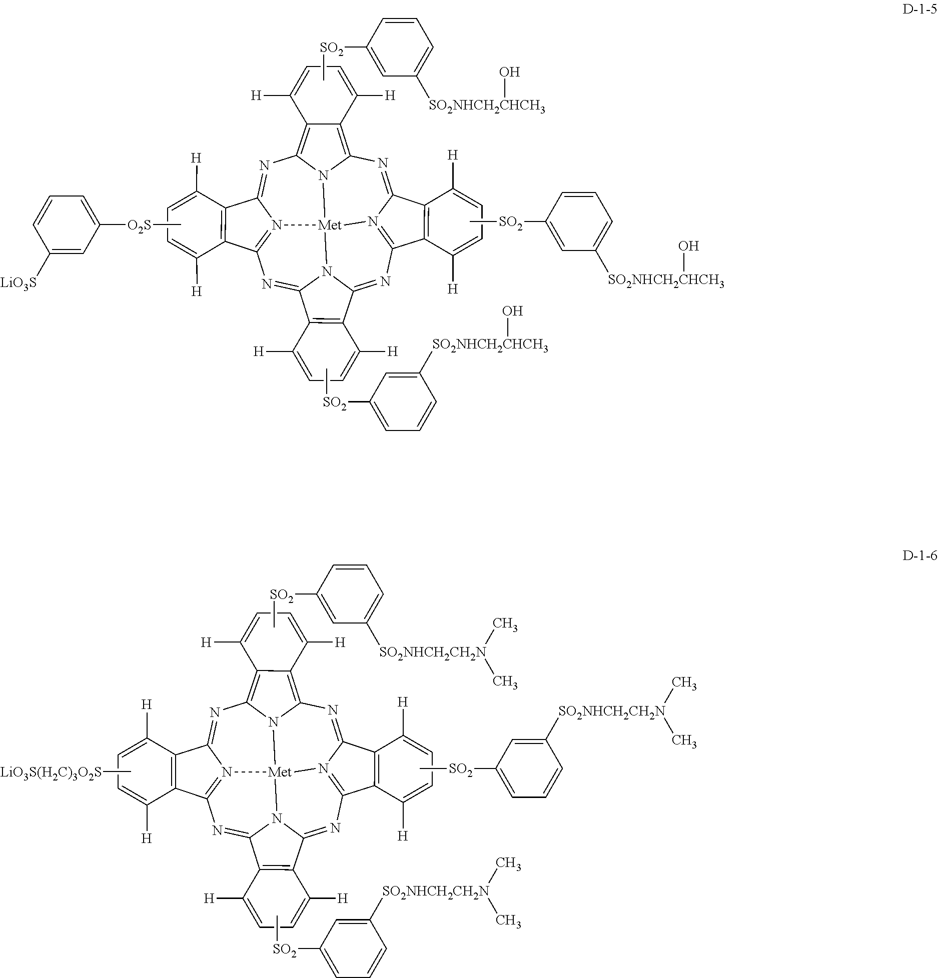

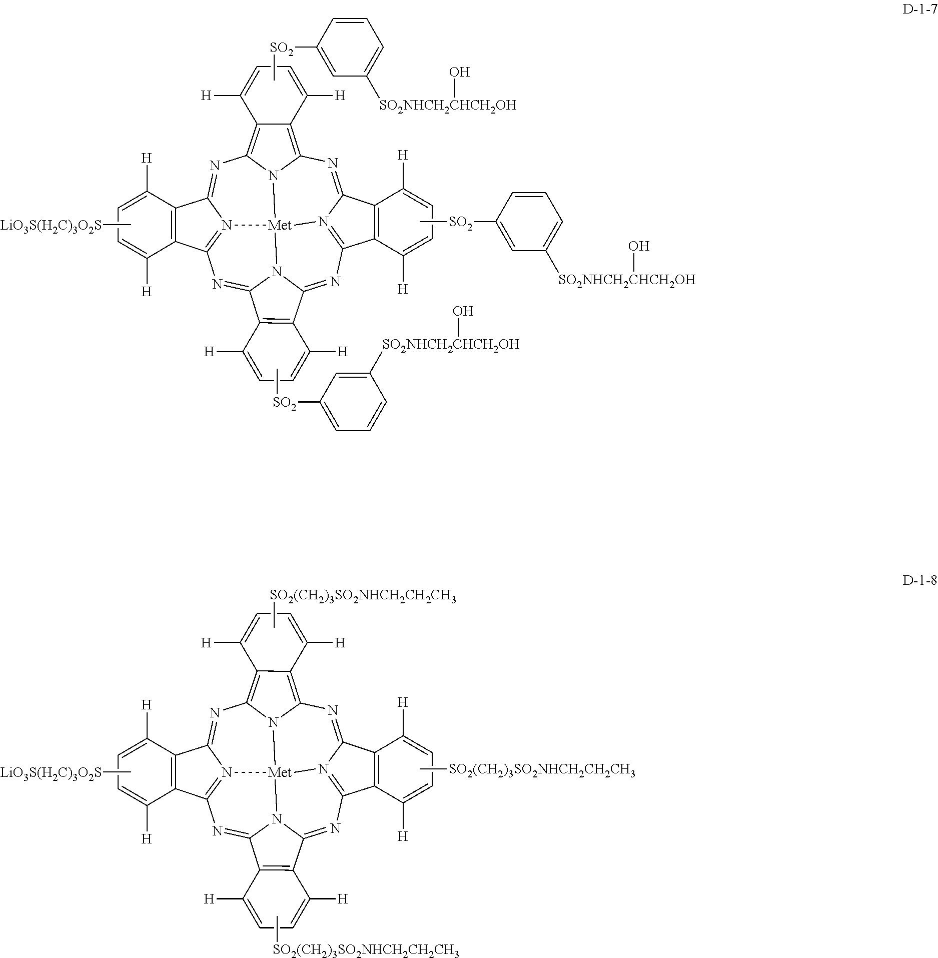

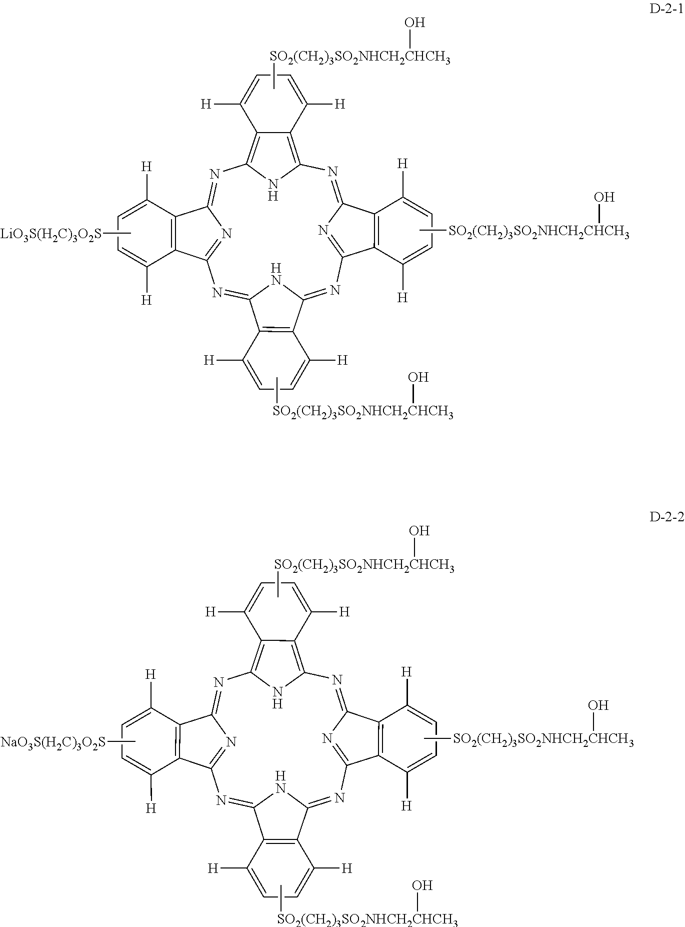

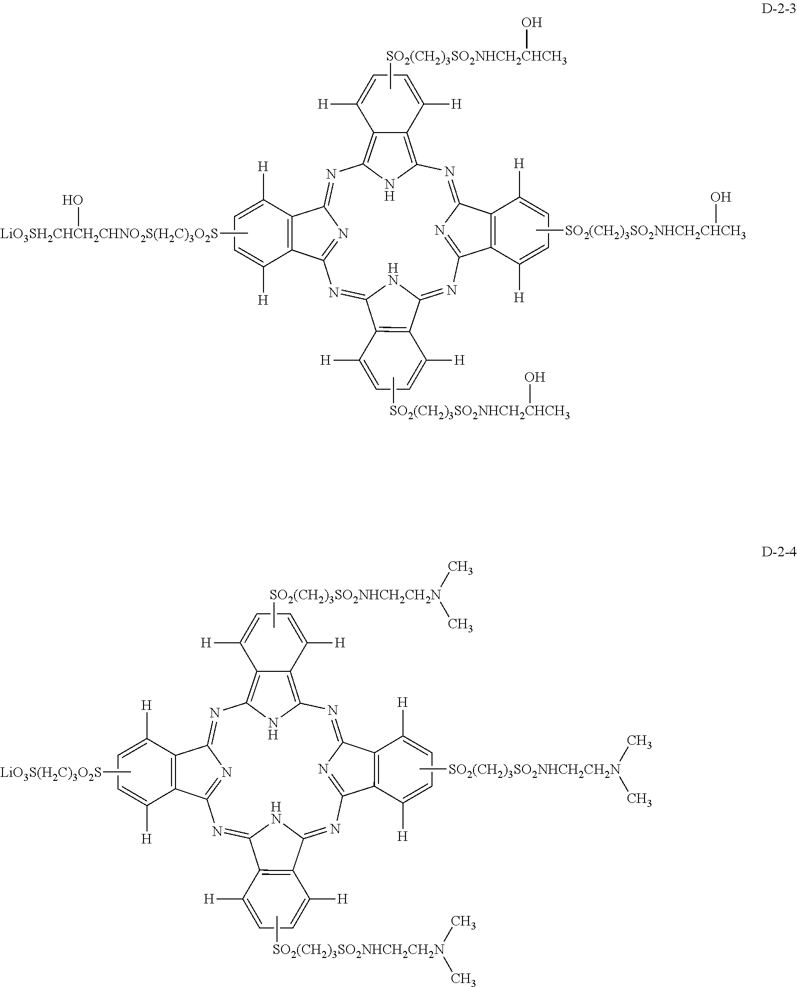

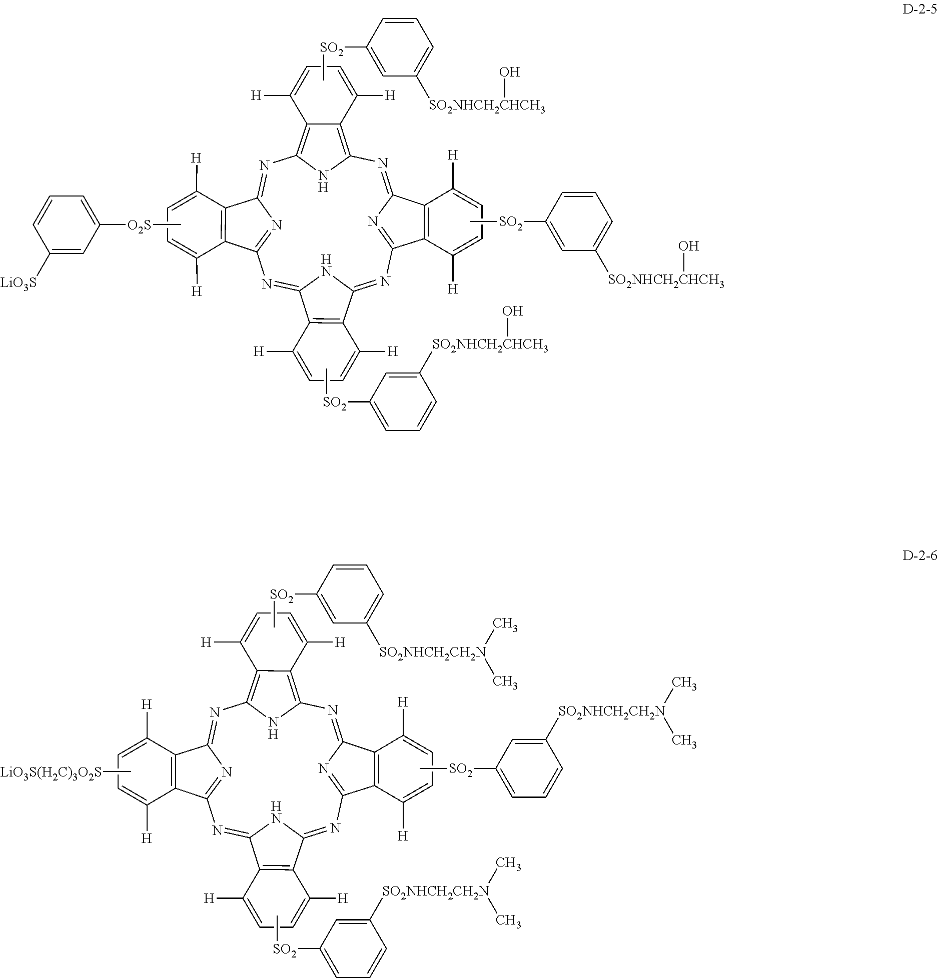

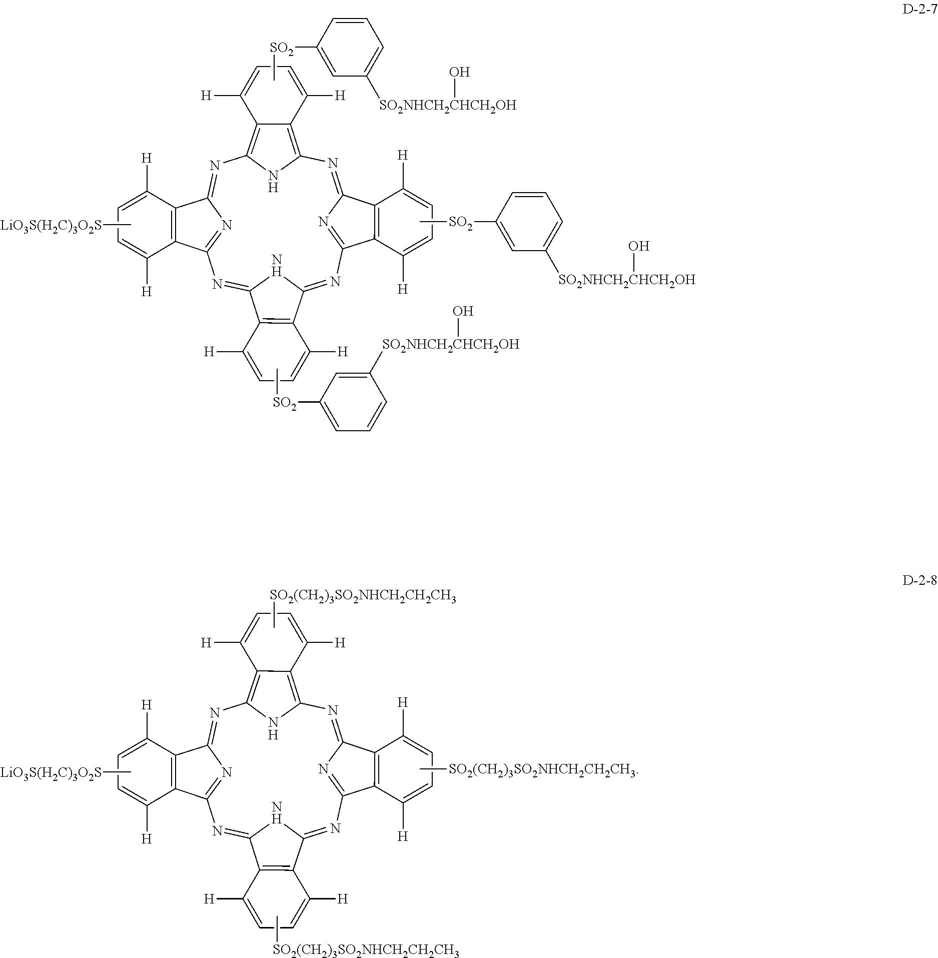

Specific examples of the compound E are given without distinguishing the substitution positions. That is, the specific examples below each encompass positional isomers having different substitution positions as in formulae (2A-1) to (2D-1) and (2A-2) to (2D-2) above. Each R in this case represents a substituent (—SO₂Z₂). In E-1-1 to E-1-12 below, Met represents Al, Fe, Co, Ni, Zn, Mg, or Mn.

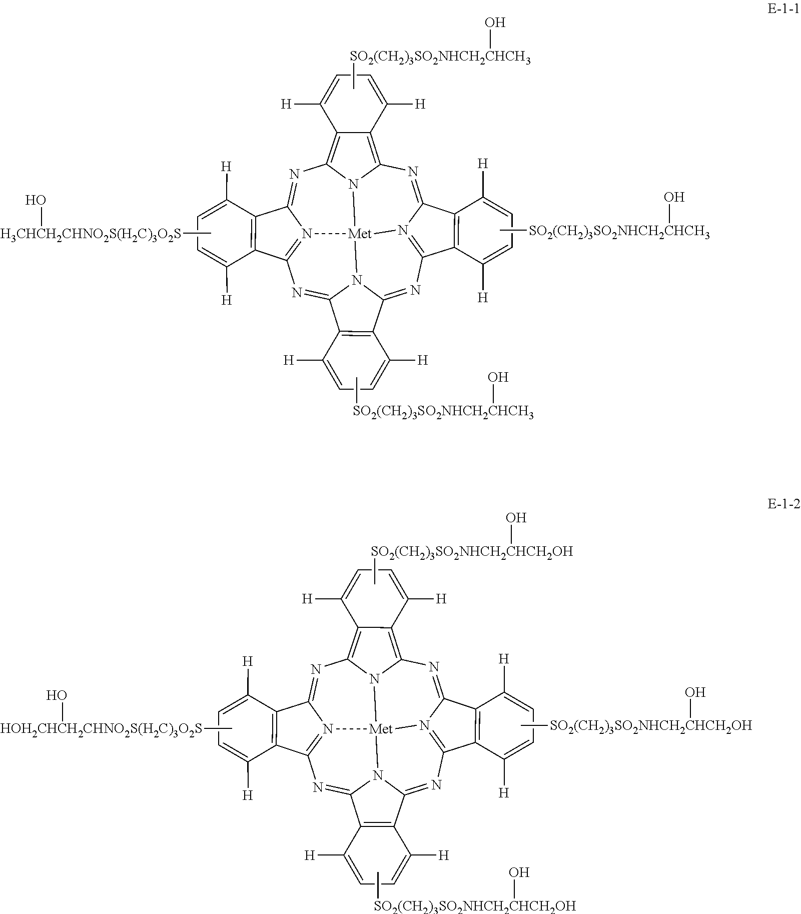

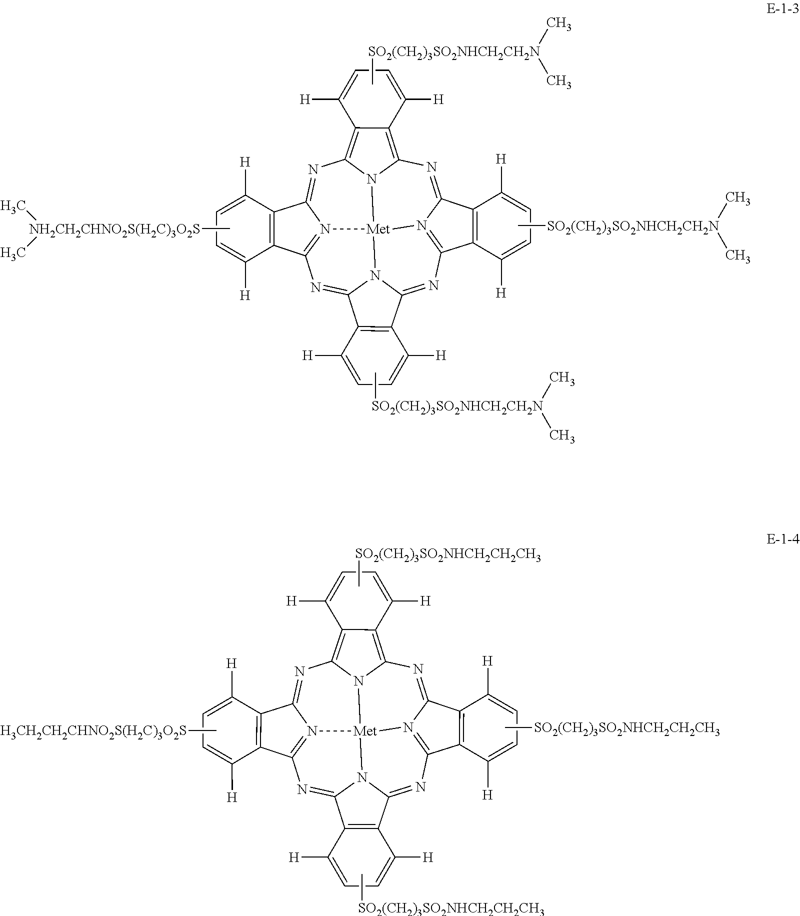

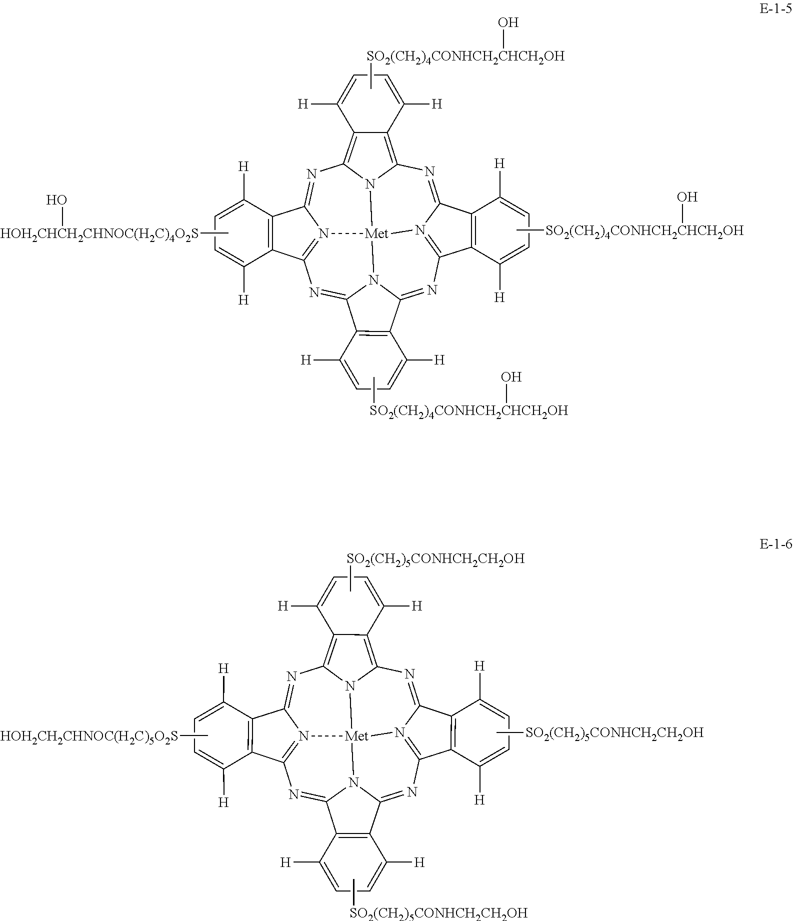

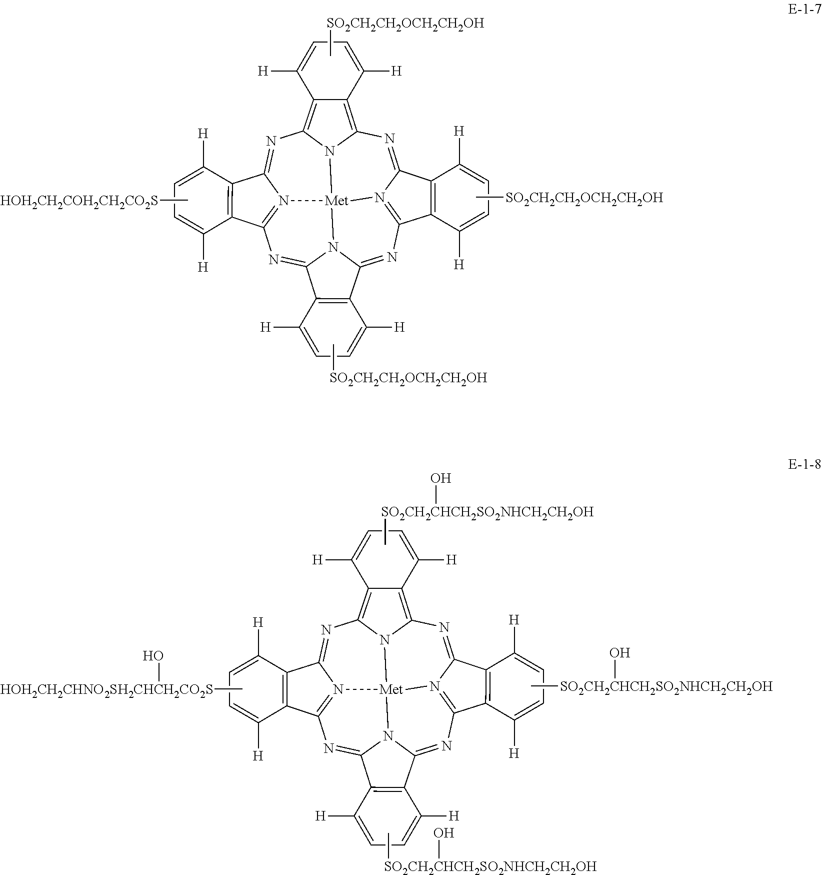

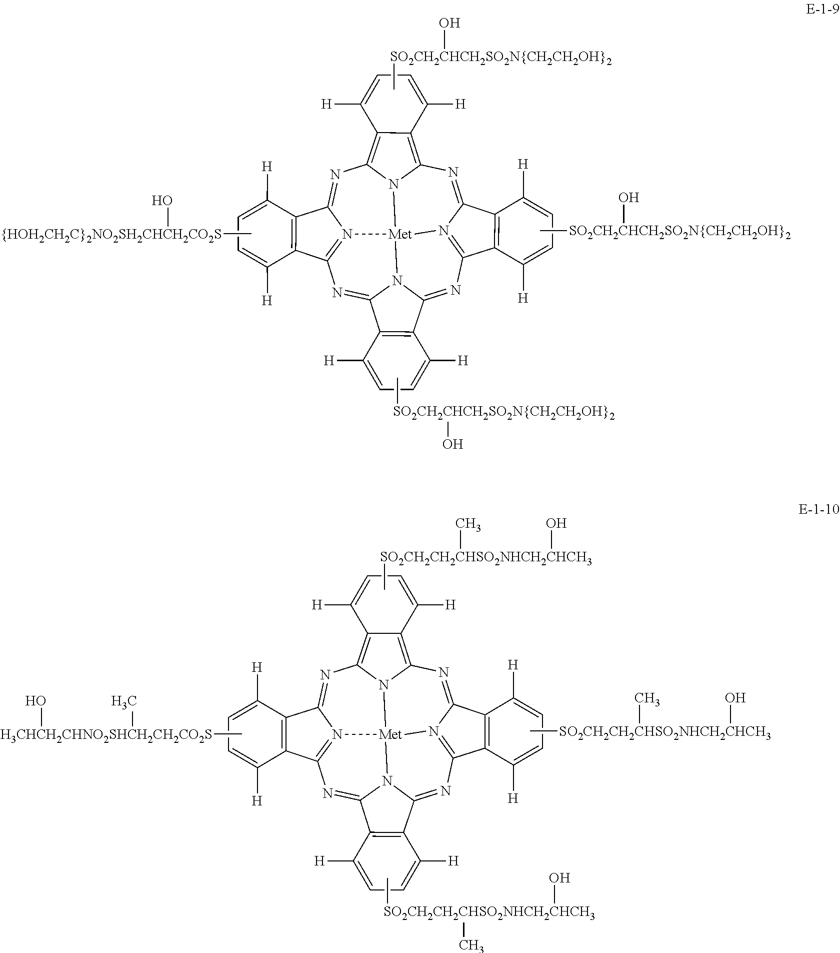

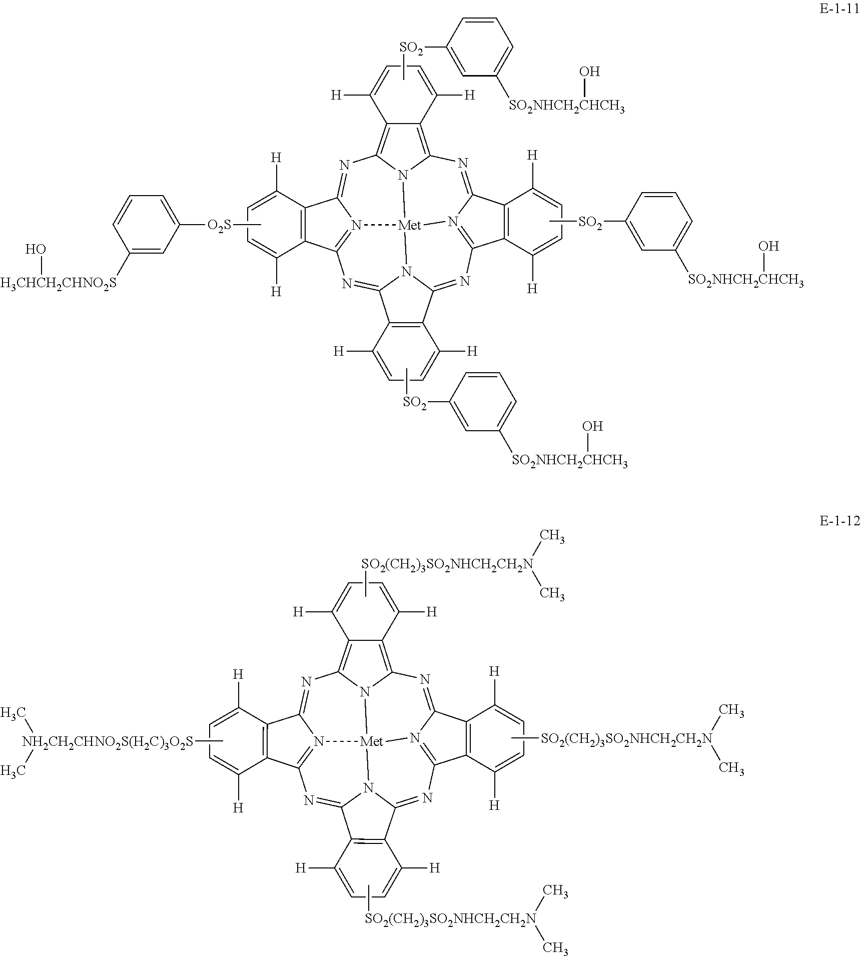

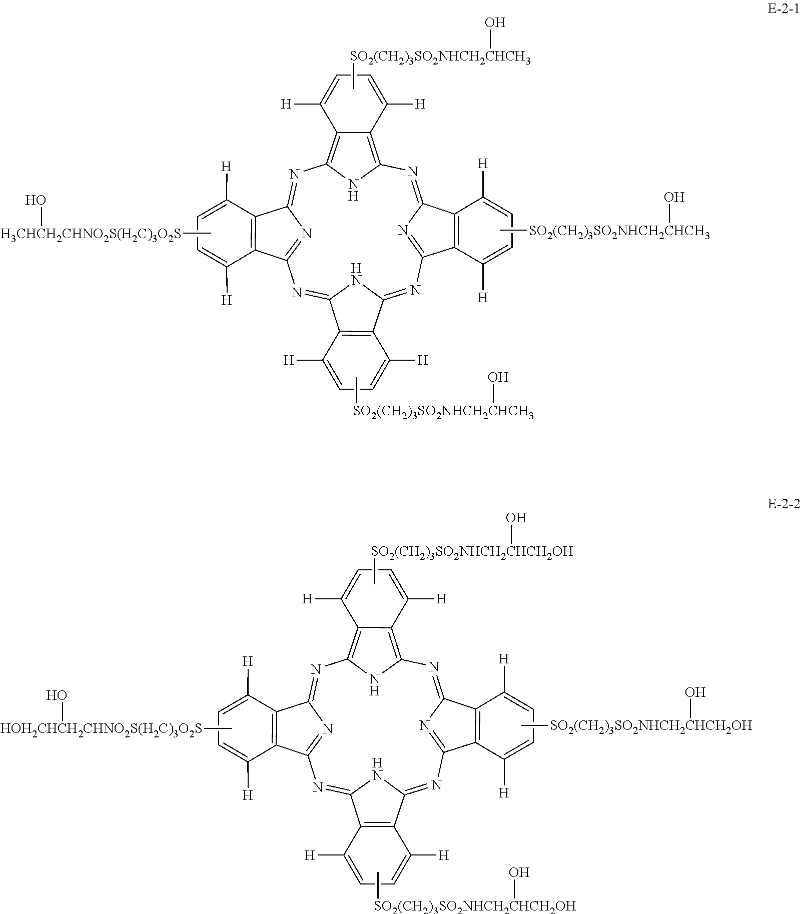

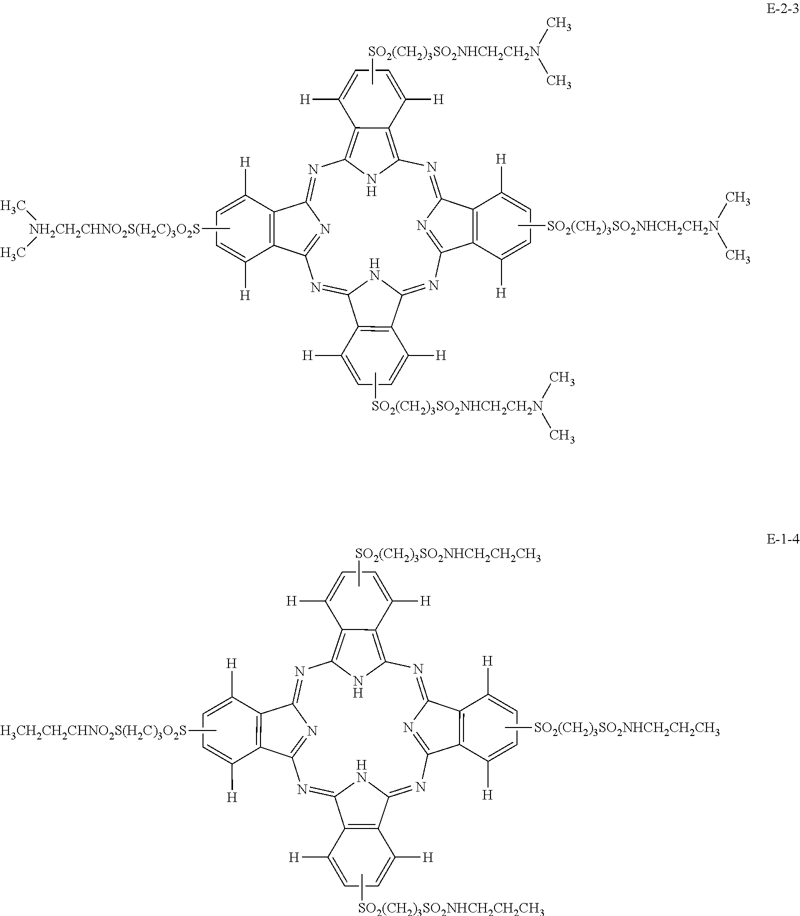

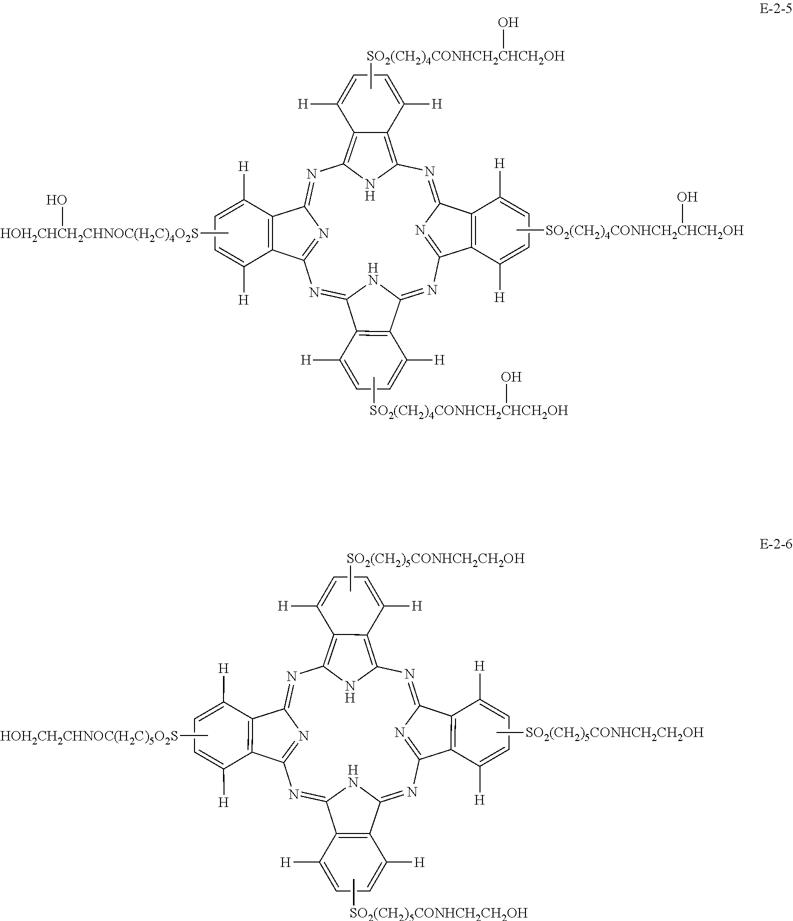

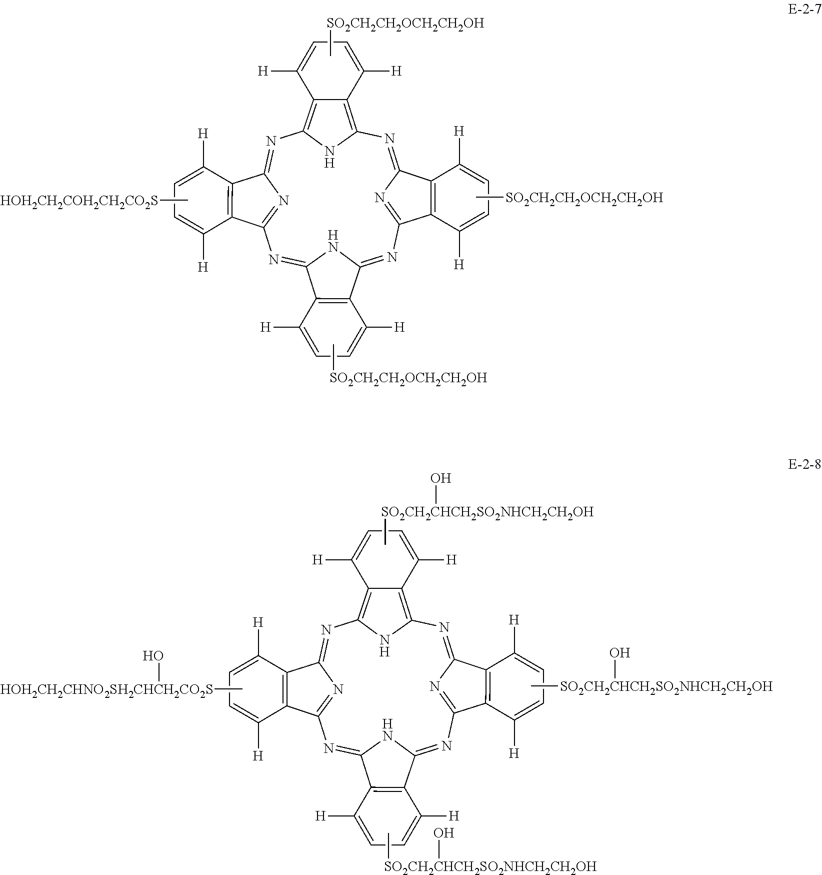

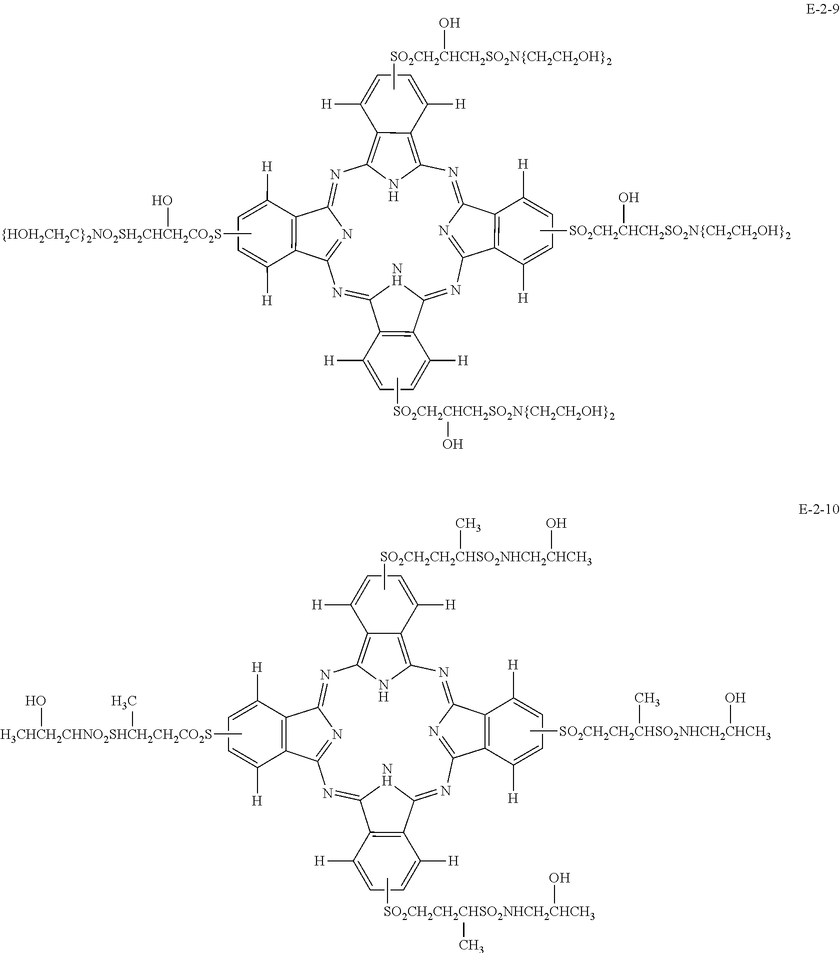

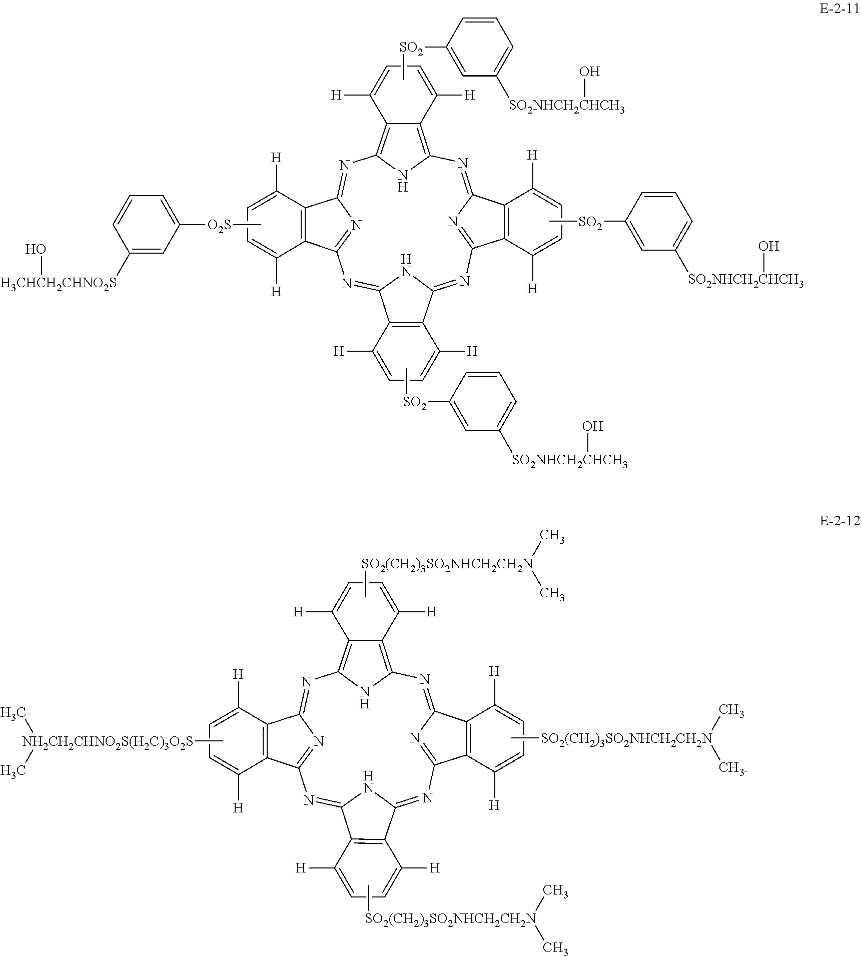

The compound A can be synthesized, isolated, and purified by using publicly known methods (for example, methods described in Examples of JP3949385B, JP4145153B, JP4512543B, and JP4625644B) alone or in combination of two or more and further applying purification, as needed. The compound B, the compound C-I, the compound C-II, the compound D, and the compound E can also be obtained by methods similar to the methods for the compound A.

In the case where the dye ink composition according to the present invention includes the compound A to the compound D but does not include the compound E, when a mass of the compound A is represented by W₁, a mass of the compound B is represented by W2, a sum of a mass of the compound C-I and a mass of the compound C-II is represented by W₃, a mass of the compound D is represented by W₄, and a sum total of W₁, W₂, W₃, and W₄ is represented by W_{A1}, (that is, when W₁+W₂+W₃+W₄=W_{A1}), the compounds A, B, C-I, C-II, and D being included in the dye ink composition according to the present invention,

preferably, a ratio of W₁ to W_{A1} ({(W₁/W_{A1})×100}) is 1.0% to 45.0% by mass,

a ratio of W₂ to W_{A1} ({(W₂/W_{A1})×100}) is 15.0% to 55.0% by mass,

a ratio of W₃ to W_{A1} ({(W₃/W_{A1})×100}) is 10.0% to 55.0% by mass, and

a ratio of W₄ to W_{A1} ({(W₄/W_{A1})×100}) is 1.0% to 45.0% by mass.

More preferably, the ratio of W₁ to W_{A1} is 2.0% to 45.0% by mass,

the ratio of W₂ to W_{A1} is 15.0% to 50.0% by mass,

the ratio of W₃ to W_{A1} is 10.0% to 50.0% by mass, and

the ratio of W₄ to W_{A1} is 1.0% to 40.0% by mass.

Particularly preferably, the ratio of W₁ to W_{A1} is 3.0% to 40.0% by mass,

the ratio of W₂ to W_{A1} is 20.0% to 50.0% by mass,

the ratio of W₃ to W_{A1} is 12.0% to 50.0% by mass, and

the ratio of W₄ to W_{A1} is 1.0% to 35.0% by mass.

Most preferably, the ratio of W₁ to W_{A1} is 6.0% to 35.0% by mass,

the ratio of W₂ to W_{A1} is 20.0% to 45.0% by mass,

the ratio of W₃ to W_{A1} is 15.0% to 45.0% by mass, and

the ratio of W₄ to W_{A1} is 1.0% to 30.0% by mass from the viewpoints of water solubility of the dye mixture and a reduction in changes in physical property values of the solution due to external factors.

In the case where the dye ink composition according to the present invention includes the compound A to the compound D and further includes the compound E, when a mass of the compound A is represented by W₁, a mass of the compound B is represented by W₂, a sum of a mass of the compound C-I and a mass of the compound C-II is represented by W₃, a mass of the compound D is represented by W₄, a mass of the compound E is represented by W₅, and a sum total of W₁, W₂, W₃, W₄, and W₅ is represented by W_{A2}, (that is, when W₁+W₂+W₃+W₄+W₅=W_{A2}), the compounds A, B, C-I, C-II, D, and E being included in the dye ink composition according to the present invention,

preferably, a ratio of W₁ to W_{A2} ({(W₁/W_{A2})×100}) is 0.4% to 40.0% by mass,

a ratio of W₂ to W_{A2} ({(W₂/W_{A2})×100}) is 1.0% to 50.0% by mass,

a ratio of W₃ to W_{A2} ({(W₃/W_{A2})×100}) is 15.0% to 40.0% by mass,

a ratio of W₄ to W_{A2} ({(W₄/W_{A2})×100}) is 1.0% to 35.0% by mass, and

a ratio of W₅ to W_{A2} ({(W₅/W_{A2})×100}) is 0.1% to 10.0% by mass.

More preferably, the ratio of W₁ to W_{A2} is 1.0% to 45.0% by mass,

the ratio of W₂ to W_{A2} is 15.0% to 55.0% by mass,

the ratio of W₃ to W_{A2} is 10.0% to 55.0% by mass,

the ratio of W₄ to W_{A2} is 1.0% to 45.0% by mass, and

the ratio of W₅ to W_{A2} is 0.1% to 20.0% by mass.

Still more preferably, the ratio of W₁ to W_{A1} is 2.0% to 45.0% by mass,

the ratio of W₂ to W_{A2} is 15.0% to 50.0% by mass,

the ratio of W₃ to W_{A2} is 10.0% to 50.0% by mass,

the ratio of W₄ to W_{A2} is 1.0% to 40.0% by mass, and

the ratio of W₅ to W_{A2} is 0.1% to 15.0% by mass.

Particularly preferably, the ratio of W₁ to W_{A2} is 3.0% to 40.0% by mass,

the ratio of W₂ to W_{A2} is 20.0% to 50.0% by mass,

the ratio of W₃ to W_{A2} is 12.0% to 50.0% by mass,

the ratio of W₄ to W_{A2} is 1.0% to 35.0% by mass, and

the ratio of W₅ to W_{A2} is 0.1% to 12.0% by mass.

Even more preferably, the ratio of W₁ to W_{A2} is 5.0% to 35.0% by mass,

the ratio of W₂ to W_{A2} is 20.0% to 45.0% by mass,

the ratio of W₃ to W_{A2} is 15.0% to 45.0% by mass,

the ratio of W₄ to W_{A2} is 1.0% to 30.0% by mass, and

the ratio of W₅ to W_{A2} is 0.1% to 10.0% by mass from the viewpoints of water solubility of the dye mixture and a reduction in changes in physical property values of the solution due to external factors.

Most preferably, the ratio of W₁ to W_{A2} is 5.0% to 30.0% by mass,

the ratio of W₂ to W_{A2} is 20.0% to 45.0% by mass,

the ratio of W₃ to W_{A2} is 15.0% to 45.0% by mass,

the ratio of W₄ to W_{A2} is 1.0% to 30.0% by mass, and

the ratio of W₅ to W_{A2} is 0.5% to 10.0% by mass from the viewpoints of water solubility of the dye mixture and a reduction in changes in physical property values of the solution due to external factors.

A mixing ratio (mass ratio) of the cyan dye mixture according to the present invention: compound A/compound B/compound C-I and compound C-II/compound D/compound E is preferably {31.80%/42.20%/21.20%/4.80%/0.00%} to {6.25%/25.00%/37.50%/25.00%/6.25%}, more preferably {31.60%/42.20%/21.10%/4.70%/0.40%} to {6.25%/25.00%/37.50%/25.00%/6.25%}, and most preferably {6.25%/25.00%/37.50%/25.00%/6.25%} from the viewpoints of solubility of the phthalocyanine dyes, long-term storage stability of the ink, and the print density on plain paper.

In the dye ink composition according to the present invention, when the compound A to the compound E are used in the ratio described above, the compound A, which has the highest water solubility, and the compound E, which induces the strongest intermolecular interaction, can coexist in an optimal ratio, and physical properties of the resulting ink liquid can be considerably rapidly stabilized compared with inks using existing phthalocyanine dye mixtures. It is inferred that, consequently, the dye ink composition is extremely less likely to undergo physicochemical changes in the physical properties of the liquid and can exhibit high long-term storage stability.

From the viewpoints of the print density on various types of image-receiving paper (ink jet paper and plain paper) and the fastness of dye color images, a ratio of W_{A1} to a total mass of the dye ink composition according to the present invention ({(W_{A1}/total mass of dye ink composition)×100}) or a ratio of W_{A2} to the total mass ({(W_{A2}/total mass of dye ink composition)×100}) is preferably 1.0% by mass or more and 8.0% by mass or less, more preferably 2.0% by mass or more and 6.0% by mass or less, still more preferably 2.5% by mass or more and 6.0% by mass or less, and particularly preferably 3.0% by mass or more and 5.5% by mass or less.

The dye ink composition according to the present invention may further include other components in addition to the compound A to the compound E.

The dye ink composition according to the present invention may include a compound represented by general formula (Cy-1) below.

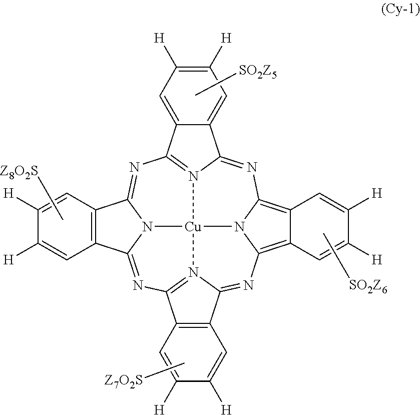

In general formula (Cy-1), Z₅, Z₆, Z₇, and Z₈ each independently represent a substituted or unsubstituted alkyl group, a substituted or unsubstituted aryl group, or a substituted or unsubstituted heterocyclic group. However, at least one of Z₅, Z₆, Z₇, or Z₈ has a substituent that includes an ionic hydrophilic group.

The substituted or unsubstituted alkyl group, the substituted or unsubstituted aryl group, and the substituted or unsubstituted heterocyclic group represented by Z₅, Z₆, Z₇, and Z₈ in general formula (Cy-1) are the same as the substituted or unsubstituted alkyl group, the substituted or unsubstituted aryl group, and the substituted or unsubstituted heterocyclic group, respectively, in Z₁ in general formula (I-1-1) described above.

At least one of Z₅, Z₆, Z₇, or Z₈ has a substituent that includes an ionic hydrophilic group, and the ionic hydrophilic group is the same as the ionic hydrophilic group present in Z₁ in general formula (I-1-1) described above.

The compound represented by general formula (Cy-1) is a phthalocyanine dye in which substituted sulfonyl groups (—SO₂—Z₅, —SO₂—Z₆, —SO₂—Z₇, and —SO₂—Z₈) are introduced to α positions. That is, in general formula (Cy-1), —SO₂—Z₅, —SO₂—Z₆, —SO₂—Z₇, and —SO₂—Z₈ replace hydrogen atoms at α positions but do not replace hydrogen atoms at β positions.

The a positions and the β positions of the phthalocyanine skeleton are as illustrated in formulae (a-1) and (a-2) above.

The compound represented by general formula (Cy-1) can be synthesized by a publicly known method (for example, methods described in JP3949385B and JP4854250B).

Specific examples of the compound represented by general formula (Cy-1) are given below, but are not limited thereto. In structural formulae of specific compounds below, each specific compound is a mixture including positional isomers (refer to (3A) to (3D) below) of substituted sulfonyl groups (Q represents —SO₂—Z₅, —SO₂—Z₆, —SO₂—Z₇, or —SO₂—Z₈). Therefore, the introduction positions of substituents are not specified, and the positional isomers are treated as the same compound. In the specific examples below, hydrogen atoms are illustrated at β positions in each structural formula to indicate that a substituted sulfonyl group replaces any hydrogen atom at an α position but does not replace a hydrogen atom at a β position.

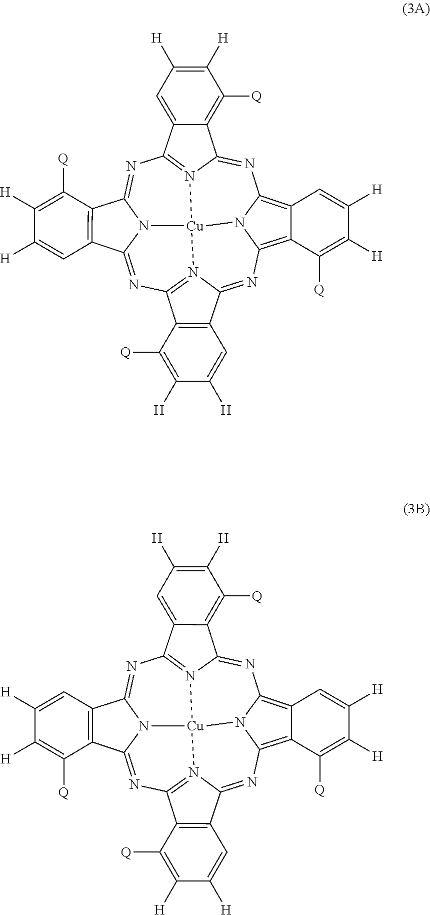

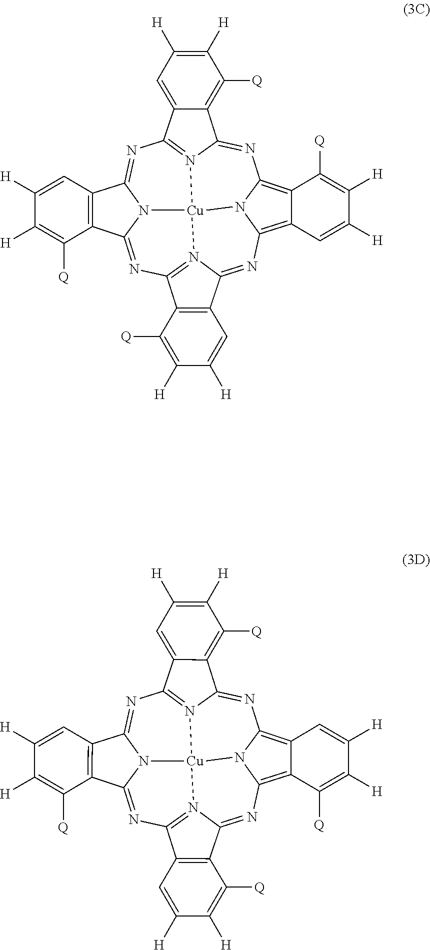

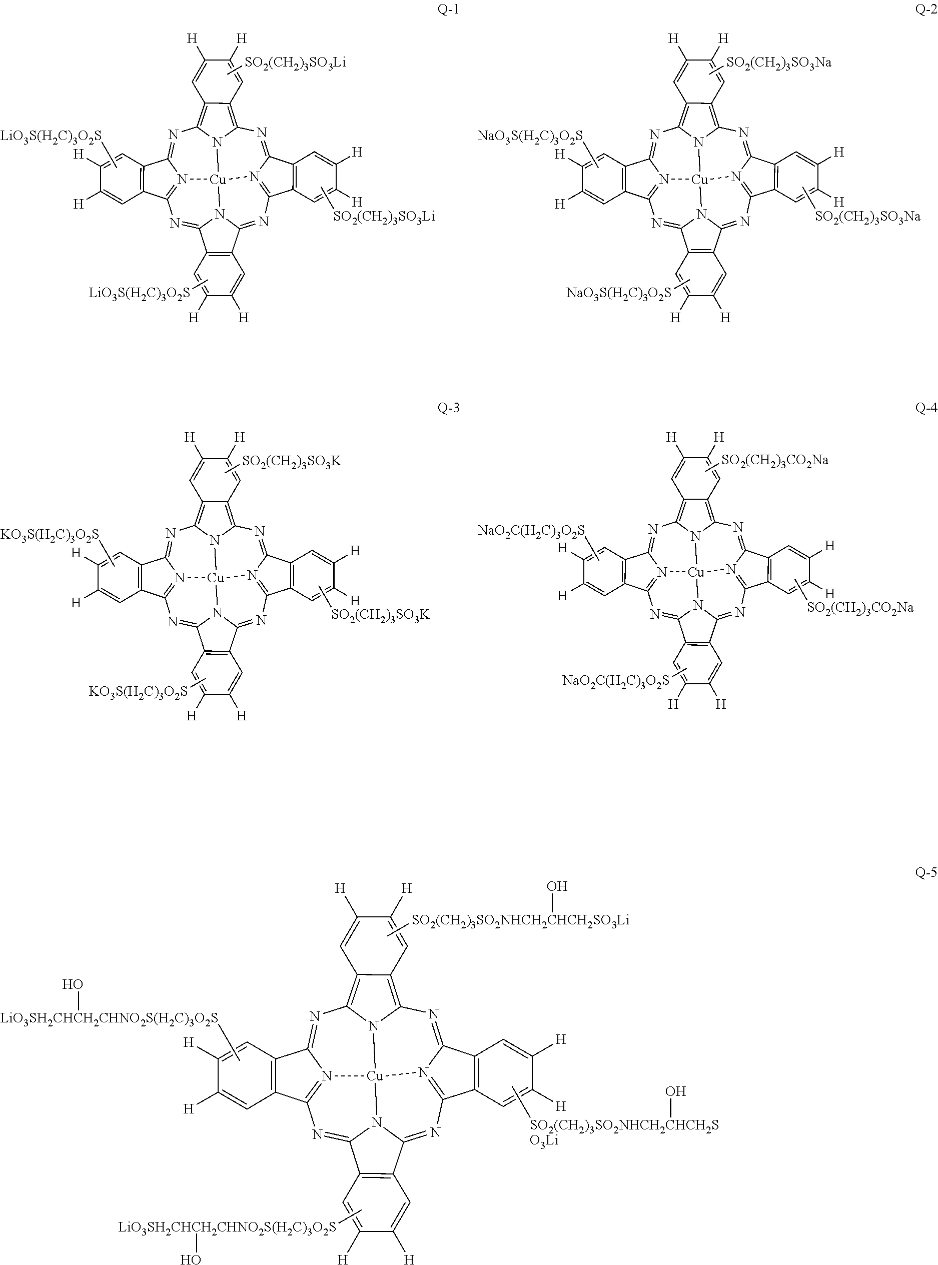

The use of the β-position substituted compound A to compound E and the α-position substituted compound represented by general formula (Cy-1) enables the adjustment of the ratio of α-position substitution and β-position substitution between molecules rather than in a molecule. Consequently, both high print density (on plain paper and on ink jet paper) and good image durability can be achieved at a high level.

The dye ink composition according to the present invention may include a compound (toning agent) represented by any of general formulae (Cy-2) to (Cy-5) below.

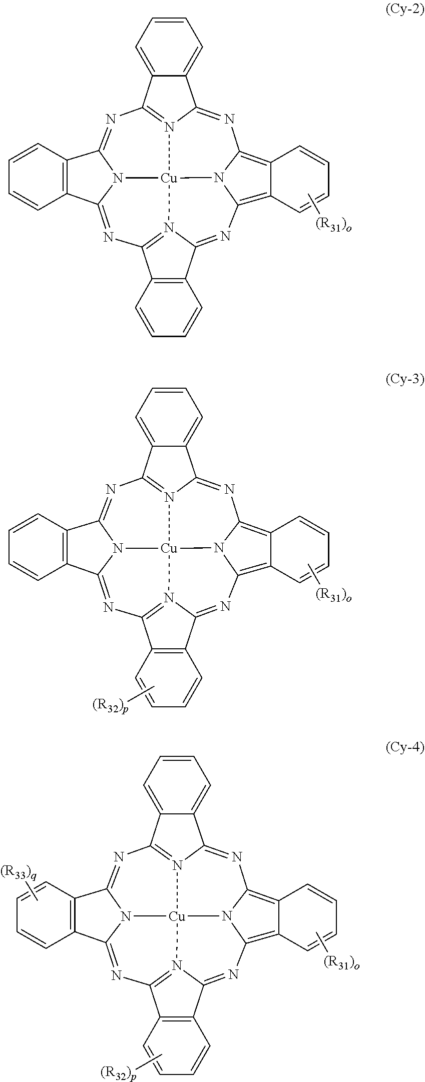

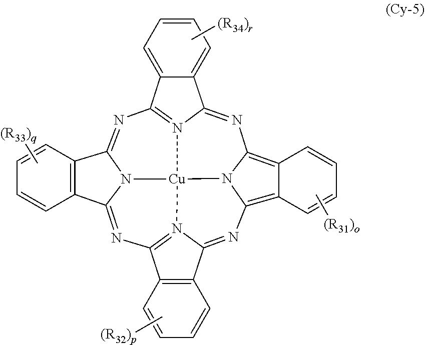

In general formulae (Cy-2) to (Cy-5), R₃₁, R₃₂, R₃₃, and R₃₄ each independently represent a substituted or unsubstituted sulfamoyl group, a substituted or unsubstituted carbamoyl group, a sulfo group, or a carboxy group. In a case where a plurality of R₃₁, R₃₂, R₃₃, or R₃₄ are present, they may be the same or different. o, p, q, and r each independently represent an integer of 1 to 4.

The compound represented by any of general formulae (Cy-2) to (Cy-5) is an α-position/β-position substitution mixture (for example, α-position/β-position≈10%/90% to 50%/50%) in which there is no selectivity of the introduction positions of substituents with regard to the α positions and the β positions of the phthalocyanine dye skeleton illustrated in formulae (a-1) and (a-2) above.

In general formulae (Cy-2) to (Cy-5), R₃₁, R₃₂, R₃₃, and R₃₄ may each be independently a substituted or unsubstituted sulfamoyl group, a substituted or unsubstituted carbamoyl group, a sulfo group (—SO₃M), or a carboxy group (—CO₂M) from the viewpoints of availability of raw materials and the ease of synthesis, are preferably each independently a substituted sulfamoyl group (—SO₂NR₄₁R₄₂: where R₄₁ and R₄₂ each independently represent a hydrogen atom or a substituent, provided that at least one of R₄₁ or R₄₂ represents a substituent), an unsubstituted sulfamoyl group (—SO₂NH₂), or a sulfo group (—SO₃M) from the viewpoints of water solubility and image durability, and are more preferably a mixture of a substituted sulfamoyl group (—SO₂NHR₄₂: where R₄₂ represents a substituent that includes an ionic hydrophilic group), an unsubstituted sulfamoyl group (—SO₂NH₂), and a sulfo group (—SO₃M) from the viewpoints of water solubility and image durability. The substituent may be an alkyl group or an aryl group. The ionic hydrophilic group is the same as the ionic hydrophilic group present in Z₁ in general formula (I-1-1) described above.

When R₃₁, R₃₂, R₃₃, and R₃₄ in general formulae (Cy-2) to (Cy-5) represent a sulfo group (—SO₃M) or a carboxy group (—CO₂M), M represents a hydrogen atom or a counter cation. M is the same as M in —SO₃M or —CO₂M serving as an ionic hydrophilic group present in Z₁ in general formula (I-1-1) described above.

o, p, q, and r each independently represent an integer of 1 to 4, preferably 1 to 3, more preferably 1 or 2, and most preferably 1. A mixture of general formulae (Cy-2), (Cy-3), (Cy-4), and (Cy-5) is preferred from the viewpoint of availability of a dye serving as a coloring agent. Examples of the specific compound include C.I. Direct Blue 86, C.I. Direct Blue 87, and C.I. Direct Blue 199.

Compounds (phthalocyanine derivatives) represented by general formulae (Cy-2) to (Cy-5) can be synthesized, for example, on the basis of methods described in, for example, “Phthalocyanine—Chemistry and Function—” written by Shirai and Kobayashi, published by IPC, pp. 1 to 62 and “Phthalocyanines—Properties and Applications” written by C. C. Leznoff and A. B. P. Lever, published by VCH, pp. 1 to 54.

The dye ink composition according to the present invention may further include dyes below. Note that “C.I.” is an abbreviation of “color index”.

C.I. Direct Blue: 6, 22, 25, 71, 78, 90, 106, 189, 262, 264, 276, 282, 314, etc.

C.I. Acid Blue: 9, 22, 40, 59, 93, 102, 104, 113, 117, 120, 167, 185, 197, 224, 228, 229, 234, 242, 243, 249, 254, 275, 279, 283, 310, 357, etc.

When the dye ink composition according to the present invention includes, as a coloring agent, a compound represented by any of general formulae (Cy-1) to (Cy-5), another phthalocyanine dye or a partial azaphthalocyanine dye, or a triarylmethane dye in addition to the compound A to the compound E, the total content (% by mass) of all coloring agents in the dye ink composition is preferably 1.0% by mass or more and 8.0% by mass or less, more preferably 2.0% by mass or more and 6.0% by mass or less, still more preferably 3.0% by mass or more and 6.0% by mass or less, and most preferably 3.0% by mass or more and 5.5% by mass or less with respect to the total mass of the dye ink composition from the viewpoints of print density, continuous ejection stability, and storage stability.

A ratio (W_{A1}/W_{B}/W_{C}/W_{D}) or (W_{A2}/W_{B}/W_{C}/W_{D}) of a total mass (total content based on the mass) W_{A1} of the compound A to the compound D included in the dye ink composition according to the present invention or a total mass (total content based on the mass) W_{A2} of the compound A to the compound E, a mass (content based on the mass) W_{B} of the dye represented by general formula (Cy-1) above, a mass (content based on the mass) W_{C} of the dye represented by general formula (Cy-2) above, and a total mass (total content based on the mass) W_{D} of the compounds represented by general formulae (Cy-3) to (Cy-5) above is preferably 45 to 100/0 to 35/0 to 10/0 to 10, more preferably 50 to 100/0 to 35/0 to 10/0 to 5, still more preferably 55 to 100/0 to 35/0 to 10/0 to 5, particularly preferably 60 to 100/0 to 35/0 to 10/0, and most preferably 60 to 100/0 to 30/10/0 from the viewpoint of achieving both print density on plain paper and image fastness on ink jet paper.

When the ratio W_{A1}/W_{B}/W_{C}/W_{D} or W_{A2}/W_{B}/W_{C}/W_{D} is within the range described above, it is possible to obtain the effect of satisfying, at a high level, required performances such as good long-term temporal stability (e.g., change in viscosity, change in surface tension, or reduction in precipitate) of the ink, high print density (print density on ink jet paper and plain paper), a reduction in bronze luster, and high image durability (in particular, ozone resistance and light resistance on an ink jet paper).

The dye ink composition according to the present invention can be used as a cyan dye ink. The dye ink composition according to the present invention can be used to produce a cyan dye ink.

A cyan dye ink according to the present invention preferably has the dye ink composition according to the present invention.

### Compound Represented by General Formula (II)

The dye ink composition according to the present invention preferably includes a compound represented by general formula (II) below.

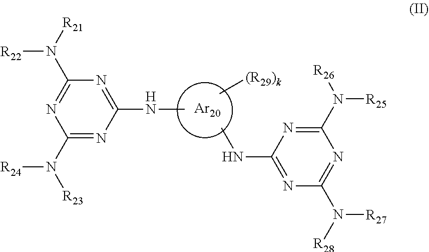

In general formula (II), Ara) represents a benzene ring or a naphthalene ring. R₂₁ to R₂₈ each independently represent a hydrogen atom or a substituent. R₂₁ and R₂₂ may be linked to each other to form a ring. R₂₃ and R₂₄ may be linked to each other to form a ring. R₂₅ and R₂₆ may be linked to each other to form a ring. R₂₇ and R₂₈ may be linked to each other to form a ring. R₂₉ represents a substituent. In a case where Ar₂₀ represents a benzene ring, k represents an integer of 0 to 4. In a case where Ar₂₀ represents a naphthalene ring, k represents an integer of 0 to 6. In a case where a plurality of R₂₉ are present, the plurality of R₂₉ may be the same or different. In a case where a plurality of R₂₉ are present, the plurality of R₂₉ may be linked together to form a ring. However, at least any one of R₂₁ to R₂₉ has a hydrophilic group.

The compound represented by general formula (II) is a compound having high planarity, and the inventors of the present invention have found that when this compound is added to the dye ink composition (phthalocyanine dye ink composition) according to the present invention, in an image immediately after being formed by the ink jet recording method, the print density, continuous ejection stability, and storage stability are further improved by the effect of the intermolecular interaction between the dye mixture constituted by the compound A to the compound E and the compound represented by general formula (II).

The compound represented by general formula (II) is preferably a colorless, water-soluble planar compound having more than 10 delocalized π electrons in one molecule.

When the number of π electrons constituting the delocalized π-electron system increases and the π-electron system extends, compounds often have an absorption in the visible range. In the present invention, “colorless” also includes a state of being very slightly colored within a range that does not affect an image. The water-soluble compound represented by general formula (II) may be a fluorescent compound, but is preferably a non-fluorescent compound, more preferably a compound having an absorption peak wavelength (λmax) of 350 nm or less, still more preferably 320 nm or less on the longest wavelength side and having a molar absorption coefficient of 10,000 or less.

The upper limit of the number of delocalized it electrons in one molecule of the compound represented by general formula (II) is not particularly limited, but is preferably 80 or less, more preferably 50 or less, and particularly preferably 30 or less. More than 10 π electrons may form a single large delocalization system or may form two or more delocalization systems. In particular, a compound having three or more aromatic rings in one molecule is preferred. The aromatic rings may be aromatic hydrocarbon rings or aromatic heterocyclic rings including heteroatoms, or may be fused together to form a single aromatic ring. Examples of the aromatic rings include a benzene ring, a naphthalene ring, an anthracene ring, a pyridine ring, a pyrimidine ring, a pyrazine ring, and a triazine ring.

The compound represented by general formula (II) is preferably water-soluble and is preferably a compound that dissolves in an amount of at least 1 g or more in 100 g of water at 20° C. The compound represented by general formula (II) is more preferably a compound that dissolves in an amount of 5 g or more, and most preferably a compound that dissolves in an amount of 10 g or more.

In general formula (II), R₂₁ to R₂₈ each independently represent a hydrogen atom or a substituent. Examples of the substituent include halogen atoms, substituted or unsubstituted alkyl groups, substituted or unsubstituted alkenyl groups, substituted or unsubstituted alkynyl groups, substituted or unsubstituted aryl groups, substituted or unsubstituted heterocyclic groups, a cyano group, a hydroxy group, a nitro group, substituted or unsubstituted alkyloxy groups, substituted or unsubstituted aryloxy groups, substituted or unsubstituted heterocyclic oxy groups, substituted or unsubstituted alkylcarbonyl groups, substituted or unsubstituted alkylcarbonyloxy groups, substituted or unsubstituted alkyloxycarbonyl groups, substituted or unsubstituted arylcarbonyl groups, substituted or unsubstituted arylcarbonyloxy groups, substituted or unsubstituted aryloxycarbonyl groups, substituted or unsubstituted carbamoyl groups, substituted or unsubstituted carbamoyloxy groups, substituted or unsubstituted amino groups, substituted or unsubstituted mercapto groups, substituted or unsubstituted alkylthio groups, substituted or unsubstituted arylthio groups, substituted or unsubstituted heterocyclic thio groups, substituted or unsubstituted sulfamoyl groups, substituted or unsubstituted alkylsulfinyl groups, substituted or unsubstituted arylsulfinyl groups, substituted or unsubstituted alkylsulfonyl groups, substituted or unsubstituted arylsulfonyl groups, substituted or unsubstituted phosphino groups, substituted or unsubstituted phosphinyl groups, substituted or unsubstituted silyl groups, substituted or unsubstituted silyloxy groups, and ionic hydrophilic groups. When these substituents can further have at least one substituent, groups having, as the additional substituent, a substituent selected from the group consisting of the aforementioned substituents are also included in the examples of the substituent.

R₂₁ to R₂₈ preferably each independently represent a hydrogen atom or a substituted or unsubstituted alkyl group. The alkyl group is preferably an alkyl group having 1 to 12 carbon atoms, more preferably an alkyl group having 1 to 8 carbon atoms, and most preferably an alkyl group having 1 to 6 carbon atoms. The alkyl group preferably has, as a substituent, a hydrophilic group described later from the viewpoint of preservation stability of the dye ink composition.

R₂₁ and R₂₂, R₂₃ and R₂₄, R₂₅ and R₂₆, and R₂₇ and R₂₈ may each be linked to each other to form a ring. The ring is not particularly limited, may be an aromatic ring or a non-aromatic ring, and is preferably a five-membered ring or a six-membered ring. The ring may include a heteroatom (such as an oxygen atom, a nitrogen atom, or a sulfur atom) besides the nitrogen atoms to which R₂₁ to R₂₈ are linked.

R₂₉ represents a substituent, and examples of the substituent are the same as those that have been described as the substituent when R₂₁ to R₂₈ each represent a substituent.

R₂₉ preferably represents an ionic hydrophilic group or a substituted or unsubstituted alkyl group. The alkyl group is preferably an alkyl group having 1 to 12 carbon atoms, more preferably an alkyl group having 1 to 8 carbon atoms, and most preferably an alkyl group having 1 to 6 carbon atoms.

In a case where a plurality of R₂₉ are present, the plurality of R₂₉ may be the same or different. In a case where a plurality of R₂₉ are present, the plurality of R₂₉ may be linked together to form a ring. The ring is not particularly limited, may be an aromatic ring or a non-aromatic ring, and is preferably a five-membered ring or a six-membered ring. The ring may include a heteroatom (such as an oxygen atom, a nitrogen atom, or a sulfur atom).

At least any one of R₂₁ to R₂₉ has a hydrophilic group. The compound represented by general formula (II) particularly preferably has at least two hydrophilic groups.

The hydrophilic groups can be easily selected as substituents from the I/O calculated value of {O: organic value} and {I: inorganic value} outlined in Shin Yuuki Gainen Zu-Kiso to Ouyo- (New Edition of Organic Conceptual Diagram—Fundamentals and Applications—) (SANKYO SHUPPAN Co., Ltd.), the logP value (usually, the partition coefficient P of molecules in the 1-octanol/water system), which is widely used as the value of the hydrophobic parameter of compounds in the fields of chemistry/medical and pharmaceutical science, or the calculated value thereof, i.e., the ClogP value, and the acid dissociation constant (pKa value) of a functional group. The hydrophilic groups are also preferably “strongly hydrophilic groups” and “groups that are not very strongly hydrophilic” in the description of “hydrophilic groups” of Kagaku Daijiten (Encyclopedic Dictionary of Chemistry), Fourth edition, (KYORITSU SHUPPAN Co., Ltd.). Since the dye ink composition (ink jet ink) according to the present invention is preferably used in a basic form, a hydrophilic group that has a high acid dissociation constant (pKa value) (group that is not very strongly hydrophilic) is also applicable. Specifically, such a group may be —NH₂, —OH, or —CO₂H (or an alkali metal salt of a carboxy group).

Examples of more preferred hydrophilic groups include, but are not limited to, a hydroxy group, alkylcarbonylamino groups, arylcarbonylamino groups, alkylsulfonylamino groups, arylsulfonylamino groups, and quaternary ammonium groups, in addition to ionic hydrophilic groups. The hydrophilic group is preferably an ionic hydrophilic group, more preferably a sulfo group (—SO₃M) or a carboxy group (—CO₂M), and most preferably a sulfo group (—SO₃M). The ionic hydrophilic group is the same as the ionic hydrophilic group present in Z₁ in general formula (I-1-1) described above.

M represents a hydrogen atom or a counter cation. M is the same as M in —SO₃M or —CO₂M serving as an ionic hydrophilic group present in Z₁ in general formula (I-1-1) described above.

The compound represented by general formula (II) preferably has 1 to 10 hydrophilic groups and more preferably has 2 to 8 hydrophilic groups in one molecule.

The compound represented by general formula (II) preferably has 2 to 6 ionic hydrophilic groups and more preferably has 2 to 4 ionic hydrophilic groups in one molecule.

At least any one of R₂₁ to R₂₉ in general formula (II) preferably has an ionic hydrophilic group and more preferably has —SO₃M. Still more preferably, 2 to 6 of R₂₁ to R₂₉ have —SO₃M, and particularly preferably, 2 to 4 of R₂₁ to R₂₉ have —SO₃M.

In general formula (II), Ar₂₀ represents a benzene ring or a naphthalene ring and preferably represents a benzene ring.

In a case where Ar₂₀ represents a benzene ring, k represents an integer of 0 to 4 and is preferably an integer of 0 to 2, and more preferably 0 or 1.

In a case where Ar₂₀ represents a naphthalene ring, k represents an integer of 0 to 6 and is preferably an integer of 0 to 4, more preferably an integer of 0 to 2, and still more preferably 0 or 1.

Specific examples of the compound represented by general formula (II) are shown below but are not limited thereto.

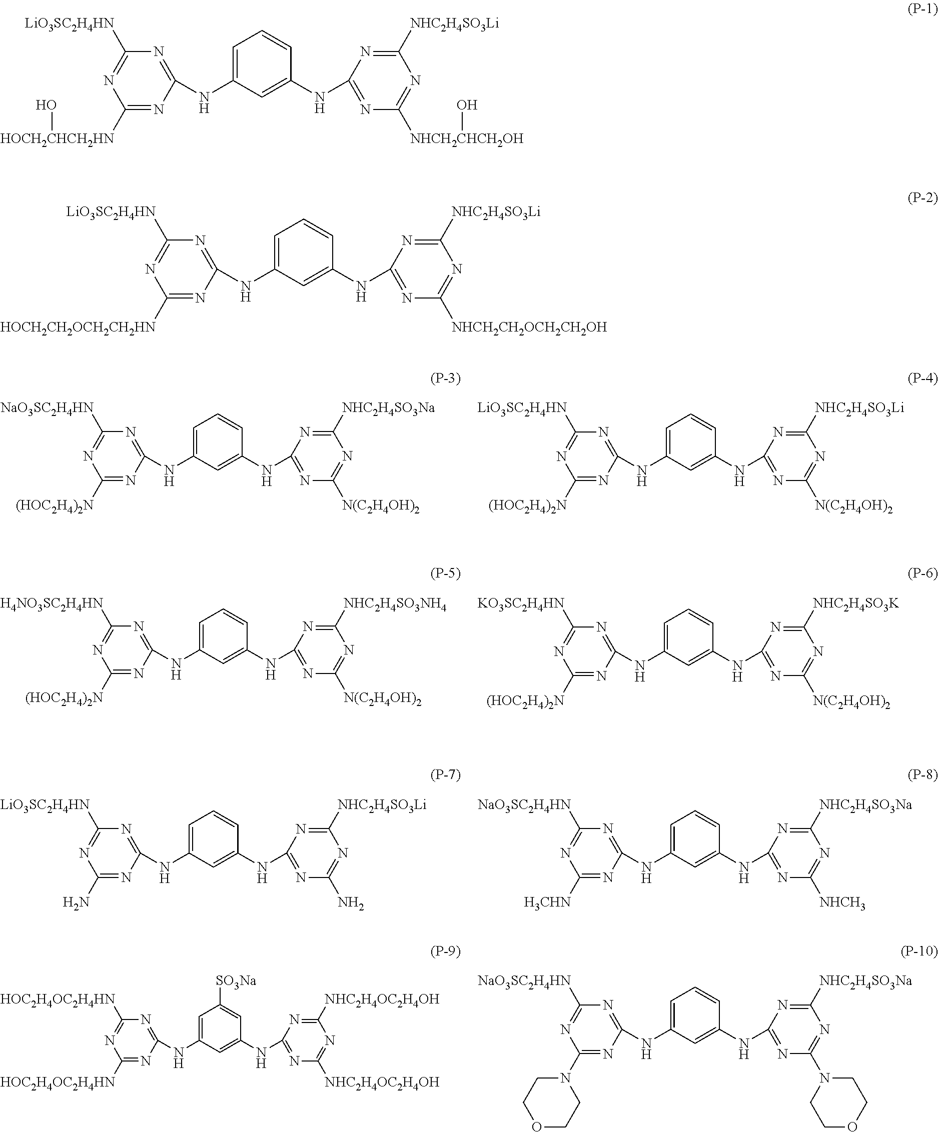

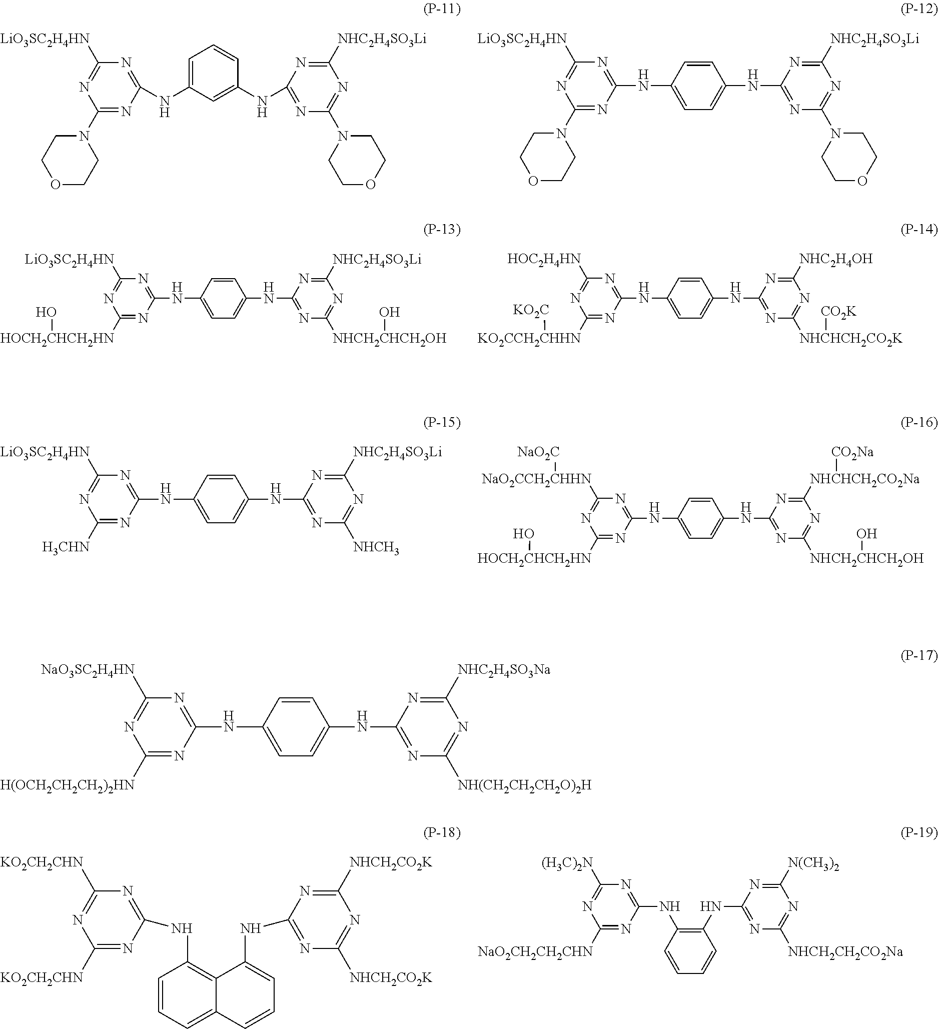

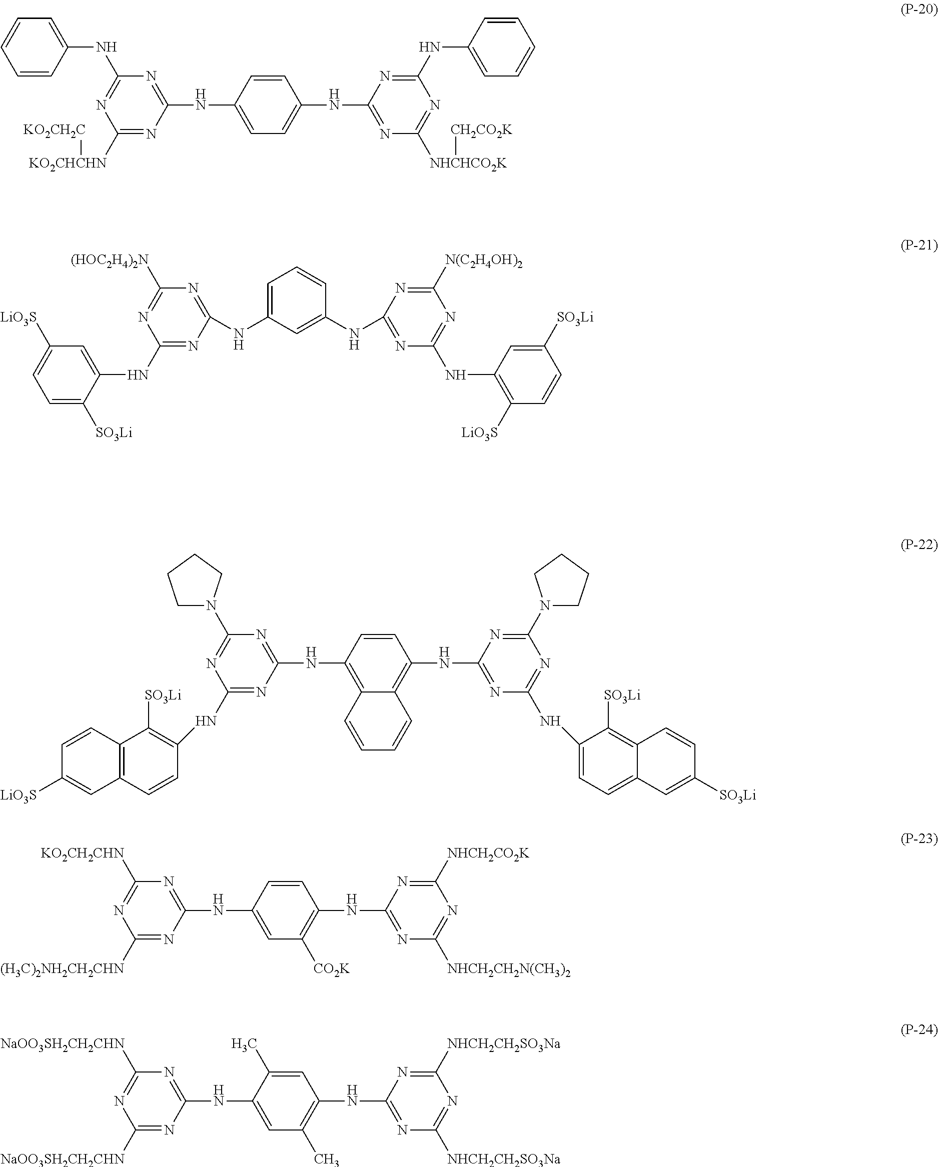

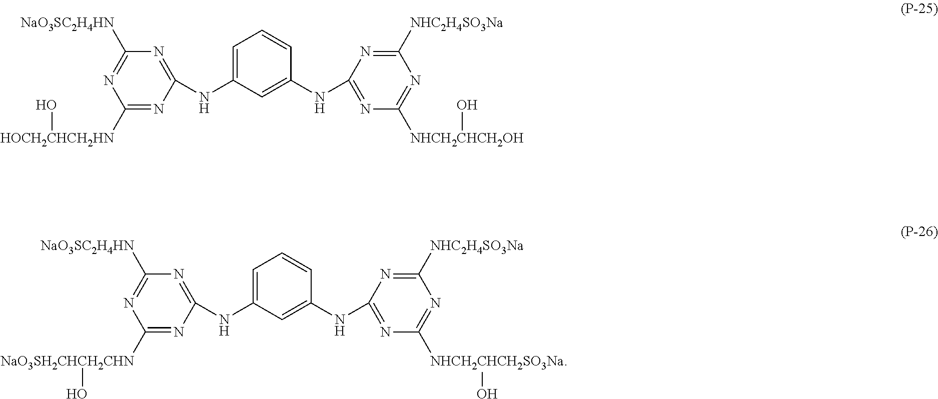

The content of the compound represented by general formula (II) in the dye ink composition according to the present invention is preferably 0.1% to 10.0% by mass, more preferably 0.3% to 5.0% by mass, still more preferably 0.5% to 4.0% by mass, particularly preferably 0.5% to 3.5% by mass, even still more preferably 0.5% to 3.0% by mass, and most preferably 0.5% to 2.5% by mass with respect to the total mass of the dye ink composition. When the content of the compound represented by general formula (II) is within the range described above, while continuous ejection reliability of the dye ink composition is ensured, the intermolecular interaction between the compound A to the compound E and the compound represented by general formula (II) that coexist in the dye ink composition is enhanced after the formation of a printed article to thereby reduce association between phthalocyanine dye molecules, and thus the print density (in particular, print density on plain paper) is dramatically improved, and furthermore, the image durability (in particular, ozone resistance and light resistance) can also be satisfied.

The compound represented by general formula (II) can be synthesized by a publicly known method (for example, a method described in JP4686151B).

### Chelating Agent

The dye ink composition according to the present invention may include a chelating agent.

The chelating agent (also referred to as a “chelator”) is a compound that binds to an inorganic or metal cation (particularly preferably, a polyvalent cation) to produce a chelate compound.

In the present invention, the chelating agent has a function of preventing the formation and growth (that is, functions as a solubilizing agent) of insoluble, precipitated foreign matter in the dye ink composition, the foreign matter being derived from an inorganic or metal cation (in particular, a polyvalent cation).

When the dye ink composition according to the present invention includes a chelating agent, the generation of precipitated foreign matter can be reduced even in long-term preservation of the dye ink composition. Consequently, when an image is printed with an ink jet printer by using an ink for ink jet recording, the ink including the dye ink composition after long-term preservation, ink clogging in a nozzle or the like is less likely to occur, and a printed article with a high quality can be obtained.

Recently, inks for ink jet recording have been experiencing a change from cartridge inks to large-volume ink-tank models, and further improvements have been required for storage stability in long-term preservation (print density and continuous ejection stability after long-term preservation). When the dye ink composition according to the present invention includes a chelating agent, the storage stability in long-term preservation can be further improved.

The chelating agent may be any solubilizing agent that forms a complex with a cation present in the dye ink composition by a chelating action to exhibit the effect of reducing the generation and growth of precipitated foreign matter in the dye ink composition, and various types of such chelating agents can be used alone or in combination of two or more thereof. The chelating agent is preferably a water-soluble compound.

Examples of the chelating agent include ethylenediaminetetraacetic acid (EDTA) and salts thereof (e.g., EDTA-4 sodium (tetrasodium salt) and EDTA-4 lithium (tetralithium salt)), picolinic acid and salts thereof (e.g., picolinic acid sodium salt), quinolinic acid and salts thereof (e.g., quinolinic acid sodium salt), 1,10-phenanthroline, 8-hydroxyquinoline, 3-hydroxy-2,T-iminodisuccinic acid tetrasodium salt, methylglycinediacetic acid (MGDA) and salts thereof, L-glutamic acid diacetic acid (GLDA) and salts thereof, L-aspartic acid diacetic acid (ASDA) and salts thereof, hydroxyethyliminodiacetic acid (HIDA) and salts thereof, 3-hydroxy-2,2′-iminodisuccinic acid (HIDS) and salts thereof, dicarboxymethyl glutamic acid (CMGA) and salts thereof, and (S,S)-ethylenediaminedisuccinic acid (EDDS) and salts thereof. The salts among the above chelating agents are preferably, for example, salts of ammonium, amine, or the like besides salts of a monovalent metal such as sodium, potassium, or lithium. Among the above chelating agents, these exhibit a chelating action that is less likely to decrease with respect to a change in the pH of the dye ink composition. Therefore, the chelating action is exhibited in a wider pH range, and for example, it is possible to further improve the response to a change in the pH of the dye ink composition, such as a change with time.

The content of the chelating agent is preferably 0.001% by mass or more and 1.1% by mass or less, more preferably 0.001% by mass or more and 0.5% by mass or less, still more preferably 0.001% by mass or more and 0.3% by mass or less, and particularly preferably 0.001% by mass or more and 0.1% by mass or less with respect to the total mass of the dye ink composition. In a case where the content is 0.001% by mass or more, the chelating action can be effectively exhibited. In a case where the content is 1.1% by mass or less, it is possible to suppress an excessive increase in the viscosity of the dye ink composition and an excessive increase in the pH thereof due to the addition of the chelating agent.

A ratio of the chelating agent to the coloring agent (content of chelating agent based on mass:content of coloring agent based on mass) in the dye ink composition is preferably in the range of 0.0001:1 to 0.15:1 (chelating agent/coloring agent is preferably from 0.0001 to 0.15). The ratio is more preferably in the range of 0.0001:1 to 0.01:1, and still more preferably in the range of 0.0002:1 to 0.005:1.

A metal that is likely to form a metal salt is a metal that can be mixed during the manufacturing process of a dye or a metal that can be included in an ink container of a dye ink composition and eluted into the dye ink composition. The ratio described above is preferred because the generation of foreign matter that causes clogging of an ink jet head can be effectively suppressed. In addition, the ratio described above is preferred because the chelating action can be effectively exhibited, and an excessive increase in the viscosity of the dye ink composition and an excessive increase in the pH thereof can be suppressed.

An example of the use of the dye ink composition according to the present invention is an image recording material for forming an image. Specific examples thereof include, besides a recording material for an ink jet process described in detail below, a thermal recording material, a pressure-sensitive recording material, a recording material for an electrophotographic process, a transfer-type silver halide photosensitive material, a printing ink, and a recording pen. The use of the dye ink composition is preferably a recording material for an ink jet process, a thermal recording material, or a recording material for an electrophotographic process, and more preferably a recording material for an ink jet process.

The dye ink composition according to the present invention is applicable to a color filter for recording and reproducing a color image used in a solid-state imaging element such as a charge-coupled device (CCD) or a display such as a liquid crystal display (LCD) or a plasma display panel (PDP), or a dyeing solution for dyeing various fibers.

The dye ink composition according to the present invention can be used in such a manner that physical properties, such as solubility, dispersibility, and thermal mobility, suitable for the use thereof are adjusted by the substituents.

The dye ink composition according to the present invention is particularly suitable for a dye ink for ink jet recording.

A dye ink for ink jet recording according to the present invention has the dye ink composition according to the present invention.

The dye ink composition according to the present invention can be produced by using, as a medium, water, further using a lipophilic medium or an aqueous medium, as needed, and dissolving and/or dispersing a coloring agent, a toning agent, and an additive in the media.

Examples of the water include pure water such as deionized water, ion-exchange water, ultrafiltered water, reverse osmosis water, and distilled water; and ultrapure water.

The dye ink composition according to the present invention can include the following organic solvents in addition to water. Examples of organic solvents include alcohols (e.g., methanol, ethanol, propanol, isopropanol, butanol, isobutanol, sec-butanol, t-butanol, pentanol, hexanol, cyclohexanol, and benzyl alcohol); polyhydric alcohols (e.g., ethylene glycol, diethylene glycol, triethylene glycol, polyethylene glycol, propylene glycol, dipropylene glycol, polypropylene glycol, butylene glycol, hexanediol, pentanediol, glycerin, hexanetriol, and thiodiglycol); glycol derivatives (e.g., ethylene glycol monomethyl ether, ethylene glycol monoethyl ether, ethylene glycol monobutyl ether, diethylene glycol monomethyl ether, diethylene glycol monobutyl ether, propylene glycol monomethyl ether, propylene glycol monobutyl ether, dipropylene glycol monomethyl ether, triethylene glycol monomethyl ether, ethylene glycol diacetate, ethylene glycol monomethyl ether acetate, triethylene glycol monoethyl ether, and ethylene glycol monophenyl ether); amines (e.g., ethanolamine, diethanolamine, triethanolamine, N-methyldiethanolamine, N-ethyldiethanolamine, morpholine, N-ethylmorpholine, ethylenediamine, diethylenetriamine, triethylenetetramine, polyethyleneimine, and tetramethylpropylenediamine); and other polar solvents (e.g., formamide, N,N-dimethylformamide, N,N-dimethylacetamide, dimethyl sulfoxide, sulfolane, 2-pyrrolidone, N-methyl-2-pyrrolidone, N-vinyl-2-pyrrolidone, 2-oxazolidone, 1,3-dimethyl-2-imidazolidinone, acetonitrile, and acetone). Two or more organic solvents may be used in combination.

When the dye ink composition according to the present invention includes an organic solvent, the content of the organic solvent is preferably 10% to 55% by mass, more preferably 20% to 50% by mass, and still more preferably 30% to 45% by mass with respect to the total mass of the dye ink composition.

In the dye ink composition according to the present invention, the water content is preferably 40% to 80% by mass, more preferably 45% to 70% by mass, and still more preferably 50% to 60% by mass with respect to the total mass of the dye ink composition from the viewpoints of continuous ejection stability and storage stability of the ink.

The dye ink composition according to the present invention can optionally include other additives as long as the effects of the present invention are not impaired.

Examples of the other additives include publicly known additives (described in JP2003-306623A) such as anti-drying agents (humectants), anti-fading agents, emulsion stabilizers, penetration enhancing agents, ultraviolet absorbers, preservatives, fungicides, pH adjusting agents, surface tension adjusting agents, anti-foaming agents, viscosity modifiers, dispersing agents, dispersion stabilizers, anticorrosives, and betaines. These additives can be added directly to the dye ink composition. The preservatives that can be used are the same as preservatives included in an aqueous dye solution according to the present invention described later.

Examples of the surface tension adjusting agents include nonionic, cationic, and anionic surfactants. Preferred examples of the surfactants include anionic surfactants such as fatty acid salts, alkyl sulfate ester salts, alkyl benzene sulfonates, alkyl naphthalene sulfonates, dialkyl sulfosuccinates, alkyl phosphate ester salts, naphthalene sulfonic acid formalin condensates, and polyoxyethylene alkyl sulfate ester salts; and nonionic surfactants such as polyoxyethylene alkyl ethers, polyoxyethylene alkyl allyl ethers, polyoxyethylene fatty acid esters, sorbitan fatty acid esters, polyoxyethylene sorbitan fatty acid esters, polyoxyethylene alkyl amines, glycerin fatty acid esters, and oxyethylene oxypropylene block copolymers. SURFYNOL (registered trademark) series, which are acetylene-based polyoxyethylene oxide surfactants manufactured by Nissin Chemical Industry Co., Ltd., are also preferably used. In addition, for example, an amine oxide amphoteric surfactant such as N,N-dimethyl-N-alkylamine oxide is also preferable. Furthermore, the agents described as surfactants on pages (37) to (38) of JP1984-157636A (JP-S59-157636A) and the research disclosure No. 308119 (1989) can also be used.

The dye ink composition according to the present invention preferably includes a compound that is represented by general formula (S) and that is preferably included in an aqueous dye solution described later.

### Physical Properties of Dye Ink Composition

The surface tension of the dye ink composition according to the present invention is preferably 10 mN/m or more and 60 mN/m or less, more preferably 20 mN/m or more and 60 mN/m or less, and still more preferably 30 mN/m or more and 40 mN/m or less, at 25° C. When the dye ink composition according to the present invention has a surface tension within the range described above, it is possible to effectively suppress the occurrence of, for example, misdirected ejection (deviation of a landing point of an ink) due to wetting near ejection ports caused when the dye ink composition is used for an ink jet process. The surface tension of the ink can be adjusted by appropriately determining the contents of the surfactant and the like in the dye ink composition. The pH of the dye ink composition according to the present invention is preferably adjusted to a desired value so as to achieve good ejection properties when the dye ink composition is used in an ink jet recording apparatus. The dye ink composition according to the present invention preferably has a viscosity of 1.0 mPa·s or more and 5.0 mPa·s or less, at 25° C.

### Ink Jet Recording Method

An ink jet recording method according to the present invention has a step of ejecting a dye ink for ink jet recording according to the present invention with a recording head for an ink jet process. More specifically, the ink jet recording method according to the present invention is a recording method in which energy is provided to the dye ink for ink jet recording according to the present invention to form an image on a publicly known image-receiving material, that is, plain paper, resin coat paper, ink jet paper described in, for example, JP1996-169172A (JP-H08-169172A), JP1996-27693A (JP-H08-27693A), JP1990-276670A (JP-H02-276670A), JP1995-276789A (JP-H07-276789A), JP1997-323475A (JP-H09-323475A), JP1987-238783A (JP-S62-238783A), JP1998-153989A (JP-H10-153989A), JP1998-217473A (JP-H10-217473A), JP1998-235995A (JP-H10-235995A), JP1998-337947A (JP-H10-337947A), and JP1998-217597A (JP-H10-217597A), a film, paper for common use in electrophotography, a textile, glass, metal, ceramic, or the like.

In the formation of an image, a polymer latex compound may be added for the purpose of providing glossiness and water resistance and improving weather resistance.

The recording process of the ink jet recording method according to the present invention is not limited, and any publicly known process is employed. Examples thereof include a charge control process of utilizing an electrostatic attraction force to eject an ink; a drop-on-demand process (pressure pulse process) using vibration pressure of a piezo element; an acoustic ink jet process including converting electric signals into acoustic beams and applying the acoustic beams to an ink to eject the ink by utilizing the radiation pressure; and a thermal ink jet process including heating an ink to form bubbles and utilizing the generated pressure. The ink jet recording process includes a process including ejecting a plurality of droplets of a low-concentration ink called a photo ink with a small volume, a process in which the image quality is improved by using a plurality of inks having substantially the same hue but different densities, and a process of using a colorless, transparent ink.

In the ink jet recording method according to the present invention, an image can be recorded on a recording medium by ejecting a dye ink for ink jet recording, the dye ink including the above-described dye ink composition according to the present invention, with a recording head for an ink jet process. In addition to the above-described dye ink composition (preferably, a cyan dye ink composition) according to the present invention, a magenta ink composition, a yellow ink composition, and a black ink composition can be used as an ink set.

Since the dye ink composition and the dye ink for ink jet recording according to the present invention have good storage stability, they are applicable to ink jet printers mounting large-volume ink-tanks.

### Aqueous Dye Solution

An aqueous dye solution according to the present invention is

an aqueous dye solution including a preservative,

in which the aqueous dye solution includes

a compound A represented by general formula (I-1-1) or (I-1-2) below,

a compound B represented by general formula (I-2-1) or (I-2-2) below,

at least one of a compound C-I represented by general formula (I-3-1-1) or (I-3-1-2) below or a compound C-II represented by general formula (I-3-2-1) or (I-3-2-2) below, and

a compound D represented by general formula (I-4-1) or (I-4-2) below, and

when a mass of the compound A is represented by W₁, a mass of the compound B is represented by W₂, a sum of a mass of the compound C-I and a mass of the compound C-II is represented by W₃, a mass of the compound D is represented by W₄, and a sum total of WI, W₂, W₃, and W₄ is represented by W_{A1}, a ratio of W_{A1} to a total mass of the aqueous dye solution is 8% to 15% by mass.

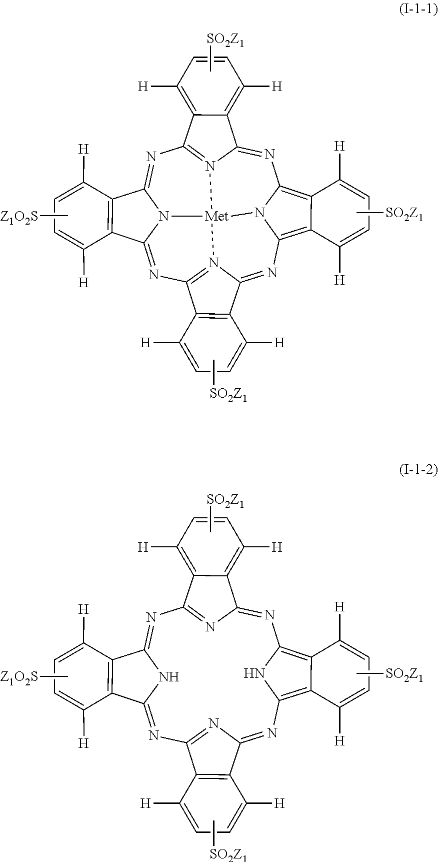

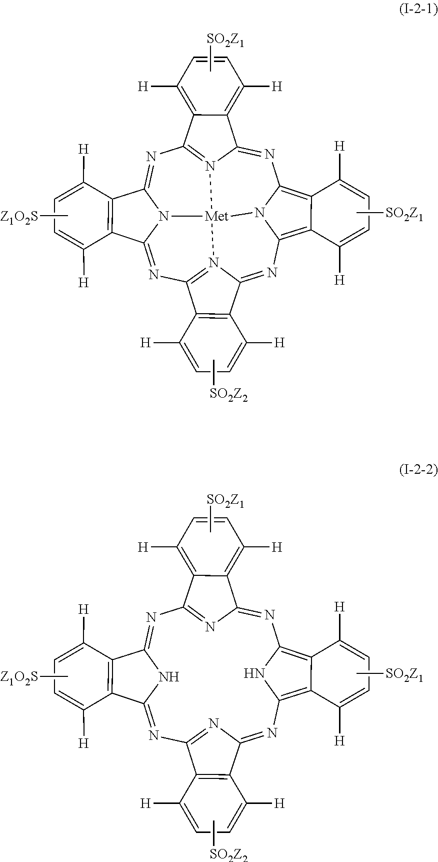

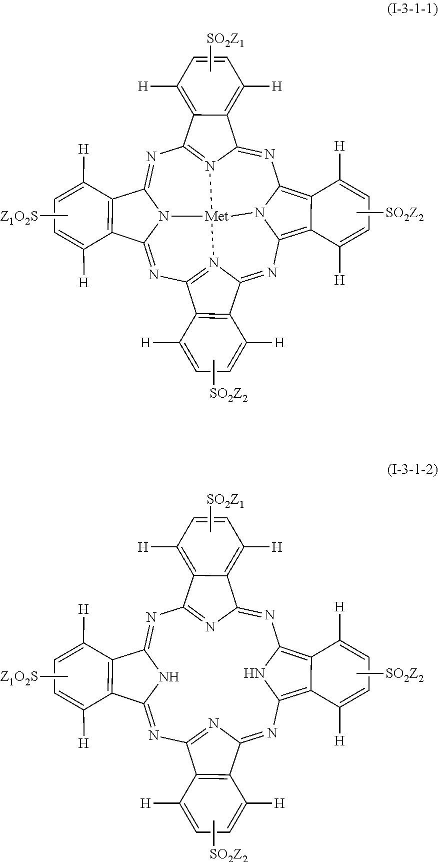

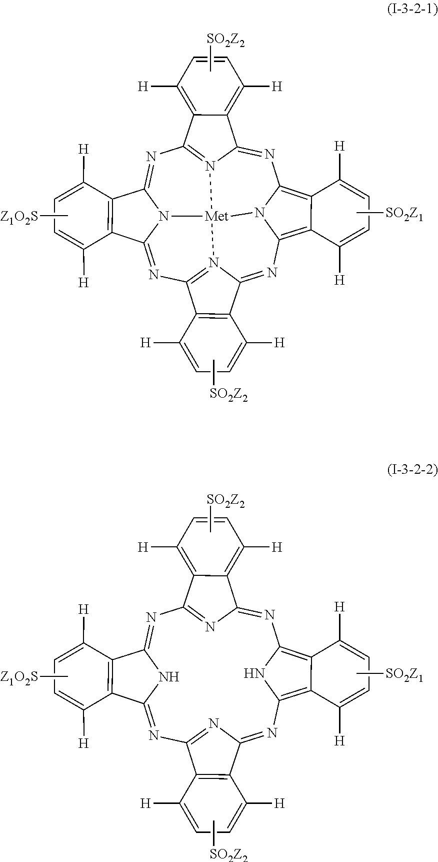

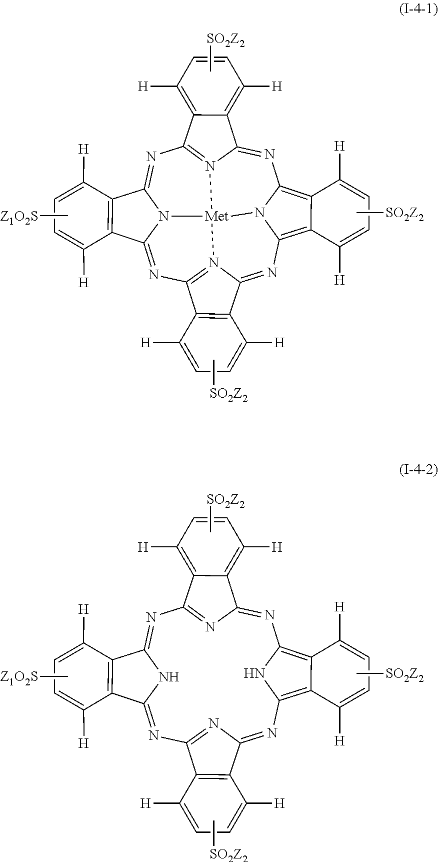

In general formulae (I-1-1), (I-2-1), (I-3-1-1), (I-3-2-1), and (I-4-1), Met represents Al, Fe, Co, Ni, Zn, Mg, or Mn.

In general formulae (I-1-1), (I-1-2), (I-2-1), (I-2-2), (I-3-1-1), (I-3-1-2), (I-3-2-1), (I-3-2-2), (I-4-1), and (I-4-2), Zi represents an alkyl group, aryl group, or heterocyclic group having a substituent that includes at least one ionic hydrophilic group. A plurality of Z₁ in general formulae (I-1-1), (I-1-2), (I-2-1), (I-2-2), (I-3-1-1), (I-3-1-2), (I-3-2-1), and (I-3-2-2) may be the same or different.

In general formulae (I-2-1), (I-2-2), (I-3-1-1), (I-3-1-2), (I-3-2-1), (I-3-2-2), (I-4-1), and (I-4-2), each Z₂ represents a substituted or unsubstituted alkyl group, a substituted or unsubstituted aryl group, or a substituted or unsubstituted heterocyclic group. However, Z₂ does not have an ionic hydrophilic group. A plurality of Z₂ in general formulae (I-3-1-1), (I-3-1-2), (I-3-2-1), (I-3-2-2), (I-4-1), and (I-4-2) may be the same or different.

The aqueous dye solution according to the present invention is preferably the aqueous dye solution further including a compound E represented by general formula (I-5-1) or (I-5-2) below, in which when a mass of the compound E is represented by W₅ and a sum total of W₁, W₂, W₃, W₄, and W₅ is represented by W_{A2}, a ratio of W_{A2} to the total mass of the aqueous dye solution is 8% to 15% by mass.

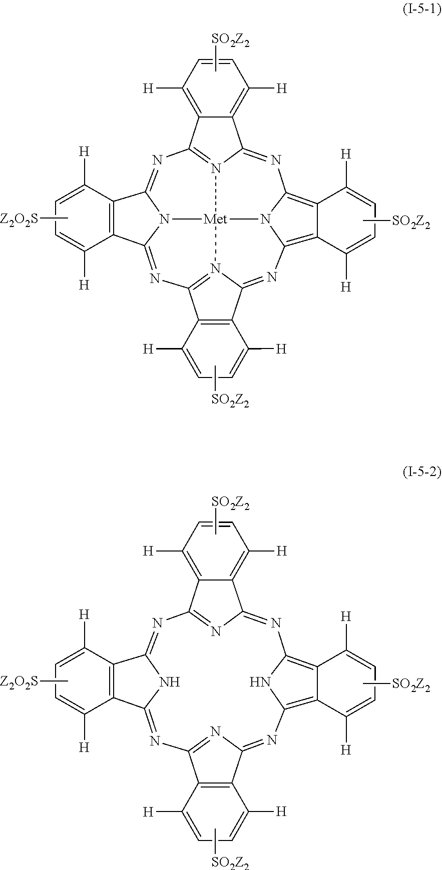

In general formula (I-5-1), Met represents the same as that in general formulae (I-1-1), (I-2-1), (I-3-1-1), (I-3-2-1), and (I-4-1). Each Z₂ represents the same as that in general formulae (I-2-1), (I-2-2), (I-3-1-1), (I-3-1-2), (I-3-2-1), (I-3-2-2), (I-4-1), and (I-4-2). The plurality of Z₂ may be the same or different.

The compound A to the compound E in the aqueous dye solution according to the present invention are the same as those in the foregoing dye ink composition according to the present invention.

In the aqueous dye solution according to the present invention, the ratio of W_{A1} to the total mass of the aqueous dye solution ({(W_{A1}/total mass of aqueous dye solution)×100}) or the ratio of W_{A2} to the total mass of the aqueous dye solution ({(W_{A2}/total mass of aqueous dye solution)×100}) is 8% to 15% by mass, preferably 10% to 15% by mass, and more preferably 10% to 12% by mass. Since the aqueous dye solution according to the present invention includes the compound A to the compound D or the compound A to the compound E in a high concentration, the dye ink composition according to the present invention can be easily prepared by diluting the aqueous dye solution according to the present invention with a solvent (at least one of water or the aforementioned organic solvents).

### Preservative

Next, the preservative will be described.

In the present invention, the preservative refers to an agent having a function of preventing microorganisms, in particular, bacteria and fungi (mold) from generating and growing.

The use of the preservative in the aqueous dye solution according to the present invention enables generation of mold to be reduced even when the aqueous dye solution is preserved for a long period of time. Consequently, when an image is printed with an ink jet printer by using an ink for ink jet recording, the ink including the aqueous dye solution after long-term preservation, ink clogging in a nozzle or the like is less likely to occur, and a printed article with a high quality can be obtained.

Various preservatives can be used as the preservative in the present invention.

Example of the preservative include inorganic preservative including heavy-metal ions and organic preservatives. Various organic preservatives can be used. Examples thereof include quaternary ammonium salts (such as tetrabutylammonium chloride, cetylpyridinium chloride, and benzyltrimethylammonium chloride), phenols (such as phenol, cresol, butylphenol, xylenol, and bisphenol), phenoxy ether derivatives (such as phenoxyethanol), heterocyclic compounds (such as benzotriazole, 1,2-benzisothiazolin-3-one, sodium dehydroacetate, and PROXEL (registered trademark) series manufactured by LONZA), alkane diols (such as pentylene glycol (1,2-pentanediol), isopentyldiol (3-methyl-1,3-butanediol), hexanediol (such as (1,2-hexanediol), and caprylyl glycol (1,2-octanediol)), acid amides, carbamic acid, carbamates, amidines/guanidines, pyridines (such as sodium pyridinethione-1-oxide), diazines, triazines, pyrroles/imidazoles, oxazoles/oxazines, thiazoles/thiadiazines, thioureas, thiosemicarbazides, dithiocarbamates, sulfides, sulfoxides, sulfones, sulfamides, antibiotic substances (such as penicillin and tetracycline), aromatic carboxylic acids and salts thereof (such as sodium benzoate), and aromatic carboxylic acid esters and salts thereof (such as p-hydroxybenzoic acid ethyl ester).

The preservative is preferably at least one selected from the group consisting of heterocyclic compounds, phenols, phenoxy ether derivatives, and alkane diols, and more preferably a heterocyclic compound.

Preservatives described in, for example, Bokin Bobai Handbook (Antibacterial and antifungal handbook) (GIHODO SHUPPAN Co., Ltd.: 1986) and Bokin-bobai-zai Jiten (Encyclopedia of antibacterial and antifungal agents) (edited by encyclopedia editorial committee of The Society for Antibacterial and Antifungal Agents, Japan) can also be used as the preservatives.

Various compounds having, for example, an oil-soluble structure or a water-soluble structure can be used as these compounds; however, these compounds are preferably water-soluble compounds.

The aqueous dye solution according to the present invention may include two or more preservatives.

The heterocyclic compound is preferably a thiazole compound or a benzotriazole compound.

Thiazole compounds particularly function as fungicides among preservatives. Examples of thiazole compounds include benzisothiazoline, isothiazoline, 1,2-benzisothiazolin-3-one, 5-chloro-2-methyl-4-isothiazolin-3-one, 2-(thiocyanomethylthio)benzothiazole, 2-mercaptobenzothiazole, and 3-allyloxy-1,2-benzisothiazole-1,1-oxide. PROXEL (registered trademark) series (such as BDN, BD20, GXL, LV, XL2, XL2(s), and Ultra 10) manufactured by LONZA can also be used as the thiazole fungicides.

Benzotriazole compounds particularly function as anticorrosives among preservatives and can prevent, for example, formation of rust, one cause of which is contact of a metal material (in particular, 42 alloy (nickel-iron alloy containing 42% nickel)) constituting an ink jet head with an ink. Examples of benzotriazole compounds include 1H-benzotriazole, 4-methyl-1H-benzotriazole, 5-methyl-1H-benzotriazole, sodium salts thereof, and potassium salts thereof.

The preservative in the aqueous dye solution according to the present invention can be used in a wide content range. The content of the preservative is preferably 0.001% to 10% by mass, more preferably 0.005% to 2.0% by mass, still more preferably 0.01% to 0.5% by mass, and particularly preferably 0.01% to 0.1% by mass with respect to the total amount of the aqueous dye solution. When the content of the preservative is 0.001% to 10% by mass, the effect of the preservative can be more efficiently obtained, and generation of a precipitate can be reduced.

The aqueous dye solution according to the present invention may further include a chelating agent. The chelating agent that can be used is the same as that described as the chelating agent that may be included in the above-described dye ink composition according to the present invention.

### Compound Represented by General Formula (S)

The aqueous dye solution according to the present invention preferably includes a compound represented by general formula (S) below. The compound represented by general formula (S) is also referred to as a “compound (S)”.

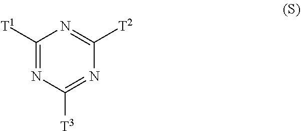

In general formula (S), T¹, T², and T³ each independently represent *-NH—(CH₂)ₙ-Rt, *—NH—(CH₂)ₙ—OH, *—N—((CH₂)ₙ—OH)₂, *—OM, a halogen atom, or a substituted or unsubstituted arylamino group. However, at least one of T¹, T², or T³ represents *—NH—(CH₂)ₙ-Rt, *—NH—(CH₂)ₙ—OH, or *—N—((CH₂)ₙ—OH)₂. * represents a binding site to a triazine ring, n represents an integer of 1 to 5, and Rt represents COOM, SO₃M, or PO(OM)₂. M represents a hydrogen atom or a counter cation. In a case where a plurality of n are present, the plurality of n may be the same or different. In a case where a plurality of M are present, the plurality of M may be the same or different.

In general formula (S), T¹, T², and T³ each independently represent *—NH—(CH₂)ₙ-Rt, *—NH—(CH₂)ₙ—OH, *—N—((CH₂)ₙ—OH)₂, *—OM, a halogen atom, or a substituted or unsubstituted arylamino group. The halogen atom is preferably a chlorine atom. The arylamino group is preferably an arylamino group having 6 to 20 carbon atoms, more preferably an arylamino group having 6 to 10 carbon atoms, and still more preferably a phenylamino group. The arylamino group may have a substituent, and the substituent is not particularly limited but is preferably an amino group.

However, at least one of T¹, T², or T³ represents *—NH—(CH₂)ₙ-Rt, *—NH—(CH₂)ₙ—OH, or *—N—((CH₂)ₙ—OH)₂. One of T¹, T², and T³ may represent *—NH—(CH₂)ₙ-Rt, *—NH—(CH₂)ₙ—OH, or *—N—((CH₂)ₙ—OH)₂, two of T¹, T², and T³ may represent *—NH—(CH₂)ₙ-Rt, *—NH—(CH₂)ₙ—OH, or *—N—((CH₂)ₙ—OH)₂, or all of T¹, T², and T³ may represent *—NH—(CH₂)ₙ-Rt, *13 NH—(CH₂)ₙ—OH, or *—N—((CH₂)ₙ—OH)₂.

M represents a hydrogen atom or a counter cation. A single type of M may be present, or a plurality of types of M may be present. In a case where a plurality of M are present in one compound (S), the plurality of M may be the same or different.

The compound (S) can also be in the form of an inner salt.

M represents a hydrogen atom or a counter cation.

Examples of the counter cation include, but are not particularly limited to, alkali metal ions, an ammonium ion, and organic cations (such as tetramethylammonium, guanidinium, and pyridinium).

M is preferably a hydrogen atom, an alkali metal ion, or an ammonium ion, more preferably an alkali metal ion or an ammonium ion, still more preferably a lithium ion, a sodium ion, or a potassium ion, particularly preferably a lithium ion or a sodium ion, and most preferably a lithium ion.

When M represents a particular cation (e.g., a lithium ion), all M need not necessarily be lithium ions, but substantially, the counter cation having the highest presence ratio is preferably a lithium ion. Under the condition of such a presence ratio, a hydrogen atom, an alkali metal ion (for example, a sodium ion or a potassium ion), an ammonium ion, or the like can be included as M. The amount of lithium ions is preferably 50% or more, more preferably 60% or more, still more preferably 80% or more, and particularly preferably 90% or more relative to the whole of M, and the upper limit thereof is preferably 100%.

The case of a lithium ion also applies to a case where the particular cation represents a cation (e.g., a sodium ion) other than a lithium ion.

The compound (S) is preferably a compound having an ionic hydrophilic group, which increases water solubility, for the purpose of being used as an aqueous solution. Examples of the ionic hydrophilic group include a sulfo group (—SO₃M), a carboxy group (—CO₂M), a phosphate group (—PO(OM)₂), and a hydroxy group (—OM). As the ionic hydrophilic group, a sulfo group (—SO₃M), a carboxy group (—CO₂M), and a hydroxy group (—OM) are preferred, a sulfo group (—SO₃M) and a hydroxy group (—OM) are more preferred, and a sulfo group (—SO₃M) is most preferred. M is as described above. In particular, lithium salts of sulfo groups (—SO₃Li) are preferred because they increase water solubility of the compound and improve solution stability.

The ionic hydrophilic group may be in the form of a free acid, in the form of a salt, or in the form of a mixture of a free acid and a salt.

In the present invention, when a compound is a salt, the salt is present in the water-soluble ink in the form of being dissolved in a state where the salt is completely dissociated into ions. When a compound has an ionic hydrophilic group having a high acid dissociation constant (pKa), the compound may be present in the form of being dissolved in water in a state where most of the compound is dissociated and a part thereof is in a salt (undissociated) state.

The compound represented by general formula (S) is preferably at least one compound selected from the following compound group (s).

The charge positions of a cation and an anion when the compound (S) is in the form of an inner salt are illustrated as an example by a localized chemical structural formula. However, all the canonical chemical structures that can be taken within the scope of common sense in organic chemistry can be included.

Compound Group (s):

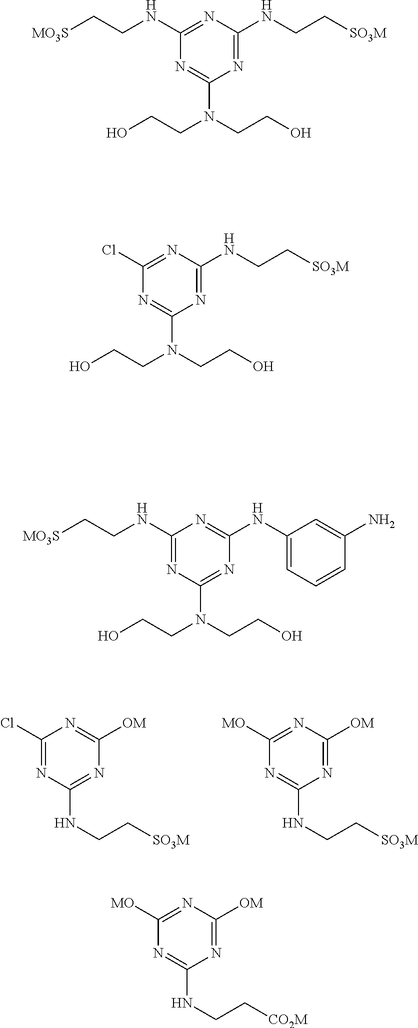

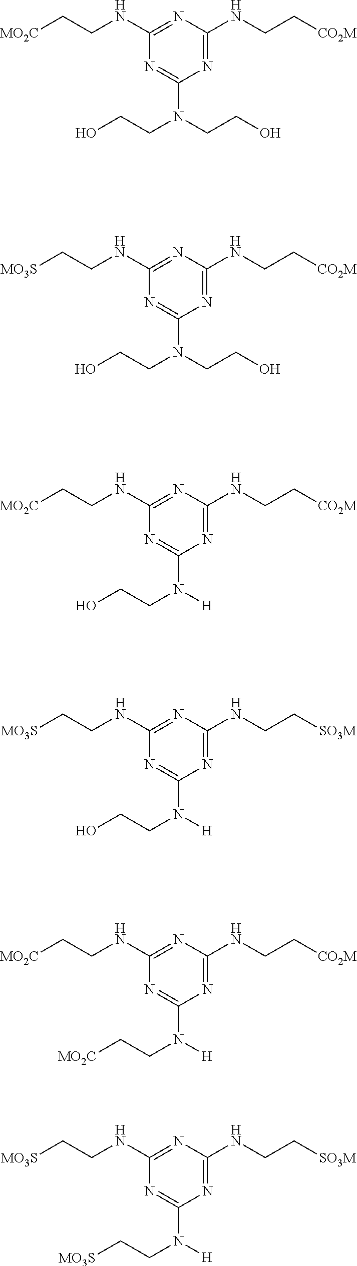

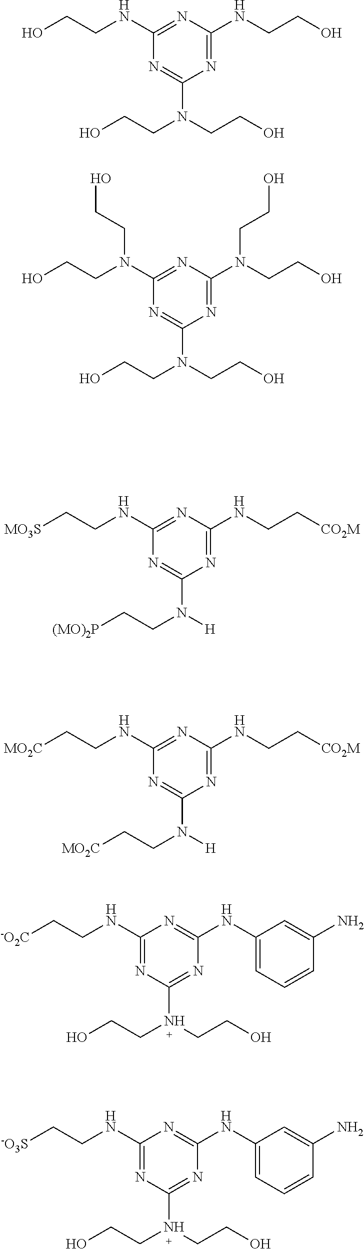

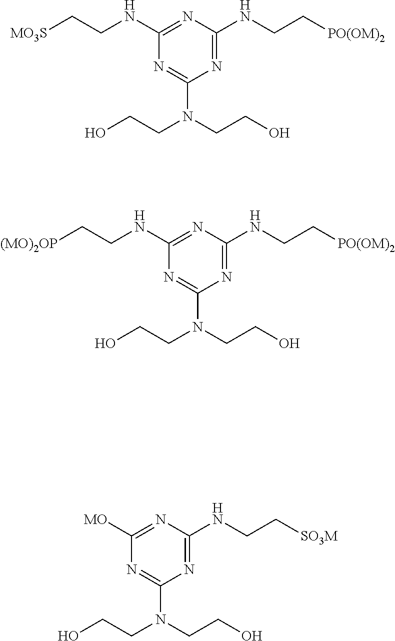

Each M in compounds of the compound group (s) represents a hydrogen atom or a counter cation. In a case where a plurality of M are present in a compound, the plurality of M may be the same or different.

M is as described above.

Preferred specific examples of the compound (S) are shown below but are not limited thereto.

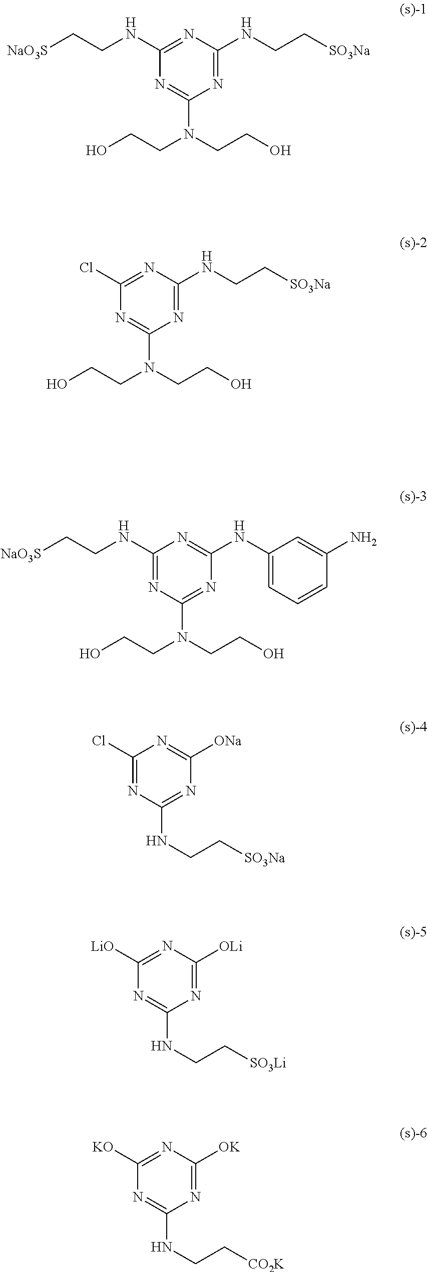

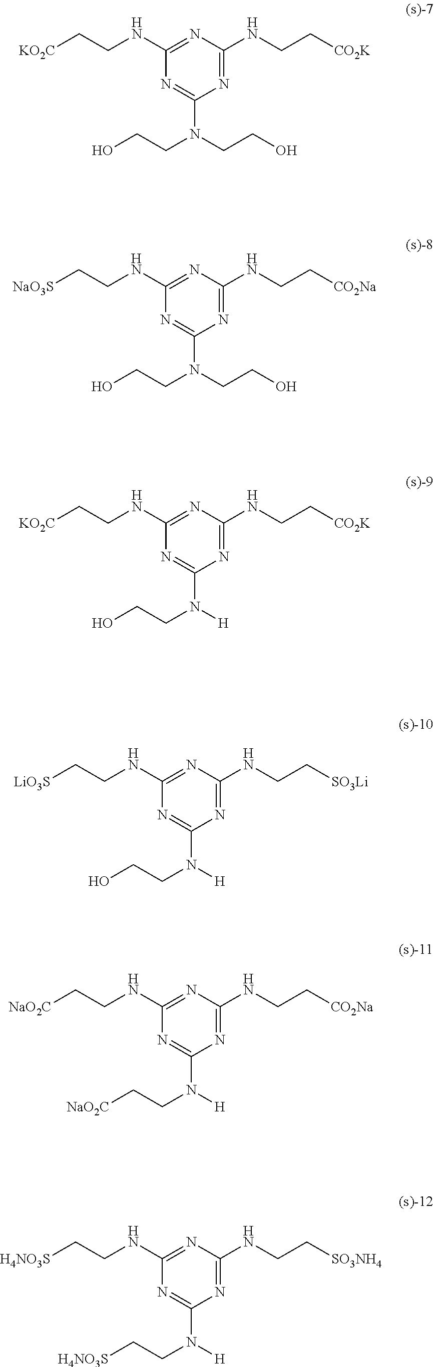

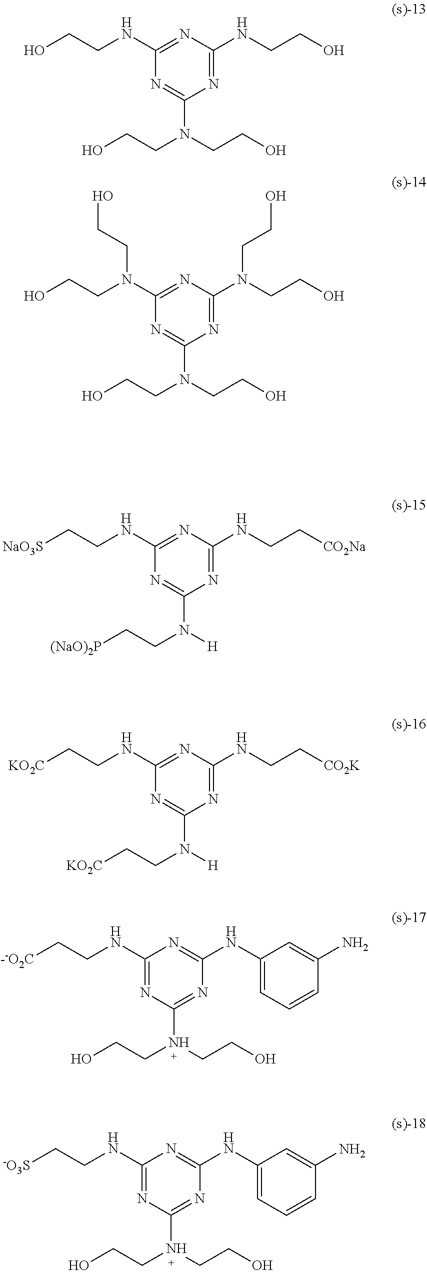

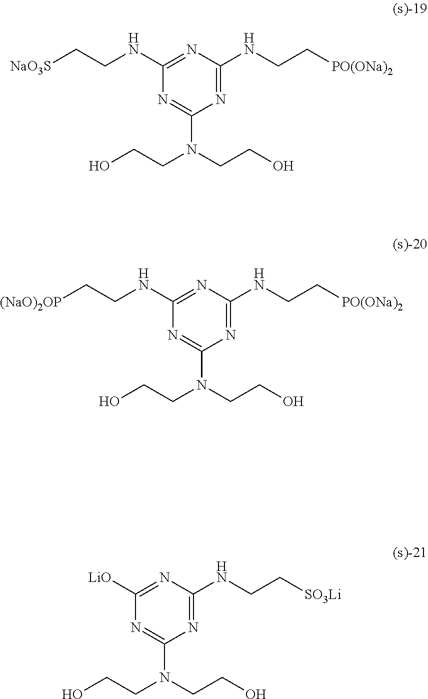

The compound (S) can be easily synthesized, isolated, and purified by using publicly known methods (for example, a method described in JP4686151B) alone or in combination of two or more, and further applying a reverse osmosis membrane purification method, a gel filtration chromatography purification method, and a preparative high-performance liquid chromatography purification method, as needed.

Specific examples of typical synthesis schemes of the compound (S) are shown below, but the synthesis scheme is not limited thereto.

A compound having an s-triazine ring can be easily synthesized using cyanuric chloride as a raw material by a single publicly known method or in combination of a plurality of publicly known methods. Three types of substituents on the s-triazine ring can be introduced with good selectivity according to the reactivity of the three chlorine atoms of cyanuric chloride and the types of substituents to be introduced by a publicly known method (for example, according to the pH value of the system during reaction, the nucleophilicity of the substituents to be introduced, and the order of introduction of the substituents).

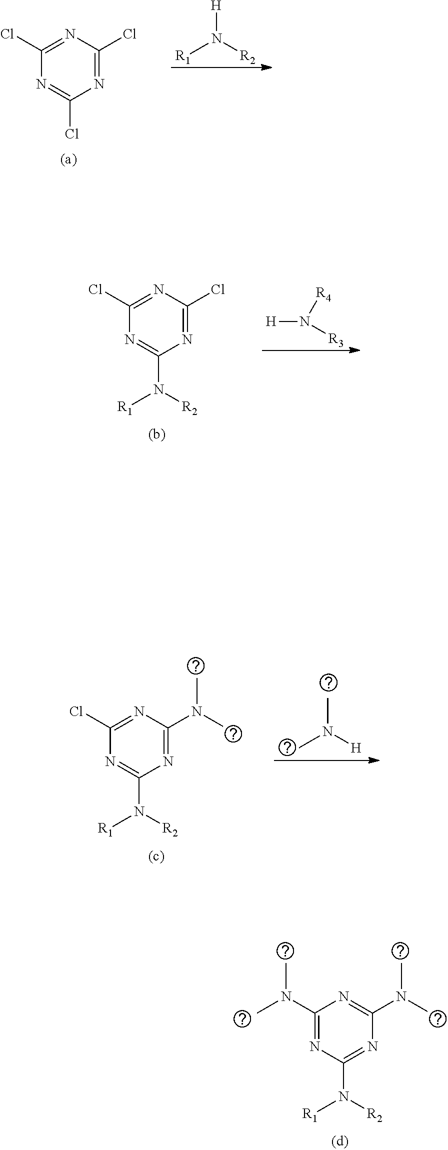

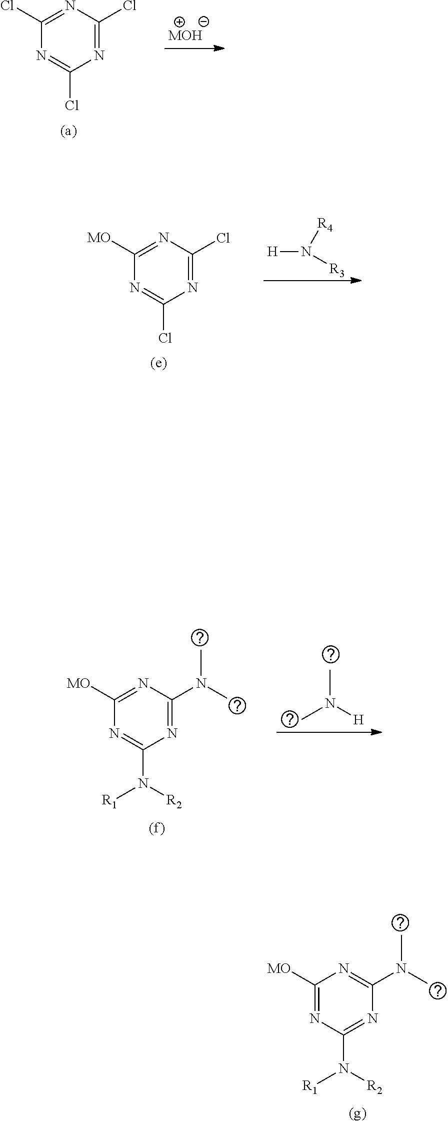

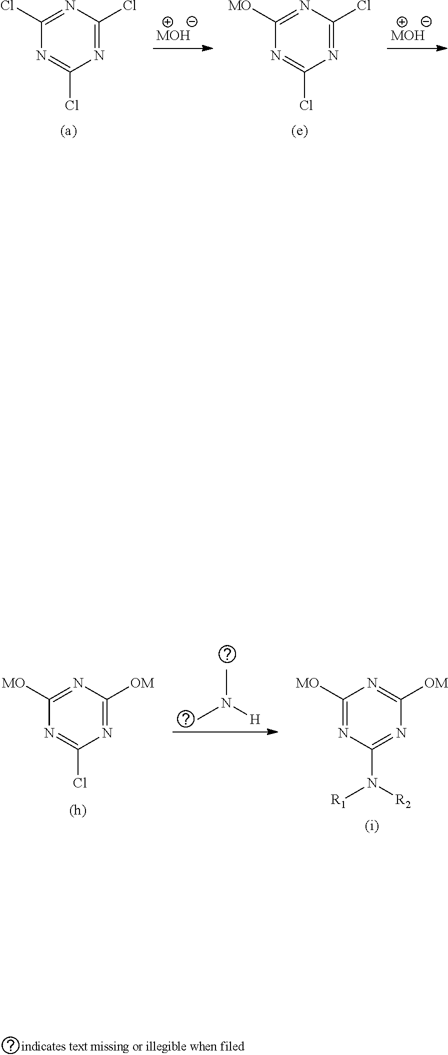

R₁, R₂, R₃, R₄, R₅, and R₆ each independently represent a hydrogen atom or a corresponding substituent in the compound (S). M represents the same meaning as that in the compound (S).

The above compound (s)-2 corresponds to a compound represented by (c) above and can be synthesized according to the above synthesis scheme.

The above compounds (s)-1, (s)-3, and (s)-7 to (s)-20 correspond to compounds represented by (d) above and can be synthesized according to the above synthesis scheme.

The above compound (s)-4 corresponds to a compound represented by (f) above and can be synthesized according to the above synthesis scheme.

The above compound (s)-21 corresponds to a compound represented by (g) above and can be synthesized according to the above synthesis scheme.

The above compounds (s)-5 and (s)-6 correspond to compounds represented by (i) above and can be synthesized according to the above synthesis scheme.

The content of the compound (S) (the total amount of the compounds (S) if two or more compounds (S) are included) in the aqueous dye solution according to the present invention is preferably 0.01% to 1.0% by mass, more preferably 0.05% to 1.0% by mass, and particularly preferably 0.1% to 1.0% by mass with respect to the total mass of the aqueous dye solution.

When the content of the compound (S) in the aqueous dye solution according to the present invention is 0.01% by mass or more, the intermolecular interaction with the compound represented by general formula (II) in the aqueous dye solution becomes stronger (compatibility is improved), and the effect of the long-term dissolution stability of the compound represented by general formula (II) in an aqueous solution is more likely to be exhibited. On the other hand, when the content of the compound (S) in the aqueous dye solution is 1.0% by mass or less, the concentration of solid contents in the aqueous dye solution does not increase, and, during the storage of the aqueous dye solution, the range of variation in liquid physical properties over time is decreased, thus improving the continuous ejection stability (reliability) of an ink composition for ink jet recording, the ink composition being prepared using the aqueous dye solution.

### EXAMPLES

Hereafter, the present invention will be described in detail with reference to Examples, but the present invention is not limited to these Examples.

The compound A, the compound B, the compound C-I, the compound C-II, the compound D, and the compound E in the present invention can be synthesized, isolated, and purified by using publicly known methods (for example, methods described in Detailed Description and Examples of JP3949385B, JP4145153B, JP4190187B, JP4512543B, JP4625644B, JP4854250B, and JP4691318B) alone or in combination of two or more, and further applying a reverse osmosis membrane purification method and a gel filtration chromatography purification method, as needed.

A synthesis example of the compound A will be described below. In the following Examples, λmax is a maximal absorption wavelength, and an ε value means a molar absorption coefficient at the maximal absorption wavelength. The above physical property values of aqueous dye solutions were measured by using, as an instrumental analysis apparatus, a UV-Vis spectrophotometer (UV-3100PC) manufactured by Shimadzu Corporation.

### Synthesis Example 1

### Synthesis of A-2-1

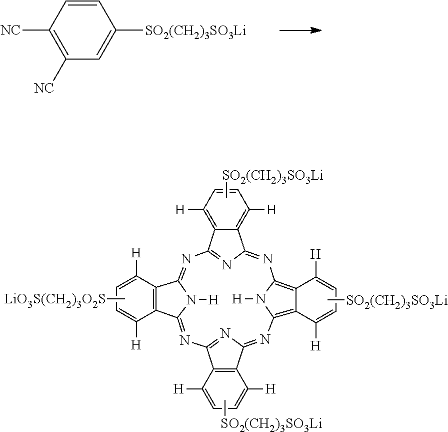

To a liquid mixture of 0.7 mL of acetic acid, 12 mL of triethyl orthoacetate, and 60 mL of diethylene glycol, 14.3 g (45 mmol) of a phthalocyanine dye intermediate (phthalonitrile derivative) synthesized by the method described in Examples of JP4625644B was suspended, the internal temperature was then increased to 100° C., stirring was performed at the same temperature for three hours, the internal temperature was then decreased to 20° C. by cooling, and a precipitated crude product was filtered, washed with 200 mL of isopropanol, and dried at 70° C. for 12 hours. The dried crude crystals were dissolved in 100 mL of ion-exchange water, and a 1.0 mol/L aqueous LiOH solution was then added at 25° C. until the pH of the resulting aqueous crude dye solution reached 7.0. Subsequently, the aqueous solution was filtered at the same temperature to remove dust. The resulting aqueous crude dye solution was purified by gel permeation chromatography (SEPHADEX™ LH-20 support: manufactured by Pharmacia, swollen with ion-exchange water) to obtain A-2-1. According to the measurement results of a visible spectrum of the obtained A-2-1 in an aqueous solution, λmax=630 nm (ε value≈58100).

### Synthesis Example 2

### Synthesis of A-1-1Fe (Compound in which Met of A-1-1 is Fe)

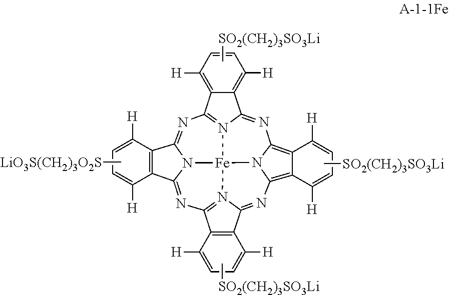

In 30 mL of diethylene glycol, 3.0 g of A-2-1 obtained in Synthesis Example 1 and 0.79 g of iron(II) acetate were suspended, the internal temperature was then increased to 70° C., and stirring was performed at the same temperature for one hour. The internal temperature of the reaction mixture was decreased to 50° C. by cooling, 100 mL of a mixture of n-hexane/isopropanol (3/1: vol/vol) was then added dropwise, the internal temperature was then decreased to 20° C. by cooling, and a precipitated crude product was filtered, washed with 200 mL of isopropanol, and dried at 70° C. for 12 hours. The dried crude crystals were dissolved in 10 mL of ion-exchange water, and a 1.0 mol/L aqueous LiOH solution was then added at 25° C. until the pH of the resulting aqueous crude dye solution reached 7.0. Subsequently, the aqueous solution was filtered at the same temperature to remove dust. The resulting aqueous crude dye solution was purified by gel permeation chromatography (SEPHADEX™ LH-20 support: manufactured by Pharmacia, swollen with ion-exchange water) to obtain A-1-1Fe.

According to the measurement results of a visible spectrum of A-1-1Fe in an aqueous solution, λmax=631 nm (ε value≈72800).

### Synthesis Example 3

### Synthesis of A-1-1Zn (Compound in which Met of A-1-1 is Zn)

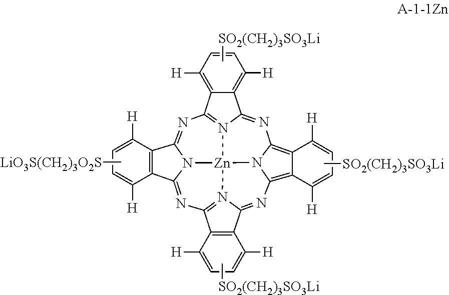

A-1-1Zn was obtained by performing the reaction under the same conditions and performing the same purification operation except that 0.79 g of iron(II) acetate used in Synthesis Example 2 was changed to 0.63 g of zinc(II) chloride. According to the measurement results of a visible spectrum of A-1-1Zn in an aqueous solution, λmax=630 nm (ε value≈59400).

### Synthesis Example 4

### Synthesis of A-1-1Mg (Compound in which Met of A-1-1 is Mg)

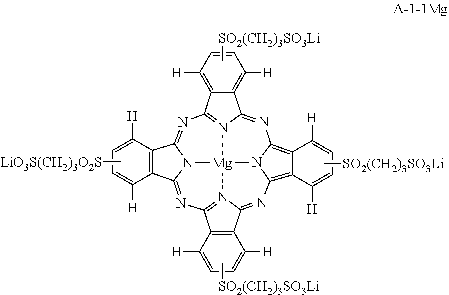

A-1-1Mg was obtained by performing the reaction under the same conditions and performing the same purification operation except that 0.79 g of iron(II) acetate used in Synthesis Example 2 was changed to 0.65 g of magnesium(II) acetate. According to the measurement results of a visible spectrum of A-1-1Mg in an aqueous solution, ,max of the visible spectrum in the aqueous solution was equal to 635 nm (ε value≈77300).

### Synthesis Example 5

### Synthesis of A-1-1Mn (Compound in which Met of A-1-1 is Mn)

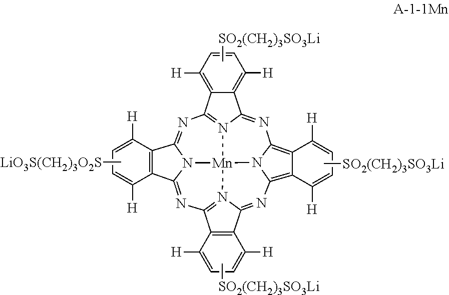

A-1-1Mn was obtained by performing the reaction under the same conditions and performing the same purification operation except that iron(II) acetate used in Synthesis Example 2 was changed to 0.79 g of manganese(II) acetate. According to the measurement results of a visible spectrum of A-1-1Mn in an aqueous solution, λmax of the visible spectrum in the aqueous solution was equal to 625 nm (ε value≈41900).

The compound B to the compound E were synthesized, isolated, and purified in the same manner as described above by using publicly known methods alone or in combination of two or more, and combining a reverse osmosis membrane purification method (RO: Reverse Osmosis, NF: Nano Filtration) and a gel filtration chromatography purification method.

### Example A

### Example 1

### Preparation of Dye Ink Composition 1

In 200.00 parts by mass of deionized water, 15.80 parts by mass of A-2-1, 21.00 parts by mass of B-2-1, a total of 10.60 parts by mass of C-2-1-1 and C-2-1-2, 2.40 parts by mass of D-2-1, 0.20 parts by mass of E-2-1, 1.10 parts by mass of a preservative (PROXEL (registered trademark) XL2(s) manufactured by LONZA), and 0.30 parts by mass of a buffering agent (LiHCO3) were dissolved, and the pH of the resulting solution was adjusted to 8.5 with a pH adjusting agent (10 mol/L aqueous lithium hydroxide solution). The solution was filtered under reduced pressure through a microfilter having an average pore size of 0.20 μm and washed with deionized water to prepare 500.00 parts by mass of a dye concentrated ink (liquid I).

Separately, organic solvents {9.70 parts by mass of glycerin, 3.40 parts by mass of triethylene glycol, 9.90 parts by mass of triethylene glycol monobutyl ether, 2.50 parts by mass of 2-pyrrolidone, 1.30 parts by mass of 1,2-hexane diol, and 0.12 parts by mass of propylene glycol} and 1.00 part by mass of a surfactant (SURFYNOL (registered trademark) 465 manufactured by Nissin Chemical Industry Co., Ltd.) were mixed to prepare an ink composition mother liquid (liquid II-1).

Next, 50.00 parts by mass of the (liquid I) and the whole amount of the (liquid II-1) were mixed at 30° C. to 40° C. and stirred at the same temperature for one hour, and the internal temperature was then decreased to 25° C. by cooling. Subsequently, the pH of the mixture was adjusted to 9.0 with a 10 mol/L aqueous lithium hydroxide solution, and the mixture was filtered under reduced pressure through a microfilter having an average pore size of 0.20 μm. Deionized water was added to the filtrate to prepare a cyan dye ink 1 (100.00 parts by mass) for ink jet recording.

Regarding the contents of phthalocyanine dyes (solid contents) in the cyan dye ink 1 (100.00 parts by mass) for ink jet recording, the content of A-2-1 was 1.58 parts by mass, the content of B-2-1 was 2.10 parts by mass, the total content of C-2-1-1 and C-2-1-2 was 1.06 parts by mass, the content of D-2-1 was 0.24 parts by mass, and the content of E-2-1 was 0.02 parts by mass.

### Example 2

### Preparation of Dye Ink Composition 2

In 200.00 parts by mass of deionized water, 3.10 parts by mass of A-2-1, 12.50 parts by mass of B-2-1, a total of 18.80 parts by mass of C-2-1-1 and C-2-1-2, 12.50 parts by mass of D-2-1, 3.10 parts by mass of E-2-1, 1.10 parts by mass of a preservative (PROXEL (registered trademark) XL2(s) manufactured by LONZA), and 0.30 parts by mass of a buffering agent (LiHCO₃) were dissolved, and the pH of the resulting solution was adjusted to 8.5 with a pH adjusting agent (10 mol/L aqueous lithium hydroxide solution). The solution was filtered under reduced pressure through a microfilter having an average pore size of 0.20 p.m and washed with deionized water to prepare 500.00 parts by mass of a dye concentrated ink (liquid I).

Separately, organic solvents {9.70 parts by mass of glycerin, 3.40 parts by mass of triethylene glycol, 9.90 parts by mass of triethylene glycol monobutyl ether, 2.50 parts by mass of 2-pyrrolidone, 1.30 parts by mass of 1,2-hexane diol, and 0.12 parts by mass of propylene glycol} and 1.00 part by mass of a surfactant (SURFYNOL (registered trademark) 465 manufactured by Nissin Chemical Industry Co., Ltd.) were mixed to prepare an ink composition mother liquid (liquid II-1).

Next, 50.00 parts by mass of the (liquid I) and the whole amount of the (liquid II-1) were mixed at 30° C. to 40° C. and stirred at the same temperature for one hour, and the internal temperature was then decreased to 25° C. by cooling. Subsequently, the pH of the mixture was adjusted to 9.0 with a 10 mol/L aqueous lithium hydroxide solution, and the mixture was then filtered under reduced pressure through a microfilter having an average pore size of 0.20 μm. Deionized water was added to the filtrate to prepare a cyan dye ink 2 (100.00 parts by mass) for ink jet recording.

Regarding the contents of phthalocyanine dyes (solid contents) in the cyan dye ink 2 (100.00 parts by mass) for ink jet recording, the content of A-2-1 was 0.31 parts by mass, the content of B-2-1 was 1.25 parts by mass, the total content of C-2-1-1 and C-2-1-2 was 1.88 parts by mass, the content of D-2-1 was 1.25 parts by mass, and the content of E-2-1 was 0.31 parts by mass.

### Examples 3 to 10

Cyan dye inks 3 to 10 (100.00 parts by mass each) for ink jet recording were prepared as in Example 1 except that the dye mixture used was changed so as to obtain cyan dye inks for ink jet recording, the cyan dye inks including components shown in Tables 1 and 2 below in the corresponding amounts shown in Tables I and 2 below. Numerical values in the tables are expressed in parts by mass.

TABLE 1

| | Phthalocyanine dye (solid content) | | | | | | | | Ink |
|---|---|---|---|---|---|---|---|---|---|
| | | | Compound C-I | | | Dye used in | Chelating | | composition |
| | Compound A | Compound B | Compound C-II | Compound D | Compound E | combination | agent | Additive | mother liquid |
| Example 1 | A-2-1 | B-2-1 | C-2-1-1 | D-2-1 | E-2-1 | No | No | No | Liquid (II-1) |
| | | | C-2-1-2 | | | addition | addition | addition | |
| | 1.58 | 2.10 | 1.06 | 0.24 | 0.02 | | | | |
| Example 2 | A-2-1 | B-2-1 | C-2-1-1 | D-2-1 | E-2-1 | No | No | No | Liquid (II-1) |
| | | | C-2-1-2 | | | addition | addition | addition | |
| | 0.31 | 1.25 | 1.88 | 1.25 | 0.31 | | | | |
| Example 3 | A-1-1Fe | B-1-1Fe | C-1-1-1Fe | D-1-1Fe | E-1-1Fe | No | No | No | Liquid (II-1) |
| | | | C-1-1-2Fe | | | addition | addition | addition | |
| | 1.58 | 2.10 | 1.06 | 0.24 | 0.02 | | | | |
| Example 4 | A-1-1Fe | B-1-1Fe | C-1-1-1Fe | D-1-1Fe | E-1-1Fe | No | No | No | Liquid (II-1) |
| | | | C-1-1-2Fe | | | addition | addition | addition | |
| | 0.31 | 1.25 | 1.88 | 1.25 | 0.31 | | | | |
| Example 5 | A-1-1Zn | B-1-1Zn | C-1-1-1Zn | D-1-1Zn | E-1-1Zn | No | No | No | Liquid (II-1) |
| | | | C-1-1-2Zn | | | addition | addition | addition | |
| | 1.58 | 2.10 | 1.06 | 0.24 | 0.02 | | | | |
| Example 6 | A-1-1Zn | B-1-1Zn | C-1-1-1Zn | D-1-1Zn | E-1-1Zn | No | No | No | Liquid (II-1) |
| | | | C-1-1-2Zn | | | addition | addition | addition | |
| | 0.31 | 1.25 | 1.88 | 1.25 | 0.31 | | | | |

TABLE 2

| | Phthalocyanine dye (solid content) | | | | | | | | Ink |
|---|---|---|---|---|---|---|---|---|---|
| | | | Compound C-I | | | Dye used in | Chelating | | composition |
| | Compound A | Compound B | Compound C-II | Compound D | Compound E | combination | agent | Additive | mother liquid |
| Example 7 | A-1-1Mg | B-1-1Mg | C-1-1-1Mg | D-1-1Mg | E-1-1Mg | No | No | No | Liquid (II-1) |
| | | | C-1-1-2Mg | | | addition | addition | addition | |
| | 1.58 | 2.10 | 1.06 | 0.24 | 0.02 | | | | |
| Example 8 | A-1-1Mg | B-1-1Mg | C-1-1-1Mg | D-1-1Mg | E-1-1Mg | No | No | No | Liquid (II-1) |
| | | | C-1-1-2Mg | | | addition | addition | addition | |
| | 0.31 | 1.25 | 1.88 | 1.25 | 0.31 | | | | |
| Example 9 | A-1-1Mn | B-1-1Mn | C-1-1-1Mn | D-1-1Mn | E-1-1Mn | No | No | No | Liquid (II-1) |
| | | | C-1-1-2Mn | | | addition | addition | addition | |
| | 1.58 | 2.10 | 1.06 | 0.24 | 0.02 | | | | |
| Example 10 | A-1-1Mn | B-1-1Mn | C-1-1-1Mn | D-1-1Mn | E-1-1Mn | No | No | No | Liquid (II-1) |
| | | | C-1-1-2Mn | | | addition | addition | addition | |
| | 0.31 | 1.25 | 1.88 | 1.25 | 0.31 | | | | |

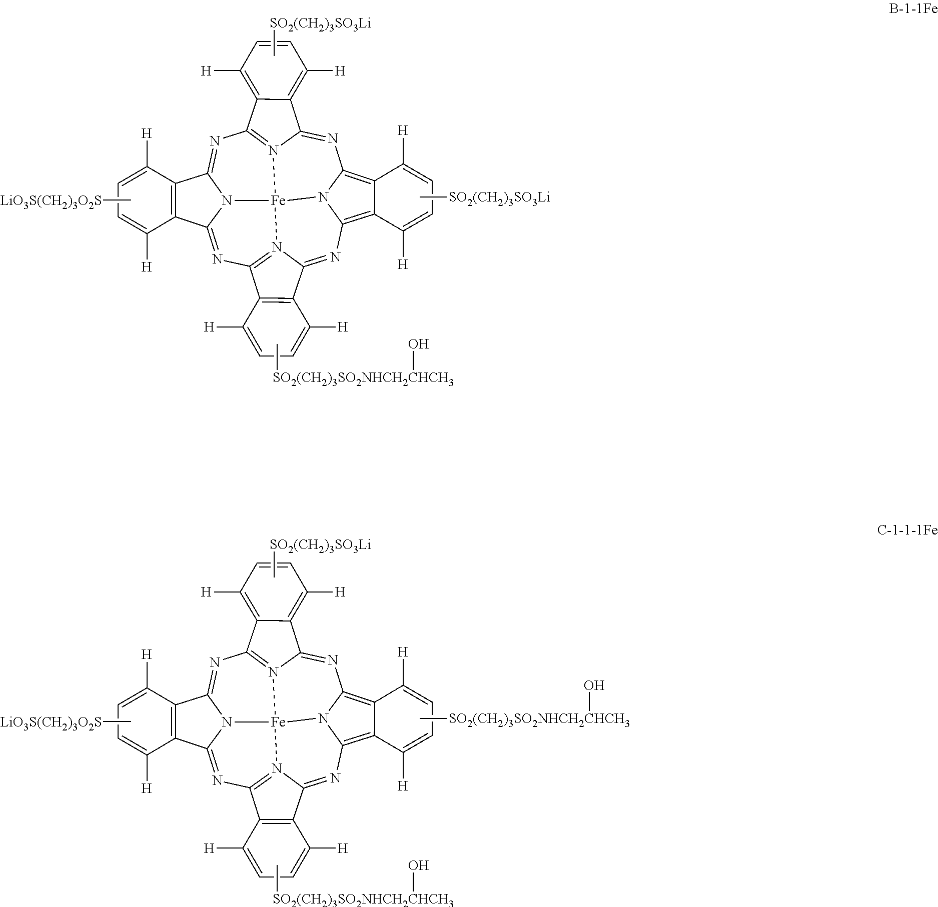

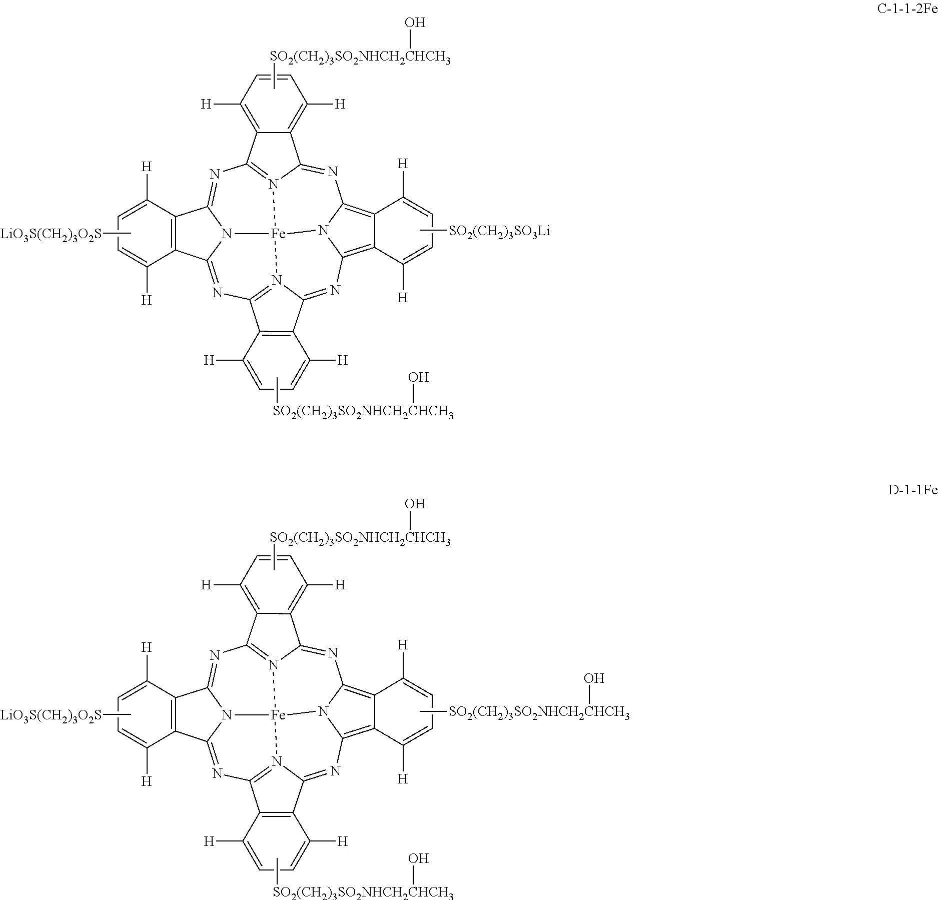

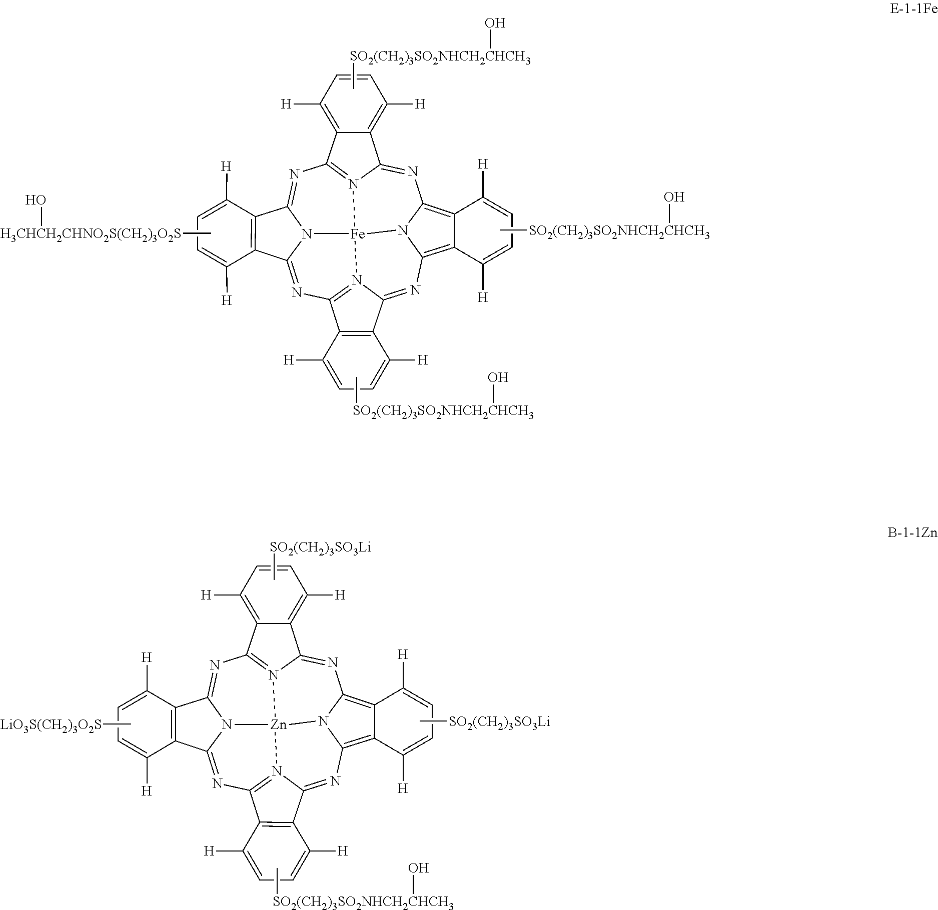

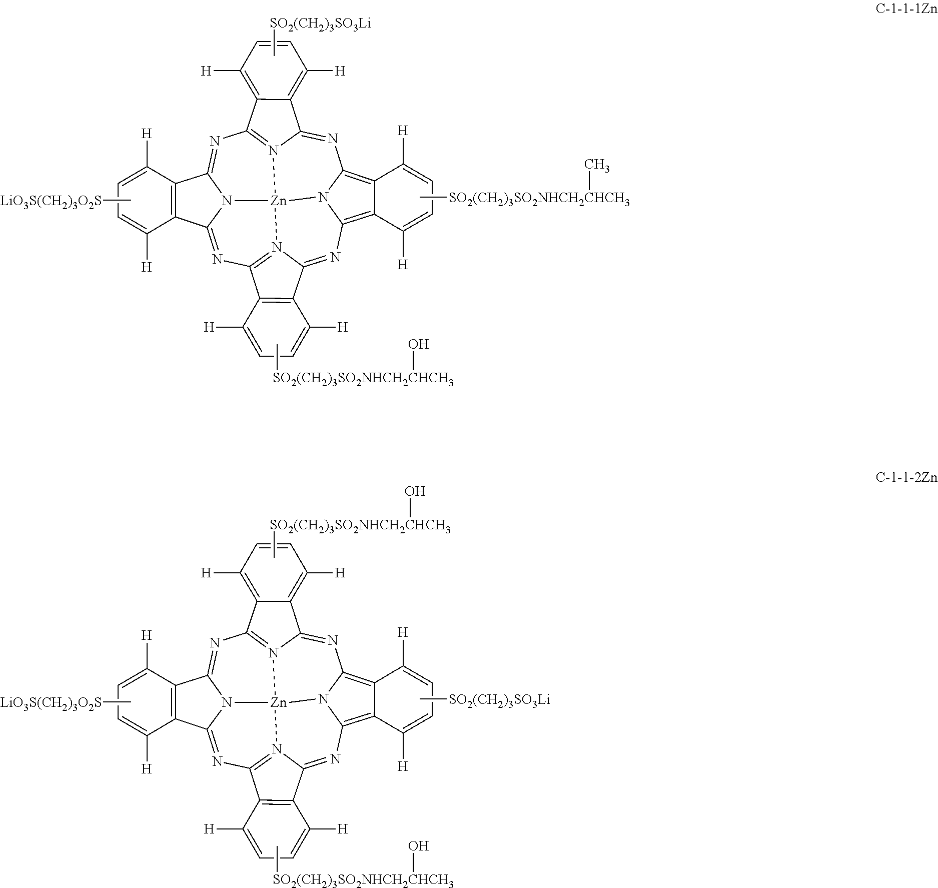

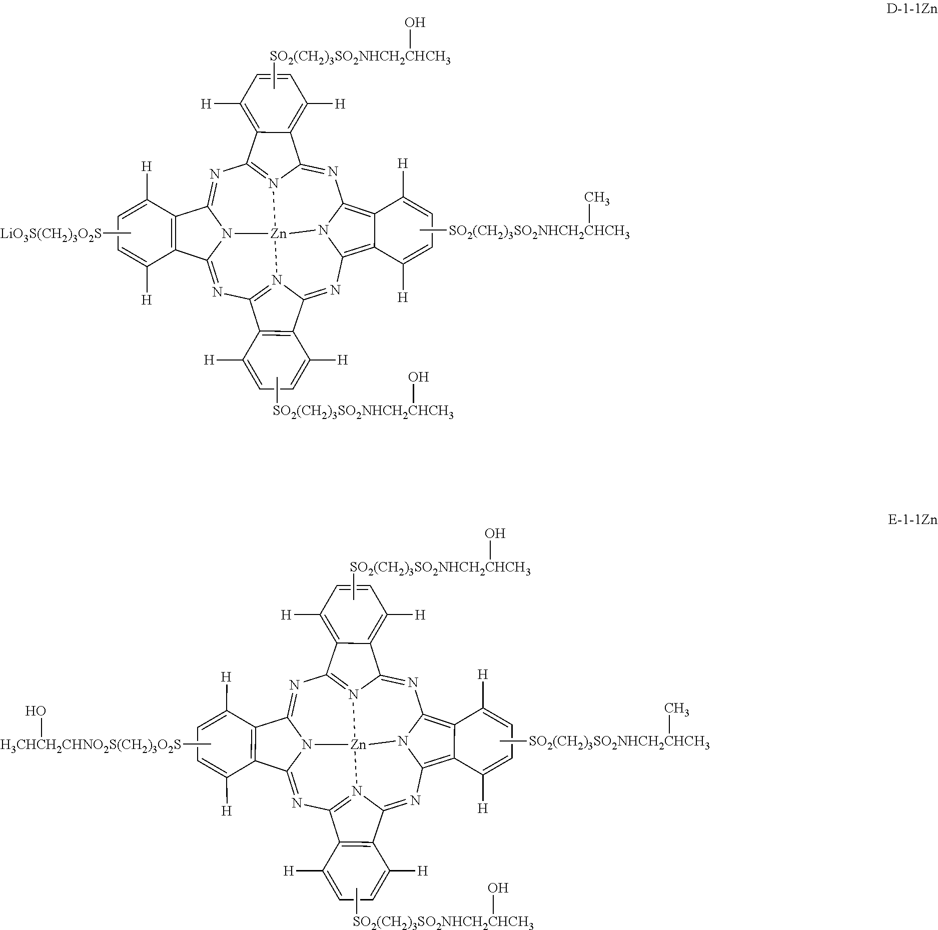

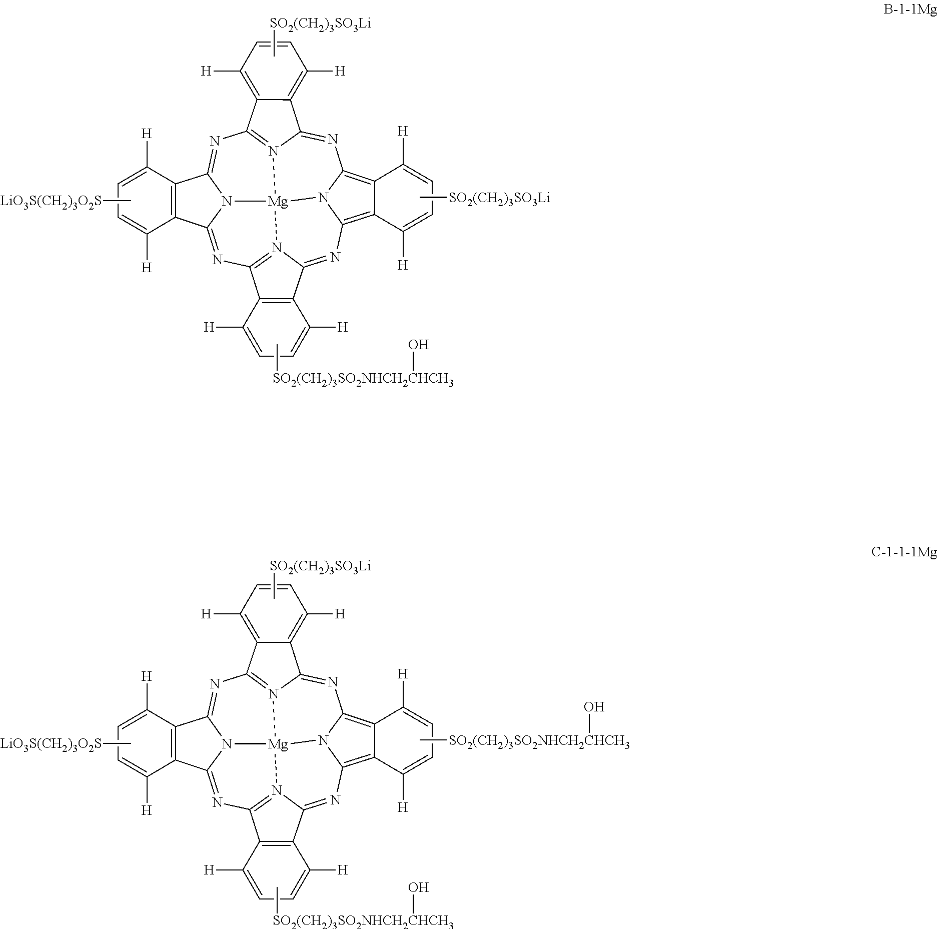

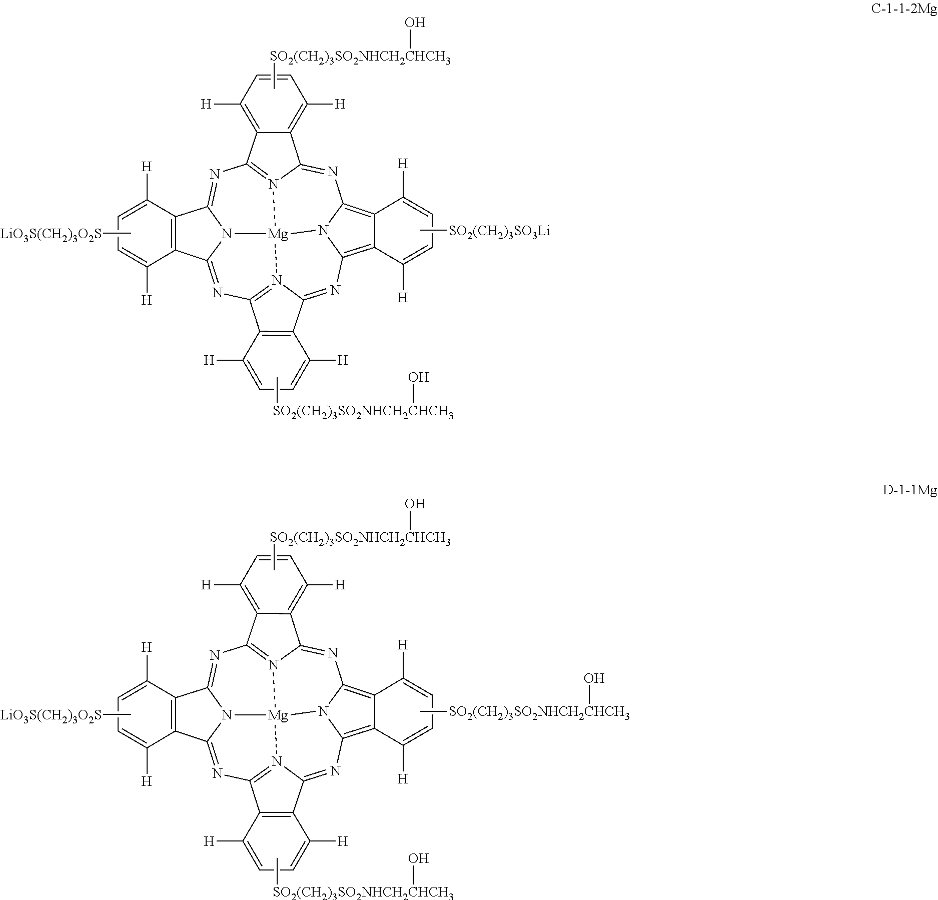

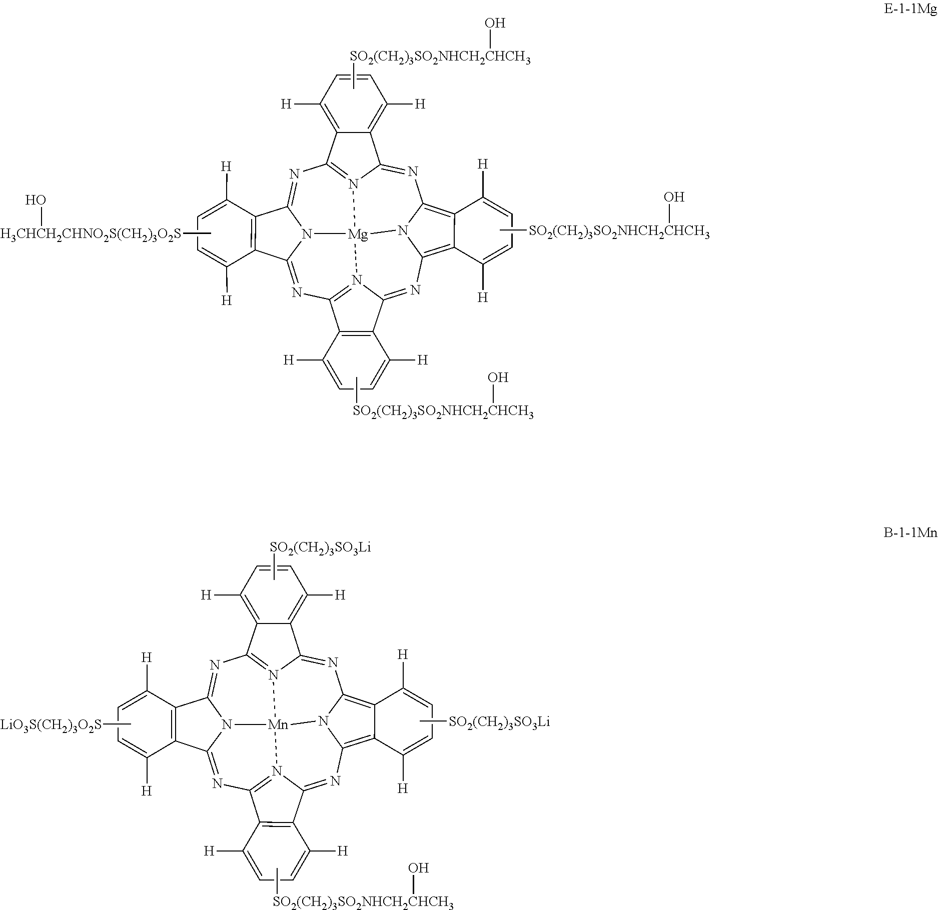

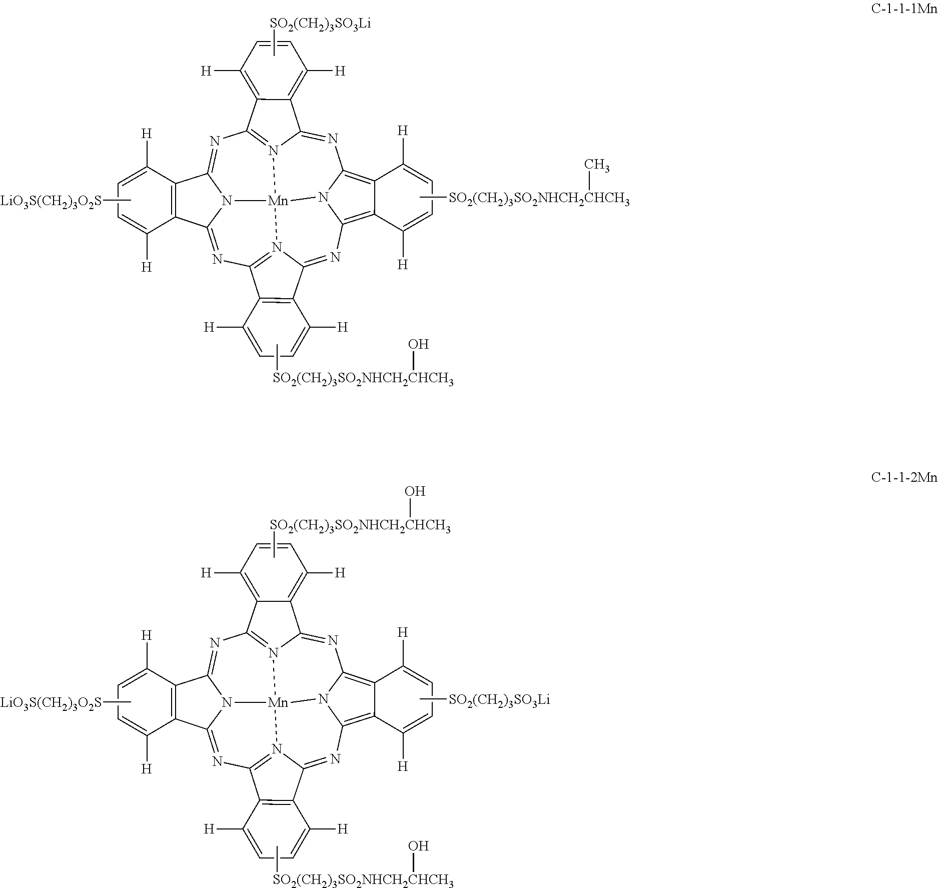

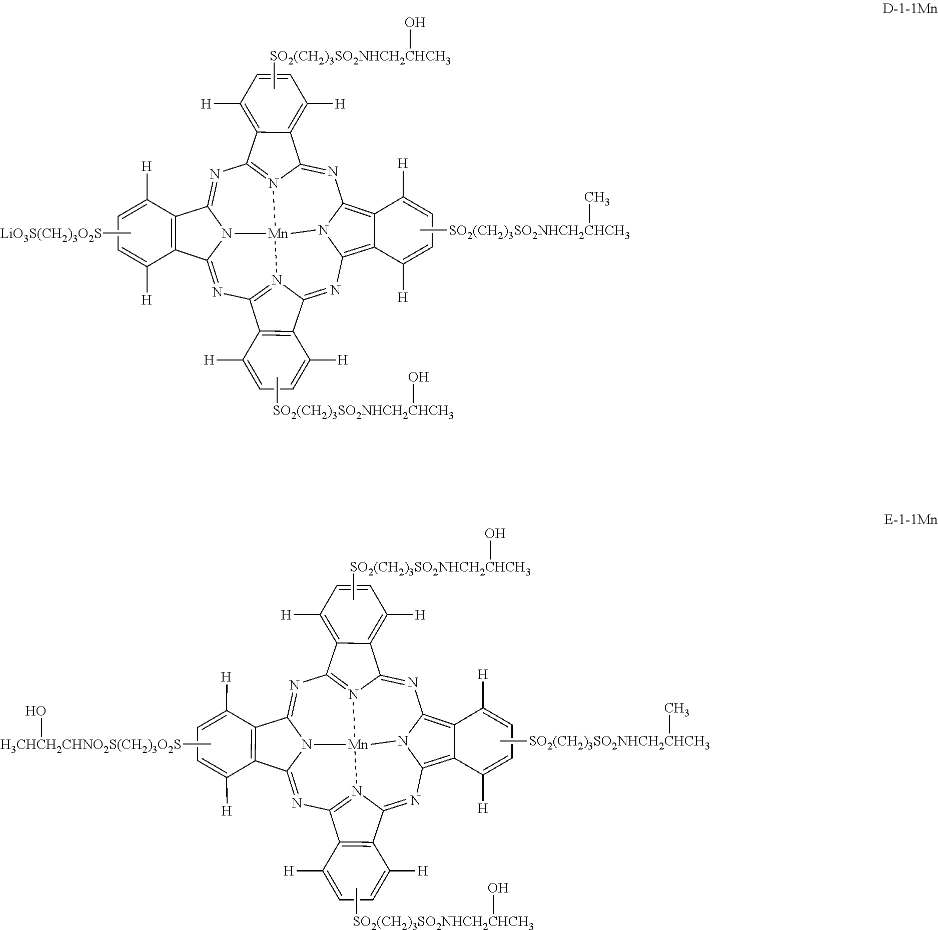

### Example 11

In 200.00 parts by mass of deionized water, 2.70 parts by mass of A-1-1Fe, 11.30 parts by mass of B-1-1Fe, a total of 17.00 parts by mass of C-1-1-1Fe and C-1-1-2Fe, 11.30 parts by mass of D-1-1Fe, 2.70 parts by mass of E-1-1Fe, 5.00 parts by mass of Q-1, 1.10 parts by mass of a preservative (PROXEL (registered trademark) XL2(s) manufactured by LONZA), and 0.30 parts by mass of a buffering agent (LiHCO₃) were dissolved, and the pH of the resulting solution was adjusted to 8.5 with a pH adjusting agent (10 mol/L aqueous lithium hydroxide solution). The solution was filtered under reduced pressure through a microfilter having an average pore size of 0.20 μm and washed with deionized water to prepare 500.00 parts by mass of a dye concentrated ink (liquid I).

Separately, organic solvents {9.70 parts by mass of glycerin, 3.40 parts by mass of triethylene glycol, 9.90 parts by mass of triethylene glycol monobutyl ether, 2.50 parts by mass of 2-pyrrolidone, 1.30 parts by mass of 1,2-hexane diol, and 0.12 parts by mass of propylene glycol} and 1.00 part by mass of a surfactant (SURFYNOL (registered trademark) 465 manufactured by Nissin Chemical Industry Co., Ltd.) were mixed to prepare an ink composition mother liquid (liquid II-1).

Next, 50.00 parts by mass of the (liquid I) and the whole amount of the (liquid II-1) were mixed at 30° C. to 40° C. and stirred at the same temperature for one hour, and the internal temperature was then decreased to 25° C. by cooling. Subsequently, the pH of the mixture was adjusted to 9.0 with a 10 mol/L aqueous lithium hydroxide solution, and the mixture was filtered under reduced pressure through a microfilter having an average pore size of 0.20 μm. Deionized water was added to the filtrate to prepare a cyan dye ink 11 (100.00 parts by mass) for ink jet recording.

Regarding the contents of phthalocyanine dyes (solid contents) in the cyan dye ink 11 (100.00 parts by mass) for ink jet recording, the content of A-1-1Fe was 0.27 parts by mass, the content of B-1-1Fe was 1.13 parts by mass, the total content of C-1-1-1Fe and C-1-1-2Fe was 1.70 parts by mass, the content of D-1-1Fe was 1.13 parts by mass, and the content of E-1-1Fe was 0.27 parts by mass. The content of Q-1, which was a dye used in combination, was 0.50 parts by mass.

### Example 12

In 200.00 parts by mass of deionized water, 3.10 parts by mass of A-1-1Fe, 12.50 parts by mass of B-1-1Fe, a total of 18.80 parts by mass of C-1-1-1Fe and C-1-1-2Fe, 12.50 parts by mass of D-1-1Fe, 3.10 parts by mass of E-1-1Fe, 1.10 parts by mass of a preservative (PROXEL (registered trademark) XL2(s) manufactured by LONZA), 0.30 parts by mass of a buffering agent (LiHCO₃), and 0.50 parts by mass of a chelating agent (EDTA-4Li salt) were dissolved, and the pH of the resulting solution was adjusted to 8.5 with a pH adjusting agent (10 mol/L aqueous lithium hydroxide solution). The solution was filtered under reduced pressure through a microfilter having an average pore size of 0.20 μm and washed with deionized water to prepare 500.00 parts by mass of a dye concentrated ink (liquid I).

Separately, organic solvents {9.70 parts by mass of glycerin, 3.40 parts by mass of triethylene glycol, 9.90 parts by mass of triethylene glycol monobutyl ether, 2.50 parts by mass of 2-pyrrolidone, 1.30 parts by mass of 1,2-hexane diol, and 0.12 parts by mass of propylene glycol} and 1.00 part by mass of a surfactant (SURFYNOL (registered trademark) 465 manufactured by Nissin Chemical Industry Co., Ltd.) were mixed to prepare an ink composition mother liquid (liquid II-1).

Next, 50.00 parts by mass of the (liquid I) and the whole amount of the (liquid II-1) were mixed at 30° C. to 40° C. and stirred at the same temperature for one hour, and the internal temperature was then decreased to 25° C. by cooling. Subsequently, the pH of the mixture was adjusted to 9.0 with a 10 mol/L aqueous lithium hydroxide solution, and the mixture was filtered under reduced pressure through a microfilter having an average pore size of 0.20 μm. Deionized water was added to the filtrate to prepare a cyan dye ink 12 (100.00 parts by mass) for ink jet recording.

Regarding the contents of phthalocyanine dyes (solid contents) in the cyan dye ink 12 (100.00 parts by mass) for ink jet recording, the content of A-1-1Fe was 0.31 parts by mass, the content of B-1-1Fe was 1.25 parts by mass, the total content of C-1-1-1Fe and C-1-1-2Fe was 1.88 parts by mass, the content of D-1-1Fe was 1.25 parts by mass, and the content of E-1-1Fe was 0.31 parts by mass. The content of the chelating agent was 0.05 parts by mass.

### Example 13

In 200.00 parts by mass of deionized water, 3.10 parts by mass of A-1-1Fe, 12.50 parts by mass of B-1-1Fe, a total of 18.80 parts by mass of C-1-1-1Fe and C-1-1-2Fe, 12.50 parts by mass of D-1-1Fe, 3.10 parts by mass of E-1-1Fe, 1.10 parts by mass of a preservative (PROXEL (registered trademark) XL2(s) manufactured by LONZA), 0.30 parts by mass of a buffering agent (LiHCO₃), 0.50 parts by mass of a chelating agent (EDTA-4Li salt), and 5.00 parts by mass of (P-4) were dissolved, and the pH of the resulting solution was adjusted to 8.5 with a pH adjusting agent (10 mol/L aqueous lithium hydroxide solution). The solution was filtered under reduced pressure through a microfilter having an average pore size of 0.20 um and washed with deionized water to prepare 500.00 parts by mass of a dye concentrated ink (liquid I).

Separately, organic solvents {9.70 parts by mass of glycerin, 3.40 parts by mass of triethylene glycol, 9.90 parts by mass of triethylene glycol monobutyl ether, 2.50 parts by mass of 2-pyrrolidone, 1.30 parts by mass of 1,2-hexane diol, and 0.12 parts by mass of propylene glycol} and 1.00 part by mass of a surfactant (SURFYNOL (registered trademark) 465 manufactured by Nissin Chemical Industry Co., Ltd.) were mixed to prepare an ink composition mother liquid (liquid II-1).

Next, 50.00 parts by mass of the (liquid I) and the whole amount of the (liquid II-1) were mixed at 30° C. to 40° C. and stirred at the same temperature for one hour, and the internal temperature was then decreased to 25° C. by cooling. Subsequently, the pH of the mixture was adjusted to 9.0 with a 10 mol/L aqueous lithium hydroxide solution, and the mixture was then filtered under reduced pressure through a microfilter having an average pore size of 0.20 μm. Deionized water was added to the filtrate to prepare a cyan dye ink 13 (100.00 parts by mass) for ink jet recording.

Regarding the contents of phthalocyanine dyes (solid contents) in the cyan dye ink 13 (100.00 parts by mass) for ink jet recording, the content of A-1-1Fe was 0.31 parts by mass, the content of B-1-1Fe was 1.25 parts by mass, the total content of C-1-1-1Fe and C-1-1-2Fe was 1.88 parts by mass, the content of D-1-1Fe was 1.25 parts by mass, and the content of E-1-1Fe was 0.31 parts by mass. The content of the chelating agent was 0.05 parts by mass. The content of (P-4), which was an additive, was 0.50 parts by mass.

### Example 14

In 200.00 parts by mass of deionized water, 2.70 parts by mass of A-1-1Fe, 11.30 parts by mass of B-1-1Fe, a total of 17.00 parts by mass of C-1-1-1Fe and C-1-1-2Fe, 11.30 parts by mass of D-1-1Fe, 2.70 parts by mass of E-1-1Fe, 5.00 parts by mass of Q-1, 1.10 parts by mass of a preservative (PROXEL (registered trademark) XL₂(s) manufactured by LONZA), 0.30 parts by mass of a buffering agent (LiHCO₃), 0.50 parts by mass of a chelating agent (EDTA-4Li salt), and 5.00 parts by mass of (P-4) were dissolved, and the pH of the resulting solution was adjusted to 8.5 with a pH adjusting agent (10 mol/L aqueous lithium hydroxide solution). The solution was filtered under reduced pressure through a microfilter having an average pore size of 0.20 μm and washed with deionized water to prepare 500.00 parts by mass of a dye concentrated ink (liquid I).

Separately, organic solvents {9.70 parts by mass of glycerin, 3.40 parts by mass of triethylene glycol, 9.90 parts by mass of triethylene glycol monobutyl ether, 2.50 parts by mass of 2-pyrrolidone, 1.30 parts by mass of 1,2-hexane diol, and 0.12 parts by mass of propylene glycol} and 1.00 part by mass of a surfactant (SURFYNOL 465: registered trademark, manufactured by Nissin Chemical Industry Co., Ltd.) were mixed to prepare an ink composition mother liquid (liquid II-1).

Next, 50.00 parts by mass of the (liquid I) and the whole amount of the (liquid II-1) were mixed at 30° C. to 40° C. and stirred at the same temperature for one hour, and the internal temperature was then decreased to 25° C. by cooling. Subsequently, the pH of the mixture was adjusted to 9.0 with a 10 mol/L aqueous lithium hydroxide solution, and the mixture was then filtered under reduced pressure through a microfilter having an average pore size of 0.20 μm. Deionized water was added to the filtrate to prepare a cyan dye ink 14 (100.00 parts by mass) for ink jet recording.

Regarding the contents of phthalocyanine dyes (solid contents) in the cyan dye ink 14 (100.00 parts by mass) for ink jet recording, the content of A-1-1Fe was 0.27 parts by mass, the content of B-1-1Fe was 1.13 parts by mass, the total content of C-1-1-1Fe and C-1-1-2Fe was 1.70 parts by mass, the content of D-1-1Fe was 1.13 parts by mass, and the content of E-1-1Fe was 0.27 parts by mass. The content of Q-1, which was a dye used in combination, was 0.50 parts by mass. The content of the chelating agent was 0.05 parts by mass. The content of (P-4), which was an additive, was 0.50 parts by mass.

### Examples 15 to 20

Cyan dye inks 15 to 20 (100.00 parts by mass each) for ink jet recording were prepared as in Examples 11 to 14 except that the dye mixture, dye used in combination, chelating agent, and additive used were changed so as to obtain cyan dye inks for ink jet recording, the cyan dye inks including the components shown in Table 4 below in the corresponding amounts shown in Table 4 below. Numerical values in the tables are expressed in parts by mass.

TABLE 3

| | Phthalocyanine dye (solid content) | | | | | | | | Ink |
|---|---|---|---|---|---|---|---|---|---|
| | | | Compound C-I | | | Dye used in | Chelating | | composition |
| | Compound A | Compound B | Compound C-II | Compound D | Compound E | combination | agent | Additive | mother liquid |
| Example 11 | A-1-1Fe | B-1-1Fe | C-1-1-1Fe | D-1-1Fe | E-1-1Fe | Q-1 | No | No | Liquid (II-1) |
| | | | C-1-1-2Fe | | | | addition | addition | |
| | 0.27 | 1.13 | 1.70 | 1.13 | 0.27 | 0.50 | | | |
| Example 12 | A-1-1Fe | B-1-1Fe | C-1-1-1Fe | D-1-1Fe | E-1-1Fe | No | EDTA-4Li | No | Liquid (II-1) |
| | | | C-1-1-2Fe | | | addition | salt | addition | |
| | 0.31 | 1.25 | 1.88 | 1.25 | 0.31 | | 0.05 | | |
| Example 13 | A-1-1Fe | B-1-1Fe | C-1-1-1Fe | D-1-1Fe | E-1-1Fe | No | EDTA-4Li | (P-4) | Liquid (II-1) |
| | | | C-1-1-2Fe | | | addition | salt | | |
| | 0.31 | 1.25 | 1.88 | 1.25 | 0.31 | | 0.05 | 0.50 | |
| Example 14 | A-1-1Fe | B-1-1Fe | C-1-1-1Fe | D-1-1Fe | E-1-1Fe | Q-1 | EDTA-4Li | (P-4) | Liquid (II-1) |
| | | | C-1-1-2Fe | | | | salt | | |
| | 0.27 | 1.13 | 1.70 | 1.13 | 0.27 | 0.50 | 0.05 | 0.50 | |

TABLE 4

| | Phthalocyanine dye (solid content) | | | | | | | | Ink |
|---|---|---|---|---|---|---|---|---|---|
| | | | Compound C-I | | | Dye used in | Chelating | | composition |
| | Compound A | Compound B | Compound C-II | Compound D | Compound E | combination | agent | Additive | mother liquid |
| Example 15 | A-1-1Zn | B-1-1Zn | C-1-1-1Zn | D-1-1Zn | E-1-1Zn | Q-1 | No | No | Liquid (II-1) |
| | | | C-1-1-2Zn | | | | addition | addition | |
| | 0.27 | 1.13 | 1.70 | 1.13 | 0.27 | 0.50 | | | |
| Example 16 | A-1-1Zn | B-1-1Zn | C-1-1-1Zn | D-1-1Zn | E-1-1Zn | No | EDTA-4Li | No | Liquid (II-1) |
| | | | C-1-1-2Zn | | | addition | salt | addition | |
| | 0.31 | 1.25 | 1.88 | 1.25 | 0.31 | | 0.05 | | |
| Example 17 | A-1-1Zn | B-1-1Zn | C-1-1-1Zn | D-1-1Zn | E-1-1Zn | No | EDTA-4Li | (P-4) | Liquid (II-1) |
| | | | C-1-1-2Zn | | | addition | salt | | |
| | 0.31 | 1.25 | 1.88 | 1.25 | 0.31 | | 0.05 | 0.50 | |
| Example 18 | A-1-1Zn | B-1-1Zn | C-1-1-1Zn | D-1-1Zn | E-1-1Zn | Q-1 | EDTA-4Li | (P-4) | Liquid (II-1) |
| | | | C-1-1-2Zn | | | | salt | | |
| | 0.27 | 1.13 | 1.70 | 1.13 | 0.27 | 0.50 | 0.05 | 0.50 | |
| Example 19 | A-1-1Mg | B-1-1Mg | C-1-1-1Mg | D-1-1Mg | E-1-1Mg | No | EDTA-4Li | No | Liquid (II-1) |
| | | | C-1-1-2Mg | | | addition | salt | addition | |
| | 0.31 | 1.25 | 1.88 | 1.25 | 0.31 | | 0.05 | | |
| Example 20 | A-1-1Mg | B-1-1Mg | C-1-1-1Mg | D-1-1Mg | E-1-1Mg | No | EDTA-4Li | (P-4) | Liquid (II-1) |
| | | | C-1-1-2Mg | | | addition | salt | | |
| | 0.31 | 1.25 | 1.88 | 1.25 | 0.31 | | 0.05 | 0.50 | |

### Example 21

In 200.00 parts by mass of deionized water, 3.10 parts by mass of A-1-1Fe, 12.50 parts by mass of B-1-1Fe, a total of 18.80 parts by mass of C-1-1-1Fe and C-1-1-2Fe, 12.50 parts by mass of D-1-1Fe, 3.10 parts by mass of Q-1, 1.10 parts by mass of a preservative (PROXEL (registered trademark) XL2(s) manufactured by LONZA), and 0.30 parts by mass of a buffering agent (LiHCO₃) were dissolved, and the pH of the resulting solution was adjusted to 8.5 with a pH adjusting agent (10 mol/L aqueous lithium hydroxide solution). The solution was filtered under reduced pressure through a microfilter having an average pore size of 0.20 μm and washed with deionized water to prepare 500.00 parts by mass of a dye concentrated ink (liquid I).

Separately, organic solvents {9.70 parts by mass of glycerin, 3.40 parts by mass of triethylene glycol, 9.90 parts by mass of triethylene glycol monobutyl ether, 2.50 parts by mass of 2-pyrrolidone, 1.30 parts by mass of 1,2-hexane diol, and 0.12 parts by mass of propylene glycol} and 1.00 part by mass of a surfactant (SURFYNOL (registered trademark) 465 manufactured by Nissin Chemical Industry Co., Ltd.) were mixed to prepare an ink composition mother liquid (liquid II-1).

Next, 50.00 parts by mass of the (liquid I) and the whole amount of the (liquid II-I) were mixed at 30° C. to 40° C. and stirred at the same temperature for one hour, and the internal temperature was then decreased to 25° C. by cooling. Subsequently, the pH of the mixture was adjusted to 9.0 with a 10 mol/L aqueous lithium hydroxide solution, and the mixture was then filtered under reduced pressure through a microfilter having an average pore size of 0.20 μm. Deionized water was added to the filtrate to prepare a cyan dye ink 21 (100.00 parts by mass) for ink jet recording.

Regarding the contents of phthalocyanine dyes (solid contents) in the cyan dye ink 21 (100.00 parts by mass) for ink jet recording, the content of A-1-1Fe was 0.31 parts by mass, the content of B-1-1Fe was 1.25 parts by mass, the total content of C-1-1-1Fe and C-1-1-2Fe was 1.88 parts by mass, and the content of D-1-1Fe was 1.25 parts by mass. The content of Q-1, which was a dye used in combination, was 0.31 parts by mass.

### Example 22

In 200.00 parts by mass of deionized water, 15.80 parts by mass of A-1-1Fe, 21.00 parts by mass of B-1-1Fe, a total of 10.60 parts by mass of C-1-1-1Fe and C-1-1-2Fe, 2.40 parts by mass of D-1-1Fe, 0.20 parts by mass of Q-1, 1.10 parts by mass of a preservative (PROXEL (registered trademark) XL2(s) manufactured by LONZA), and 0.30 parts by mass of a buffering agent (LiHCO3) were dissolved, and the pH of the resulting solution was adjusted to 8.5 with a pH adjusting agent (10 mol/L aqueous lithium hydroxide solution). The solution was filtered under reduced pressure through a microfilter having an average pore size of 0.20 μm and washed with deionized water to prepare 500.00 parts by mass of a dye concentrated ink (liquid I).

Separately, organic solvents {9.70 parts by mass of glycerin, 3.40 parts by mass of triethylene glycol, 9.90 parts by mass of triethylene glycol monobutyl ether, 2.50 parts by mass of 2-pyrrolidone, 1.30 parts by mass of 1,2-hexane diol, and 0.12 parts by mass of propylene glycol} and 1.00 part by mass of a surfactant (SURFYNOL (registered trademark) 465 manufactured by Nissin Chemical Industry Co., Ltd.) were mixed to prepare an ink composition mother liquid (liquid II-1).

Next, 50.00 parts by mass of the (liquid I) and the whole amount of the (liquid II-1) were mixed at 30° C. to 40° C. and stirred at the same temperature for one hour, and the internal temperature was then decreased to 25° C. by cooling. Subsequently, the pH of the mixture was adjusted to 9.0 with a 10 mol/L aqueous lithium hydroxide solution, and the mixture was then filtered under reduced pressure through a microfilter having an average pore size of 0.20 μm. Deionized water was added to the filtrate to prepare a cyan dye ink 22 (100.00 parts by mass) for ink jet recording.

Regarding the contents of phthalocyanine dyes (solid contents) in the cyan dye ink 22 (100.00 parts by mass) for ink jet recording, the content of A-1-1Fe was 1.58 parts by mass, the content of B-1-1Fe was 2.10 parts by mass, the total content of C-1-1-1Fe and C-1-1-2Fe was 1.06 parts by mass, and the content of D-1-1Fe was 0.24 parts by mass. The content of Q-1, which was a dye used in combination, was 0.02 parts by mass.

### Examples 23 to 30

Cyan dye inks 23 to 30 (100.00 parts by mass each) for ink jet recording were prepared as in Examples 21 and 22 except that the dye mixture, dye used in combination, chelating agent, and additive used were changed so as to obtain cyan dye inks for ink jet recording, the cyan dye inks including the components shown in Tables 5 and 6 below in the corresponding amounts shown in Tables 5 and 6 below. Numerical values in the tables are expressed in parts by mass.

TABLE 5

| | Phthalocyanine dye (solid content) | | | | | | | | Ink |
|---|---|---|---|---|---|---|---|---|---|
| | | | Compound C-I | | | Dye used in | Chelating | | composition |
| | Compound A | Compound B | Compound C-II | Compound D | Compound E | combination | agent | Additive | mother liquid |
| Example 21 | A-1-1Fe | B-1-1Fe | C-1-1-1Fe | D-1-1Fe | — | Q-1 | No | No | Liquid (II-1) |
| | | | C-1-1-2Fe | | | | addition | addition | |
| | 0.31 | 1.25 | 1.88 | 1.25 | 0.00 | 0.31 | | | |
| Example 22 | A-1-1Fe | B-1-1Fe | C-1-1-1Fe | D-1-1Fe | — | Q-1 | No | No | Liquid (II-1) |
| | | | C-1-1-2Fe | | | | addition | addition | |
| | 1.58 | 2.10 | 1.06 | 0.24 | 0.00 | 0.02 | | | |
| Example 23 | A-1-1Fe | B-1-1Fe | C-1-1-1Fe | D-1-1Fe | — | No addition | No | No | Liquid (II-1) |
| | | | C-1-1-2Fe | | | | addition | addition | |
| | 1.59 | 2.11 | 1.06 | 0.24 | 0.00 | | | | |
| Example 24 | A-1-1Fe | B-1-1Fe | C-1-1-1Fe | D-1-1Fe | — | No addition | EDTA-4Li | No | Liquid (II-1) |
| | | | C-1-1-2Fe | | | | salt | addition | |
| | 1.59 | 2.11 | 1.06 | 0.24 | 0.00 | | 0.05 | | |
| Example 25 | A-1-1Fe | B-1-1Fe | C-1-1-1Fe | D-1-1Fe | — | No addition | EDTA-4Li | (P-4) | Liquid (II-1) |
| | | | C-1-1-2Fe | | | | salt | | |
| | 1.59 | 2.11 | 1.06 | 0.24 | 0.00 | | 0.05 | 0.50 | |

TABLE 6

| | Phthalocyanine dye (solid content) | | | | | | | | Ink |
|---|---|---|---|---|---|---|---|---|---|
| | | | Compound C-I | | | Dye used in | Chelating | | composition |
| | Compound A | Compound B | Compound C-II | Compound D | Compound E | combination | agent | Additive | mother liquid |
| Example 26 | A-1-1Zn | B-1-1Zn | C-1-1-1Zn | D-1-1Zn | — | Q-1 | No | No | Liquid (II-1) |
| | | | C-1-1-2Zn | | | | addition | addition | |
| | 0.31 | 1.25 | 1.88 | 1.25 | 0.00 | 0.31 | | | |
| Example 27 | A-1-1Zn | B-1-1Zn | C-1-1-1Zn | D-1-1Zn | — | Q-1 | No | No | Liquid (II-1) |
| | | | C-1-1-2Zn | | | | addition | addition | |
| | 1.58 | 2.10 | 1.06 | 0.24 | 0.00 | 0.02 | | | |
| Example 28 | A-1-1Zn | B-1-1Zn | C-1-1-1Zn | D-1-1Zn | — | No | No | No | Liquid (II-1) |
| | | | C-1-1-2Zn | | | addition | addition | addition | |
| | 1.59 | 2.11 | 1.06 | 0.24 | 0.00 | | | | |
| Example 29 | A-1-1Zn | B-1-1Zn | C-1-1-1Zn | D-1-1Zn | — | No | EDTA-4Li | No | Liquid (II-1) |
| | | | C-1-1-2Zn | | | addition | salt | addition | |
| | 1.59 | 2.11 | 1.06 | 0.24 | 0.00 | | 0.05 | | |
| Example 30 | A-1-1Zn | B-1-1Zn | C-1-1-1Zn | D-1-1Zn | — | No | EDTA-4Li | (P-4) | Liquid (II-1) |
| | | | C-1-1-2Zn | | | addition | salt | | |
| | 1.59 | 2.11 | 1.06 | 0.24 | 0.00 | | 0.05 | 0.50 | |

### Example 31

In 200.00 parts by mass of deionized water, 3.10 parts by mass of A-1-4Fe, 12.50 parts by mass of B-1-8Fe, a total of 18.80 parts by mass of C-1-8-1Fe and C-1-8-2Fe, 12.50 parts by mass of D-1-4Fe, 3.10 parts by mass of E-1-1Fe, 1.10 parts by mass of a preservative (PROXEL (registered trademark) XL2(s) manufactured by LONZA), 0.30 parts by mass of a buffering agent (NaHCO₃), and 5.00 parts by mass of (P-3) were dissolved, and the pH of the resulting solution was adjusted to 8.5 with a pH adjusting agent (10 mol/L aqueous sodium hydroxide solution). The solution was filtered under reduced pressure through a microfilter having an average pore size of 0.20 μm and washed with deionized water to prepare 500.00 parts by mass of a dye concentrated ink (liquid I).

Separately, organic solvents {9.70 parts by mass of glycerin, 3.40 parts by mass of triethylene glycol, 9.90 parts by mass of triethylene glycol monobutyl ether, 2.50 parts by mass of 2-pyrrolidone, 1.30 parts by mass of 1,2-hexane diol, and 0.12 parts by mass of propylene glycol} and 1.00 part by mass of a surfactant (SURFYNOL (registered trademark) 465 manufactured by Nissin Chemical Industry Co., Ltd.) were mixed to prepare an ink composition mother liquid (liquid II-1).

Next, 50.00 parts by mass of the (liquid I) and the whole amount of the (liquid II-1) were mixed at 30° C. to 40° C. and stirred at the same temperature for one hour, and the internal temperature was then decreased to 25° C. by cooling. Subsequently, the pH of the mixture was adjusted to 9.0 with a 10 mol/L aqueous sodium hydroxide solution, and the mixture was then filtered under reduced pressure through a microfilter having an average pore size of 0.20 Deionized water was added to the filtrate to prepare a cyan dye ink 31 (100.00 parts by mass) for ink jet recording.

Regarding the contents of phthalocyanine dyes (solid contents) in the cyan dye ink 31 (100.00 parts by mass) for ink jet recording, the content of A-1-4Fe was 0.31 parts by mass, the content of B-1-8Fe was 1.25 parts by mass, the total content of C-1-8-1Fe and C-1-8-2Fe was 1.88 parts by mass, the content of D-1-4Fe was 1.25 parts by mass, and the content of E-1-1Fe was 0.31 parts by mass. The content of (P-3), which was an additive, was 0.50 parts by mass.

### Example 32

In 200.00 parts by mass of deionized water, 3.10 parts by mass of A-1-4Fe, 12.50 parts by mass of B-1-8Fe, a total of 18.80 parts by mass of C-1-8-1Fe and C-1-8-2Fe, 12.50 parts by mass of D-1-4Fe, 3.10 parts by mass of E-1-1Fe, 1.10 parts by mass of a preservative (PROXEL (registered trademark) XL2(s) manufactured by LONZA), 0.30 parts by mass of a buffering agent (NaHCO3), 0.30 parts by mass of a chelating agent (EDTA-4Na salt), and 5.00 parts by mass of (P-3) were dissolved, and the pH of the resulting solution was adjusted to 8.5 with a pH adjusting agent (10 mol/L aqueous sodium hydroxide solution). The solution was filtered under reduced pressure through a microfilter having an average pore size of 0.20 μm and washed with deionized water to prepare 500.00 parts by mass of a dye concentrated ink (liquid I).

Separately, organic solvents {9.70 parts by mass of glycerin, 3.40 parts by mass of triethylene glycol, 9.90 parts by mass of triethylene glycol monobutyl ether, 2.50 parts by mass of 2-pyrrolidone, 1.30 parts by mass of 1,2-hexane diol, and 0.12 parts by mass of propylene glycol} and 1.00 part by mass of a surfactant (SURFYNOL (registered trademark) 465 manufactured by Nissin Chemical Industry Co., Ltd.) were mixed to prepare an ink composition mother liquid (liquid II-1).

Next, 50.00 parts by mass of the (liquid I) and the whole amount of the (liquid II-1) were mixed at 30° C. to 40° C. and stirred at the same temperature for one hour, and the internal temperature was then decreased to 25° C. by cooling. Subsequently, the pH of the mixture was adjusted to 9.0 with a 10 mol/L aqueous sodium hydroxide solution, and the mixture was then filtered under reduced pressure through a microfilter having an average pore size of 0.20 μm. Deionized water was added to the filtrate to prepare a cyan dye ink 32 (100.00 parts by mass) for ink jet recording.

Regarding the contents of phthalocyanine dyes (solid contents) in the cyan dye ink 32 (100.00 parts by mass) for ink jet recording, the content of A-1-4Fe was 0.31 parts by mass, the content of B-1-8Fe was 1.25 parts by mass, the total content of C-1-8-1Fe and C-1-8-2Fe was 1.88 parts by mass, the content of D-1-4Fe was 1.25 parts by mass, and the content of E-1-1Fe was 0.31 parts by mass. The content of the chelating agent was 0.03 parts by mass. The content of (P-3), which was an additive, was 0.50 parts by mass.

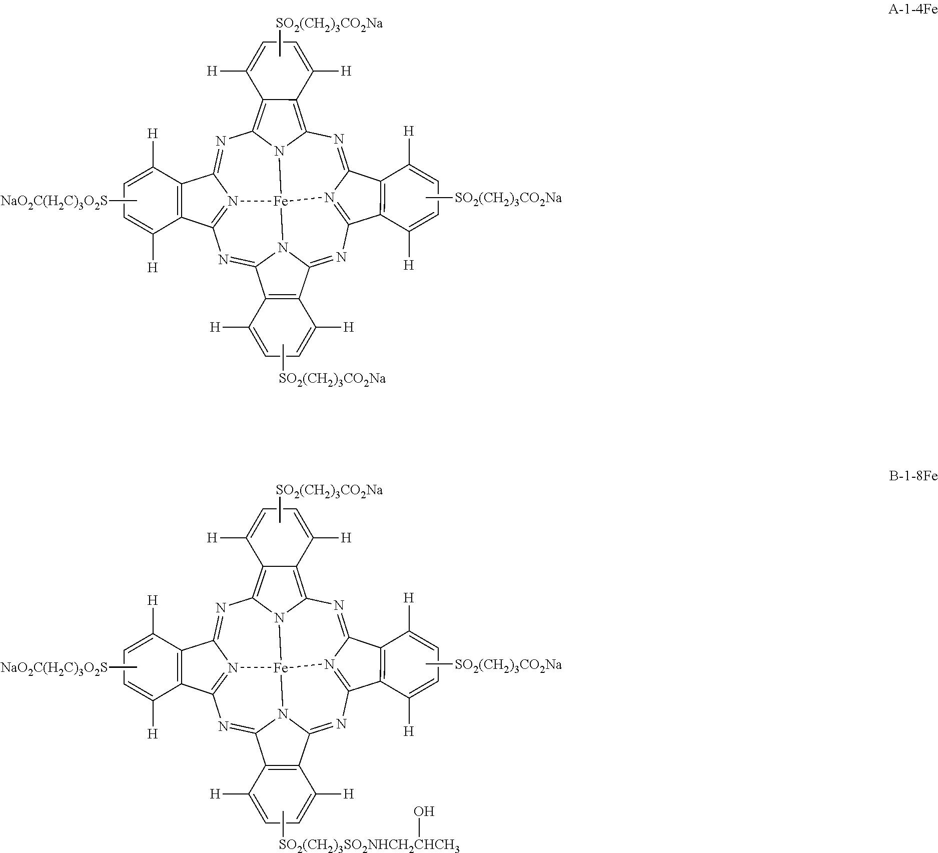

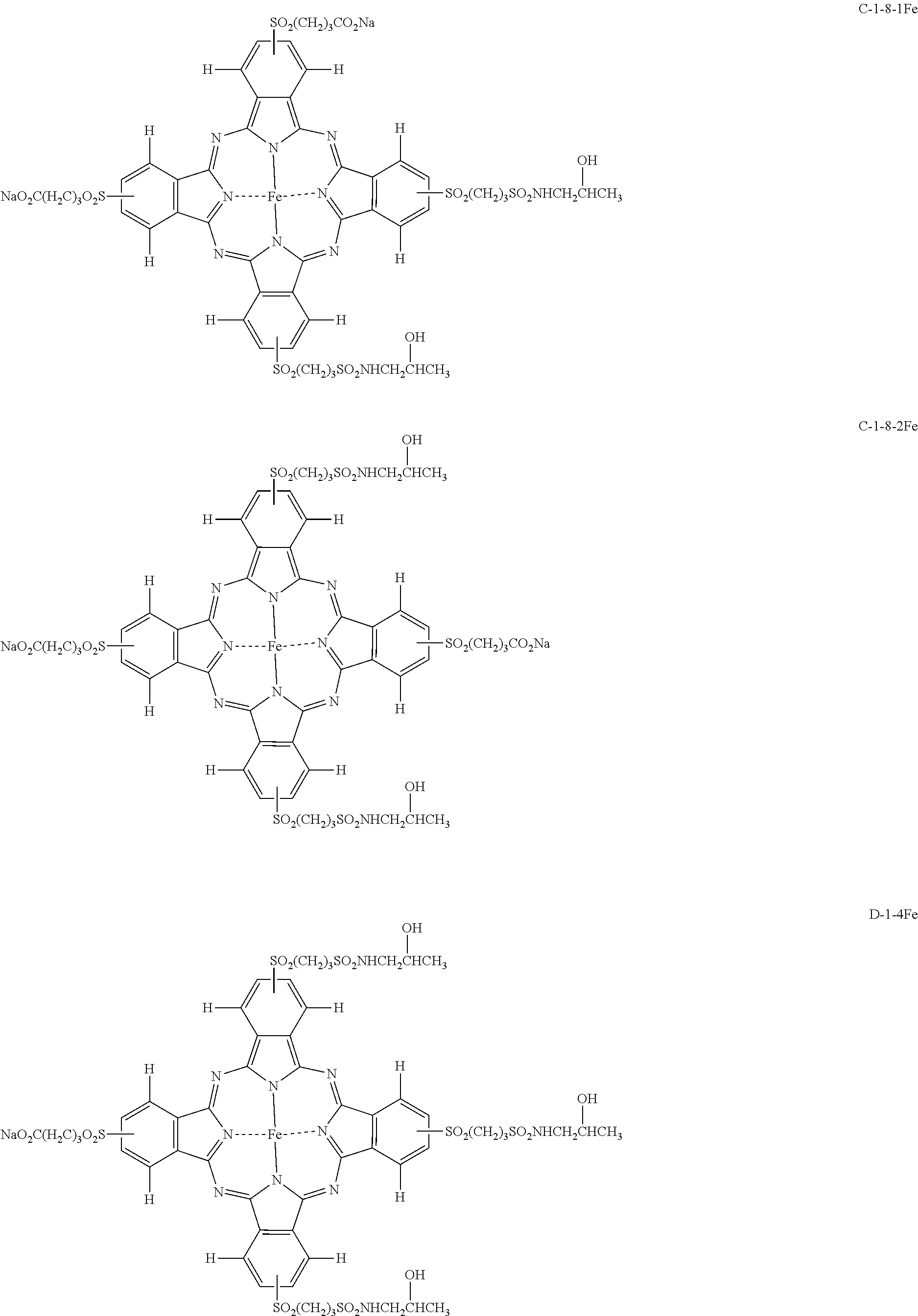

### Examples 33 to 40

Cyan dye inks 33 to 40 (100.00 parts by mass each) for ink jet recording were prepared as in Examples 31 and 32 except that the dye mixture, chelating agent, and additive used were changed so as to obtain cyan dye inks for ink jet recording, the cyan dye inks including the components shown in Tables 7 and 8 below in the corresponding amounts shown in Tables 7 and 8 below. Numerical values in the tables are expressed in parts by mass.

TABLE 7

| | Phthalocyanine dye (solid content) | | | | | | | | Ink |
|---|---|---|---|---|---|---|---|---|---|
| | | | Compound C-I | | | Dye used in | Chelating | | composition |
| | Compound A | Compound B | Compound C-II | Compound D | Compound E | combination | agent | Additive | mother liquid |
| Example 31 | A-1-4Fe | B-1-8Fe | C-1-8-1Fe | D-1-4Fe | E-1-1Fe | No | No | (P-3) | Liquid (II-1) |
| | | | C-1-8-2Fe | | | addition | addition | | |
| | 0.31 | 1.25 | 1.88 | 1.25 | 0.31 | | | 0.50 | |
| Example 32 | A-1-4Fe | B-1-8Fe | C-1-8-1Fe | D-1-4Fe | E-1-1Fe | No | EDTA-4Na | (P-3) | Liquid (II-1) |
| | | | C-1-8-2Fe | | | addition | salt | | |
| | 0.31 | 1.25 | 1.88 | 1.25 | 0.31 | | 0.03 | 0.50 | |
| Example 33 | A-1-4Fe | B-1-8Fe | C-1-8-1Fe | D-1-4Fe | E-1-1Fe | No | EDTA-4Na | (P-3) | Liquid (II-1) |
| | | | C-1-8-2Fe | | | addition | salt | | |
| | 0.31 | 1.25 | 1.88 | 1.25 | 0.31 | | 0.05 | 0.50 | |
| Example 34 | A-1-4Fe | B-1-8Fe | C-1-8-1Fe | D-1-4Fe | E-1-1Fe | No | EDTA-4Na | (P-3) | Liquid (II-1) |
| | | | C-1-8-2Fe | | | addition | salt | | |
| | 0.31 | 1.25 | 1.88 | 1.25 | 0.31 | | 0.10 | 0.50 | |

TABLE 8

| | Phthalocyanine dye (solid content) | | | | | | | | Ink |
|---|---|---|---|---|---|---|---|---|---|
| | | | Compound C-I | | | Dye used in | Chelating | | composition |
| | Compound A | Compound B | Compound C-II | Compound D | Compound E | combination | agent | Additive | mother liquid |
| Example 35 | A-1-4Zn | B-1-8Zn | C-1-8-1Zn | D-1-4Zn | E-1-1Zn | No | EDTA-4Na | No | Liquid (II-1) |
| | | | C-1-8-2Zn | | | addition | salt | addition | |
| | 0.31 | 1.25 | 1.88 | 1.25 | 0.31 | | 0.05 | | |
| Example 36 | A-1-4Zn | B-1-8Zn | C-1-8-1Zn | D-1-4Zn | E-1-1Zn | No | EDTA-4Na | (P-3) | Liquid (II-1) |
| | | | C-1-8-2Zn | | | addition | salt | | |
| | 0.31 | 1.25 | 1.88 | 1.25 | 0.31 | | 0.05 | 0.30 | |
| Example 37 | A-1-4Zn | B-1-8Zn | C-1-8-1Zn | D-1-4Zn | E-1-1Zn | No | EDTA-4Na | (P-3) | Liquid (II-1) |
| | | | C-1-8-2Zn | | | addition | salt | | |
| | 0.31 | 1.25 | 1.88 | 1.25 | 0.31 | | 0.05 | 0.50 | |
| Example 38 | A-1-4Zn | B-1-8Zn | C-1-8-1Zn | D-1-4Zn | E-1-1Zn | No | EDTA-4Na | (P-3) | Liquid (II-1) |
| | | | C-1-8-2Zn | | | addition | salt | | |
| | 0.31 | 1.25 | 1.88 | 1.25 | 0.31 | | 0.05 | 1.00 | |
| Example 39 | A-1-4Zn | B-1-8Zn | C-1-8-1Zn | D-1-4Zn | E-1-1Zn | No | EDTA-4Na | (P-3) | Liquid (II-1) |
| | | | C-1-8-2Zn | | | addition | salt | | |
| | 0.31 | 1.25 | 1.88 | 1.25 | 0.31 | | 0.05 | 1.50 | |
| Example 40 | A-1-4Mg | B-1-8Mg | C-1-8-1Mg | D-1-4Mg | E-1-1Mg | No | EDTA-4Na | (P-3) | Liquid (II-1) |
| | | | C-1-8-2Mg | | | addition | salt | | |
| | 0.31 | 1.25 | 1.88 | 1.25 | 0.31 | | 0.05 | 0.50 | |

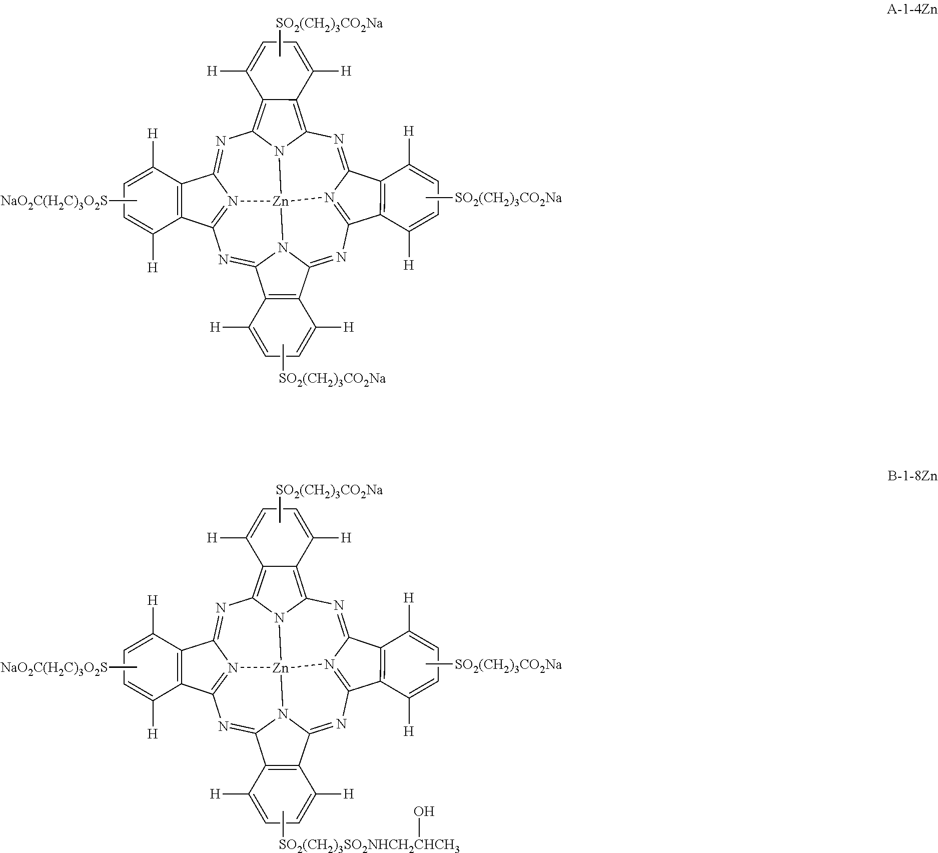

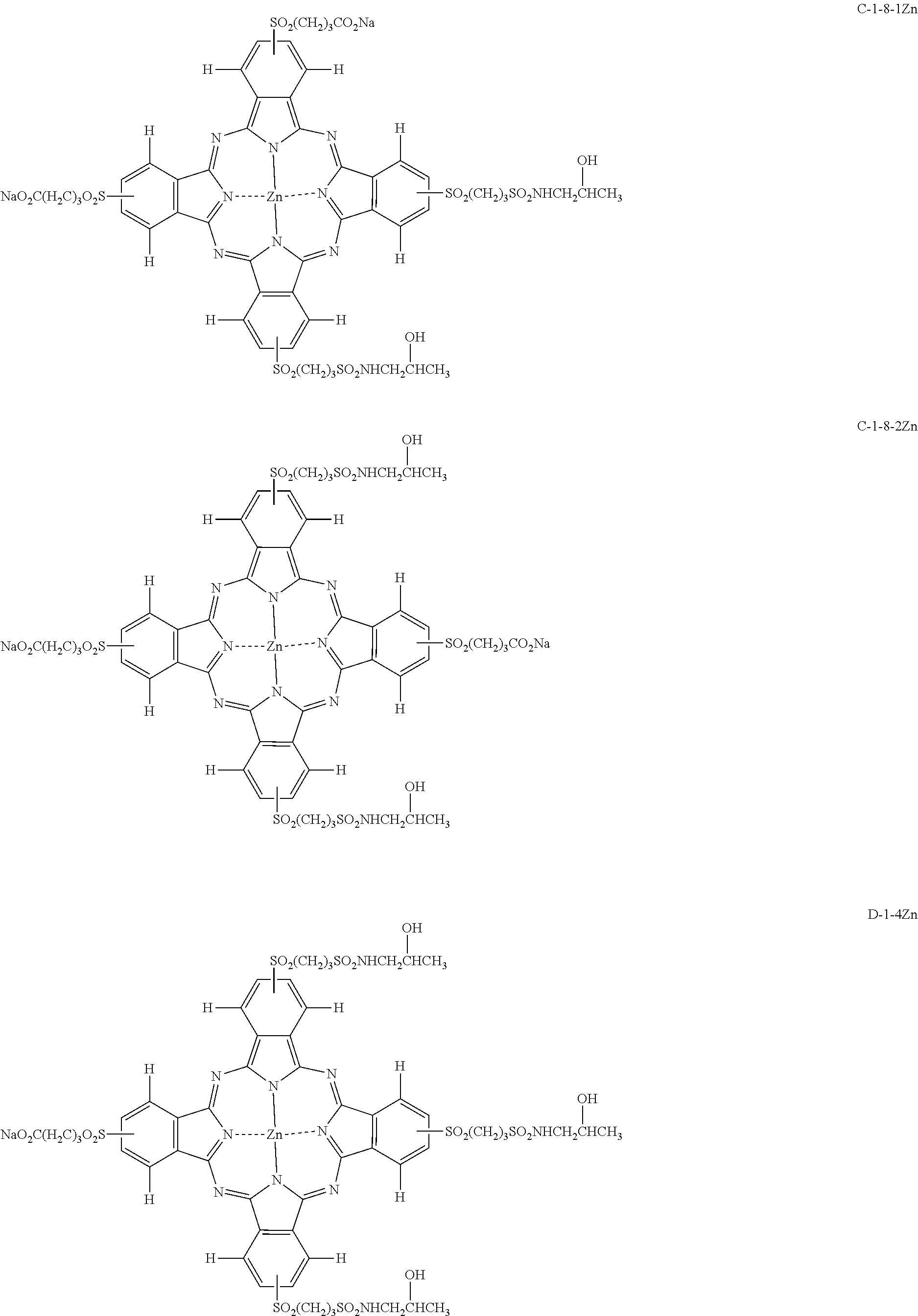

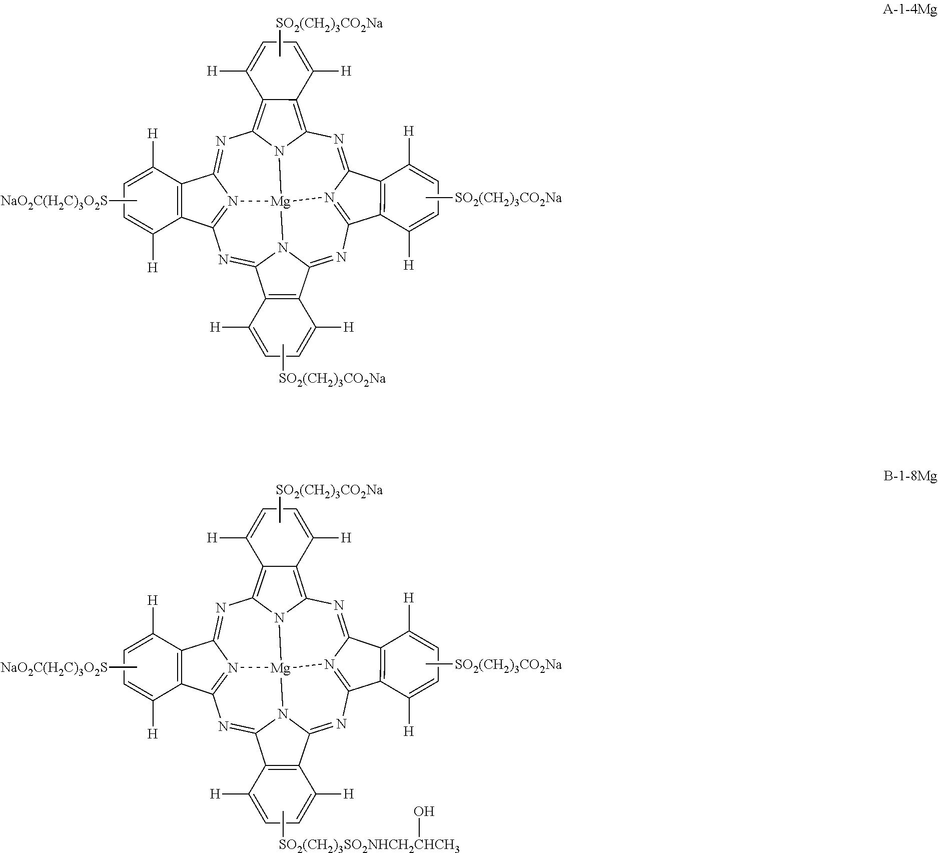

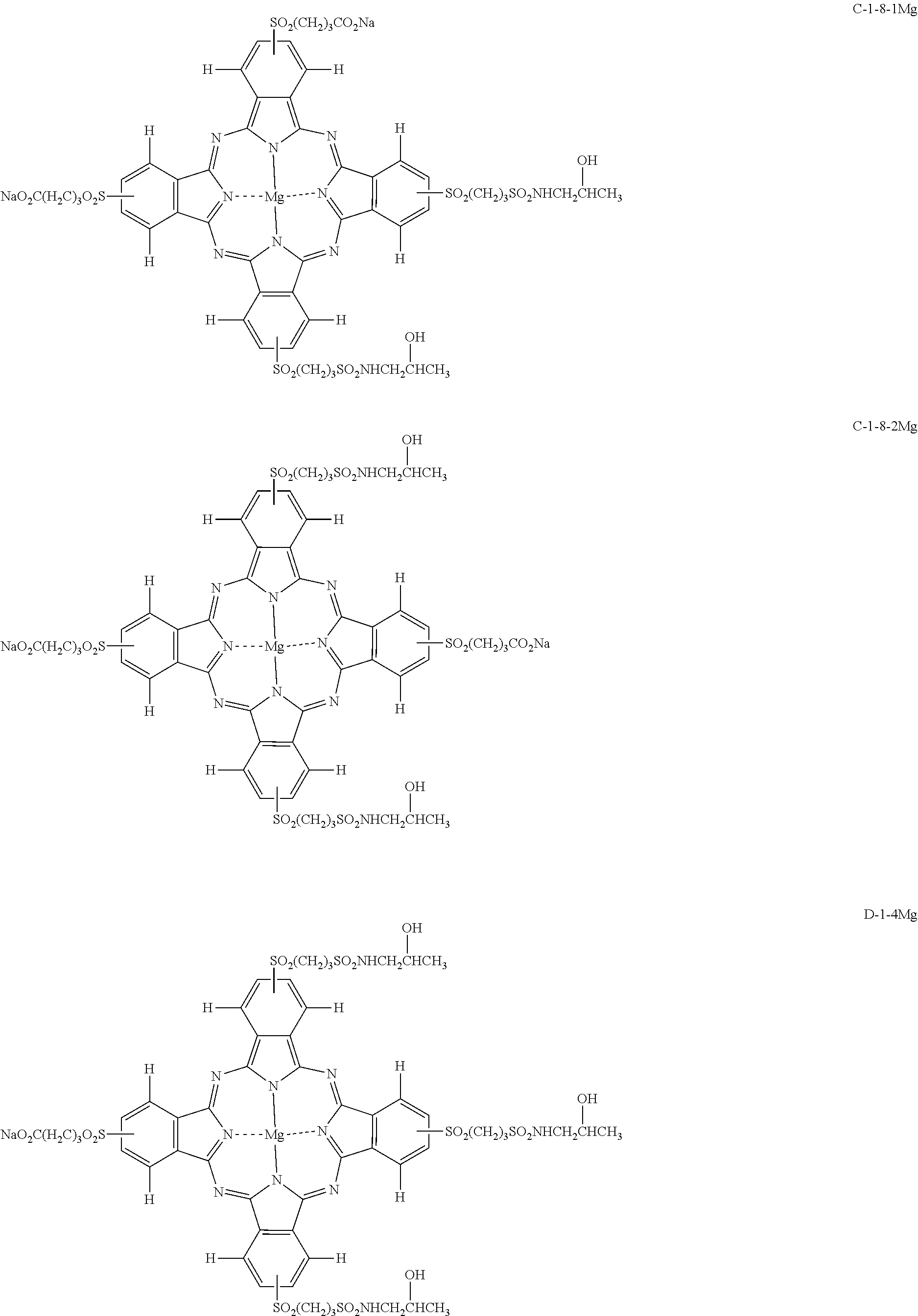

### Example B

### Example 41

### Preparation of Dye Ink Composition 41

In 200.00 parts by mass of deionized water, 15.80 parts by mass of A-1-1Fe, 21.00 parts by mass of B-1-1Fe, a total of 10.60 parts by mass of C-1-1-1Fe and C-1-1-2Fe, 2.40 parts by mass of D-1-1Fe, 0.20 parts by mass of E-1-1Fe, 1.10 parts by mass of a preservative (PROXEL (registered trademark) XL2(s) manufactured by LONZA), and 0.30 parts by mass of a buffering agent (LiHCO₃) were dissolved, and the pH of the resulting solution was adjusted to 8.5 with a pH adjusting agent (10 mol/L aqueous lithium hydroxide solution). The solution was filtered under reduced pressure through a microfilter having an average pore size of 0.20 μm and washed with deionized water to prepare 500.00 parts by mass of a dye concentrated ink (liquid I).

Separately, organic solvents {7.00 parts by mass of glycerin, 7.00 parts by mass of ethylene urea, 7.00 parts by mass of 1,5-pentanediol, and 5.00 parts by mass of 2-pyrrolidone} were mixed to prepare an ink composition mother liquid (liquid II-2).

Next, 50.00 parts by mass of the (liquid I) and the whole amount of the (liquid II-2) were mixed at 30° C. to 40° C. and stirred at the same temperature for one hour, and the internal temperature was then decreased to 25° C. by cooling. Subsequently, the pH of the mixture was adjusted to 9.0 with a 10 mol/L aqueous lithium hydroxide solution, and the mixture was then filtered under reduced pressure through a microfilter having an average pore size of 0.20 μm. Deionized water was added to the filtrate to prepare a cyan dye ink 41 (100.00 parts by mass) for ink jet recording.

Regarding the contents of phthalocyanine dyes (solid contents) in the cyan dye ink 41 (100.00 parts by mass) for ink jet recording, the content of A-1-1Fe was 1.58 parts by mass, the content of B-1-1Fe was 2.10 parts by mass, the total content of C-1-1-1Fe and C-1-1-2Fe was 1.06 parts by mass, the content of D-1-1Fe was 0.24 parts by mass, and the content of E-1-1Fe was 0.02 parts by mass.

### Example 42

### Preparation of Dye Ink Composition 42

In 200.00 parts by mass of deionized water, 3.10 parts by mass of A-1-1Fe, 12.50 parts by mass of B-1-1Fe, a total of 18.80 parts by mass of C-1-1-1Fe and C-1-1-2Fe, 12.50 parts by mass of D-1-1Fe, 3.10 parts by mass of E-1-1Fe, 1.10 parts by mass of a preservative (PROXEL (registered trademark) XL2(s) manufactured by LONZA), and 0.30 parts by mass of a buffering agent (LiHCO₃) were dissolved, and the pH of the resulting solution was adjusted to 8.5 with a pH adjusting agent (10 mol/L aqueous lithium hydroxide solution). The solution was filtered under reduced pressure through a microfilter having an average pore size of 0.20 μm and washed with deionized water to prepare 500.00 parts by mass of a dye concentrated ink (liquid I).

Separately, organic solvents {7.00 parts by mass of glycerin, 7.00 parts by mass of ethylene urea, 7.00 parts by mass of 1,5-pentanediol, and 5.00 parts by mass of 2-pyrrolidone} were mixed to prepare an ink composition mother liquid (liquid II-2).

Next, 50.00 parts by mass of the (liquid I) and the whole amount of the (liquid II-2) were mixed at 30° C. to 40° C. and stirred at the same temperature for one hour, and the internal temperature was then decreased to 25° C. by cooling. Subsequently, the pH of the mixture was adjusted to 9.0 with a 10 mol/L aqueous lithium hydroxide solution, and the mixture was then filtered under reduced pressure through a microfilter having an average pore size of 0.20 μm. Deionized water was added to the filtrate to prepare a cyan dye ink 42 (100.00 parts by mass) for ink jet recording.

Regarding the contents of phthalocyanine dyes (solid contents) in the cyan dye ink 42 (100.00 parts by mass) for ink jet recording, the content of A-1-1Fe was 0.31 parts by mass, the content of B-1-1Fe was 1.25 parts by mass, the total content of C-1-1-1Fe and C-1-1-2Fe was 1.88 parts by mass, the content of D-1-1Fe was 1.25 parts by mass, and the content of E-1-1Fe was 0.31 parts by mass.

### Examples 43 to 50

Cyan dye inks 43 to 50 (100.00 parts by mass each) for ink jet recording were prepared as in Examples 41 and 42 except that the dye mixture, chelating agent, and additive used were changed so as to obtain cyan dye inks for ink jet recording, the cyan dye inks including the components shown in Tables 9 and 10 below in the corresponding amounts shown in Tables 9 and 10 below. Numerical values in the tables are expressed in parts by mass.

TABLE 9

| | Phthalocyanine dye (solid content) | | | | | | | | Ink |
|---|---|---|---|---|---|---|---|---|---|
| | | | Compound C-I | | | Dye used in | Chelating | | composition |
| | Compound A | Compound B | Compound C-II | Compound D | Compound E | combination | agent | Additive | mother liquid |
| Example 41 | A-1-1Fe | B-1-1Fe | C-1-1-1Fe | D-1-1Fe | E-1-1Fe | No | No | No | Liquid (II-2) |
| | | | C-1-1-2Fe | | | addition | addition | addition | |
| | 1.58 | 2.10 | 1.06 | 0.24 | 0.02 | | | | |
| Example 42 | A-1-1Fe | B-1-1Fe | C-1-1-1Fe | D-1-1Fe | E-1-1Fe | No | No | No | Liquid (II-2) |
| | | | C-1-1-2Fe | | | addition | addition | addition | |
| | 0.31 | 1.25 | 1.88 | 1.25 | 0.31 | | | | |
| Example 43 | A-1-1Fe | B-1-1Fe | C-1-1-1Fe | D-1-1Fe | E-1-1Fe | No | EDTA-4Li | No | Liquid (II-2) |
| | | | C-1-1-2Fe | | | addition | salt | addition | |
| | 1.58 | 2.10 | 1.06 | 0.24 | 0.02 | | 0.05 | | |
| Example 44 | A-1-1Fe | B-1-1Fe | C-1-1-1Fe | D-1-1Fe | E-1-1Fe | No | EDTA-4Li | (P-4) | Liquid (II-2) |
| | | | C-1-1-2Fe | | | addition | salt | | |
| | 0.31 | 1.25 | 1.88 | 1.25 | 0.31 | | 0.05 | 0.50 | |

TABLE 10

| | Phthalocyanine dye (solid content) | | | | | | | | Ink |
|---|---|---|---|---|---|---|---|---|---|
| | | | Compound C-I | | | Dye used in | Chelating | | composition |
| | Compound A | Compound B | Compound C-II | Compound D | Compound E | combination | agent | Additive | mother liquid |
| Example 45 | A-1-1Zn | B-1-1Zn | C-1-1-1Zn | D-1-1Zn | E-1-1Zn | No | No | No | Liquid (II-2) |
| | | | C-1-1-2Zn | | | addition | addition | addition | |
| | 1.58 | 2.10 | 1.06 | 0.24 | 0.02 | | | | |
| Example 46 | A-1-1Zn | B-1-1Zn | C-1-1-1Zn | D-1-1Zn | E-1-1Zn | No | No | No | Liquid (II-2) |
| | | | C-1-1-2Zn | | | addition | addition | addition | |
| | 0.31 | 1.25 | 1.88 | 1.25 | 0.31 | | | | |
| Example 47 | A-1-1Zn | B-1-1Zn | C-1-1-1Zn | D-1-1Zn | E-1-1Zn | No | EDTA-4Li | No | Liquid (II-2) |
| | | | C-1-1-2Zn | | | addition | salt | addition | |
| | 1.58 | 2.10 | 1.06 | 0.24 | 0.02 | | 0.05 | | |
| Example 48 | A-1-1Zn | B-1-1Zn | C-1-1-1Zn | D-1-1Zn | E-1-1Zn | No | EDTA-4Li | (P-4) | Liquid (II-2) |
| | | | C-1-1-2Zn | | | addition | salt | | |
| | 0.31 | 1.25 | 1.88 | 1.25 | 0.31 | | 0.05 | 0.50 | |
| Example 49 | A-1-1Mg | B-1-1Mg | C-1-1-1Mg | D-1-1Mg | E-1-1Mg | No | EDTA-4Li | No | Liquid (II-2) |
| | | | C-1-1-2Mg | | | addition | salt | addition | |
| | 1.58 | 2.10 | 1.06 | 0.24 | 0.02 | | 0.05 | | |
| Example 50 | A-1-1Mg | B-1-1Mg | C-1-1-1Mg | D-1-1Mg | E-1-1Mg | No | EDTA-4Li | (P-4) | Liquid (II-2) |
| | | | C-1-1-2Mg | | | addition | salt | | |
| | 0.31 | 1.25 | 1.88 | 1.25 | 0.31 | | 0.05 | 0.50 | |

### Comparative Example 1

In 200.00 parts by mass of deionized water, 14.30 parts by mass of B-1-1Fe, a total of 21.40 parts by mass of C-1-1-1Fe and C-1-1-2Fe, 14.30 parts by mass of D-1-1Fe, 1.10 parts by mass of a preservative (PROXEL (registered trademark) XL2(s) manufactured by LONZA), and 0.30 parts by mass of a buffering agent (LiHCO₃) were dissolved, and the pH of the resulting solution was adjusted to 8.5 with a pH adjusting agent (10 mol/L aqueous lithium hydroxide solution). The solution was filtered under reduced pressure through a microfilter having an average pore size of 0.20 μm and washed with deionized water to prepare 500.00 parts by mass of a dye concentrated ink (liquid I).

Separately, organic solvents {9.70 parts by mass of glycerin, 3.40 parts by mass of triethylene glycol, 9.90 parts by mass of triethylene glycol monobutyl ether, 2.50 parts by mass of 2-pyrrolidone, 1.30 parts by mass of 1,2-hexane diol, and 0.12 parts by mass of propylene glycol} and 1.00 part by mass of a surfactant (SURFYNOL (registered trademark) 465 manufactured by Nissin Chemical Industry Co., Ltd.) were mixed to prepare an ink composition mother liquid (liquid II-3).

Next, 50.00 parts by mass of the (liquid I) and the whole amount of the (liquid II-3) were mixed at 30° C. to 40° C. and stirred at the same temperature for one hour, and the internal temperature was then decreased to 25° C. by cooling. Subsequently, the pH of the mixture was adjusted to 9.0 with a 10 mol/L aqueous lithium hydroxide solution, and the mixture was then filtered under reduced pressure through a microfilter having an average pore size of 0.20 μm. Deionized water was added to the filtrate to prepare a cyan dye comparative ink 1 (100.00 parts by mass) for ink jet recording.

### Comparative Example 2

In 200.00 parts by mass of deionized water, 12.50 parts by mass of B-1-1Fe, a total of 18.80 parts by mass of C-1-1-1Fe and C-1-1-2Fe, 12.50 parts by mass of D-1-1Fe, 3.10 parts by mass of E-1-1Fe, 3.10 parts by mass of Q-1, 1.10 parts by mass of a preservative (PROXEL (registered trademark) XL2(s) manufactured by LONZA), and 0.30 parts by mass of a buffering agent (LiHCO₃) were dissolved, and the pH of the resulting solution was adjusted to 8.5 with a pH adjusting agent (10 mol/L aqueous lithium hydroxide solution). The solution was filtered under reduced pressure through a microfilter having an average pore size of 0.20 μm and washed with deionized water to prepare 500.00 parts by mass of a dye concentrated ink (liquid I).

Separately, organic solvents {9.70 parts by mass of glycerin, 3.40 parts by mass of triethylene glycol, 9.90 parts by mass of triethylene glycol monobutyl ether, 2.50 parts by mass of 2-pyrrolidone, 1.30 parts by mass of 1,2-hexane diol, and 0.12 parts by mass of propylene glycol} and 1.00 part by mass of a surfactant (SURFYNOL (registered trademark) 465 manufactured by Nissin Chemical Industry Co., Ltd.) were mixed to prepare an ink composition mother liquid (liquid II-3).

Next, 50.00 parts by mass of the (liquid I) and the whole amount of the (liquid II-3) were mixed at 30° C. to 40° C. and stirred at the same temperature for one hour, and the internal temperature was then decreased to 25° C. by cooling. Subsequently, the pH of the mixture was adjusted to 9.0 with a 10 mol/L aqueous lithium hydroxide solution, and the mixture was then filtered under reduced pressure through a microfilter having an average pore size of 0.20 μm. Deionized water was added to the filtrate to prepare a cyan dye comparative ink 2 (100.00 parts by mass) for ink jet recording.

### Comparative Examples 3 to 5

Cyan dye comparative inks 3 to 5 (100.00 parts by mass each) for ink jet recording were prepared as in Comparative Examples 1 and 2 except that the dye mixture used and the dye used in combination were changed so as to obtain cyan dye comparative inks for ink jet recording, the cyan dye comparative inks including the components shown in Table 11 below in the corresponding amounts shown in Table 11 below. Numerical values in the table are expressed in parts by mass.

### Comparative Example 6

In 200.00 parts by mass of deionized water, 14.30 parts by mass of B-1-1Fe, a total of 21.40 parts by mass of C-1-1-1Fe and C-1-1-2Fe, 14.30 parts by mass of D-1-1Fe, 1.10 parts by mass of a preservative (PROXEL (registered trademark) XL2(s) manufactured by LONZA), and 0.30 parts by mass of a buffering agent (LiHCO₃) were dissolved, and the pH of the resulting solution was adjusted to 8.5 with a pH adjusting agent (10 mol/L aqueous lithium hydroxide solution). The solution was filtered under reduced pressure through a microfilter having an average pore size of 0.20 μm and washed with deionized water to prepare 500.00 parts by mass of a dye concentrated ink (liquid I).

Separately, organic solvents {7.00 parts by mass of glycerin, 7.00 parts by mass of ethylene urea, 7.00 parts by mass of 1,5-pentanediol, and 5.00 parts by mass of 2-pyrrolidone} were mixed to prepare an ink composition mother liquid (liquid II-4).

Next, 50.00 parts by mass of the (liquid I) and the whole amount of the (liquid II-4) were mixed at 30° C. to 40° C. and stirred at the same temperature for one hour, and the internal temperature was then decreased to 25° C. by cooling. Subsequently, the pH of the mixture was adjusted to 9.0 with a 10 mol/L aqueous lithium hydroxide solution, and the mixture was then filtered under reduced pressure through a microfilter having an average pore size of 0.20 μm. Deionized water was added to the filtrate to prepare a cyan dye comparative ink 6 (100.00 parts by mass) for ink jet recording.

### Comparative Example 7

In 200.00 parts by mass of deionized water, 12.50 parts by mass of B-1-1Fe, a total of 18.80 parts by mass of C-1-1-1Fe and C-1-1-2Fe, 12.50 parts by mass of D-1-1Fe, 3.10 parts by mass of E-1-1Fe, 3.10 parts by mass of Q-1, 1.10 parts by mass of a preservative (PROXEL (registered trademark) XL2(s) manufactured by LONZA), and 0.30 parts by mass of a buffering agent (LiHCO₃) were dissolved, and the pH of the resulting solution was adjusted to 8.5 with a pH adjusting agent (10 mol/L aqueous lithium hydroxide solution). The solution was filtered under reduced pressure through a microfilter having an average pore size of 0.20 μm and washed with deionized water to prepare 500.00 parts by mass of a dye concentrated ink (liquid I).

Separately, organic solvents {7.00 parts by mass of glycerin, 7.00 parts by mass of ethylene urea, 7.00 parts by mass of 1,5-pentanediol, and 5.00 parts by mass of 2-pyrrolidone} were mixed to prepare an ink composition mother liquid (liquid II-4).

Next, 50.00 parts by mass of the (liquid I) and the whole amount of the (liquid II-4) were mixed at 30° C. to 40° C. and stirred at the same temperature for one hour, and the internal temperature was then decreased to 25° C. by cooling. Subsequently, the pH of the mixture was adjusted to 9.0 with a 10 mol/L aqueous lithium hydroxide solution, and the mixture was then filtered under reduced pressure through a microfilter having an average pore size of 0.20 μm. Deionized water was added to the filtrate to prepare a cyan dye comparative ink 7 (100.00 parts by mass) for ink jet recording.

### Comparative Examples 8 to 10

Cyan dye comparative inks 8 to 10 (100.00 parts by mass each) for ink jet recording were prepared as in Comparative Examples 6 and 7 except that the dye mixture used and the dye used in combination were changed so as to obtain cyan dye comparative inks for ink jet recording, the cyan dye comparative inks including the components shown in Table 12 below in the corresponding amounts shown in Table 12 below. Numerical values in the table are expressed in parts by mass.

TABLE 11

| | Phthalocyanine dye (solid content) | | | | | | | | Ink |
|---|---|---|---|---|---|---|---|---|---|
| | | | Compound C-I | | | Dye used in | Chelating | | composition |
| | Compound A | Compound B | Compound C-II | Compound D | Compound E | combination | agent | Additive | mother liquid |
| Comparative | — | B-1-1Fe | C-1-1-1Fe | D-1-1Fe | — | No | No | No | Liquid (II-3) |
| Example 1 | | | C-1-1-2Fe | | | addition | addition | addition | |
| | 0.00 | 1.43 | 2.14 | 1.43 | 0.00 | | | | |
| Comparative | — | B-1-1Fe | C-1-1-1Fe | D-1-1Fe | E-1-1Fe | Q-1 | No | No | Liquid (II-3) |
| Example 2 | | | C-1-1-2Fe | | | | addition | addition | |
| | 0.00 | 1.25 | 1.88 | 1.25 | 0.31 | 0.31 | | | |
| Comparative | — | B-1-1Zn | C-1-1-1Zn | D-1-1Zn | — | No | No | No | Liquid (II-3) |
| Example 3 | | | C-1-1-2Zn | | | addition | addition | addition | |
| | 0.00 | 1.43 | 2.14 | 1.43 | 0.00 | | | | |
| Comparative | — | B-1-1Zn | C-1-1-1Zn | D-1-1Zn | E-1-1Zn | Q-1 | No | No | Liquid (II-3) |
| Example 4 | | | C-1-1-2Zn | | | | addition | addition | |
| | 0.00 | 1.25 | 1.88 | 1.25 | 0.31 | 0.31 | | | |
| Comparative | — | B-1-1Cu | C-1-1-1Cu | D-1-1Cu | — | No | No | No | Liquid (II-3) |
| Example 5 | | | C-1-1-2Cu | | | addition | addition | addition | |
| | 0.00 | 1.43 | 2.14 | 1.43 | 0.00 | | | | |

TABLE 12

| | Phthalocyanine dye (solid content) | | | | | | | | Ink |
|---|---|---|---|---|---|---|---|---|---|
| | | | Compound C-I | | | Dye used in | Chelating | | composition |
| | Compound A | Compound B | Compound C-II | Compound D | Compound E | combination | agent | Additive | mother liquid |
| Comparative | — | B-1-1Fe | C-1-1-1Fe | D-1-1Fe | — | No | No | No | Liquid (II-4) |
| Example 6 | | | C-1-1-2Fe | | | addition | addition | addition | |
| | 0.00 | 1.43 | 2.14 | 1.43 | 0.00 | | | | |
| Comparative | — | B-1-1Fe | C-1-1-1Fe | D-1-1Fe | E-1-1Fe | Q-1 | No | No | Liquid (II-4) |
| Example 7 | | | C-1-1-2Fe | | | | addition | addition | |
| | 0.00 | 1.25 | 1.88 | 1.25 | 0.31 | 0.31 | | | |
| Comparative | — | B-1-1Zn | C-1-1-1Zn | D-1-1Zn | — | No | No | No | Liquid (II-4) |
| Example 8 | | | C-1-1-2Zn | | | addition | addition | addition | |
| | 0.00 | 1.43 | 2.14 | 1.43 | 0.00 | | | | |
| Comparative | — | B-1-1Zn | C-1-1-1Zn | D-1-1Zn | E-1-1Zn | Q-1 | No | No | Liquid (II-4) |
| Example 9 | | | C-1-1-2Zn | | | | addition | addition | |
| | 0.00 | 1.25 | 1.88 | 1.25 | 0.31 | 0.31 | | | |
| Comparative | — | B-1-1Cu | C-1-1-1Cu | D-1-1Cu | — | No | No | No | Liquid (II-4) |
| Example 10 | | | C-1-1-2Cu | | | addition | addition | addition | |
| | 0.00 | 1.43 | 2.14 | 1.43 | 0.00 | | | | |

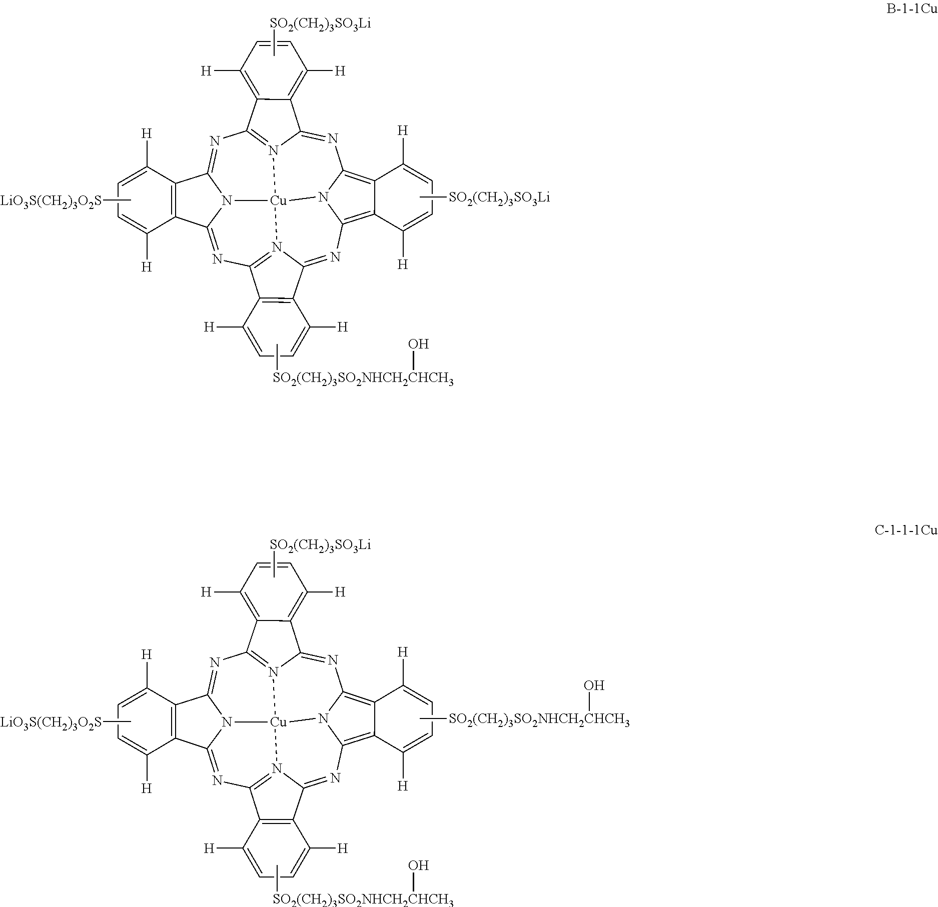

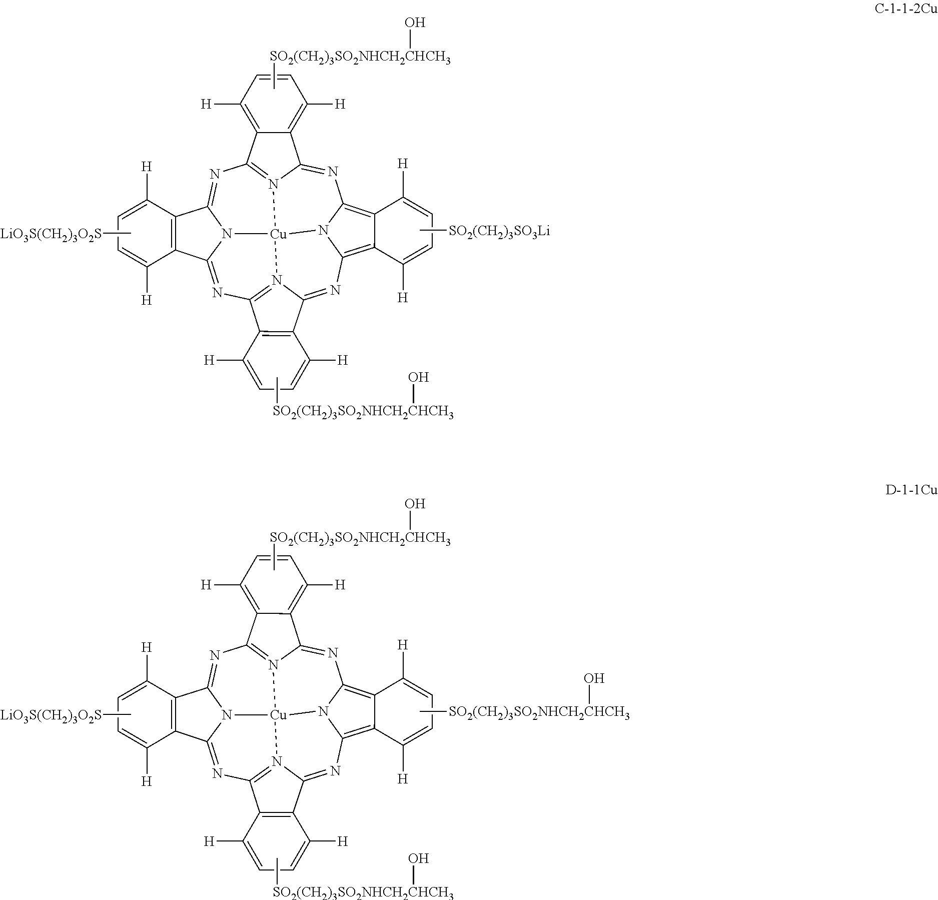

### Comparative Example 11

In 200.00 parts by mass of deionized water, 50.00 parts by mass of Q-1, 1.10 parts by mass of a preservative (PROXEL (registered trademark) XL2(s) manufactured by LONZA), and 0.30 parts by mass of a buffering agent (LiHCO₃) were dissolved, and the pH of the resulting solution was adjusted to 8.5 with a pH adjusting agent (10 mol/L aqueous lithium hydroxide solution). The solution was filtered under reduced pressure through a microfilter having an average pore size of 0.20 μm and washed with deionized water to prepare 500.00 parts by mass of a dye concentrated ink (liquid I).

Separately, organic solvents {9.70 parts by mass of glycerin, 3.40 parts by mass of triethylene glycol, 9.90 parts by mass of triethylene glycol monobutyl ether, 2.50 parts by mass of 2-pyrrolidone, 1.30 parts by mass of 1,2-hexane diol, and 0.12 parts by mass of propylene glycol} and 1.00 part by mass of a surfactant (SURFYNOL (registered trademark) 465 manufactured by Nissin Chemical Industry Co., Ltd.) were mixed to prepare an ink composition mother liquid (liquid II-3).

Next, 50.00 parts by mass of the (liquid 1) and the whole amount of the (liquid II-3) were mixed at 30° C. to 40° C. and stirred at the same temperature for one hour, and the internal temperature was then decreased to 25° C. by cooling. Subsequently, the pH of the mixture was adjusted to 9.0 with a 10 mol/L aqueous lithium hydroxide solution, and the mixture was then filtered under reduced pressure through a microfilter having an average pore size of 0.20 μm. Deionized water was added to the filtrate to prepare a cyan dye comparative ink 11 (100.00 parts by mass) for ink jet recording.

### Comparative Example 12

In 200.00 parts by mass of deionized water, 50.0 parts by mass of Q-1, 0.50 parts by mass of a chelating agent (EDTA-4Li salt), 1.10 parts by mass of a preservative (PROXEL (registered trademark) XL2(s) manufactured by LONZA), and 0.30 parts by mass of a buffering agent (LiHCO₃) were dissolved, and the pH of the resulting solution was adjusted to 8.5 with a pH adjusting agent (10 mol/L aqueous lithium hydroxide solution). The solution was filtered under reduced pressure through a microfilter having an average pore size of 0.20 μm and washed with deionized water to prepare 500.00 parts by mass of a dye concentrated ink (liquid I).

Separately, organic solvents {9.70 parts by mass of glycerin, 3.40 parts by mass of triethylene glycol, 9.90 parts by mass of triethylene glycol monobutyl ether, 2.50 parts by mass of 2-pyrrolidone, 1.30 parts by mass of 1,2-hexane diol, and 0.12 parts by mass of propylene glycol} and 1.00 part by mass of a surfactant (SURFYNOL (registered trademark) 465 manufactured by Nissin Chemical Industry Co., Ltd.) were mixed to prepare an ink composition mother liquid (liquid II-3).

Next, 50.00 parts by mass of the (liquid I) and the whole amount of the (liquid II-3) were mixed at 30° C. to 40° C. and stirred at the same temperature for one hour, and the internal temperature was then decreased to 25° C. by cooling. Subsequently, the pH of the mixture was adjusted to 9.0 with a 10 mol/L aqueous lithium hydroxide solution, and the mixture was then filtered under reduced pressure through a microfilter having an average pore size of 0.20 μm. Deionized water was added to the filtrate to prepare a cyan dye comparative ink 12 (100.00 parts by mass) for ink jet recording.

### Comparative Examples 13 to 20

Cyan dye comparative inks 13 to 20 (100.00 parts by mass each) for ink jet recording were prepared as in Comparative Examples 11 and 12 except that the cyan dye, chelating agent, and additive used were changed so as to obtain cyan dye comparative inks for ink jet recording, the cyan dye comparative inks including the components shown in Tables 13 and 14 below in the corresponding amounts shown in Tables 13 and 14 below. Numerical values in the tables are expressed in parts by mass.

TABLE 13

| | Phthalocyanine dye (solid content) | | | | | | | | Ink |
|---|---|---|---|---|---|---|---|---|---|
| | | | Compound C-I | | | | Chelating | | composition |
| | Compound A | Compound B | Compound C-II | Compound D | Compound E | Cyan dye | agent | Additive | mother liquid |
| Comparative | — | — | — | — | — | Q-1 | No | No | Liquid (II-3) |
| Example 11 | 0.00 | 0.00 | 0.00 | 0.00 | 0.00 | 5.00 | addition | addition | |
| Comparative | — | — | — | — | — | Q-1 | EDTA-4Li | No | Liquid (II-3) |
| Example 12 | | | | | | | salt | addition | |
| | 0.00 | 0.00 | 0.00 | 0.00 | 0.00 | 5.00 | 0.05 | | |
| Comparative | — | — | — | — | — | Q-1 | EDTA-4Li | (P-4) | Liquid (II-3) |
| Example 13 | | | | | | | salt | | |
| | 0.00 | 0.00 | 0.00 | 0.00 | 0.00 | 5.00 | 0.05 | 0.05 | |
| Comparative | — | — | — | — | — | Q-4 | No | No | Liquid (II-3) |
| Example 14 | 0.00 | 0.00 | 0.00 | 0.00 | 0.00 | 5.00 | addition | addition | |
| Comparative | — | — | — | — | — | Q-4 | EDTA-4Na | No | Liquid (II-3) |
| Example 15 | | | | | | | salt | addition | |
| | 0.00 | 0.00 | 0.00 | 0.00 | 0.00 | 5.00 | 0.05 | | |

TABLE 14

| | Phthalocyanine dye (solid content) | | | | | | | | Ink |
|---|---|---|---|---|---|---|---|---|---|
| | | | Compound C-I | | | | Chelating | | composition |
| | Compound A | Compound B | Compound C-II | Compound D | Compound E | Cyan dye | agent | Additive | mother liquid |
| Comparative | — | — | — | — | — | Q-4 | EDTA-4Na | (P-3) | Liquid (II-4) |
| Example 16 | | | | | | | salt | | |
| | 0.00 | 0.00 | 0.00 | 0.00 | 0.00 | 5.00 | 0.05 | 0.05 | |
| Comparative | — | — | — | — | — | Q-5 | No | No | Liquid (II-4) |
| Example 17 | 0.00 | 0.00 | 0.00 | 0.00 | 0.00 | 5.00 | addition | addition | |
| Comparative | — | — | — | — | — | Q-5 | EDTA-4Li | No | Liquid (II-4) |
| Example 18 | | | | | | | salt | addition | |
| | 0.00 | 0.00 | 0.00 | 0.00 | 0.00 | 5.00 | 0.05 | | |
| Comparative | — | — | — | — | — | Q-5 | EDTA-4Li | (P-4) | Liquid (II-4) |
| Example 19 | | | | | | | salt | | |
| | 0.00 | 0.00 | 0.00 | 0.00 | 0.00 | 5.00 | 0.05 | 0.05 | |
| Comparative | — | — | — | — | — | Q-2 | EDTA-4Na | (P-3) | Liquid (II-4) |
| Example 20 | | | | | | | salt | | |
| | 0.00 | 0.00 | 0.00 | 0.00 | 0.00 | 5.00 | 0.05 | 0.05 | |

### Image Recording and Evaluation

Image recording was performed as follows by using the dye ink compositions prepared above, and evaluation was conducted. In Examples 1 to 40 and Comparative Examples 1 to 5 and 11 to 15, each dye ink composition was used alone as a cyan dye ink (dye ink for ink jet recording) to form a cyan single-color image. The dye ink composition was loaded in an ink cartridge, and images that were recorded on photo paper (ink jet paper) (Photo Paper <Glossy> manufactured by SEIKO EPSON CORPORATION) and plain paper (Xerox P paper: manufactured by Fuji Xerox Co., Ltd.) with an ink jet printer (PM-700C; manufactured by SEIKO EPSON CORPORATION) were used for evaluation.

In Examples 41 to 50 and Comparative Examples 6 to 10 and 16 to 20, each dye ink composition was used alone as a cyan dye ink (dye ink for ink jet recording) to form a cyan single-color image. The dye ink composition was loaded in an ink cartridge, and images that were recorded on ink jet paper (Photo Glossy Paper PT-201; manufactured by Canon Inc.) and plain paper (Xerox P paper: manufactured by Fuji Xerox Co., Ltd.) with an ink jet printer (PIXUS Pro9000 MkII; manufactured by Canon Inc.) were used for evaluation.

### Print Density (Color Developability)

A solid image (an image printed at an applied voltage of 100%) was recorded by using each dye ink composition with the combination of the ink jet printer and the recording paper described above.

The print density of the formed solid image was measured with a reflection densitometer (trade name: X-Rite 310TR, manufactured by X-Rite Inc.), and each cyan single-color image was evaluated using the following four-level rating scale in terms of print density (optical density) determined when a red filter was used. It is desirable that the evaluation below be B or higher for each of the ink jet paper and the plain paper.

### Ink Jet Paper

A: 2.0 or more

B: 1.8 or more and less than 2.0

C: 1.7 or more and less than 1.8

D: less than 1.7

### Plain Paper

A: 0.90 or more

B: 0.85 or more and less than 0.90

C: 0.80 or more and less than 0.85

D: less than 0.80

Tables 15 and 16 below show the results.

TABLE 15

| | Print density | |
|---|---|---|
| | Plain paper | Inkjet paper |
| Example 1 | B | A |
| Example 2 | A | A |
| Example 3 | B | A |
| Example 4 | A | A |
| Example 5 | B | A |
| Example 6 | A | A |
| Example 7 | B | A |
| Example 8 | A | A |
| Example 9 | B | A |
| Example 10 | A | A |
| Example 11 | A | A |
| Example 12 | A | A |
| Example 13 | A | A |
| Example 14 | A | A |
| Example 15 | A | A |
| Example 16 | A | A |
| Example 17 | A | A |
| Example 18 | A | A |
| Example 19 | A | A |
| Example 20 | A | A |
| Example 21 | A | A |
| Example 22 | A | A |
| Example 23 | B | A |
| Example 24 | B | A |
| Example 25 | B | A |
| Example 26 | A | A |
| Example 27 | A | A |
| Example 28 | B | A |
| Example 29 | B | A |
| Example 30 | B | A |
| Example 31 | A | A |
| Example 32 | A | A |
| Example 33 | A | A |
| Example 34 | A | A |
| Example 35 | A | A |
| Example 36 | A | A |
| Example 37 | A | A |
| Example 38 | A | A |
| Example 39 | A | A |
| Example 40 | A | A |

TABLE 16

| | Print density | |
|---|---|---|
| | Plain paper | Inkjet paper |
| Example 41 | B | A |
| Example 42 | A | A |
| Example 43 | B | A |
| Example 44 | A | A |
| Example 45 | B | A |
| Example 46 | A | A |
| Example 47 | B | A |
| Example 48 | A | A |
| Example 49 | B | A |
| Example 50 | A | A |
| Comparative Example 1 | D | A |
| Comparative Example 2 | C | A |
| Comparative Example 3 | D | A |
| Comparative Example 4 | C | A |
| Comparative Example 5 | D | A |
| Comparative Example 6 | D | A |
| Comparative Example 7 | C | A |
| Comparative Example 8 | D | A |
| Comparative Example 9 | C | A |
| Comparative Example 10 | D | A |
| Comparative Example 11 | D | D |
| Comparative Example 12 | D | D |
| Comparative Example 13 | D | D |
| Comparative Example 14 | D | D |
| Comparative Example 15 | D | D |
| Comparative Example 16 | D | D |
| Comparative Example 17 | D | D |
| Comparative Example 18 | D | D |
| Comparative Example 19 | D | D |
| Comparative Example 20 | D | D |

The above results show that the dye ink compositions of Examples 1 to 50 can form an image having higher print density than the dye ink compositions of Comparative Examples 1 to 20 in both cases of the ink jet paper and the plain paper.

### Continuous Ejection Stability

In Examples 1 to 40 and Comparative Examples 1 to 5 and 11 to 15, each dye ink composition was loaded as a cyan dye ink (dye ink for ink jet recording) in an ink cartridge for an ink jet printer (PM-700C; manufactured by SEIKO EPSON CORPORATION), the cartridge was installed in the ink jet printer, and ejection of the ink from all nozzles was confirmed. Subsequently, an image was output on 100 sheets with A4 size (ink jet paper: Photo Paper <Glossy> manufactured by SEIKO EPSON CORPORATION), and evaluation was conducted in accordance with the criteria below.

In Examples 41 to 50 and Comparative Examples 6 to 10 and 16 to 20, each dye ink composition was loaded as a cyan dye ink (dye ink for ink jet recording) in an ink cartridge for an ink jet printer (PIXUS Pro9000 MkII; manufactured by Canon Inc.), the cartridge was installed in the ink jet printer, and ejection of the ink from all nozzles was confirmed. Subsequently, an image was output on 100 sheets with A4 size (ink jet paper: Photo Glossy Paper PT-201; manufactured by Canon Inc.), and evaluation was conducted in accordance with the following criteria.

A: No print irregularity occurs from start to end of printing.

B: Output with print irregularity occurs on 1 sheet or more and less than 3 sheets.

C: Output with print irregularity occurs on 3 sheets or more and less than 10 sheets.

D: Output with print irregularity occurs on 10 sheets or more and less than 15 sheets.

E: Output with print irregularity occurs on 15 sheets or more.

In Tables 17 and 18 below, the results obtained in the cases where a dye ink composition immediately after the preparation was used are shown in the column of “Immediately after preparation of ink”. The evaluation of the continuous ejection stability is desirably B or higher, and more desirably A.

### Storage Stability

With regard to each of the dye ink compositions (dye inks for ink jet recording), the evaluation of storage stability of the ink was performed after, as a forced test, the ink was preserved at 60° C. and a relative humidity of 50% for 4 weeks, and after the ink was preserved at 60° C. and a relative humidity of 50% for 10 weeks.

The storage stability was evaluated using the following three-level rating scale. When a dye ink composition maintained substantially the same performance as that immediately after the preparation of the ink, the dye ink composition was rated as A. When the performance was degraded in at least one of the above-described evaluation items (the print densities or the continuous ejection stability) after the forced test (that is, when the rating was decreased by one or more levels), the dye ink composition was rated as B. When the performance was degraded in at least two of the evaluation items (that is, when the rating was decreased by two or more levels), the dye ink composition was rated as C.

It is desirable that the evaluation of the storage stability be A after the preservation at 60° C. and a relative humidity of 50% for 4 weeks, and it is more desirable that the evaluation of the storage stability be A after the preservation at 60° C. and a relative humidity of 50% for 10 weeks.

Tables 17 and 18 below show the results.

TABLE 17

| | Ejection stability | Storage stability | |
|---|---|---|---|
| | Immediately after | After 4-week | After 10-week |
| | preparation of ink | forced test | forced test |
| Example 1 | A | B | B |
| Example 2 | A | A | B |
| Example 3 | A | B | B |
| Example 4 | A | A | B |
| Example 5 | A | B | B |
| Example 6 | A | A | B |
| Example 7 | A | B | B |
| Example 8 | A | A | B |
| Example 9 | A | B | B |
| Example 10 | A | A | B |
| Example 11 | A | A | B |
| Example 12 | A | A | B |
| Example 13 | A | A | A |
| Example 14 | A | A | A |
| Example 15 | A | A | B |
| Example 16 | A | A | B |
| Example 17 | A | A | A |
| Example 18 | A | A | A |
| Example 19 | A | A | B |
| Example 20 | A | A | A |
| Example 21 | A | A | B |
| Example 22 | A | A | B |
| Example 23 | A | B | B |
| Example 24 | A | B | B |
| Example 25 | A | A | B |
| Example 26 | A | A | B |
| Example 27 | A | A | B |
| Example 28 | A | B | B |
| Example 29 | A | B | B |
| Example 30 | A | A | B |
| Example 31 | A | A | A |
| Example 32 | A | A | A |
| Example 33 | A | A | A |
| Example 34 | A | A | A |
| Example 35 | A | B | B |
| Example 36 | A | B | B |
| Example 37 | A | A | A |
| Example 38 | A | A | A |
| Example 39 | A | A | A |
| Example 40 | A | A | A |

TABLE 18

| | Ejection stability | Storage stability | |
|---|---|---|---|
| | Immediately after | After 4-week | After 10-week |
| | preparation of ink | forced test | forced test |
| Example 41 | A | B | B |
| Example 42 | A | A | B |
| Example 43 | A | A | B |
| Example 44 | A | A | A |
| Example 45 | A | B | B |
| Example 46 | A | A | B |
| Example 47 | A | A | B |
| Example 48 | A | A | A |
| Example 49 | A | A | B |
| Example 50 | A | A | A |
| Comparative Example 1 | D | C | C |
| Comparative Example 2 | C | C | C |
| Comparative Example 3 | D | C | C |
| Comparative Example 4 | C | C | C |
| Comparative Example 5 | D | C | C |
| Comparative Example 6 | D | C | C |
| Comparative Example 7 | C | C | C |
| Comparative Example 8 | D | C | C |
| Comparative Example 9 | C | C | C |
| Comparative Example 10 | D | C | C |
| Comparative Example 11 | A | B | B |
| Comparative Example 12 | A | A | B |
| Comparative Example 13 | A | A | A |
| Comparative Example 14 | A | B | B |
| Comparative Example 15 | A | A | B |
| Comparative Example 16 | A | A | A |
| Comparative Example 17 | A | B | B |
| Comparative Example 18 | A | A | B |
| Comparative Example 19 | A | A | A |
| Comparative Example 20 | A | A | A |

### Example C

### Example 51

### Preparation of Aqueous Dye Solution 51

In 200.00 parts by mass of deionized water, 31.6 parts by mass of A-2-1, 42.0 parts by mass of B-2-1, a total of 21.2 parts by mass of C-2-1-1 and C-2-1-2, 4.80 parts by mass of D-2-1, 0.40 parts by mass of E-2-1, 2.20 parts by mass of a preservative (PROXEL (registered trademark) XL2(s) manufactured by LONZA), and 0.60 parts by mass of a buffering agent (LiHCO₃) were dissolved, and the pH of the resulting solution was adjusted to 8.5 with a pH adjusting agent (10 mol/L aqueous lithium hydroxide solution). The solution was filtered under reduced pressure through a microfilter having an average pore size of 0.20 μm and washed with deionized water to prepare an aqueous dye solution 51 (1,000 parts by mass).

### Examples 52 to 60

Aqueous dye solutions 52 to 60 (1,000 parts by mass each) were prepared as in Example 51 except that mixtures including components shown in Table 19 below in the corresponding amounts shown in Table 19 below were used. The preservative is the same as that in Example 51.

### Examples 61 to 69

Aqueous dye solutions 61 to 69 (1,000 parts by mass each) were prepared as in Example 51 except that mixtures including components shown in Table 20 below in the corresponding amounts shown in Table 20 below were used and a 10 mol/L aqueous sodium hydroxide solution was used instead of the 10 mol/L aqueous lithium hydroxide solution. The preservative is the same as that in Example 51.

### Example 70

### Preparation of Aqueous Dye Solution 70

In 200.00 parts by mass of deionized water, 31.6 parts by mass of A-2-1, 42.0 parts by mass of B-2-1, a total of 21.2 parts by mass of C-2-1-1 and C-2-1-2, 4.80 parts by mass of D-2-1, 0.40 parts by mass of E-2-1, 0.36 parts by mass of the compound (s)-1, 0.072 parts by mass of the compound (s)-2, 0.146 parts by mass of the compound (s)-3, 2.20 parts by mass of a preservative (PROXEL (registered trademark) XL2(s) manufactured by LONZA), and 0.60 parts by mass of a buffering agent (LiHCO₃) were dissolved, and the pH of the resulting solution was adjusted to 8.5 with a pH adjusting agent (10 mol/L aqueous lithium hydroxide solution). The solution was filtered under reduced pressure through a microfilter having an average pore size of 0.20 μm and washed with deionized water to prepare an aqueous dye solution 70 (1,000 parts by mass).

### Example 71

### Preparation of Aqueous Dye Solution 71

In 200.00 parts by mass of deionized water, 12.4 parts by mass of A-1-1Fe, 50.0 parts by mass of B-1-1Fe, a total of 75.2 parts by mass of C-1-1-1Fe and C-1-1-2Fe, 50.0 parts by mass of D-1-1Fe, 12.4 parts by mass of E-1-1Fe, 0.36 parts by mass of the compound (s)-1, 0.072 parts by mass of the compound (s)-2, 0.146 parts by mass of the compound (s)-3, 2.20 parts by mass of a preservative (PROXEL (registered trademark) XL2(s) manufactured by LONZA), 0.60 parts by mass of a buffering agent (LiHCO₃), and 1.0 part by mass of (P-3) were dissolved, and the pH of the resulting solution was adjusted to 8.5 with a pH adjusting agent (10 mol/L aqueous sodium hydroxide solution). The solution was filtered under reduced pressure through a microfilter having an average pore size of 0.20 μm and washed with deionized water to prepare an aqueous dye solution 71 (1,000 parts by mass).

TABLE 19

| | | Example | Example | Example | Example | Example | Example | Example | Example | Example | Example |
|---|---|---|---|---|---|---|---|---|---|---|---|
| | | 51 | 52 | 53 | 54 | 55 | 56 | 57 | 58 | 59 | 60 |
| Compound A | Type | A-2-1 | A-2-1 | A-1-1Fe | A-1-1Fe | A-1-1Fe | A-1-1Zn | A-1-1Zn | A-1-1Zn | A-1-1Mg | A-1-1Mg |
| | Amount | 31.6 | 6.2 | 32.6 | 6.2 | 9.3 | 32.6 | 6.2 | 9.3 | 6.2 | 9.3 |
| Compound B | Type | B-2-1 | B-2-1 | B-1-1Fe | B-1-1Fe | B-1-1Fe | B-1-1Zn | B-1-1Zn | B-1-1Zn | B-1-1Mg | B-1-1Mg |
| | Amount | 42.0 | 25.0 | 42.0 | 25.0 | 37.5 | 42.0 | 25.0 | 37.5 | 25.0 | 37.5 |
| Compound C-I | Type | C-2-1-1 | C-2-1-1 | C-1-1-1Fe | C-1-1-1Fe | C-1-1-1Fe | C-1-1-1Zn | C-1-1-1Zn | C-1-1-1Zn | C-1-1-1Mg | C-1-1-1Mg |
| Compound C-II | | C-2-1-2 | C-2-1-2 | C-1-1-2Fe | C-1-1-2Fe | C-1-1-2Fe | C-1-1-2Zn | C-1-1-2Zn | C-1-1-2Zn | C-1-1-2Mg | C-1-1-2Mg |
| | Amount | 21.2 | 37.6 | 21.2 | 37.6 | 56.4 | 21.2 | 37.6 | 56.4 | 37.6 | 56.4 |
| Compound D | Type | D-2-1 | D-2-1 | D-1-1Fe | D-1-1Fe | D-1-1Fe | D-1-1Zn | D-1-1Zn | D-1-1Zn | D-1-1Mg | D-1-1Mg |
| | Amount | 4.8 | 25.0 | 4.8 | 25.0 | 37.5 | 4.8 | 25.0 | 37.5 | 25.0 | 37.5 |
| Compound E | Type | E-2-1 | E-2-1 | E-1-1Fe | E-1-1Fe | E-1-1Fe | E-1-1Zn | E-1-1Zn | E-1-1Zn | E-1-1Mg | E-1-1Mg |
| | Amount | 0.4 | 6.2 | 0.4 | 6.2 | 9.3 | 0.4 | 6.2 | 9.3 | 6.2 | 9.3 |
| Compound | Type | — | — | — | — | (P-4) | — | — | (P-4) | — | (P-4) |
| represented | Amount | 0.0 | 0.0 | 0.0 | 0.0 | 1.0 | 0.0 | 0.0 | 1.0 | 0.0 | 1.0 |
| by general | | | | | | | | | | | |
| formula (II) | | | | | | | | | | | |
| Chelating agent | Amount | 0.0 | 0.0 | 0.1 | 0.0 | 0.0 | 0.1 | 0.0 | 0.0 | 0.0 | 0.0 |
| (EDTA-4Li | | | | | | | | | | | |
| salt) | | | | | | | | | | | |
| Preservative | Amount | 2.2 | 2.2 | 2.2 | 2.2 | 2.2 | 2.2 | 2.2 | 2.2 | 2.2 | 2.2 |

TABLE 20

| | | Example | Example | Example | Example | Example | Example | Example | Example | Example |
|---|---|---|---|---|---|---|---|---|---|---|
| | | 61 | 62 | 63 | 64 | 65 | 66 | 67 | 68 | 69 |
| Compound A | Type | A-1-1Fe | A-1-1Fe | A-1-1Fe | A-1-1Zn | A-1-1Zn | A-1-1Zn | A-1-1Mg | A-1-1Mg | A-1-1Mg |
| | Amount | 6.2 | 9.3 | 12.4 | 6.2 | 9.3 | 12.4 | 6.2 | 9.3 | 12.4 |
| Compound B | Type | B-1-1Fe | B-1-1Fe | B-1-1Fe | B-1-1Zn | B-1-1Zn | B-1-1Zn | B-1-1Mg | B-1-1Mg | B-1-1Mg |
| | Amount | 25.0 | 37.5 | 50.0 | 25.0 | 37.5 | 50.0 | 25.0 | 37.5 | 50.0 |
| Compound C-I | Type | C-1-1-1Fe | C-1-1-1Fe | C-1-1-1Fe | C-1-1-1Zn | C-1-1-1Zn | C-1-1-1Zn | C-1-1-1Mg | C-1-1-1Mg | C-1-1-1Mg |
| Compound C-II | | C-1-1-2Fe | C-1-1-2Fe | C-1-1-2Fe | C-1-1-2Zn | C-1-1-2Zn | C-1-1-2Zn | C-1-1-2Mg | C-1-1-2Mg | C-1-1-2Mg |
| | Amount | 37.6 | 56.4 | 75.2 | 37.6 | 56.4 | 75.2 | 37.6 | 56.4 | 75.2 |
| Compound D | Type | D-1-1Fe | D-1-1Fe | D-1-1Fe | D-1-1Zn | D-1-1Zn | D-1-1Zn | D-1-1Mg | D-1-1Mg | D-1-1Mg |
| | Amount | 25.0 | 37.5 | 50.0 | 25.0 | 37.5 | 50.0 | 25.0 | 37.5 | 50.0 |
| Compound E | Type | E-1-1Fe | E-1-1Fe | E-1-1Fe | E-1-1Zn | E-1-1Zn | E-1-1Zn | E-1-1Mg | E-1-1Mg | E-1-1Mg |
| | Amount | 6.2 | 9.3 | 12.4 | 6.2 | 9.3 | 12.4 | 6.2 | 9.3 | 12.4 |
| Compound | Type | (P-3) | (P-3) | (P-3) | (P-3) | (P-3) | (P-3) | (P-3) | (P-3) | (P-3) |
| represented | Amount | 1.0 | 1.0 | 1.0 | 1.0 | 1.0 | 1.0 | 1.0 | 1.0 | 1.0 |
| by general | | | | | | | | | | |
| formula (II) | | | | | | | | | | |
| Chelating agent | Amount | 0.1 | 0.1 | 0.1 | 0.1 | 0.1 | 0.1 | 0.1 | 0.1 | 0.1 |
| (EDTA-4Na | | | | | | | | | | |
| salt) | | | | | | | | | | |
| Preservative | Amount | 2.2 | 2.2 | 2.2 | 2.2 | 2.2 | 2.2 | 2.2 | 2.2 | 2.2 |

### Storage Stability of Aqueous Dye Solution

The evaluation of storage stability was performed after, as a forced test, each of the aqueous dye solutions prepared in Examples 51 to 71 was preserved at 60° C. for 4 weeks, and after the aqueous dye solution was preserved at 60° C. for 10 weeks.

The storage stability was evaluated using the following two-level rating scale. When an aqueous dye solution maintained substantially the same physical properties (a viscosity, a surface tension, and an absorbance value measured after dilution with deionized water to a concentration of 1/7000 on a mass basis) as those immediately after the preparation of the aqueous dye solution, the aqueous dye solution was rated as A. When at least one item of the physical property values of the liquid was changed by ±5% or more after the forced test, the aqueous dye solution was rated as B.

Table 21 below shows the results.

TABLE 21

| | Storage stability | | |
|---|---|---|---|
| | After 4-week | After 10-week | Concentration |
| | forced test | forced test | of dye |
| Example 51 | A | A | 10% by mass |
| Example 52 | A | A | 10% by mass |
| Example 53 | A | A | 10% by mass |
| Example 54 | A | A | 10% by mass |
| Example 55 | A | A | 15% by mass |
| Example 56 | A | A | 10% by mass |
| Example 57 | A | A | 10% by mass |
| Example 58 | A | A | 15% by mass |
| Example 59 | A | A | 10% by mass |
| Example 60 | A | A | 15% by mass |
| Example 61 | A | A | 10% by mass |
| Example 62 | A | A | 15% by mass |
| Example 63 | A | B | 20% by mass |
| Example 64 | A | A | 10% by mass |
| Example 65 | A | A | 15% by mass |
| Example 66 | A | B | 20% by mass |
| Example 67 | A | A | 10% by mass |
| Example 68 | A | A | 15% by mass |
| Example 69 | A | B | 20% by mass |
| Example 70 | A | A | 10% by mass |
| Example 71 | A | A | 20% by mass |

The above results showed that the aqueous dye solutions of Examples of the present invention had good storage stability even when the aqueous dye solutions included dyes in high concentrations. In particular, when the concentration of the dye was 15% by mass or less, the physical properties of the liquids did not change even after the forced test was performed for 10 weeks, and thus the storage stability was found to be very high.

Moreover, in the case of using the compound (S) in combination, the physical properties of the liquids did not change even after the forced test was performed for 10 weeks, and thus the aqueous dye solutions having high concentrations were found to have extremely high storage stability.

According to the present invention, it is possible to provide a dye ink composition that enables the formation of an image having high print density on both ink jet paper and plain paper, that enables stable ejection of an ink even during long time use (that has good continuous ejection stability), and that enables the formation of an image having high print density and has good continuous ejection stability even after a long period of time has passed after preparation; a cyan dye ink including the dye ink composition; a dye ink for ink jet recording, the dye ink including the dye ink composition; an ink jet recording method using the dye ink for ink jet recording; and an aqueous dye solution that can be used to produce the dye ink composition.

While the present invention has been described in detail and with reference to specific embodiments, it will be apparent to those skilled in the art that various changes and modifications can be made without departing from the spirit and scope of the present invention.

What is claimed is:

1. A dye ink composition comprising:
a compound A represented by the following general formula (I-1-1) or (I-1-2);
a compound B represented by the following general formula (I-2-1) or (I-2-2);
at least one of a compound C-I represented by the following general formula (I-3-1-1) or (I-3-1-2) or a compound C-II represented by the following general formula (I-3-2-1) or (I-3-2-2);
a compound D represented by the following general formula (I-4-1) or (I-4-2); and
water, 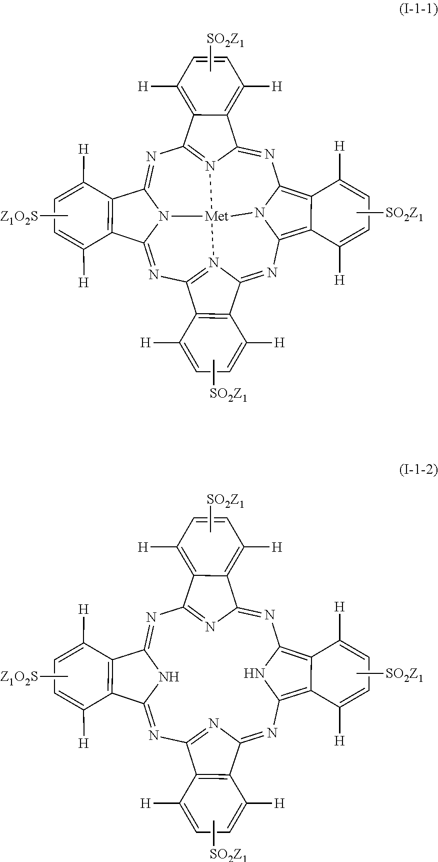 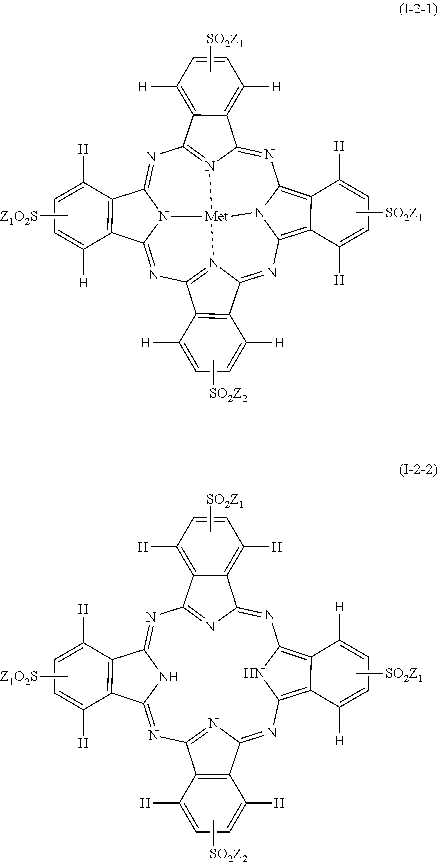 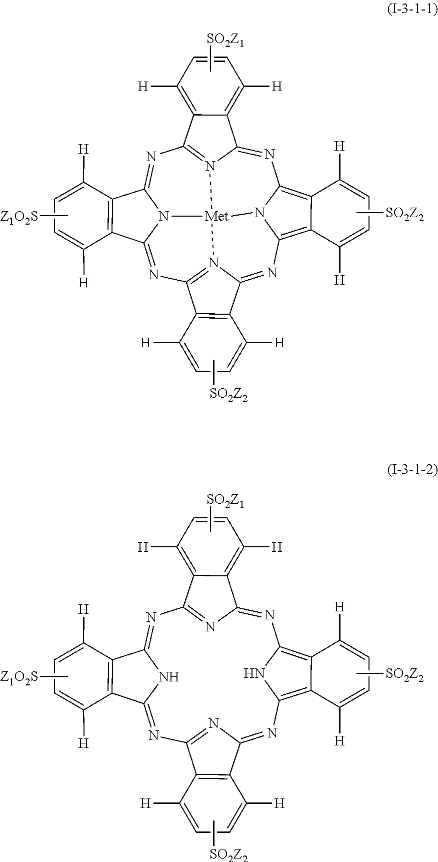 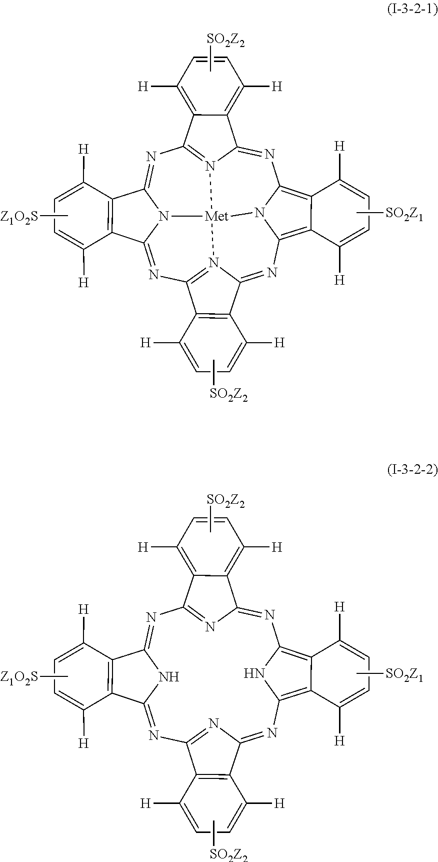 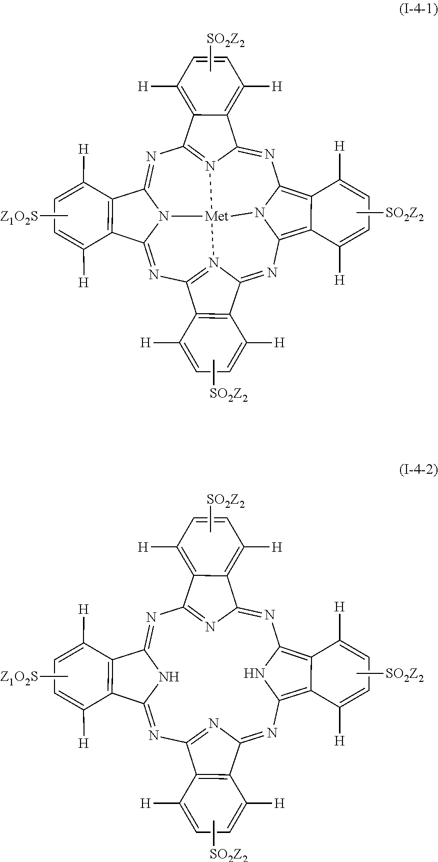
wherein, in the general formulae (I-1-1), (I-2-1), (I-3-1-1), (I-3-2-1), and (I-4-1), Met represents Al, Fe, Co, Ni, Zn, Mg, or Mn,
wherein, in the general formulae (I-1-1), (I-1-2), (I-2-1), (I-2-2), (I-3-1-1), (I-3-1-2), (I-3-2-1), (I-3-2-2), (I-4-1), and (I-4-2), Zi represents an alkyl group, an aryl group, or a heterocyclic group, the alkyl group, the aryl group, and the heterocyclic group having a substituent that has at least one ionic hydrophilic group, and a plurality of Z₁ in the general formulae (I-1-1), (I-1-2), (I-2-1), (I-2-2), (I-3-1-1), (I-3-1-2), (I-3-2-1), and (I-3-2-2) may be the same or different,
wherein, in the general formulae (I-2-1), (I-2-2), (I-3-1-1), (I-3-1-2), (I-3-2-1), (I-3-2-2), (I-4-1), and (I-4-2), Z₂ represents a substituted or unsubstituted alkyl group, a substituted or unsubstituted aryl group, or a substituted or unsubstituted heterocyclic group, Z₂ does not have an ionic hydrophilic group, and a plurality of Z₂ in the general formulae (I-3-1-1), (I-3-1-2), (I-3-2-1), (I-3-2-2), (I-4-1), and (I-4-2) may be the same or different, and
wherein, in the dye ink composition, in a case where a mass of the compound A is represented by W₁, a mass of the compound B is represented by W₂, a sum of a mass of the compound C-I and a mass of the compound C-II is represented by W₃, a mass of the compound D is represented by W₄, and a sum total of W₁, W₂, W₃, and W₄ is represented by W_{A1},
a ratio of W₁ to W_{A1} is 6.0% to 35.0% by mass,
a ratio of W₂ to W_{A1} is 20.0% to 45.0% by mass,
a ratio of W₃ to W_{A1} is 15.0% to 45.0% by mass, and
a ratio of W₄ to W_{A1} is 1.0% to 30.0% by mass.

2. The dye ink composition according to claim 1, further comprising:
a compound E represented by the following general formula (I-5-1) or (I-5-2), 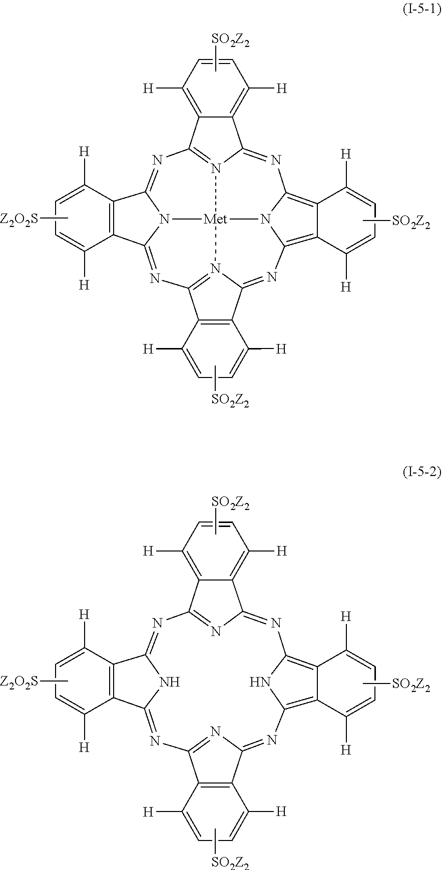
wherein, in the general formula (I-5-1), Met represents Al, Fe, Co, Ni, Zn, Mg, or Mn, Z₂ represents a substituted or unsubstituted alkyl group, a substituted or unsubstituted aryl group, or a substituted or unsubstituted heterocyclic group, Z₂ does not have an ionic hydrophilic group, and the plurality of Z₂ may be the same or different.

3. The dye ink composition according to claim 2,
wherein, in the dye ink composition, in a case where, a mass of the compound A is represented by W₁, a mass of the compound B is represented by W₂, a sum of a mass of the compound C-I and a mass of the compound C-II is represented by W₃, a mass of the compound D is represented by W₄, a mass of the compound E is represented by W₅, and a sum total of W₁, W₂, W₃, W₄, and W₅ is represented by W_{A2},
a ratio of W₁ to W_{A2} is 5.0% to 35.0% by mass,
a ratio of W₂ to W_{A2} is 20.0% to 45.0% by mass,
a ratio of W₃ to W_{A2} is 15.0% to 45.0% by mass,
a ratio of W₄ to W_{A2} is 1.0% to 30.0% by mass, and
a ratio of W₅ to W_{A2} is 0.1% to 10.0% by mass.

4. The dye ink composition according to claim 1, wherein Z2 has at least one of a hydroxy group or a tertiary nitrogen atom.

5. The dye ink composition according to claim 1, wherein the ionic hydrophilic group is at least one of —SO₃M, —CO₂M, or —PO(OM)₂, and M represents a hydrogen atom or a counter cation.

6. The dye ink composition according to claim 1, wherein a ratio of W_{A1} to a total mass of the dye ink composition is 3.0% by mass or more and 5.5% by mass or less.

7. The dye ink composition according to claim 1, further comprising:
a compound represented by the following general formula (II), 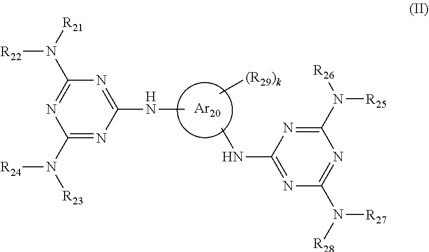
wherein, in the general formula (II), Ar₂₀ represents a benzene ring or a naphthalene ring; R₂₁ to R₂₈ each independently represent a hydrogen atom or a substituent; R₂₁ and R₂₂ may be linked to each other to form a ring; R₂₃ and R₂₄ may be linked to each other to form a ring; R₂₅ and R₂₆ may be linked to each other to form a ring; R27 and R28 may be linked to each other to form a ring; R₂₉ represents a substituent; in a case where Ar₂₀ represents a benzene ring, k represents an integer of 0 to 4; in a case where Ar₂₀ represents a naphthalene ring, k represents an integer of 0 to 6; in a case where a plurality of R₂₉ are present, the plurality of R₂₉ may be the same or different; and in a case where a plurality of R₂₉ are present, the plurality of R₂₉ may be linked together to form a ring; and at least any one of R₂₁ to R₂₉ has a hydrophilic group.

8. The dye ink composition according to claim 7, wherein a content of the compound represented by the general formula (II) is 0.5% to 3.0% by mass with respect to a total mass of the dye ink composition.

9. The dye ink composition according to claim 1, further comprising:
a compound represented by the following general formula (Cy-1), 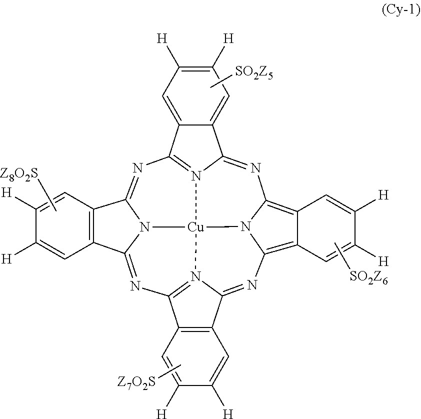
wherein, in the general formula (Cy-1), Z₅, Z₆, Z₇, and Z₈ each independently represent a substituted or unsubstituted alkyl group, a substituted or unsubstituted aryl group, or a substituted or unsubstituted heterocyclic group, and at least one of Z₅, Z₆, Z₇, or Z₈ has a substituent that has an ionic hydrophilic group.

10. The dye ink composition according to claim 1, further comprising:
a compound represented by any of the following general formulae (Cy-2) to (Cy-5), 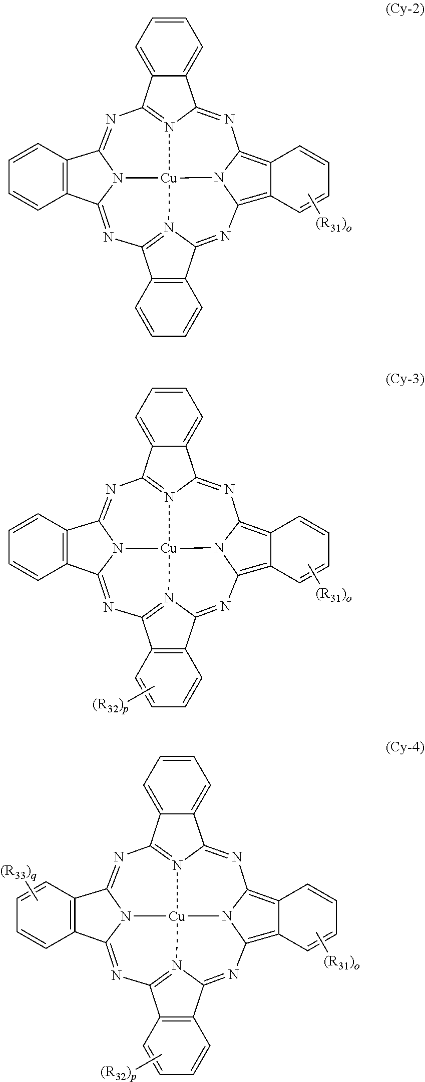 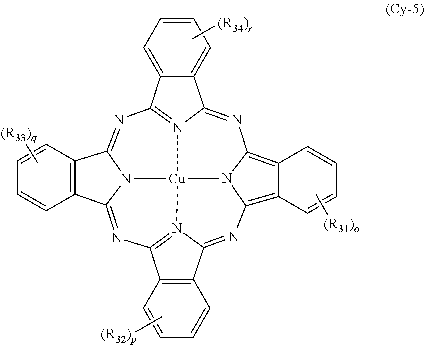
wherein, in the general formulae (Cy-2) to (Cy-5), R₃₁, R₃₂, R₃₃, and R₃₄ each independently represent a substituted or unsubstituted sulfamoyl group, a substituted or unsubstituted carbamoyl group, a sulfo group, or a carboxy group; in a case where a plurality of R₃₁ are present, the plurality of R₃₁ may be the same or different; in a case where a plurality of R₃₂ are present, the plurality of R₃₂ may be the same or different; in a case where a plurality of R₃₃, are present, the plurality of R₃₃ may be the same or different; in a case where a plurality of R₃₄ are present, the plurality of R₃₄ may be the same or different; and o, p, q, and r each independently represent an integer of 1 to 4.

11. The dye ink composition according to claim 1, further comprising a chelating agent.

12. The dye ink composition according to claim 1, further comprising a preservative.

13. A cyan dye ink comprising the dye ink composition according to claim 1.

14. A dye ink for ink jet recording, the dye ink comprising the dye ink composition according to claim 1.

15. An ink jet recording method comprising ejecting the dye ink for ink jet recording according to claim 14 with a recording head for an ink jet process.

16. An aqueous dye solution comprising:
a preservative,
a compound A represented by the following general formula (I-1-1) or (I-1-2),
a compound B represented by the following general formula (I-2-1) or (I-2-2),
at least one of a compound C-I represented by the following general formula (I-3-1-1) or (I-3-1-2) or a compound C-II represented by the following general formula (I-3-2-1) or (I-3-2-2), and
a compound D represented by the following general formula (I-4-1) or (I-4-2),
wherein in a case where a mass of the compound A is represented by W₁, a mass of the compound B is represented by W₂, a sum of a mass of the compound C-I and a mass of the compound C-II is represented by W₃, a mass of the compound D is represented by W₄, and a sum total of W₁, W₂, W₃, and W₄ is represented by W_{A1},
a ratio of W_{A1} to a total mass of the aqueous dye solution is 8% to 15% by mass, 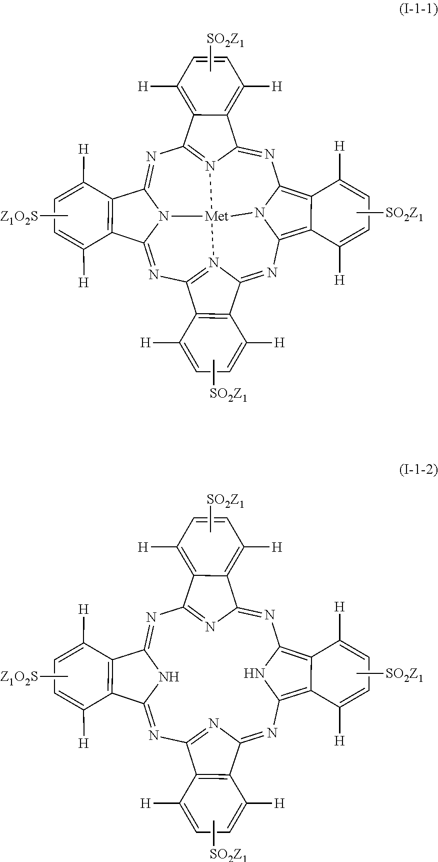 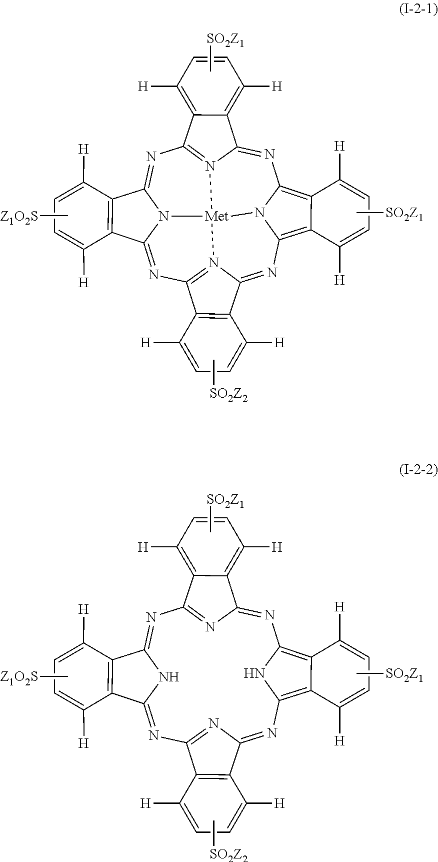 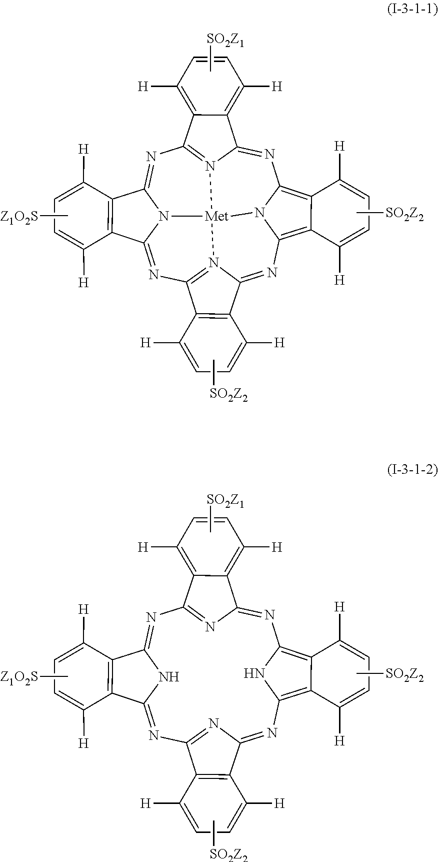 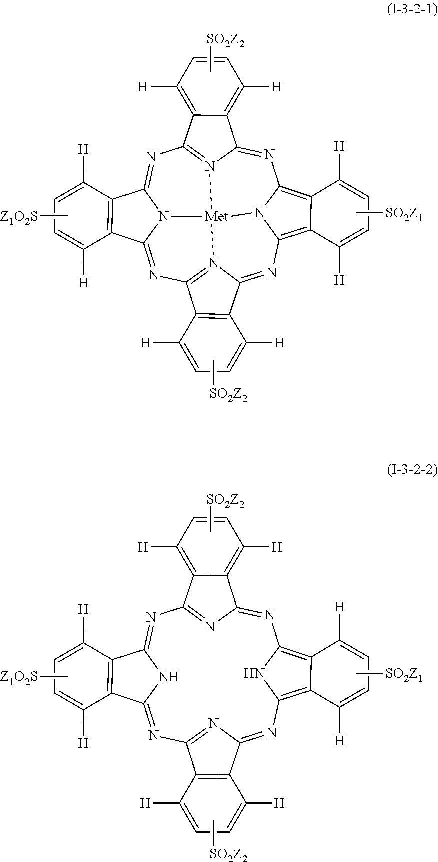 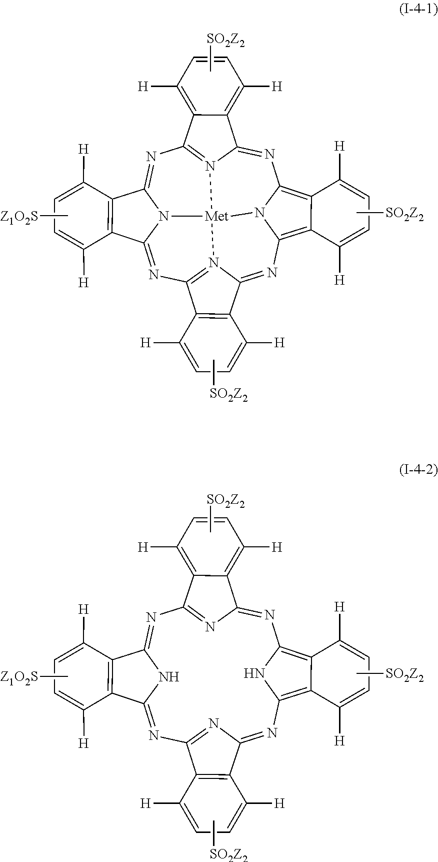
wherein, in the general formulae (I-1-1), (I-2-1), (I-3-1-1), (I-3-2-1), and (I-4-1), Met represents Al, Fe, Co, Ni, Zn, Mg, or Mn,
wherein, in the general formulae (I-1-1), (I-1-2), (I-2-1), (I-2-2), (I-3-1-1), (I-3-1-2), (I-3-2-1), (I-3-2-2), (I-4-1), and (I-4-2), Zi represents an alkyl group, an aryl group, or a heterocyclic group, the alkyl group, the aryl group, and the heterocyclic group having a substituent that has at least one ionic hydrophilic group, and a plurality of Z₁ in the general formulae (I-1-1), (I-1-2), (I-2-1), (I-2-2), (I-3-1-1), (I-3-1-2), (I-3-2-1), and (I-3-2-2) may be the same or different,
wherein, in the general formulae (I-2-1), (I-2-2), (I-3-1-1), (I-3-1-2), (I-3-2-1), (I-3-2-2), (I-4-1), and (I-4-2), Z₂ represents a substituted or unsubstituted alkyl group, a substituted or unsubstituted aryl group, or a substituted or unsubstituted heterocyclic group, Z₂ does not have an ionic hydrophilic group, and a plurality of Z₂ in the general formulae (I-3-1-1), (I-3-1-2), (I-3-2-1), (I-3-2-2), (I-4-1), and (I-4-2) may be the same or different.

17. The aqueous dye solution according to claim 16, further comprising:
a compound E represented by the following general formula (I-5-1) or (I-5-2),
wherein in a case where a mass of the compound E is represented by W₅ and a sum total of W₁, W₂, W₃, W₄, and W₅ is represented by W_{A2},
a ratio of W_{A2} to the total mass of the aqueous dye solution is 8% to 15% by mass, 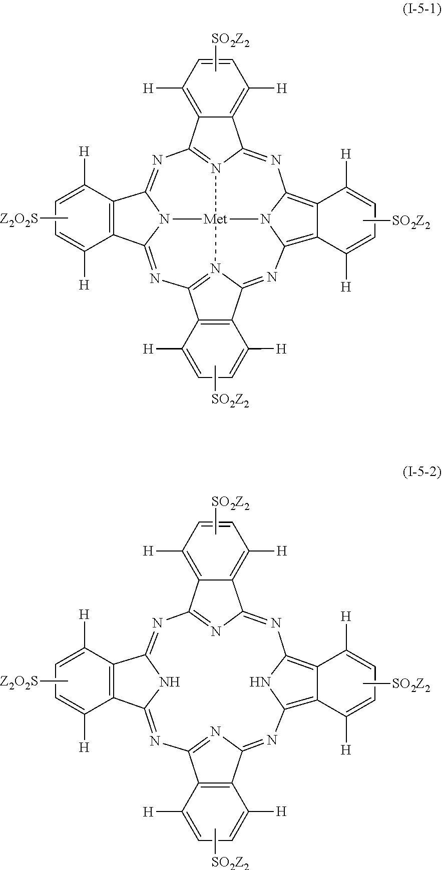
wherein, in the general formula (I-5-1), Met represents Al, Fe, Co, Ni, Zn, Mg, or Mn, Z₂ represents a substituted or unsubstituted alkyl group, a substituted or unsubstituted aryl group, or a substituted or unsubstituted heterocyclic group, Z₂ does not have an ionic hydrophilic group, and the plurality of Z₂ may be the same or different.

18. The aqueous dye solution according to claim 16, further comprising:
a compound represented by the following general formula (II), 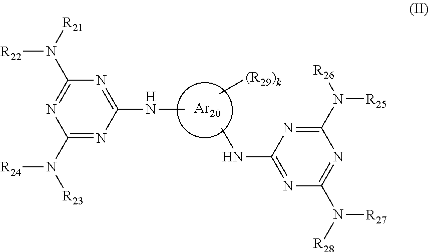
wherein, in the general formula (II), Ar₂₀ represents a benzene ring or a naphthalene ring; R₂₁ to R₂₈ each independently represent a hydrogen atom or a substituent; R₂₁ and R₂₂ may be linked to each other to form a ring; R₂₃ and R₂₄ may be linked to each other to form a ring; R₂₅ and R₂₆ may be linked to each other to form a ring; R₂₇ and R₂₈ may be linked to each other to form a ring; R₂₉ represents a substituent; in a case where Ar₂₀ represents a benzene ring, k represents an integer of 0 to 4; in a case where Ar₂₀ represents a naphthalene ring, k represents an integer of 0 to 6; in a case where a plurality of R₂₉ are present, the plurality of R₂₉ may be the same or different; in a case where a plurality of R₂₉ are present, the plurality of R₂₉ may be linked together to form a ring; and at least any one of R₂₁ to R₂₉ has a hydrophilic group.

19. The aqueous dye solution according to claim 16, further comprising a chelating agent.

20. The aqueous dye solution according to claim 16, further comprising a compound represented by the following general formula (S), 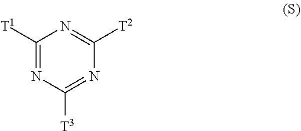
wherein, in the general formula (S), T¹, T², and T³ each independently represent *—NH—(CH₂)ₙ-Rt, *—NH—(CH₂)ₙ—OH, *—N—((CH₂)ₙ—OH)₂, *—OM, a halogen atom, or a substituted or unsubstituted arylamino group, and at least one of T¹, T², or T³ represents *—NH—(CH₂)ₙ-Rt, *—NH—(CH₂)ₙ—OH, or *—N—((CH₂)ₙ—OH)₂; * represents a binding site to a triazine ring, n represents an integer of 1 to 5, and Rt represents COOM, SO₃M, or PO(OM)₂; M represents a hydrogen atom or a counter cation; in a case where a plurality of n are present, the plurality of n may be the same or different; and in a case where a plurality of M are present, the plurality of M may be the same or different.

21. The aqueous dye solution according to claim 20, wherein the compound represented by the general formula (S) is at least one compound selected from the following compound group (s),
Compound group (s): 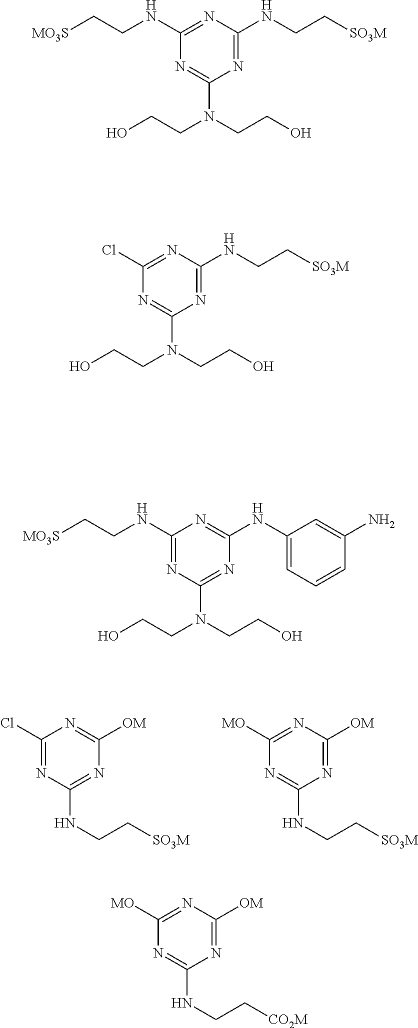 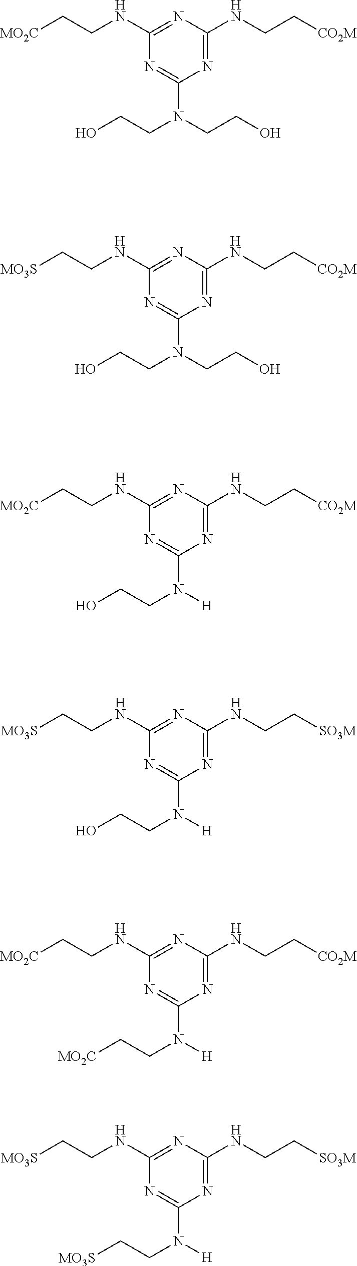 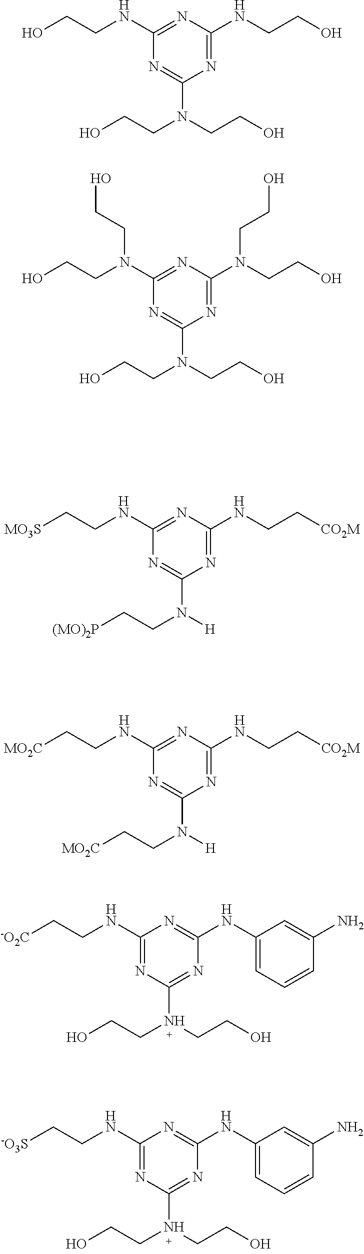 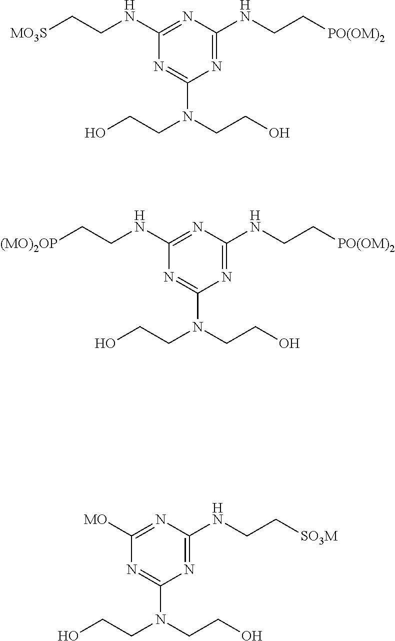
wherein M in a compound of the compound group (s) represents a hydrogen atom or a counter cation; and in a case where a plurality of M are present in the compound, the plurality of M may be the same or different.
